(19) United States
(12) Patent Application Publication
(10) Pub. No.: US 2019/0261687 A1
(43) Pub. Date: Aug. 29, 2019

(54) METHODS AND DEVICES FOR SMOKING URGE RELIEF

(71) Applicant: FONTEM HOLDINGS 1 B.V., Amsterdam (NL)

(72) Inventors: Martin WENSLEY, Campbell, CA (US); Michael HUFFORD, Chapel Hill, CA (US); Jeffrey WILLIAMS, Draper, UT (US); Peter LLOYD, Walnut Creek, CA (US)

(21) Appl. No.: 16/282,956

(22) Filed: Feb. 22, 2019

Related U.S. Application Data
(63) Continuation of application No. 14/603,217, filed on Jan. 22, 2015, now abandoned.
(60) Provisional application No. 61/977,591, filed on Apr. 9, 2014.
(60) Provisional application No. 61/971,456, filed on Mar. 27, 2014.
(60) Provisional application No. 61/950,775, filed on Mar. 10, 2014.
(60) Provisional application No. 61/949,771, filed on Mar. 7, 2014.
(60) Provisional application No. 61/937,313, filed on Feb. 7, 2014.
(60) Provisional application No. 61/930,391, filed on Jan. 22, 2014.

(51) Int. Cl. A24F 47/00; H05B 1/02

(52) U.S. Cl. CPC A24F 47/008; H05B 1/0244

(57) ABSTRACT

Provided herein are methods, devices, systems, and computer readable medium for delivering one or more compounds to a subject. Also described herein are methods, devices, systems, and computer readable medium for transitioning a smoker to an electronic nicotine delivery device and for smoking or nicotine urge relief.

### CROSS-REFERENCE TO RELATED APPLICATION(S)

This application is a continuation of U.S. patent application Ser. No. 14/603,217, filed Jan. 22, 2015 and now pending, which claims the benefit of U.S. Provisional Application No. 61/977,591, filed on Apr. 9, 2014, 61/971,456, filed on Mar. 27, 2014, 61/950,775, filed on Mar. 10, 2014, 61/949,771, filed on Mar. 7, 2014, 61/937,313, filed on Feb. 7, 2014, and 61/930,391, filed on Jan. 22, 2014, each of which is herein incorporated by reference in its entirety.

### BACKGROUND

There is a need for new methods and devices for administering compounds, such as pharmaceutical agents, to a subject. In particular, there is a need for methods and devices for delivery of compounds to a subject where the compounds are aerosolized to fall within a specified particle size range. In some cases, particles within a specified size range can be efficiently delivered to the deep lung. For example, there is an urgent need for improved methods and devices to deliver nicotine to a subject in specified doses and in a specified particle range size without the carcinogens and other chemicals associated with combustible tobacco products.

In 2011, an estimated 19% of U.S. adults were current smokers (43.8 million people), and an estimated 950 children become addicted to smoking daily. Smokers spend approximately $83 billion to support their habit, and half of smokers will die from their habit. Studies indicate that about 85% of smokers want to quit; however, only about 5% succeed.

Current nicotine replacement therapies (NRTs) are not effective for approximately 85% of users. In some cases, existing NRTs and electronic cigarettes (eCigs) fail to provide sufficient doses of nicotine. Many smokers using NRTs under-dose, resulting in break-through cravings, which can lead to smoking lapses and eventual relapse. Smokers also vary widely in terms of their daily nicotine intake, ranging from “social smokers” who may only consume 1 or 2 cigarettes in the presence of friends and/or with alcohol, to heavy smokers who consume 60 or more cigarettes per day. Thus, a need exists to provide effective, customized doses of nicotine to individuals attempting to use recreational nicotine products or to leverage these devices to help quit smoking or nicotine intake all together.

Furthermore, to facilitate nicotine delivery using an electronic nicotine delivery device, a need exists to control nicotine particle size generated from an electronic nicotine delivery device to match the rapid nicotine pharmacokinetics (PK) from smoking, which can result in deep lung absorption of nicotine. Deep lung absorption of nicotine can facilitate rapid delivery of nicotine to the brain, which can result in a subsequent cessation of nicotine cravings. When smoking combustible tobacco products, nicotine laden smoke particles are carried proximally on tar droplets (0.1-1.0 μm in diameter), are inhaled and travel to the small airways and alveoli in the deep lung. Nicotine off-gasses from particles and defuses to, and deposits on, the alveoli wall where it can be rapidly absorbed into the blood stream. A typical electronic cigarette does not produce an aerosol of nicotine with a particle size for deep lung delivery. Aerosol particles with an aerodynamic diameter larger than 5 μm can be too large to reach the deep lung because the particles can impact in the mouth and upper airway, resulting in a slow PK. Conversely, aerosol particles with a median aerodynamic diameter of less than 1 μm can be small enough to reach the deep lung but can be too light to gravitationally settle and can be exhaled, which can result in low dose delivery. Additionally, aerosols with small aerosol particle size can contain a larger percentage of the mass in the gas phase, which rapidly diffuses to the mouth and upper airway. Aerosol particles with an aerodynamic diameter of about 1 μm to about 5 μm can be small enough to reach the deep lung but large enough to gravitationally settle in alveoli, which can result in a rapid PK. A need exists for electronic nicotine delivery devices that produce such particles. In addition, a need exists for producing nicotine aerosols that produce such particles using the liquid drug. Moreover, a need exists for methods of using such devices to help users achieve a particular health goal or goals.

There is also a need for a drug delivery platform that is capable of dispensing a variety of drugs to a subject in a specified dose or in a specified particle size range.

There is also a need for a drug delivery platform that is capable of dispensing a variety of drugs to a subject in a specified dose or in a specified particle size range.

### SUMMARY

In one aspect, provided herein is a method for treating an urge of a subject to smoke, the method comprising administering to a subject a condensation aerosol comprising nicotine, wherein the administering comprises: a. producing the condensation aerosol comprising nicotine in an aerosol generating device configured to vaporize a liquid formulation comprising nicotine and condense the vaporized liquid formulation comprising nicotine into the condensation aerosol comprising nicotine, wherein the condensation aerosol comprises a diameter of from about 1 μm to about 5 μm; and b. delivering the condensation aerosol comprising nicotine to a subject using the device, wherein the delivering comprises the subject inhaling the condensation aerosol comprising nicotine from the device thereby reducing the urge of the subject to smoke. In some cases, the reduction in the urge to smoke occurs in less than about 1 minute after administering the condensation aerosol comprising nicotine. In some cases, the reduction in the urge to smoke is sustained for at least 30 minutes following administering the condensation aerosol comprising nicotine. In some cases, the reduction in the urge to smoke in the subject is at least 50%. In some cases, the reduction in the urge to smoke in the subject is at least 60%. In some cases, the reduction in the urge to smoke in the subject is at least 70%. In some cases, the reduction in the urge to smoke in the subject is at least 80%. In some cases, the reduction in the urge to smoke in the subject is a complete or substantially complete elimination of the urge to smoke in the subject. In some cases, the reduction in the urge to smoke is compared to an urge to smoke in the subject before using the aerosol generating device. In some cases, the reduction in the urge to smoke is compared to an urge to smoke in the subject following administration of a vehicle using the aerosol generating device. In some cases, the reduction in the urge to smoke is assessed using a psychometric response scale. In some cases, the psychometric response scale comprises a smoking urge visual analog scale (SU-VAS). In some cases, the reduction in the urge to smoke is sustained for at least 60 minutes. In some cases, the diameter of the condensation aerosol comprises a mass median aerodynamic diameter (MMAD). In some cases, the diameter of the condensation aerosol comprises a volume median diameter (VMD). In some cases, the condensation aerosol comprises a geometric standard deviation of less than 2. In some cases, the condensation aerosol generating device is configured to deliver the condensation aerosol comprising nicotine to a deep lung of the subject. In some cases, the subject exhales no or substantially no visible vapor following inhalation of the condensation aerosol produced by the device. In some cases, the administering comprises the subject inhaling the condensation aerosol a plurality of times per use of the device, wherein the inhaling a plurality of times administers a pre-determined dose of nicotine to the subject per use of the device. In some cases, the pre-determined dose of nicotine is from about 500 μg to about 1000 μg. In some cases, the plurality of times comprises from about 2 to about 10 inhalations from the device. In some cases, the predetermined dose of nicotine produces a nicotine blood concentration that is at least 50% less than the nicotine plasma concentration produced by a cigarette or an electronic cigarette. In some cases, the pre-determined dose of nicotine produces a nicotine plasma concentration of from about 0.5 ng/ml to about 1 ng/ml. In some cases, the nicotine plasma concentration is produced in about 30 seconds following the administration of the pre-determined dose of nicotine. In some cases, the nicotine plasma concentration is sustained for at least 10 minutes following the administration of the pre-determined dose of nicotine. In some cases, the pre-determined dose of nicotine administered to the subject per use of the device is substantially identical between uses of the device. In some cases, the subject administers the condensation aerosol comprising nicotine according to a prescribed treatment regimen. In some cases, the subject administers the condensation aerosol comprising nicotine on demand. In some cases, the subject administers the condensation aerosol comprising nicotine multiple times per day. In some cases, the aerosol generating device comprises: a. a reservoir comprising the liquid formulation comprising nicotine; b. an air flow channel comprising an inlet and an outlet; and c. a heater element within the airflow channel, wherein the heater element is in fluid communication with the liquid formulation comprising nicotine; and wherein producing the condensation aerosol comprising nicotine with a diameter of from about 1 μm to about 5 μm comprises vaporizing the liquid formulation comprising nicotine upon delivery of the liquid formulation comprising nicotine to the heater element and subsequent activation of the heater element. In some cases, the device is hand-held. In some cases, the device is disk-shaped. In some cases, the reservoir comprises a pre-determined number of doses of the liquid formulation comprising nicotine. In some cases, the pre-determined number of doses comprises an amount of nicotine sufficient to provide about 1 day of use on demand by a subject. In some cases, the pre-determined number of doses comprises an amount of nicotine sufficient to provide about 1 to about 7 days of use on demand by a subject. In some cases, the pre-determined number of doses comprises an amount of nicotine sufficient to provide about 1 to about 14 days of use on demand by a subject. In some cases, the device further comprises a pump, wherein the pump is configured to deliver the liquid nicotine formulation comprising nicotine from the reservoir to the heater element. In some cases, the pump is located completely within the reservoir. In some cases, the pump is located partially within the reservoir. In some cases, the pump is a diaphragm pump. In some cases, the pump is a piston pump. In some cases, the drive motor for the pump is located outside of the reservoir. In some cases, the heater element comprises a coil comprising electrically resistive material. In some cases, the heater element further comprises a wicking element in fluid communication with the liquid formulation comprising nicotine and wherein the coil comprising electrically resistive material is wrapped around the wicking element. In some cases, the wicking element comprises electrically resistive material. In some cases, the wicking element and the coil are continuous. In some cases, the device further comprises an additional airflow channel connected to the airflow channel. In some cases, the additional airflow channel connects between the outlet and the heater element in the airflow channel. In some cases, the additional airflow channel connects to the airflow channel between the inlet and the heater element. In some cases, the additional airflow channel permits entry of entrainment air, wherein the condensation aerosol is mixed with the entrainment air to produce a total airflow rate out of the mouthpiece of between about 20 LPM and about 80 LPM at a vacuum of about 249 Pa to about 3738 Pa (about 1 inch of water to about 15 inches of water).

In one aspect, provided herein is a method for treating an urge to smoke in a subject, the method comprising: administering a condensation aerosol comprising nicotine to the subject, wherein the condensatin erosol comprising nicotine comprises a diameter of from about 1 μm to about 5 μm, wherein the administering comprises the subject inhaling the condensation aerosol comprising nicotine from a device configured to generate the condensation aerosol comprising nicotine from a liquid formulation comprising nicotine, and wherein the condensation aerosol comprises a pre-determined amount of nicotine, whereby the subject inhales the condensation aerosol a plurality of times in order to administer a pre-determined dose of nicotine, thereby reducing the urge to smoke in the subject. In some cases, the diameter comprises a mass median aerodynamic diameter (MMAD). In some cases, the condensation aerosol comprises a geometric standard deviation of less than 2. In some cases, the device is configured to deliver the condensation aerosol comprising nicotine to a deep lung of the subject. In some cases, the reduction in the urge to smoke in the subject is at least 50%. In some cases, the reduction in the urge to smoke in the subject is at least 60%. In some cases, the reduction in the urge to smoke in the subject is at least 70%. In some cases, the reduction in the urge to smoke in the subject is at least 80%. In some cases, the reduction in the urge to smoke in the subject is a complete or substantially complete elimination of the urge to smoke in the subject. In some cases, the reduction in the urge to smoke is compared to an urge to smoke in the subject before using the aerosol generating device. In some cases, the reduction in the urge to smoke is compared to an urge to smoke in the subject following administration of a vehicle using the aerosol generating device. In some cases, the reduction in the urge to smoke is sustained for at least 60 minutes. In some cases, the reduction in the urge to smoke is assessed using a psychometric response scale. In some cases, the psychometric response scale comprises a smoking urge visual analog scale (SU-VAS). In some cases, the reduction in the urge to smoke in the subject occurs within about 1 minute after administering the condensation aerosol comprising nicotine to the subject using the device. In some cases, the subject exhales no or substantially no visible vapor following inhalation of the condensation aerosol produced by the device. In some cases, the pre-determined amount of nicotine is from about 25 to about 100 μg. In some cases, the pre-determined dose of nicotine is from about 500 μg to about 1000 μg. In some cases, the pre-determined dose of nicotine is about 500 μg. In some cases, the pre-determined dose of nicotine is about 1000 μg. In some cases, the plurality of times comprises from about 2 to about 10 inhalations from the device. In some cases, the pre-determined dose of nicotine produces a nicotine plasma concentration that is at least 50% less than the nicotine plasma concentration produced by a cigarette or an electronic cigarette. In some cases, the pre-determined dose of nicotine produces a nicotine plasma concentration of from about 0.5 ng/ml to about 1 ng/ml. In some cases, the nicotine plasma concentration is produced in about 30 seconds following the administration of the pre-determined dose of nicotine. In some cases, the nicotine plasma concentration is sustained for at least 10 minutes following the administration of the pre-determined dose of nicotine. In some cases, the device is hand-held. In some cases, the device is disk-shaped. In some cases, the device further comprises a reservoir and a heater element, wherein the reservoir comprises a pre-determined number of doses of the liquid formulation comprising nicotine. In some cases, the pre-determined number of doses comprises an amount of nicotine sufficient to provide about 1 day of use on demand by a subject. In some cases, the pre-determined number of doses comprises an amount of nicotine sufficient to provide about 1 to about 7 days of use on demand by a subject. In some cases, the pre-determined number of doses comprises an amount of nicotine sufficient to provide about 1 to about 14 days of use on demand by a subject. In some cases, the device further comprises a pump, wherein the pump is adapted to deliver the liquid nicotine formulation comprising nicotine from the reservoir to the heater element. In some cases, the pump is located completely within the reservoir. In some cases, the pump is located partially within the reservoir. In some cases, the pump is a diaphragm pump. In some cases, the pump is a piston pump. In some cases, the drive motor for the pump is located outside of the reservoir. In some cases, the heater element comprises a coil comprising electrically resistive material. In some cases, the heater element further comprises a wicking element in fluid communication with the liquid formulation comprising nicotine and wherein the coil comprising electrically resistive material is wrapped around the wicking element. In some cases, the wicking element comprises electrically resistive material. In some cases, the wicking element and the coil are continuous. In some cases, the device further comprises a first airflow channel and a second airflow channel, wherein the first airflow channel comprises an inlet and an outlet, wherein the heater element is located within the first airflow channel between the inlet and the outlet, and wherein the second airflow channel is connected to the first airflow channel. In some cases, the second airflow channel connects between the outlet and the heater element in the first airflow channel. In some cases, the second airflow channel connects to the first airflow channel between the inlet and the heater element. In some cases, the condensation aerosol is produced in the first airflow channel. In some cases, the second airflow channel permits entry of entrainment air, wherein the condensation aerosol is mixed with the entrainment air to produce a total airflow rate out of the mouthpiece of between about 20 LPM and about 80 LPM at a vacuum of about 249 Pa to about 3738 Pa (about 1 inch of water to about 15 inches of water). In some cases, the pre-determined dose of nicotine administered to the subject per use of the device is substantially identical between uses of the device. In some cases, the subject administers the condensation aerosol comprising nicotine according to a prescribed treatment regimen. In some cases, the subject administers the condensation aerosol comprising nicotine on demand. In some cases, the subject administers the condensation aerosol comprising nicotine multiple times per day.

In one aspect, provided herein is an aerosol generating device for generating a condensation aerosol from a liquid formulation comprising a pharmaceutically active agent, the device comprising: a. a reservoir comprising the liquid formulation comprising a pharmaceutically active agent; b. a pump, wherein the pump is located within the reservoir, and wherein the pump is in fluid communication with the liquid formulation comprising a pharmaceutically active agent; and c. a heater element, wherein the heater element is in fluid communication with the pump, and wherein the pump is configured to deliver the liquid formulation comprising a pharmaceutically active agent to the heater element, wherein the heater element is configured to vaporize the liquid formulation upon activation to generate the condensation aerosol. In some cases, the pump is located completely within the reservoir. In some cases, the pump is located partially within the reservoir. In some cases, the device further comprises an airflow channel comprising an inlet and an outlet, wherein the heater element is located within the airflow channel between the inlet and the outlet. In some cases, the device further comprises an additional airflow channel connected to the airflow channel. In some cases, the additional airflow channel connects between the outlet and the heater element in the airflow channel. In some cases, the additional airflow channel connects to the airflow channel between the inlet and the heater element. In some cases, the additional airflow channel permits entry of entrainment air, wherein the condensation aerosol is mixed with the entrainment air to produce a total airflow rate out of the mouthpiece of between about 20 LPM and about 80 LPM at a vacuum of about 249 Pa to about 3738 Pa (about 1 inch of water to about 15 inches of water). In some cases, the airflow passageway is configured to produce the condensation aerosol in the device. In some cases, the condensation aerosol has a diameter of from about 1 μm to about 5 μm. In some cases, the pharmaceutically active agent is nicotine. In some cases, the pump is a diaphragm pump. In some cases, the pump is a piston pump. In some cases, a drive motor of the pump is located outside of the reservoir. In some cases, the drive motor is a magnetic drive motor. In some cases, the heater element comprises a coil comprising electrically resistive material. In some cases, the heater element further comprises a wicking element in fluid communication with the liquid formulation comprising nicotine and wherein the coil comprising electrically resistive material is wrapped around the wicking element. In some cases, the wicking element comprises electrically resistive material. In some cases, the wicking element and the coil are continuous. In some cases, the device further comprises a mouthpiece. In some cases, the mouthpiece comprises a slidable door, wherein the slidable door is configured to slidably cover the mouthpiece. In some cases, the reservoir comprises a pre-determined number of doses of the liquid formulation comprising nicotine. In some cases, the reservoir is disposable. In some cases, the reservoir is refillable. In some cases, the pre-determined number of doses comprises an amount of nicotine sufficient to provide about 1 day of use on demand by a subject. In some cases, the pre-determined number of doses comprises an amount of nicotine sufficient to provide about 1 to about 7 days of use on demand by a subject. In some cases, the pre-determined number of doses comprises an amount of nicotine sufficient to provide about 1 to about 14 days of use on demand by a subject. In some cases, the device is hand-held. In some cases, the device is disk-shaped. In one aspect, provided herein is a method of treating a condition, the method comprising: administering a condensation aerosol comprising nicotine to a subject, wherein the administering comprises the subject inhaling the condensation aerosol comprising nicotine from the device described herein, wherein the inhaling the condensation aerosol comprising nicotine delivers a pre-determined dose of nicotine to the subject, thereby treating the condition. In some cases, the condition is an urge to smoke. In some cases, the administering is self-administering. In some cases, the subject administers the condensation aerosol comprising nicotine on demand. In some cases, the subject administers the condensation aerosol comprising nicotine multiple times per day.

In one aspect, provided herein is an aerosol generating device comprising: a liquid formulation comprising a pharmaceutically active agent, a heater element, and a control program, wherein the control program comprises a first phase and a second phase, wherein the first phase controls delivery of a first amount of the liquid formulation to the heater element to generate a first aerosol comprising a first diameter and the second phase controls delivery of a second amount of the liquid formulation to the heater element to generate a second aerosol comprising a second diameter, wherein the first amount is different from the second amount. In some cases, the pharmaceutically active agent is nicotine. In some cases, the device further comprises an airflow channel comprising an inlet and an outlet, wherein the heater element is located within the airflow channel between the inlet and the outlet. In some cases, the device further comprises an additional airflow channel connected to the airflow channel. In some cases, the additional airflow channel connects between the outlet and the heater element in the airflow channel. In some cases, the additional airflow channel connects to the airflow channel between the inlet and the heater element. In some cases, the additional airflow channel permits entry of entrainment air, wherein each of the first aerosol and the second aerosol is mixed with the entrainment air to produce a total airflow rate out of a mouthpiece on the device. In some cases, the total airflow rate is between about 20 LPM and about 80 LPM at a vacuum of about 249 Pa to about 3738 Pa (about 1 inch of water to about 15 inches of water). In some cases, the airflow channel is configured to produce the first aerosol and the second aerosol in the device. In some cases, the first diameter is a size effective for delivery and absorption in a deep lung of a subject using the device. In some cases, the size effective for delivery and absorption in the deep lung of a subject using the device produces no or substantially no visible vapor upon exhalation by a subject using the device. In some cases, the first diameter is from about 1 μm to about 5 μm. In some cases, the second diameter is a size effective for producing a visible vapor upon exhalation by a subject using the device. In some cases, the second diameter is less than about 1 μm. In some cases, the device further comprises a pump, wherein the first phase directs the pump to deliver the first amount to the heater element, and wherein the second phase directs the pump to deliver the second amount to the heater element. In some cases, the first phase directs the pump to operate at a first rate, and wherein the second phase directs the pump to operate at a second rate, wherein the first rate and the second rate are different. In some cases, the heater element comprises a coil comprising electrically resistive material. In some cases, the heater element further comprises a wicking element in fluid communication with the liquid formulation comprising nicotine and wherein the coil comprising electrically resistive material is wrapped around the wicking element. In some cases, the wicking element comprises electrically resistive material. In some cases, the wicking element and the coil are continuous. In some cases, the device is hand-held. In some cases, the device is disk-shaped. In some cases, the first phase and the second phase occur sequentially during a use of the device. In one aspect provided herein is a method of treating a condition, the method comprising: administering a a first aerosol comprising nicotine to a subject, wherein the administering comprises the subject inhaling the first aerosol comprising nicotine from the device as described herein, wherein the inhaling the first aerosol comprising nicotine delivers a pre-determined dose of nicotine to the subject, thereby treating the condition. In some cases, the condition is an urge to smoke. In some cases, the administering is self-administering. In some cases, the subject administers the first aerosol comprising nicotine on demand. In some cases, the subject administers the first aerosol comprising nicotine multiple times per day.

In one aspect, provided herein is a method for generating aerosols from a liquid formulation comprising a pharmaceutically active agent, the method comprising: delivering a first amount of the liquid formulation comprising a pharmaceutically active agent to a heater element in an aerosol generating device, activating the heater element a first time, wherein the first activation of the heater element produces a first aerosol comprising a first diameter, delivering a second amount of the liquid formulation comprising a pharmaceutically active agent to the heater element; and activating the heater element a second time, wherein the second activation of the heater element produces a second aerosol comprising a second diameter, wherein the first amount is different than the second amount. In some cases, the pharmaceutically active agent is nicotine. In some cases, the device comprises an airflow channel comprising an inlet and an outlet, wherein the heater element is located within the airflow channel between the inlet and the outlet. In some cases, the airflow channel is configured to produce the first aerosol and the second aerosol in the device. In some cases, the first diameter is a size effective for delivery and absorption in a deep lung of a subject using the device. In some cases, the size effective for delivery and absorption in the deep lung of the subject using the device produces no or substantially no visible vapor upon exhalation by a subject using the device. In some cases, the first diameter is from about 1 μm to about 5 μm. In some cases, the second diameter is a size effective for producing a visible vapor upon exhalation by a subject using the device. In some cases, the second diameter is less than about 1 μm. In some cases, the device comprises a pump, wherein the pump delivers the first amount to the heater element, and wherein the pump delivers the second amount to the heater element. In some cases, the pump operates at a first rate during the delivering of the first amount, and wherein the pump operates at a second rate during the delivering of the second amount, wherein the first rate and the second rate are different. In some cases, the heater element comprises a coil comprising electrically resistive material. In some cases, the heater element further comprises a wicking element in fluid communication with the liquid formulation comprising nicotine and wherein the coil comprising electrically resistive material is wrapped around the wicking element. In some cases, the wicking element comprises electrically resistive material. In some cases, the wicking element and the coil are continuous. In some cases, the device is hand-held. In some cases, the device is disk-shaped. In some cases, the delivering the second amount occurs after the delivering of the first amount, and wherein the delivering of the first amount and the delivering of the second amount occur during a use of the device by a subject.

In one aspect, provided herein is an aerosol generating device for generating a condensation aerosol from a liquid formulation comprising a pharmaceutically active agent, the device comprising: a. a reservoir comprising the liquid formulation comprising a pharmaceutically active agent; b. a pump, wherein the pump is in fluid communication with the reservoir comprising the liquid formulation comprising a pharmaceutically active agent, and wherein the pump is configured to operate at a first rate and a second rate; and c. a heater element, wherein the heater element is in fluid communication with the pump, and wherein the first rate of the pump delivers a first amount of the liquid formulation comprising a pharmaceutically active agent to the heater element, wherein upon activation the heater element vaporizes the first amount that condenses to form a first condensation aerosol comprising a first diameter, and wherein the second rate of the pump delivers a second amount of the liquid formulation comprising a pharmaceutically active agent to the heater element, wherein upon activation the heater element vaporizes the second amount that condenses to form a second condensation aerosol comprising a second diameter, wherein the first amount is different than the second amount. In some cases, the first diameter is a size effective for delivery and absorption in a deep lung of a subject using the device. In some cases, the size effective for delivery and absorption in the deep lung of a subject using the device produces no or substantially no visible vapor upon exhalation by a subject using the device. In some cases, the first diameter is from about 1 μm to about 5 μm. In some cases, the second diameter is a size effective for producing a visible vapor upon exhalation of a subject using the device. In some cases, the second diameter is less than about 1 μm. In some cases, the pharmaceutically active agent is nicotine. In some cases, the pump is located completely within the reservoir. In some cases, the pump is located partially within the reservoir. In some cases, the pump is a diaphragm pump. In some cases, the pump is a piston pump. In some cases, a drive motor of the pump is located outside of the reservoir. In some cases, the drive motor is a magnetic drive motor. In some cases, the heater element comprises a coil comprising electrically resistive material. In some cases, the heater element further comprises a wicking element in fluid communication with the liquid formulation comprising nicotine and wherein the coil comprising electrically resistive material is wrapped around the wicking element. In some cases, the wicking element comprises electrically resistive material. In some cases, the wicking element and the coil are continuous. In some cases, delivery of the second amount occurs after delivery of the first amount, and wherein delivery of the first amount and delivery of the second amount occur during a use of the device by a subject. In some cases, the device comprises an airflow channel comprising an inlet and an outlet, wherein the heater element is located within the airflow channel between the inlet and the outlet. In some cases, the airflow channel is configured to produce the first aerosol and the second aerosol in the device. In one aspect, provided herein is a method of treating a condition, the method comprising: administering a first aerosol comprising nicotine to a subject, wherein the administering comprises the subject inhaling the first aerosol comprising nicotine from the device as described herein, wherein the inhaling the first aerosol comprising nicotine delivers a pre-determined dose of nicotine to the subject, thereby treating the condition. In some cases, the condition is an urge to smoke. In some cases, the administering is self-administering. In some cases, the subject administers the first aerosol comprising nicotine on demand. In some cases, the subject administers the first aerosol comprising nicotine multiple times per day.

In one aspect, provided herein is a method of treating a subject with an urge to smoke comprising administering to the subject a therapeutically effective amount of a condensation aerosol comprising nicotine, wherein the administering comprises the subject inhaling the condensation aerosol comprising nicotine from a device configured to generate the condensation aerosol comprising nicotine from a liquid formulation comprising nicotine, and wherein the administering generates a nicotine plasma concentration in the subject of from about 0.5 ng/ml to 1 ng/ml, thereby reducing the urge to smoke in the subject. In some cases, the therapeutically effective amount is from about 500 μg to about 1000 μg. In some cases, the therapeutically effective amount is about 500 μg. In some cases, the therapeutically effective amount is about 1000 μg. In some cases, the subject inhales the condensation aerosol comprising nicotine a plurality of times in order to deliver the therapeutically effective amount. In some cases, the plurality of times is from about 2 to about 10 inhalations. In some cases, the subject administers the condensation aerosol on demand. In some cases, the subject administers the condensation aerosol multiple times per day. In some cases, the reduction in the urge to smoke in the subject is at least 50%. In some cases, the reduction in the urge to smoke in the subject is at least 60%. In some cases, the reduction in the urge to smoke in the subject is at least 70%. In some cases, the reduction in the urge to smoke in the subject is at least 80%. In some cases, the reduction in the urge to smoke in the subject is a complete or substantially complete elimination of the urge to smoke in the subject. In some cases, the reduction in the urge to smoke is compared to an urge to smoke in the subject before using the aerosol generating device. In some cases, the reduction in the urge to smoke is compared to an urge to smoke in the subject following administration of a vehicle using the aerosol generating device. In some cases, the reduction in the urge to smoke is sustained for at least 60 minutes. In some cases, the reduction in the urge to smoke is assessed using a psychometric response scale. In some cases, the psychometric response scale comprises a smoking urge visual analog scale (SU-VAS). In some cases, the reduction in the urge to smoke in the subject occurs within about 1 minute after administering the condensation aerosol comprising nicotine to the subject using the device. In some cases, the nicotine plasma concentration is produced in about 30 seconds following the administration of the pre-determined dose of nicotine. In some cases, the nicotine plasma concentration is sustained for at least 10 minutes following the administration of the pre-determined dose of nicotine. In some cases, the condensation aerosol comprising nicotine has a diameter of from about 1 μm to about 5 μm. In some cases, the device comprises: a. a reservoir comprising the liquid formulation comprising nicotine; b. an air flow channel comprising an inlet and an outlet; and c. a heater element within the airflow channel, wherein the heater element is in fluid communication with the liquid formulation comprising nicotine; and wherein producing the condensation aerosol comprising nicotine comprises vaporizing the liquid formulation comprising nicotine upon delivery of the liquid formulation comprising nicotine to the heater element and subsequent activation of the heater element. In some cases, the heater element comprises a wire coil continuous with a wicking element, wherein the wire coil and wicking element comprise electrically resistive material. In some cases, the device further comprises a pump, wherein the pump is located within or partially within the reservoir.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features are set forth with particularity in the appended claims. A better understanding of the features and advantages will be obtained by reference to the following detailed description that sets forth illustrative embodiments, in which the principles are utilized, and the accompanying drawings of which:

FIG. 1 illustrates an embodiment of an electronic nicotine delivery device.

FIGS. 2A and 2B illustrate an embodiment of electronic agent (e.g., nicotine) delivery device.

FIGS. 3A and 3B illustrate embodiments of a heater element.

FIG. 4 illustrates an embodiment of an agent (e.g., nicotine) reservoir.

FIG. 5 illustrates another embodiment of an agent (e.g., nicotine) reservoir.

FIG. 6 illustrates another embodiment of an agent (e.g., nicotine) reservoir.

FIG. 7 illustrates an embodiment of a heater element.

FIG. 8 illustrates an embodiment of an electronic agent (e.g., nicotine) delivery device.

FIG. 9 illustrates another embodiment of a heater element.

FIGS. 10A and 10B illustrate additional embodiments of a heater element.

FIG. 11 illustrates inertial impaction.

FIG. 12 illustrates an embodiment of a method of removal of an agent (e.g., nicotine) mixture from a reservoir and dispensing the nicotine into desired doses.

FIG. 13 illustrates another embodiment of a method for measuring an agent (e.g., nicotine) dose.

FIG. 14 illustrates another embodiment for measuring an agent (e.g., nicotine) dose.

FIG. 15 illustrates another embodiment for measuring an agent (e.g., nicotine) dose.

FIGS. 16A and 16B illustrate embodiments for applying an agent (e.g., nicotine) to a heater element.

FIGS. 17A and 17B illustrate embodiments of mechanisms for generating an aerosol.

FIG. 18 illustrates an embodiment of a mechanism for dispensing an agent (e.g., nicotine) mixture.

FIG. 19 illustrates feedback to a nicotine user regarding nicotine intake and mean craving over time.

FIG. 20 illustrates customized feedback to a user of an electronic nicotine delivery device.

FIG. 21 illustrates an embodiment of a method for flow control.

FIG. 22 illustrates an embodiment of a heater element.

FIG. 23 illustrates another embodiment for measuring an agent (e.g., nicotine) dose.

FIG. 24 illustrates another embodiment for measuring an agent (e.g., nicotine) dose.

FIGS. 25A and 25B illustrate another embodiment of a method of removal of an agent (e.g., nicotine) mixture from a reservoir.

FIG. 26 illustrates a schematic of a test apparatus used for testing the effects of altering system parameters of an aerosol delivery device on particle size distribution.

FIGS. 27A, 27B, 27C, and 27D illustrate a schematic of a test bed used for generating an aerosol in the test apparatus of FIG. 26.

FIG. 28 illustrates a comparison of particle sizes of an aerosol created by an e-cigarette (e-cig) vs. an aerosol created by a device as provided herein.

FIGS. 29A and 29B illustrate a schematic of a test apparatus used for testing flow control. FIG. 29B illustrates a close-up of the valve (2904a) that is part of the test apparatus in FIG. 29A.

FIGS. 30A and 30B illustrates an alternative valve flap for use in the valve (2904a) in FIG. 29A. FIG. 30B illustrates a slot for use in the bypass (2908a) in FIG. 29A.

FIGS. 31A, 31B, 31C, 31D, and 31E, illustrate embodiments of airflow configurations and heater element.

FIGS. 32A, 32B, 32C, 32D, and 32E illustrate embodiments of flow-through passageways.

FIG. 33 illustrates an additional embodiment of a flow-through passageway.

FIG. 34 illustrates an embodiment of a flow control valve.

FIG. 35 illustrates an embodiment of a device comprising a primary and secondary airway.

FIG. 36 illustrates another embodiment of a heater element.

FIGS. 37A and 37B illustrate embodiments of a heater element similar to that shown in FIG. 36. FIG. 37A depicts a wire coil spanning a large percentage of the length of one end of the wire. FIG. 37B depicts a wire coil spanning a smaller percentage of the length of one end of the wire than shown in FIG. 37A.

FIG. 38 illustrates an enlarged representation of the wire coil from the heater element of FIG. 36.

FIG. 39 illustrates components of eHealth-enabled electronic agent (e.g., nicotine) delivery system, in accordance with an embodiment.

FIG. 40 illustrates example components of an electronic agent (e.g., nicotine) delivery system, in accordance with an embodiment.

FIG. 41 illustrates example components of an electronic agent (e.g., nicotine) delivery device for implementing aspects described herein, in accordance with an embodiment.

FIGS. 42A-C illustrate a cylindrical aerosol generating device that resembles a cigarette. FIG. 42A illustrates an exterior view, while FIG. 42B and FIG. 42C illustrate an interior longitudinal section view of the entire device (FIG. 42B) or the mouthpiece end (FIG. 42C).

FIGS. 43A-C illustrate a removable single unit nicotine reservoir comprising a heater element with a retractable protector. FIG. 43A illustrate an exterior view, while FIGS. 43B-C illustrate interior views of the single unit reservoir.

FIG. 44 illustrates a nicotine reservoir comprising a pump piston within the reservoir and a magnetic drive motor for use in an aerosol generating device as provided herein.

### DETAILED DESCRIPTION

### I. Overview

Provided herein are devices, systems, kits, compositions, computer readable medium, and methods for electronic delivery of an agent to a subject. For example the devices, systems, computer readable medium, and methods can be used for electronic nicotine delivery, which can facilitate recreational nicotine delivery, or full or partial smoking urge reduction. The devices, systems, computer readable medium, and methods provided herein can be used to allow each user to carefully track their usage and help them to transition completely off of cigarettes, and/or off nicotine entirely if they choose.

The devices described herein can be designed to not look like or resemble cigarettes or electronic cigarettes, and to not emit a visible or second hand vapor. The devices described herein can be designed to not glow like a cigarette. The devices provided herein can be designed to not comprise a light emitting diode (LED). The devices described herein can be designed to look like or resemble cigarettes or electronic cigarettes, and to not emit a visible or second hand vapor. The devices described herein can be designed to glow like a cigarette. The devices provided herein can be designed to comprise a light emitting diode (LED). The visible vapor can be an inhaled and/or exhaled vapor. The exhaled visible vapor can be referred to as a second-hand vapor. The subject can be a human. The human subject can be a smoker or an individual who uses tobacco or nicotine containing products. Devices described herein can generate an aerosol comprising an agent (e.g., nicotine), and the agent (e.g., nicotine) aerosol can have a known and consistent amount of agent (e.g., nicotine). Also, devices and methods for dose titration are provided. The devices and methods provided herein can help to reduce smoking urges, reduce the amount of nicotine exposure as compared to use of cigarettes, reduce exposure to harmful and potentially harmful constituents, and/or reduce smoking behavior or similarity to smoking behavior. Also, devices and methods provided herein can track usage and dependence by a user while also guiding said user toward goals using mobile health (mHealth or eHealth) tools.

The devices, systems, kits, compositions, and computer readable medium provided herein can be part of an electronic agent (e.g., nicotine) delivery platform. The electronic platform for delivering an agent (e.g., nicotine) can be used to deliver the agent (e.g., nicotine) to a subject in a particular dose, with a particular mean particle size, pH, and airflow characteristics, which can affect back of the throat impaction and upper airway deposition. In one embodiment, the electronic delivery platform regulates a schedule of delivery of an agent (e.g., nicotine) to a user over time. Furthermore, provided herein are methods of tracking usage of an agent (e.g., nicotine) to suggest a dosing strategy based on the goal or goals of the user of any device as provided herein. In some cases, a user is a human. In some cases, a user is a human who smokes or otherwise uses tobacco or a nicotine containing product.

Provided herein are devices for generating a condensation aerosol comprising particles of a size suitable for delivery to the lungs of a subject. In some cases, a subject is a human. In some cases, a subject is a human who smokes or otherwise uses tobacco or nicotine containing products. The particles can be of a size suitable for delivery to the deep lung (i.e., alveoli) of the subject. The particles can be any of the sizes provided herein. In some cases, the particles can comprise a mass median aerodynamic diameter (MMAD) of from about 1 to about 5 μm. The particles can have a geometric standard deviation (GSD) of less than 2. The condensation aerosol can be generated from a formulation comprising a pharmaceutically active agent. The formulation can be in a liquid or solid phase prior to vaporization. The agent can be any agent as provided herein; in some cases, the agent is nicotine, and in some cases the nicotine is stabilized using one or more carriers (e.g., vegetable glycerin and/or propylene glycol). The device can comprise a heater element as provided herein and a configuration of flow-through passages or chambers suitable for generating condensation aerosols comprising particles of a size suitable for delivery to the deep lungs of a subject. For example, a device can comprise a primary flow-through chamber in fluid communication with a secondary flow-through chamber. The primary flow-through chamber can comprise an upstream and downstream opening, and the upstream opening can be an inlet for a carrier gas. The device can comprise an aerosol generation chamber, wherein the aerosol generation chamber is located (disposed) between the upstream and downstream openings within the primary flow through chamber. The aerosol generation chamber can comprise a heater element as provided herein and a source of a formulation comprising a pharmaceutically active agent (e.g. nicotine) as provided herein. The aerosol generation chamber can further comprise a configuration whereby the flow rate of the carrier gas entering the aerosol generation chamber is effective to condense a vapor generated from a formulation comprising a pharmaceutically active agent (e.g. nicotine) as provided herein within the aerosol generation chamber.

Provided herein are devices for generating multiple populations of condensation aerosols. In some cases, the devices provided herein generate two populations of condensation aerosols. The first population of condensation aerosols comprise particles of a size suitable for delivery to the deep lungs of a subject. The first population of condensation aerosols suitable for delivery to the lungs of a subject can be non-visible. The second population of condensation aerosols comprise particles of a size suitable to be visible upon exhalation by the subject. Generation of the multiple populations of condensation aerosols from a device as provided herein can occur during a single use of device or between uses of the device. The generation of the multiple populations of condensation aerosols can be directly controlled by a user of the device. The generation of the multiple populations of condensation aerosols can be integrated into electronic circuitry of the device. The electronic circuitry can comprise a control program. The control program can comprise multiple phases such that each phase directs the device to produce a condensation aerosol comprising a specific size (e.g., diameter). The control program can be integrated into a controller. The controller can be programmable. Generation of the multiple populations of condensation aerosols from a device as provided herein can occur by altering an amount or volume of a liquid formulation comprising a pharmaceutically active agent (e.g., nicotine) delivered to or onto a heater element. The amount or volume of liquid formulation delivered can be altered by adjusting the pump rate of a device comprising a pump as provided herein. Alteration of the pump rate can be controlled by a user or by a control program of the device. Generation of the multiple populations of condensation aerosols from a device as provided herein can occur by altering an amount or volume of a carrier gas (e.g., air) flowing through an aerosol generation region of a the device. Alteration of the amount of volume of air can be accomplished by the number and/or size of air inlets configured to provide air inlets to the aerosol generation region of the device.

Provided herein are devices for generating a condensation aerosol comprising a reservoir comprising a liquid formulation comprising a pharmaceutically active agent (e.g., nicotine) and a pump. The pump can be a positive displacement pump. In some cases, the pump is a diaphragm pump. In some cases, the pump is a piston pump. The pump can be located completely within the reservoir. The pump can be located patially within the reservoir. In some cases, the pump comprises a pump drive located outside of the reservoir. The pump drive can be located adjacent to the reservoir. The pump drive can be a wire coil. The piston pump can be magnetically coupled to the pump drive such that the piston comprises one or magnets while the pump drive comprises a wire coil. The piston of the piston pump can comprise 3 magnets. The magnet(s) in the piston pump can be magnetically coupled to the wire coil of the pump drive such that the magnetic coupling controls movement of the piston in the piston pump, thereby affecting delivery of the liquid formulation from the reservoir.

Devices and methods for aliquoting an agent (e.g., nicotine) to ensure dose-to-dose uniformity are provided herein. Furthermore, devices and methods are provided herein for sensing an inhalation by a user and triggering a device. Devices and methods are also provided herein for inhalation flow control.

Devices and methods of use of a closed loop design to control heating are provided herein. For example, a device provided herein can incorporate electronics that control for variability in battery condition and ensure consistent heating by direct measurement of resistance through the heater element to control for changes in battery voltage/charge.

eHealth tools provided herein can yield customized doses of an agent (e.g., nicotine) to a subject. In some cases, customized dosing regimens are provided, which can include instructions to dose at specific intervals, driven by reminders on the device. Devices and methods for providing customized feedback and behavioral support to a subject are also provided. In some cases, the customized feedback and/or behavioral support comprise simple instructions. The customized feedback and/or behavioral support can comprise use of social media to leverage social networks to help induce and/or maintain behavior change.

Also provided herein are methods of identifying individual user goals and matching user goals to an agent (e.g., nicotine) dose algorithm. Furthermore, provided herein are devices and methods for giving customized feedback to achieve a nicotine administration goal. Also, provided herein are devices and methods for giving customized feedback to achieve an agent administration goal. In some cases, an individual is a human. In some cases, an individual is a human who smokes or otherwise uses tobacco or a nicotine containing product.

### II. Devices

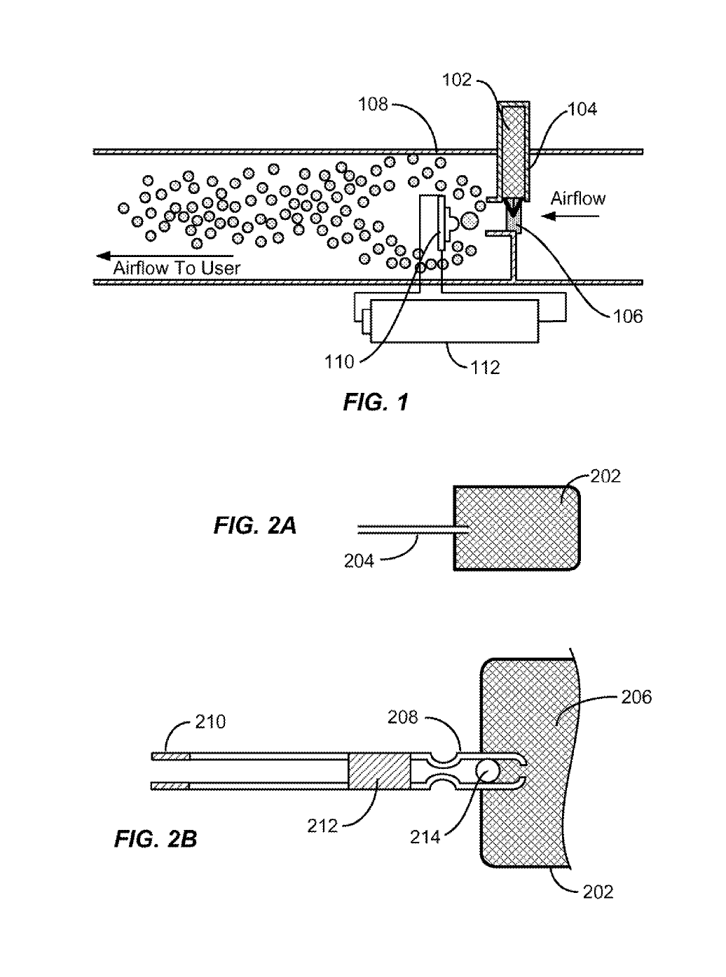

FIG. 1 illustrates an embodiment of an electronic agent (e.g., nicotine) delivery device for controlling and reducing aerosol particle size for deep lung delivery and rapid pharmacokinetics. An agent, e.g., nicotine (102) is held in an agent (e.g., nicotine) reservoir (104), and can be wicked into a dosing mechanism (106). Upon inhalation, agent (e.g., nicotine) droplets are pulled out of the dosing mechanism. Small droplets are entrapped in airflow in the airway (108). A heater (110) can be in electrical communication with a battery (112). Larger droplets inertially impact with a heater (110), deposit, and are vaporized and reduced in size. Vapor condenses to form an optimum size aerosol by controlling airflow and vaporization rate. Any of the devices as provided herein can be rechargeable. Any of the devices as provided herein can be disposable. Any of the devices as provided herein can be rechargeable and comprise disposable components.

Shape

An electronic agent (e.g., nicotine) delivery device as provided herein can be disk-shaped, oval shaped, ovoid shaped, rectangular shaped, cylindrically shaped, or triangular shaped. An electronic agent (e.g., nicotine) delivery device as provided herein can be in the shape of any smoking article known in the art. An electronic agent (e.g., nicotine) delivery device as provided herein can be in the shape of a cigarette, cigar, or smoking pipe.

Dosing

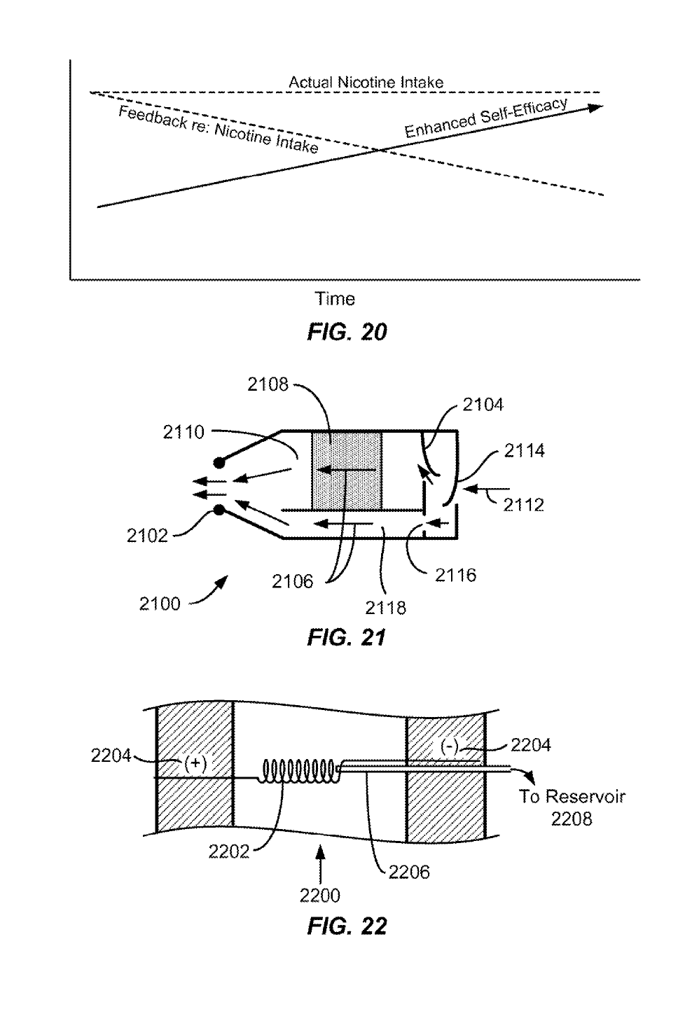

Provided herein are methods for administering an agent (e.g., nicotine) challenge doses to a subject. The administration of the challenge doses comprising nicotine can serve to reduce craving for nicotine in a subject using the device (see FIG. 19). In some cases, an electronic nicotine delivery device or web backend system as provided herein used in methods to administer an agent (e.g., nicotine) can give the user feedback regarding his/her mean nicotine dose, so as to enhance self-efficacy (see FIG. 20). In some cases, a subject is a human. In some cases, a subject is a human who smokes or otherwise uses tobacco or nicotine containing products. Methods are provided herein for generating condensation aerosols comprising particles comprising a mass median aerodynamic diameter (MMAD) effective for delivery to the deep lung of a subject. The condensation aerosols produced by devices as provided herein can provide a consistent nicotine delivery to a user of the device. The methods can comprise supplying or delivering a liquid formulation comprising a pharmaceutically active agent (e.g. nicotine) to a passageway; vaporizing the liquid formulation using a heater element in the passageway to produce a vaporized liquid formulation; and flowing a carrier gas through the passageway at a flow rate effective to allow condensation of the vaporized liquid formulation into particles comprising a size effective for delivery to the deep lung. The size of the particles following condensation can be an MMAD of from about 1 to about 5 μm. The flow rate can be about 1 to about 10 liters per minute (LPM) (a range from about 1.667×10⁻⁵ m³/s to about 1.667×10⁻⁴ m³/s), e.g., at a vacuum of about 1 to about 15 inches of water (a range from about 249 Pa to about 3738 Pa). The flow resistance of the device can be about 0.05 to about 0.15 (cm of H₂O)^{1/2}/LPM. The flow resistance of the device as provided herein for use in a method as provided herein can be about the same flow resistance as that of a combustible cigarette. The flow resistance through a device as provided herein for use in a method as provided herein can be around 2.5 (cm of H₂O)^{1/2}/LPM. In some cases, a device as provided herein for use in a method as provided herein comprises a flow rate of 1 LPM at a vacuum of 7.6 cm of H₂O. In some cases, a device as provided herein for use in a method as provided herein comprises a flow rate of 1.5 LPM at a vacuum of 16 cm of H₂O. In some cases, a device as provided herein for use in a method as provided herein comprises a flow rate of 2 LPM at a vacuum of 26 cm of H₂O. The liquid formulation can be supplied or delivered from a reservoir. The reservoir can comprise a tube, e.g., a capillary tube. The reservoir can be in fluid communication with the heater element.

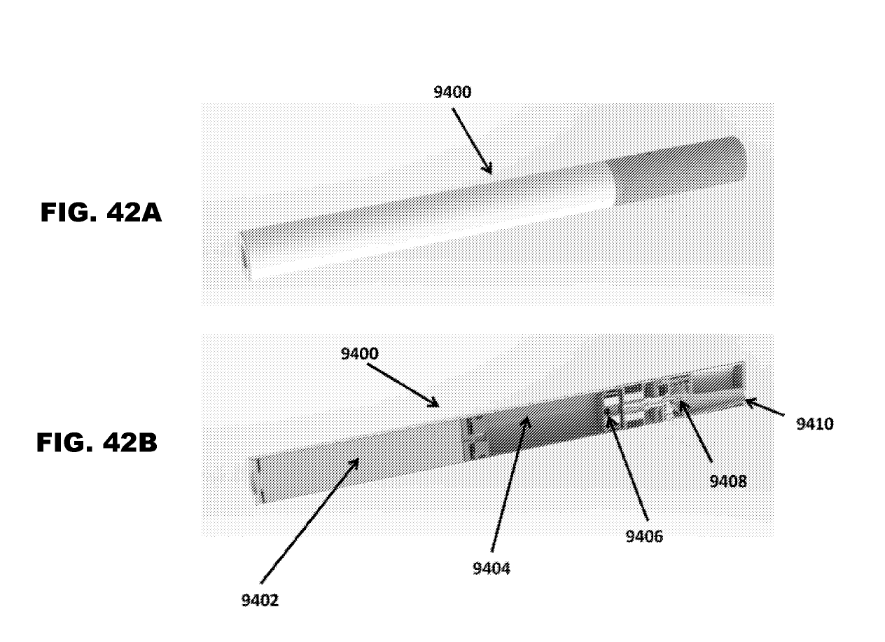

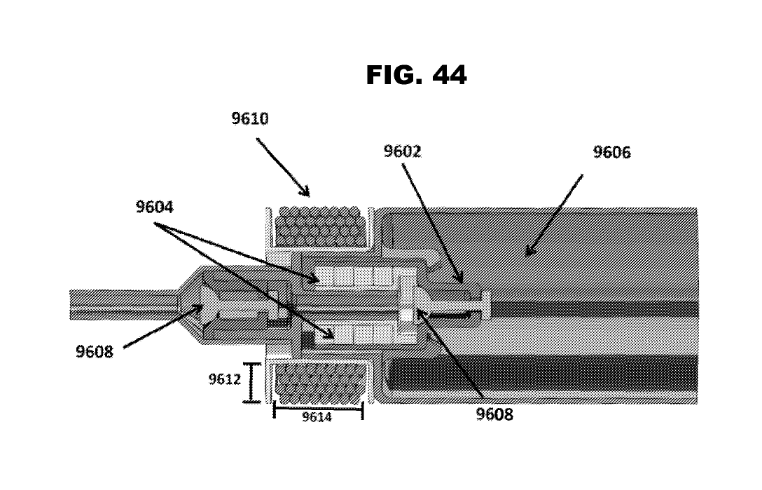

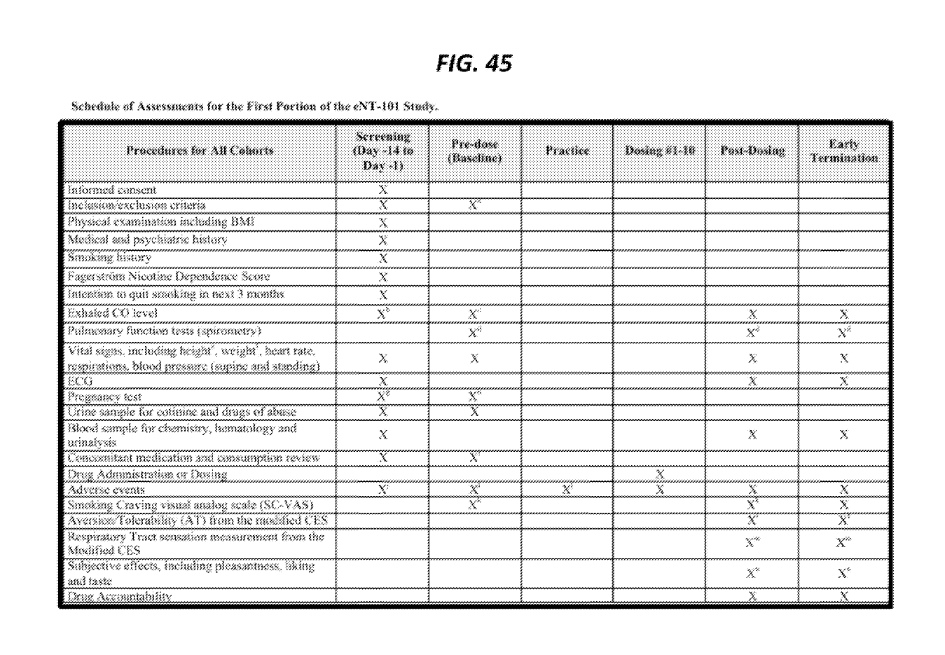

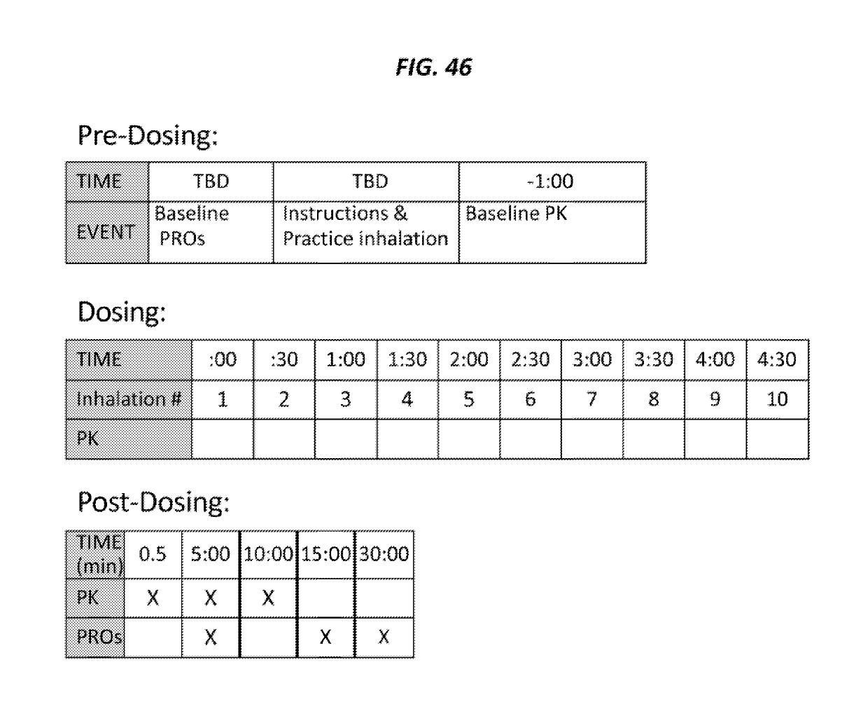

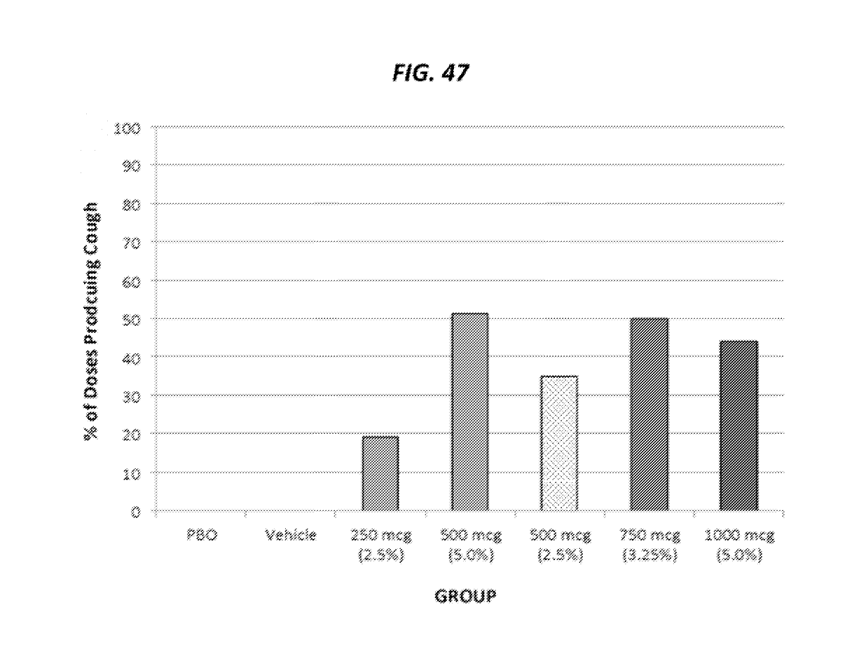

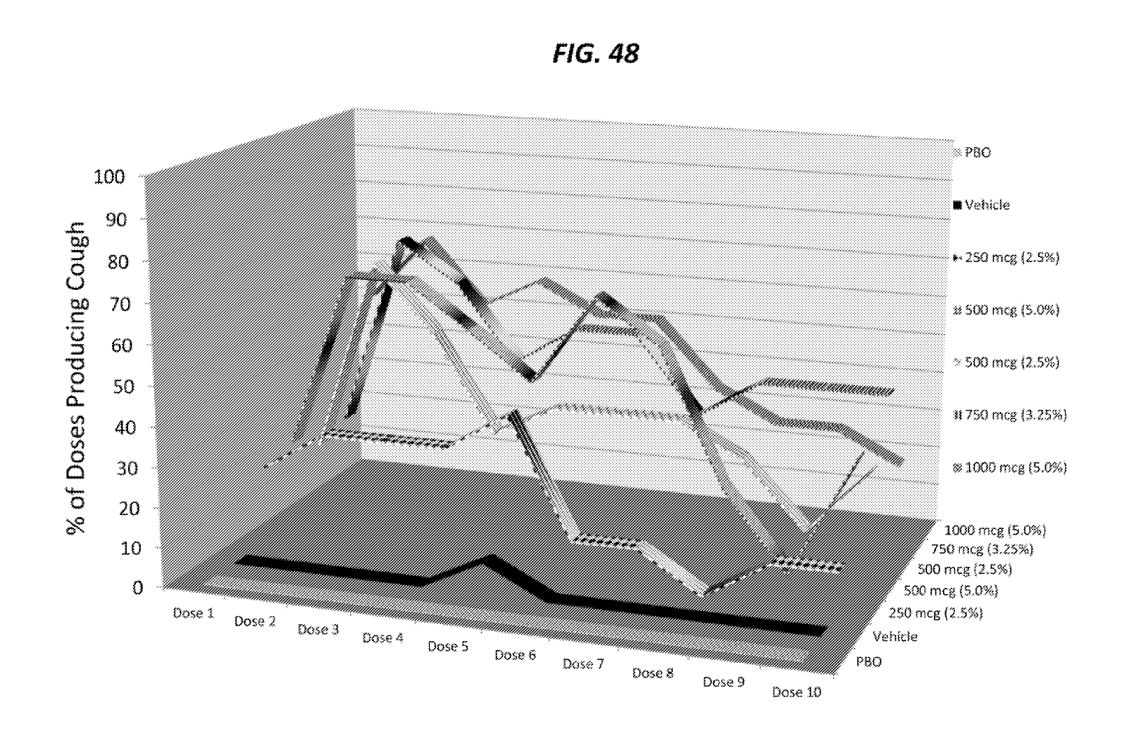

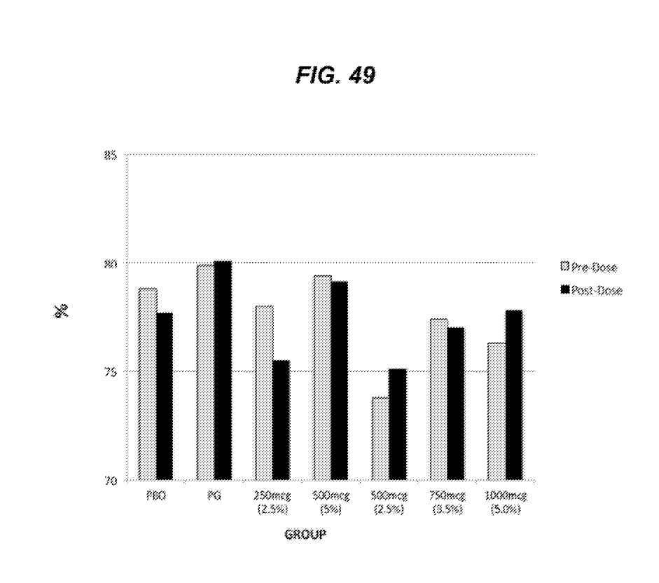

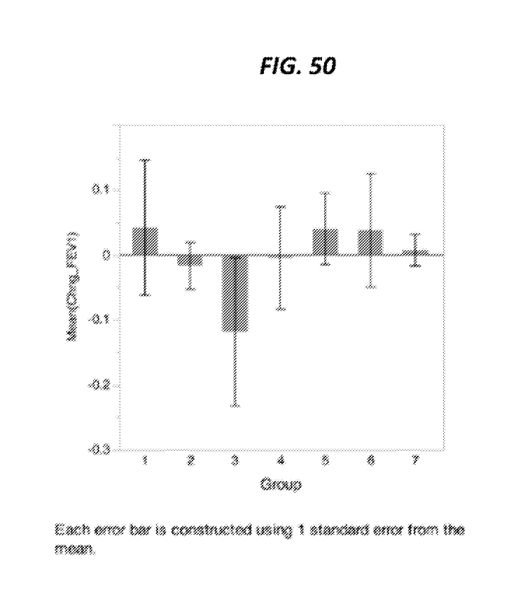

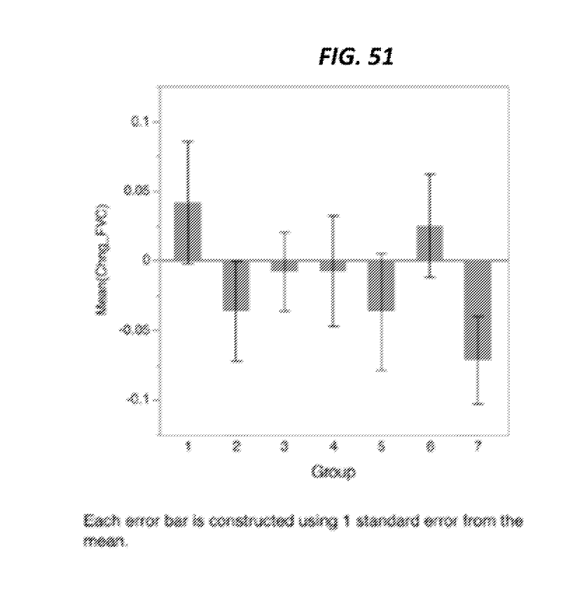

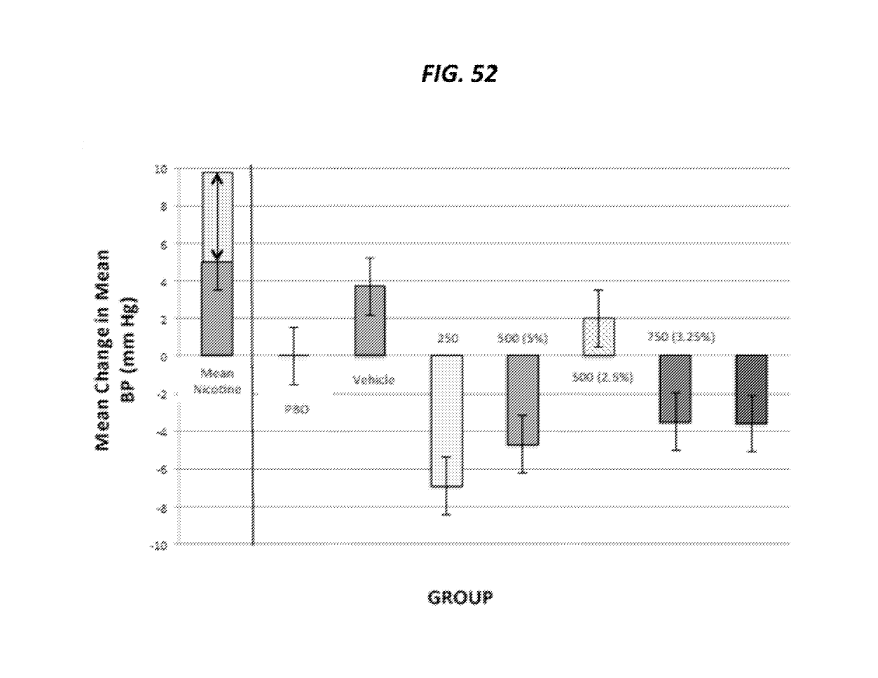

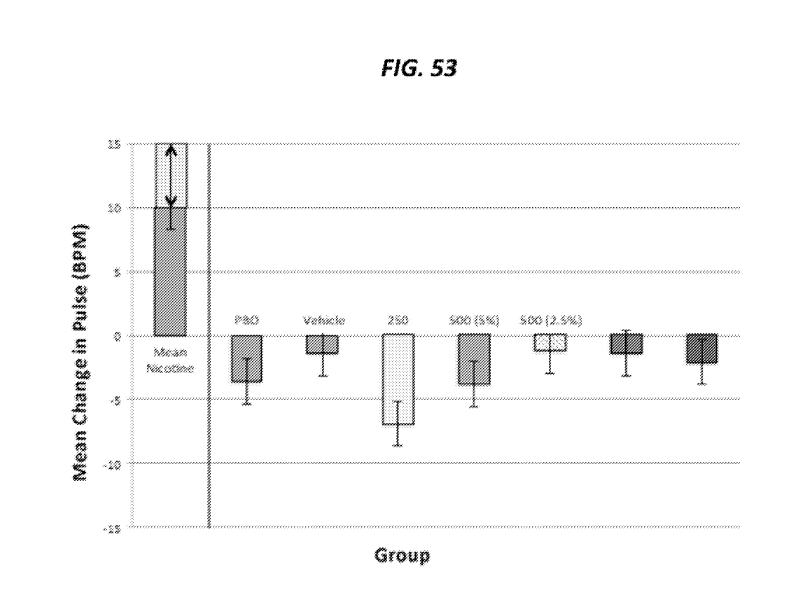

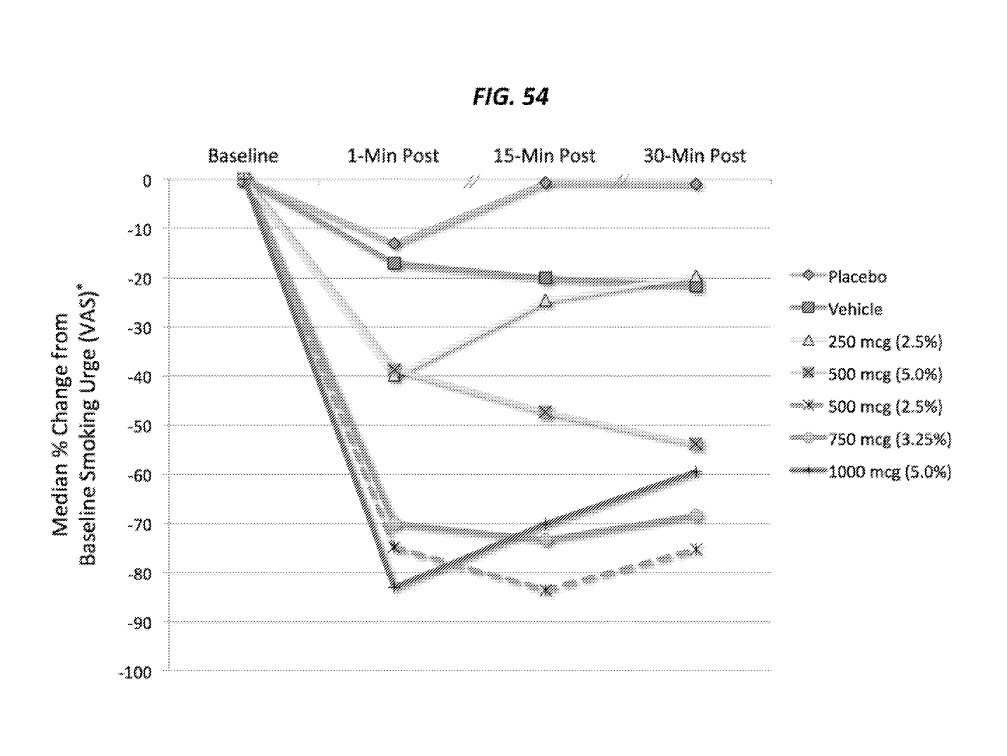

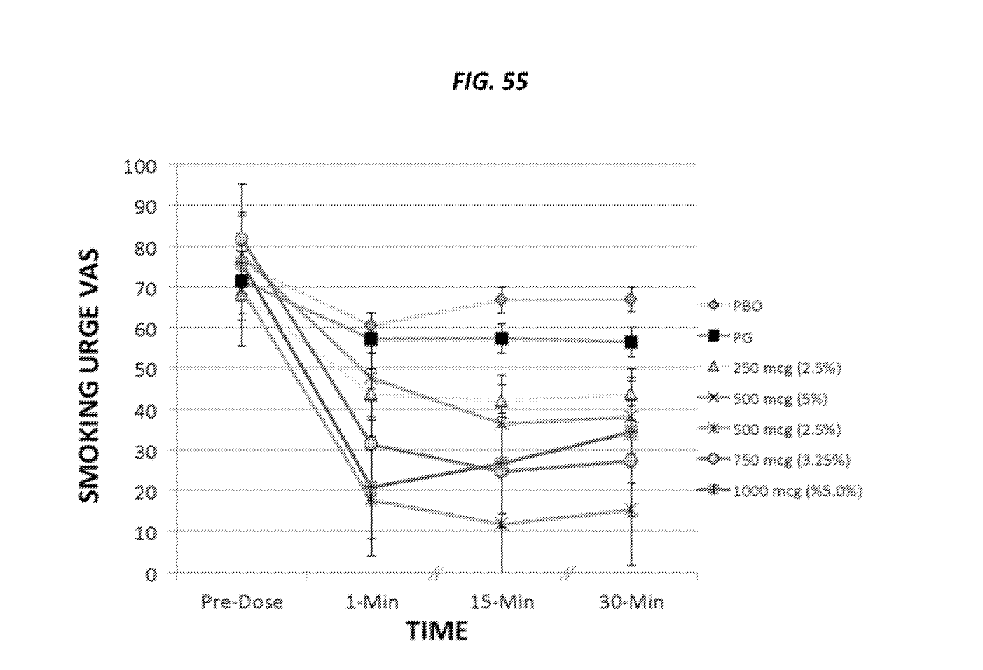

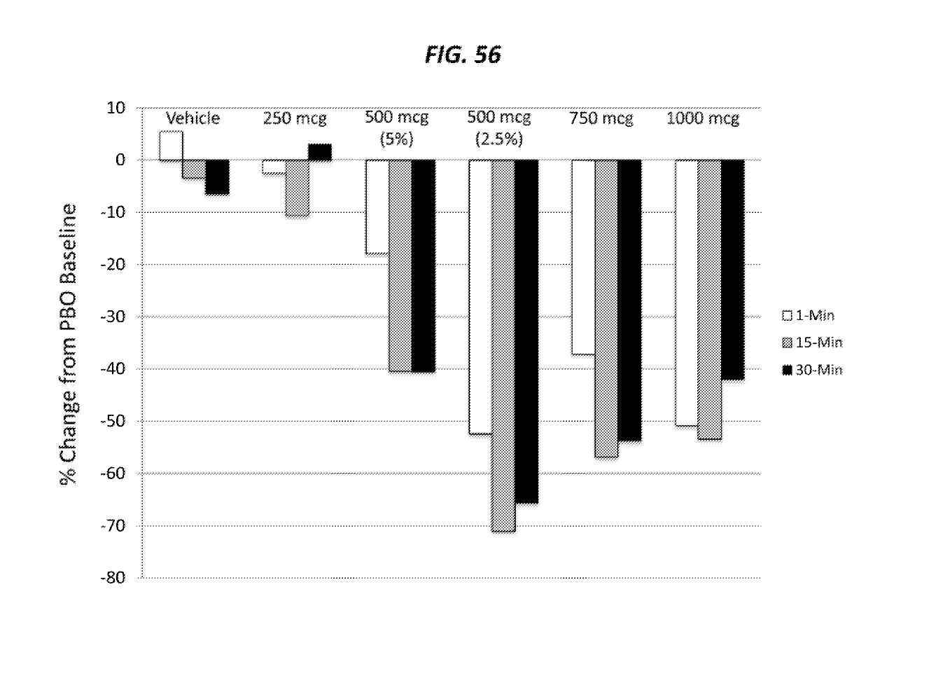

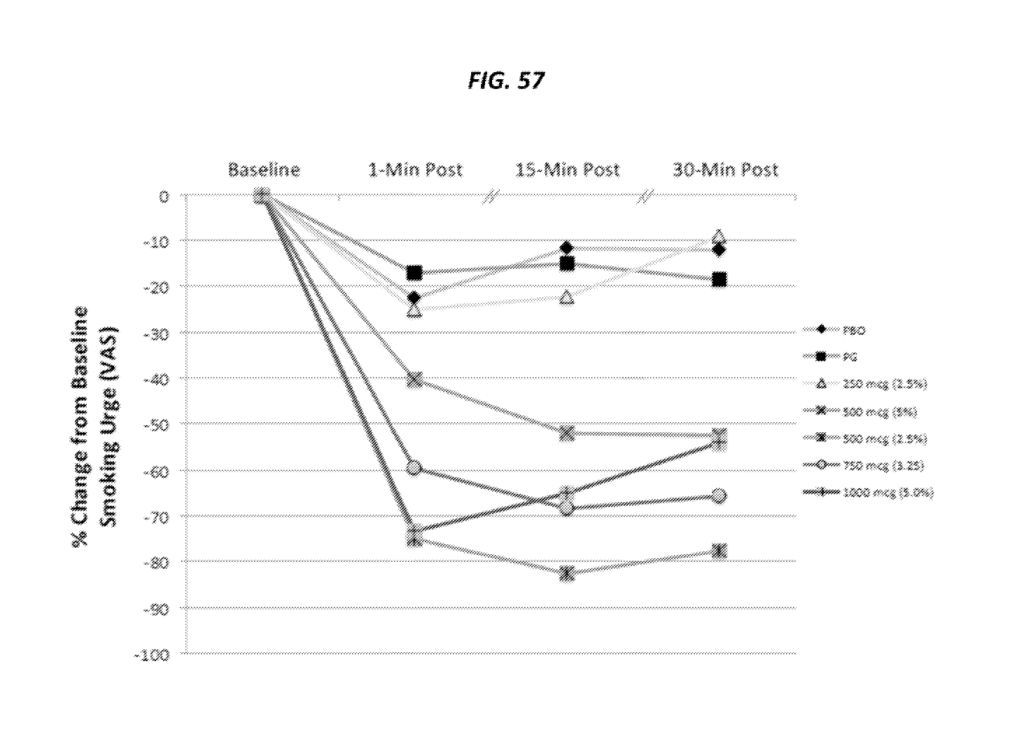

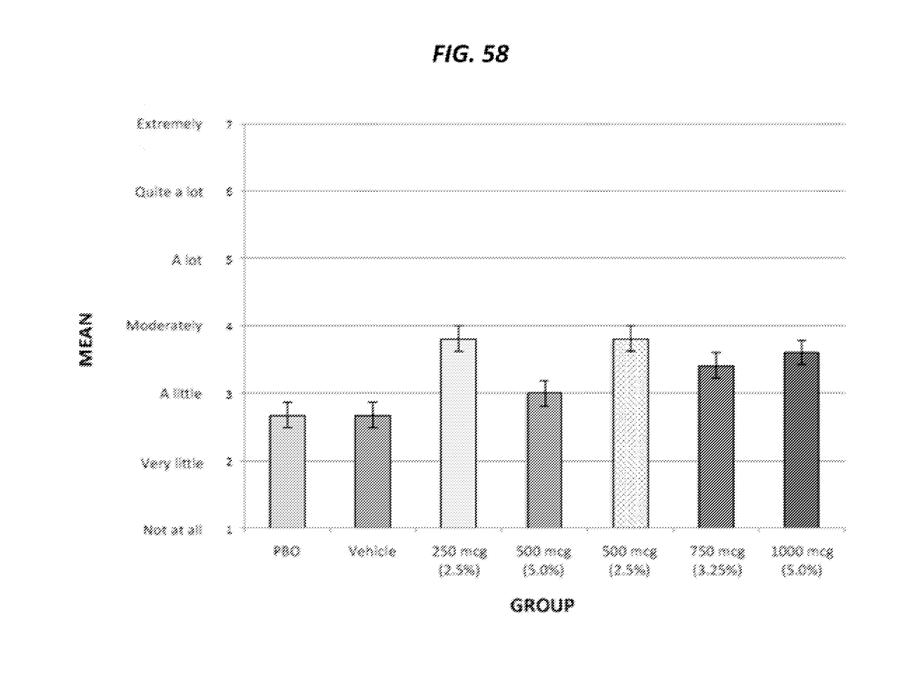

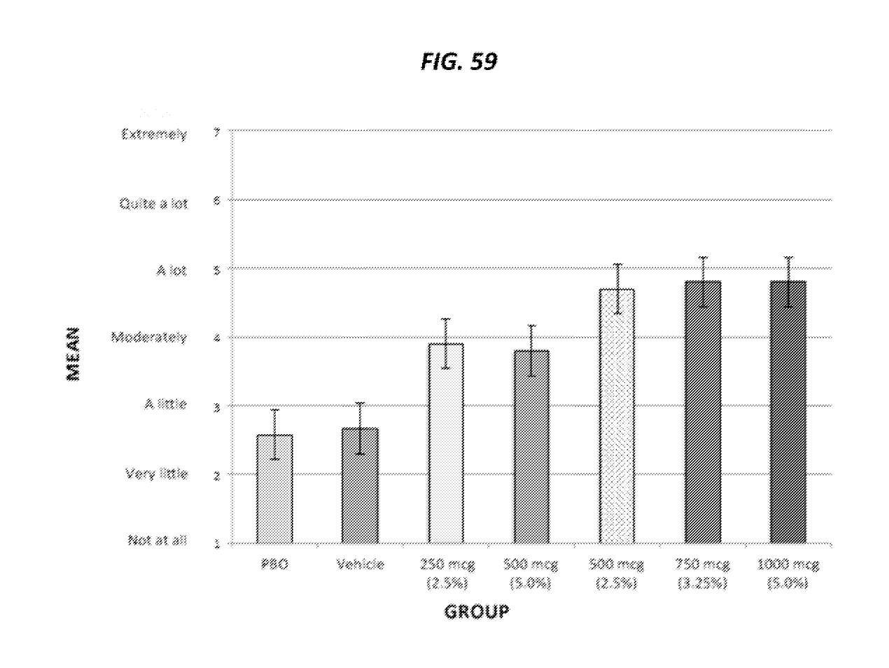

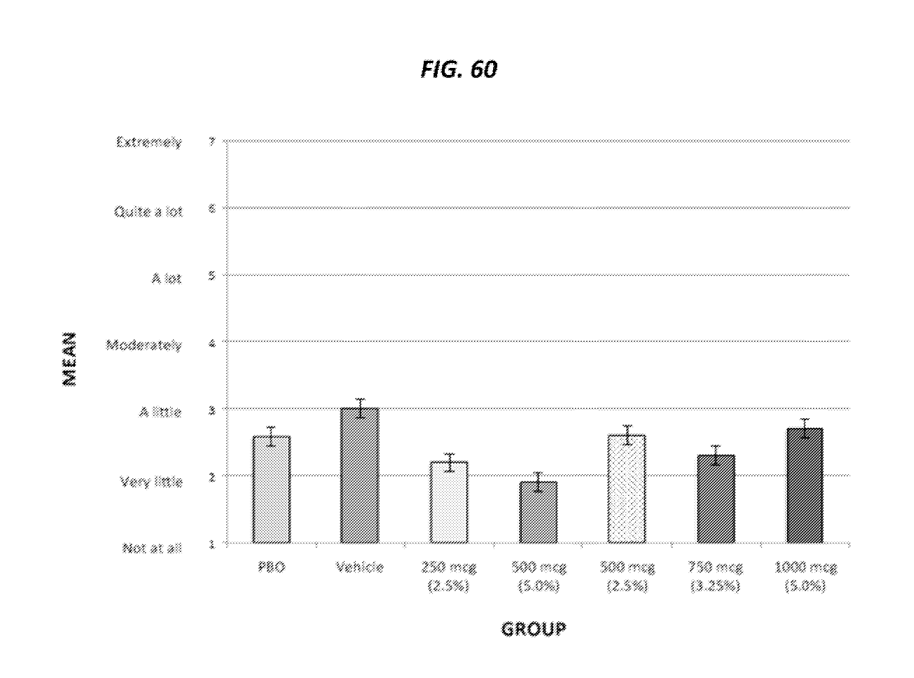

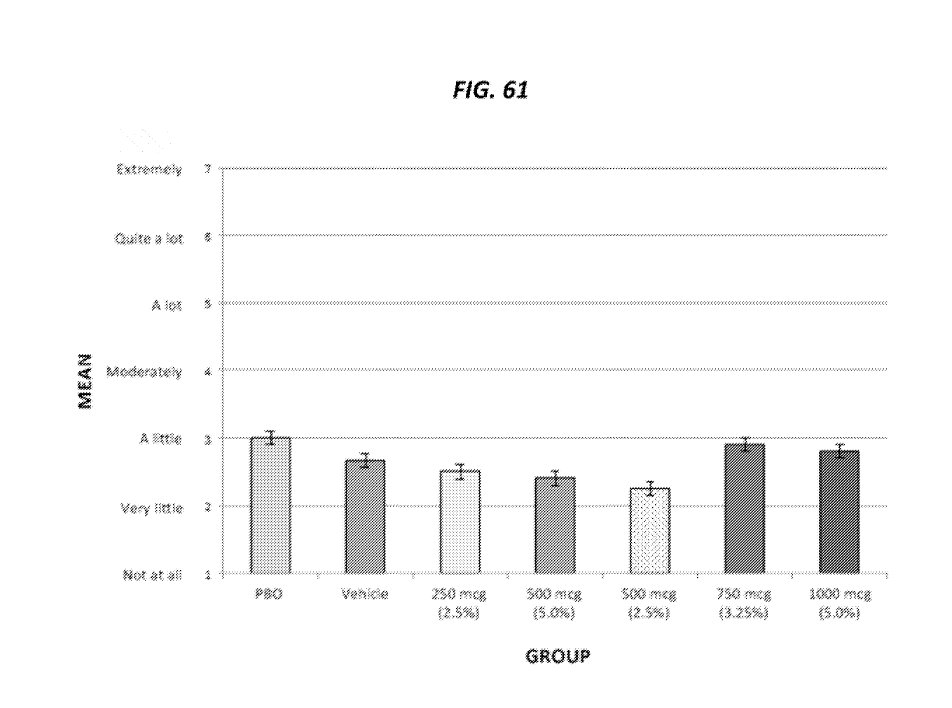

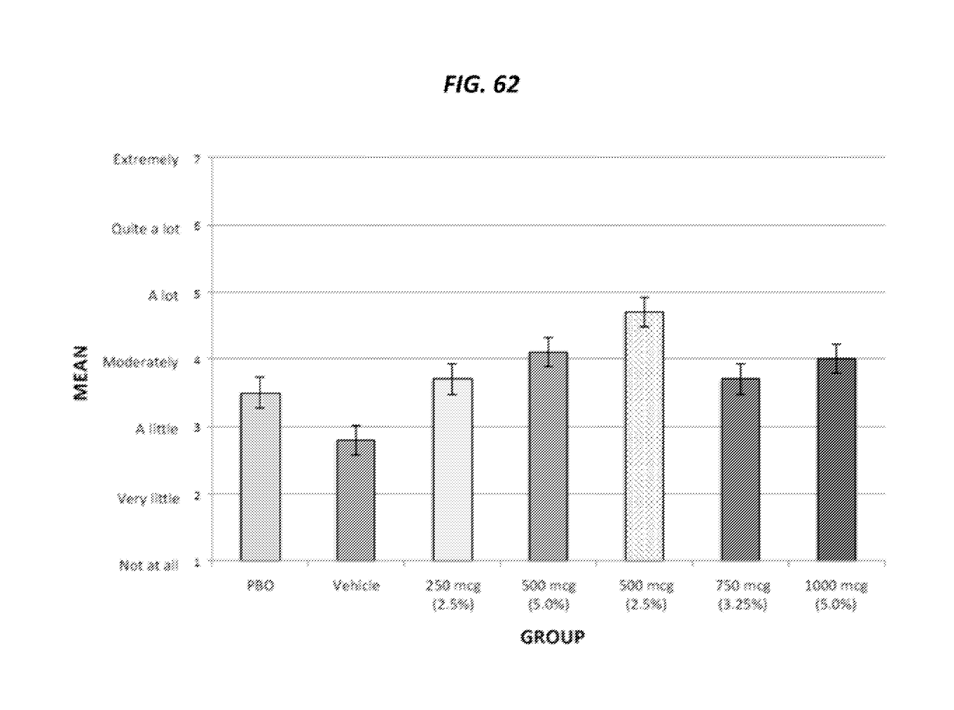

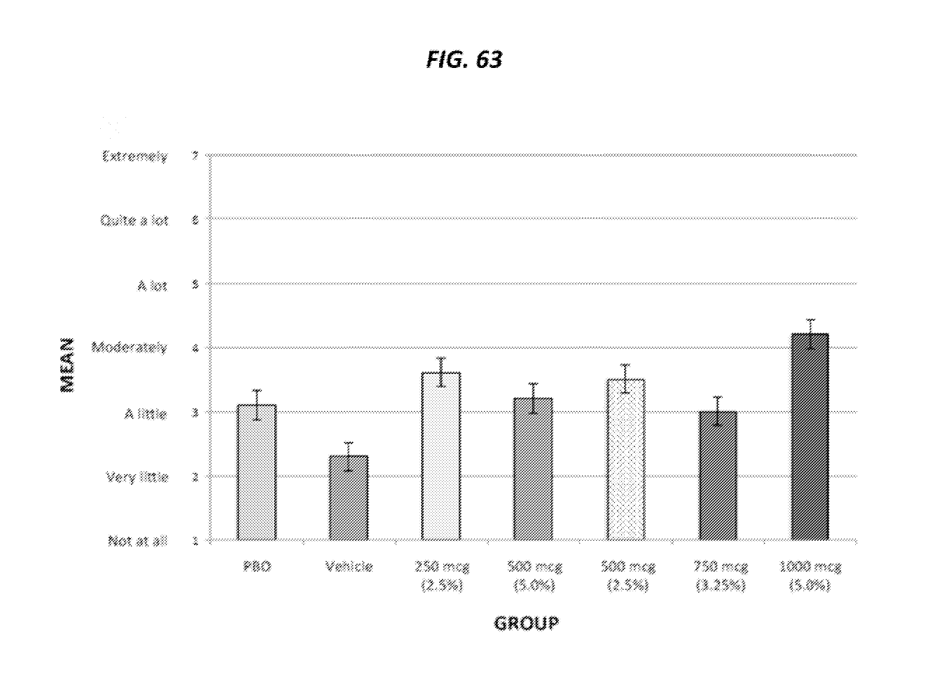

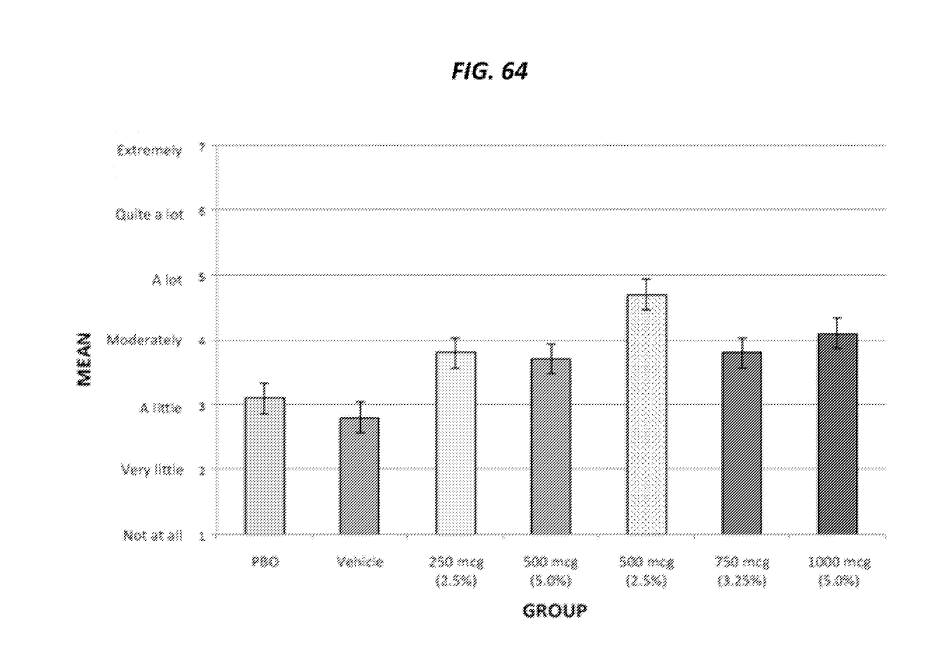

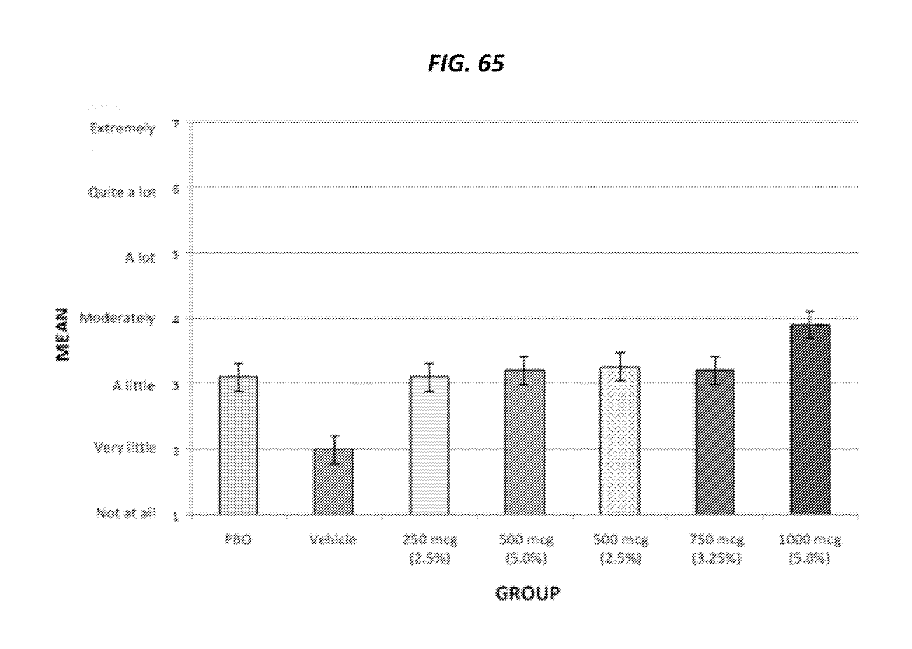

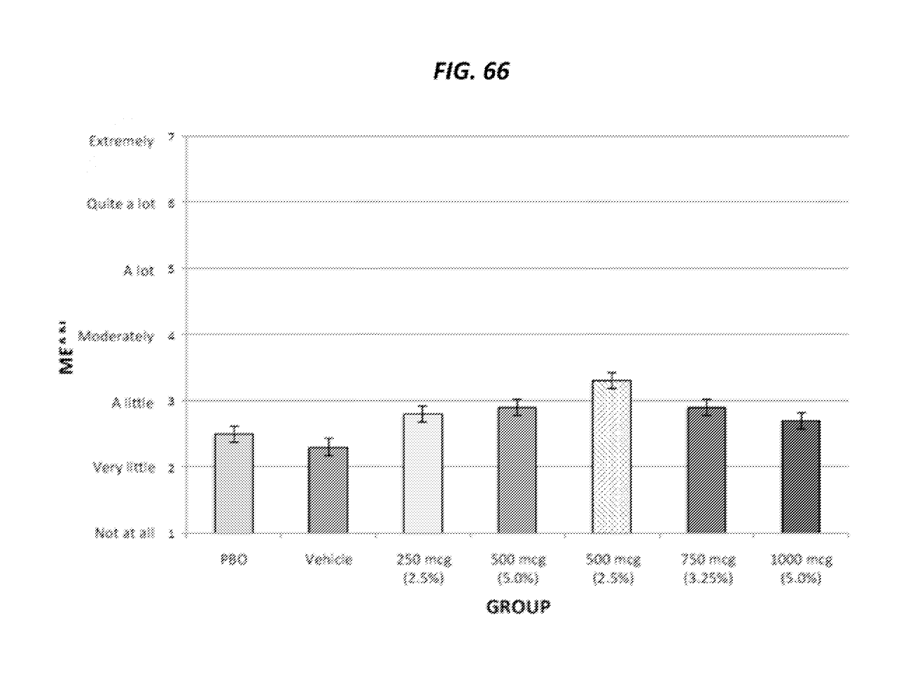

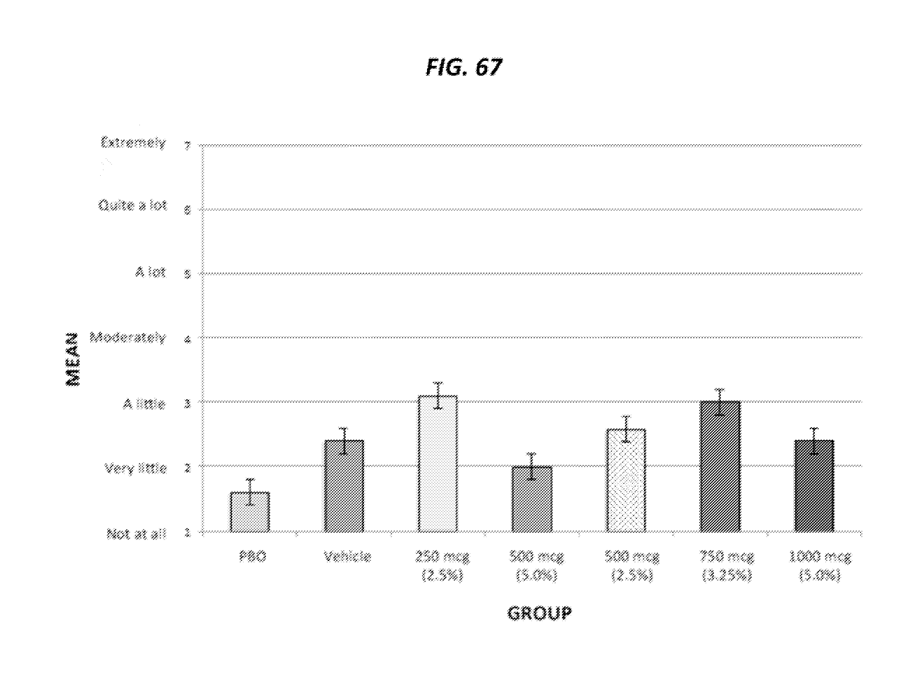

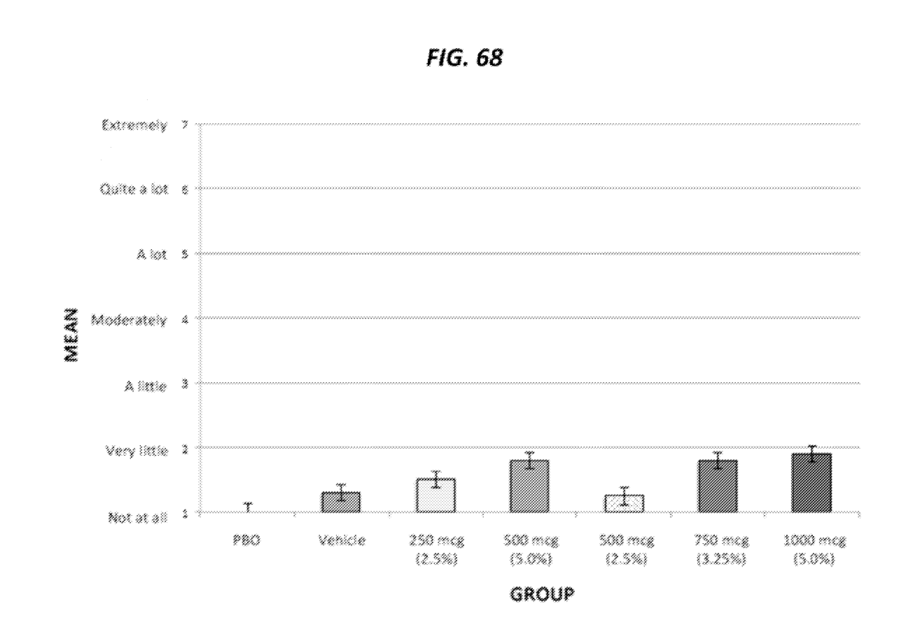

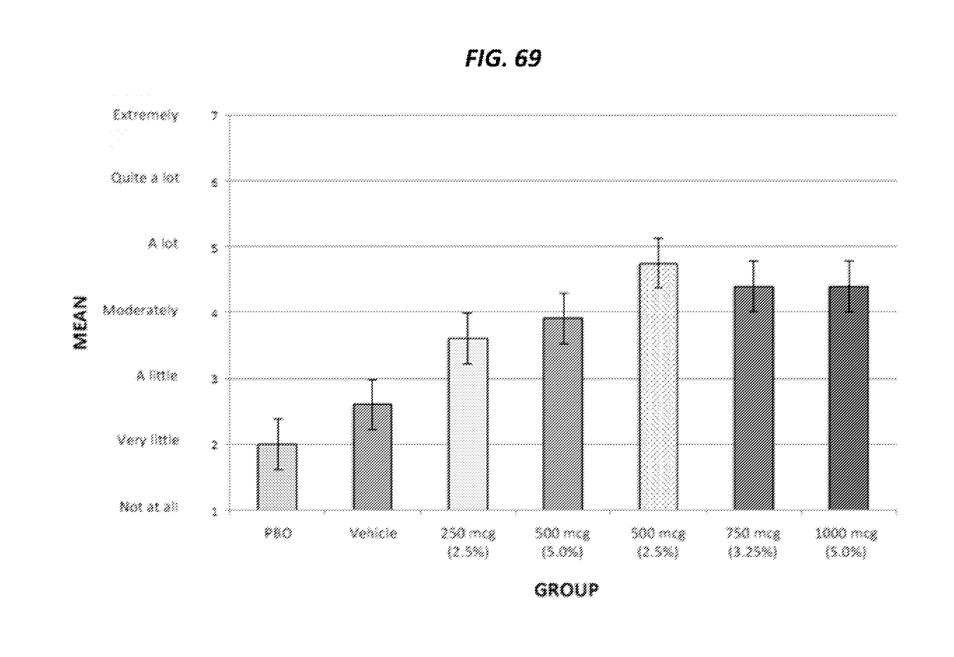

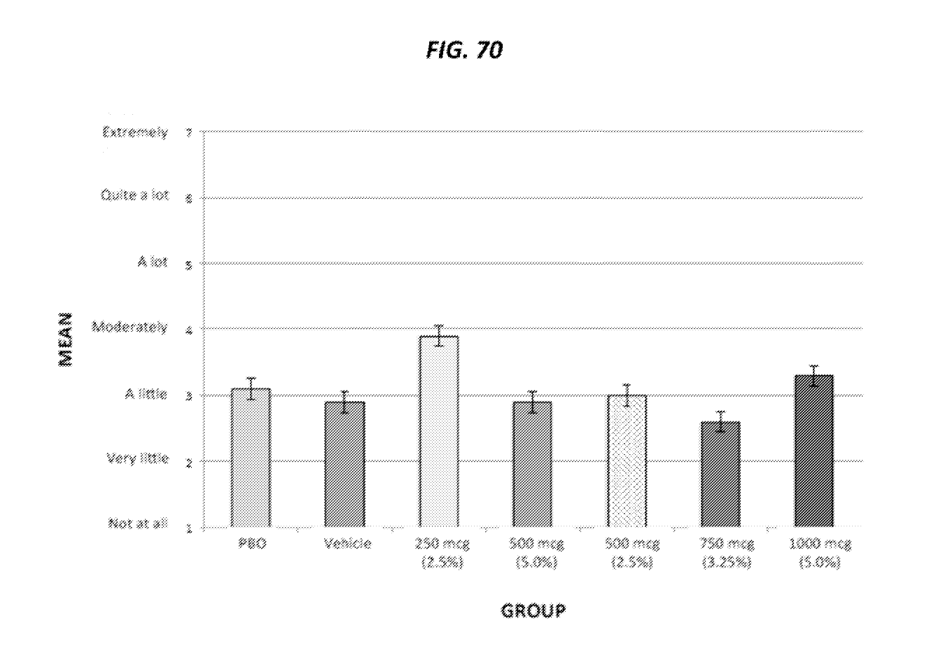

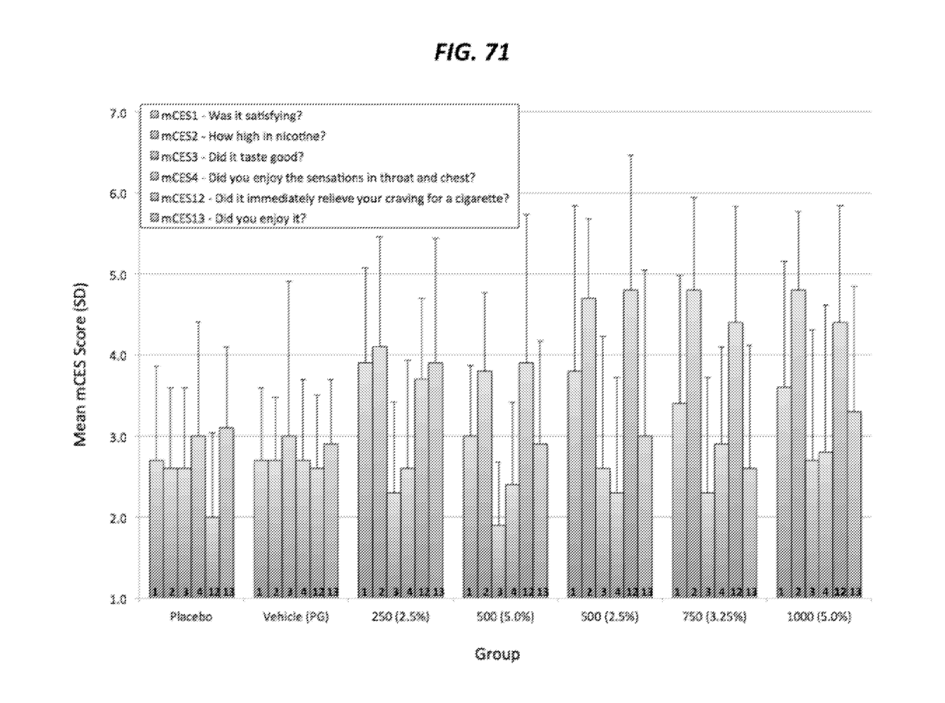

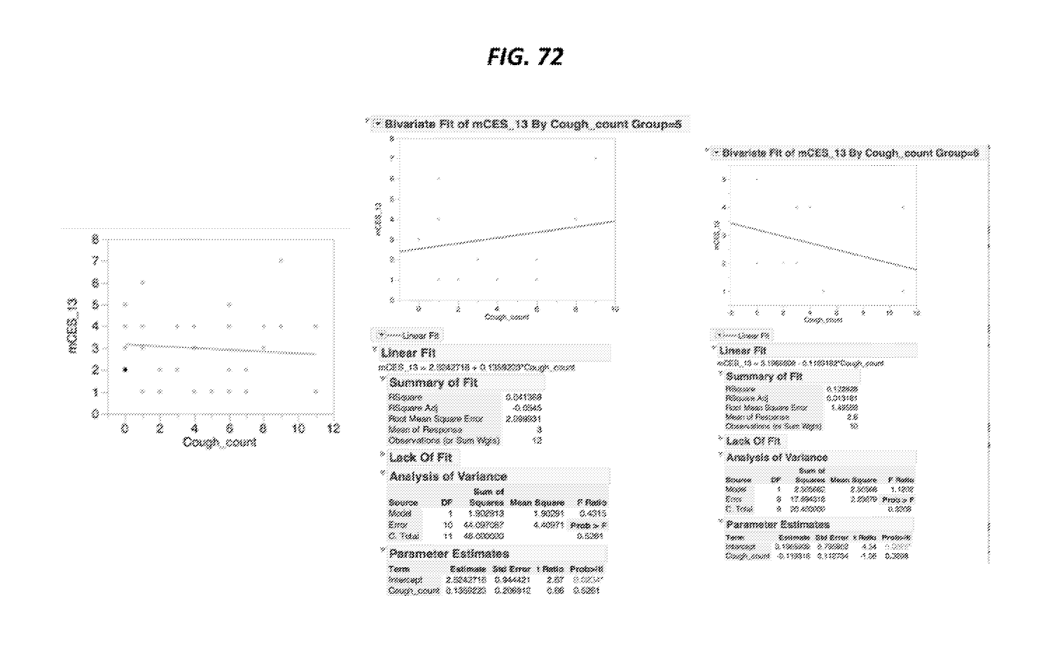

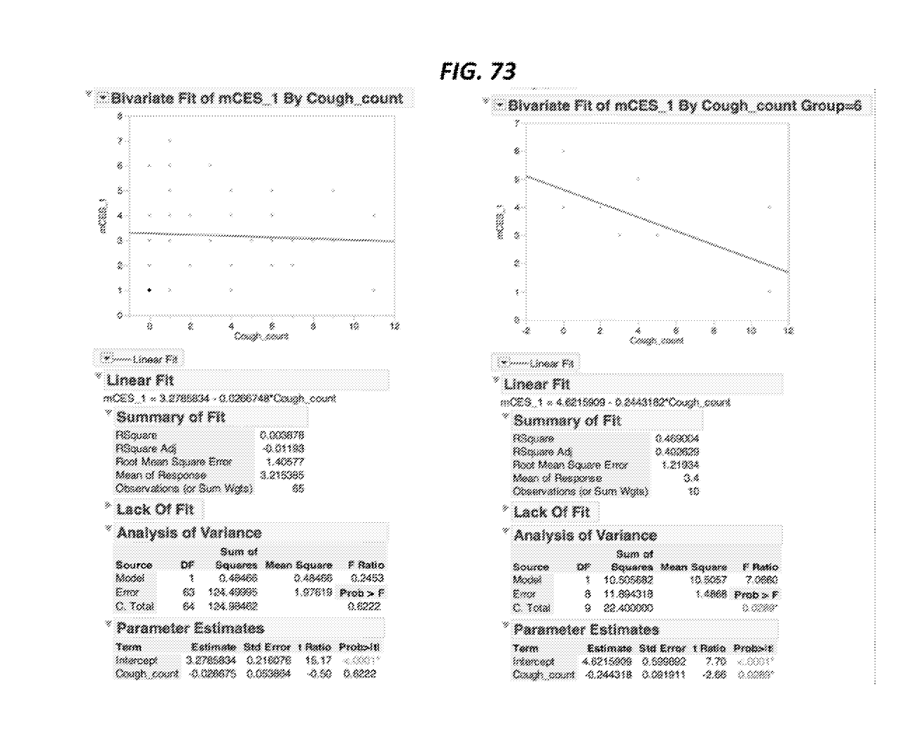

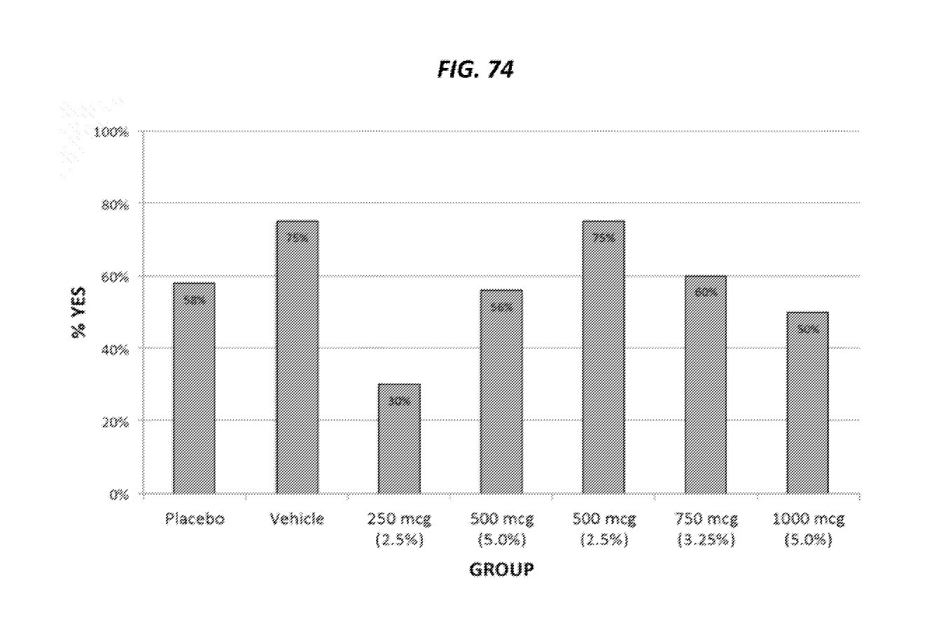

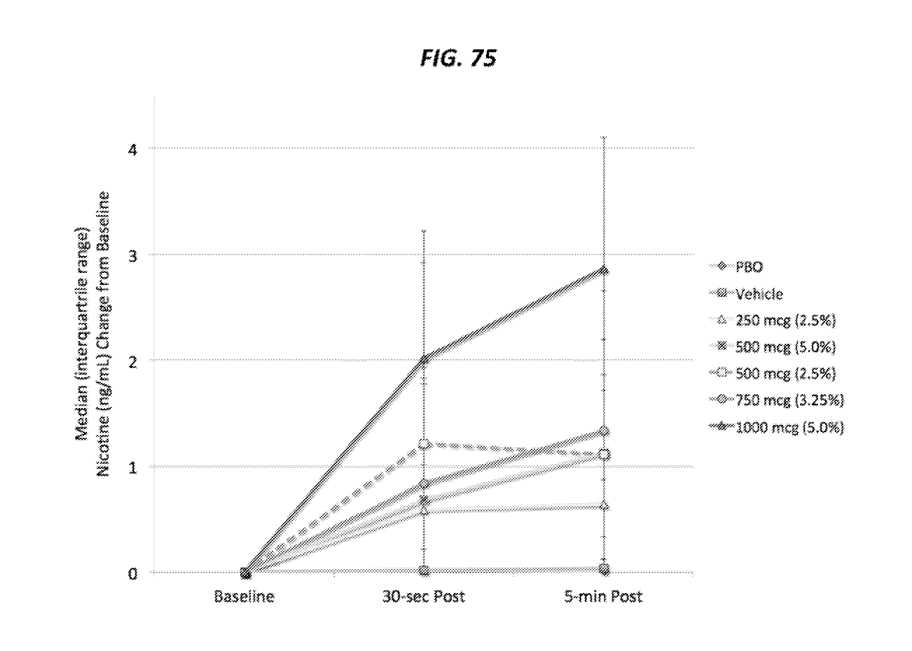

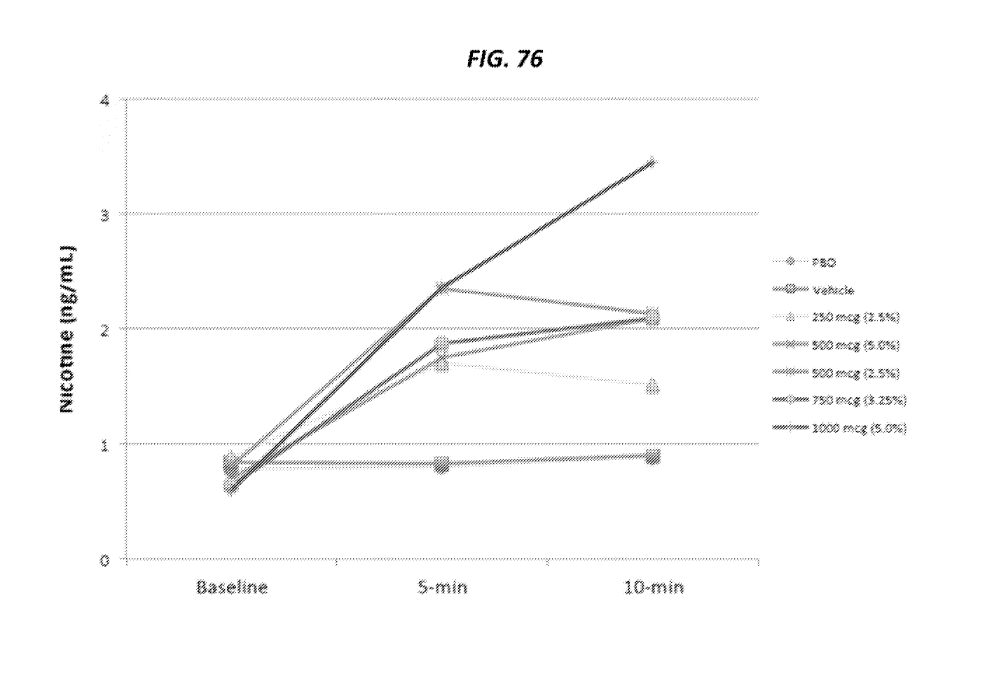

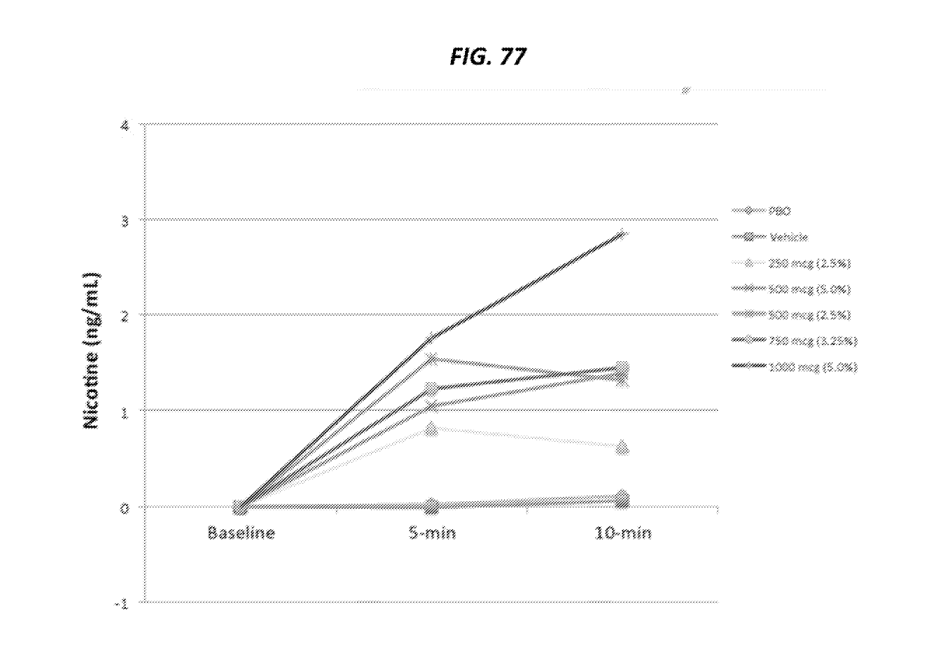

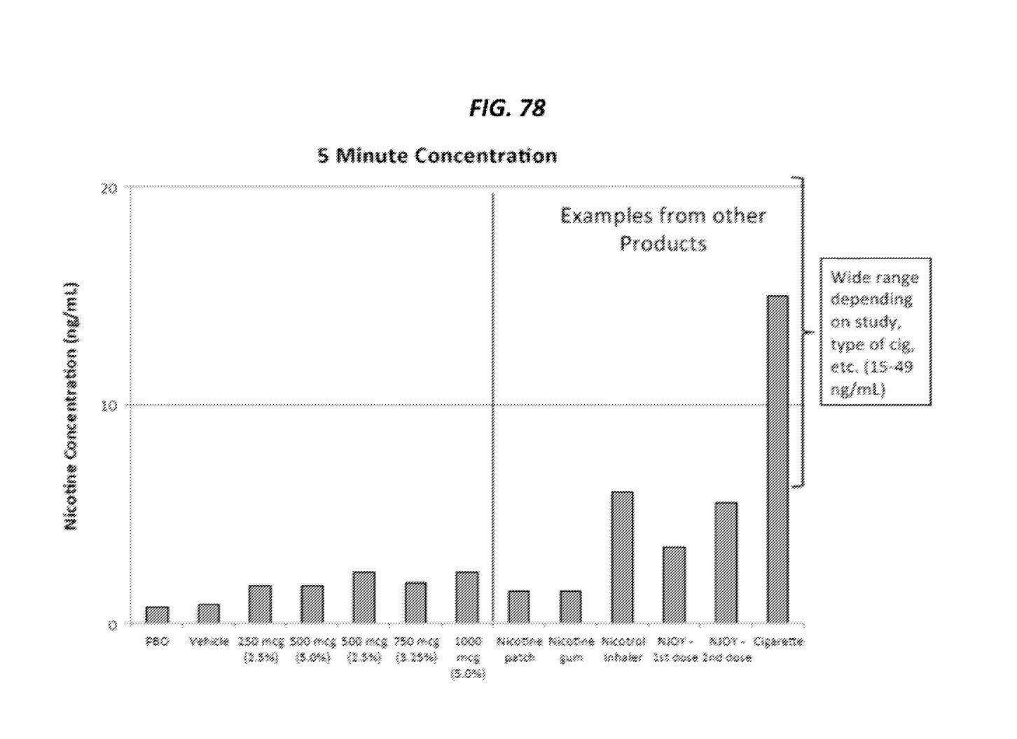

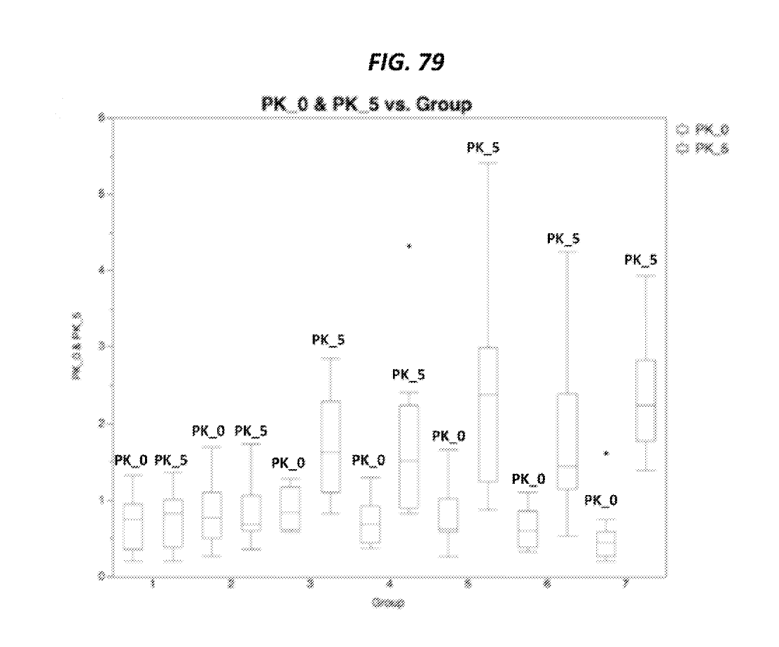

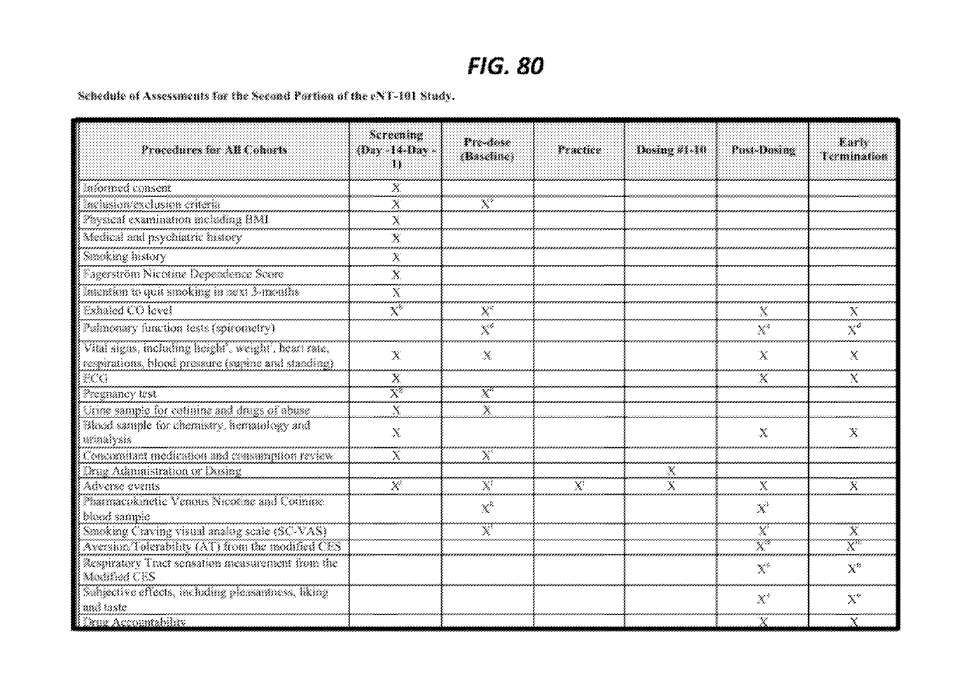

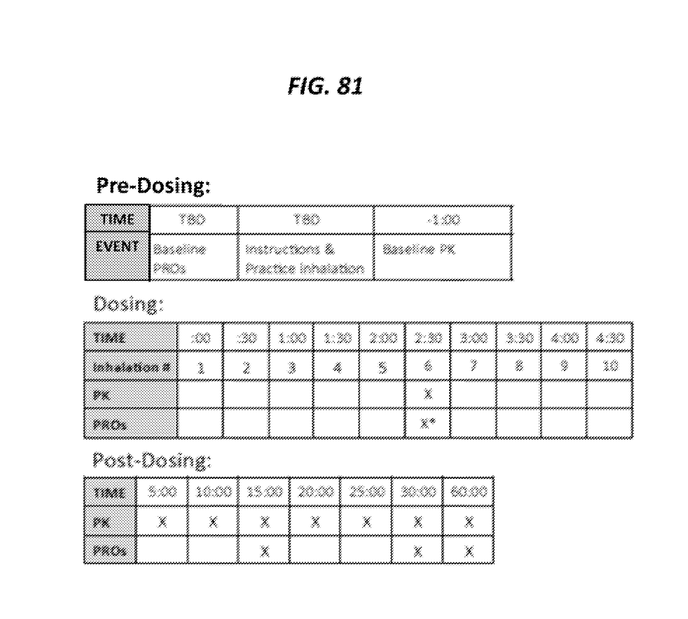

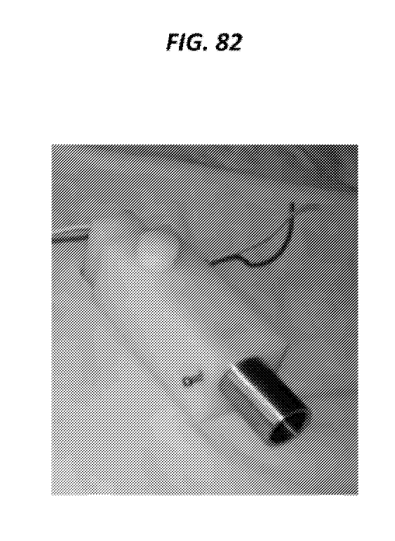

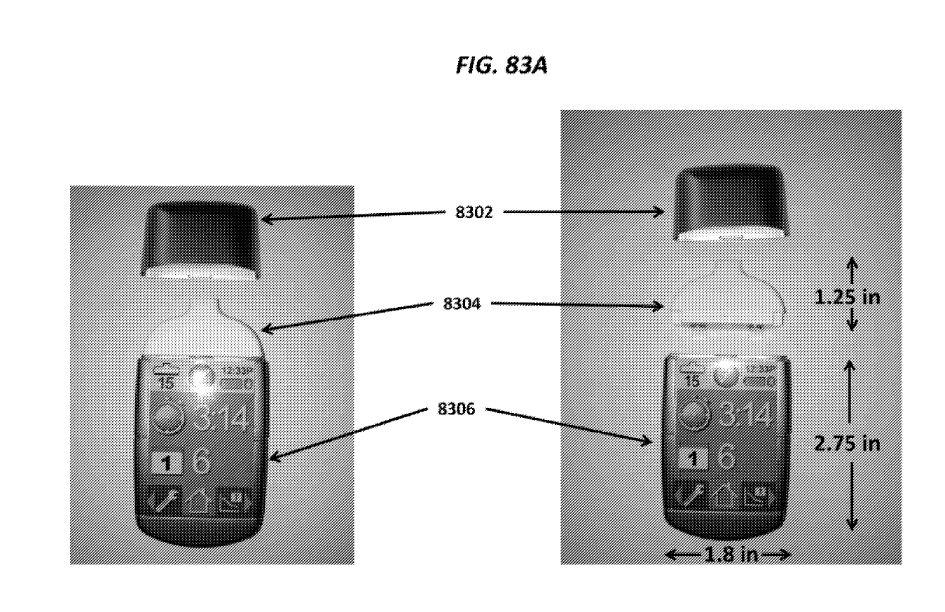

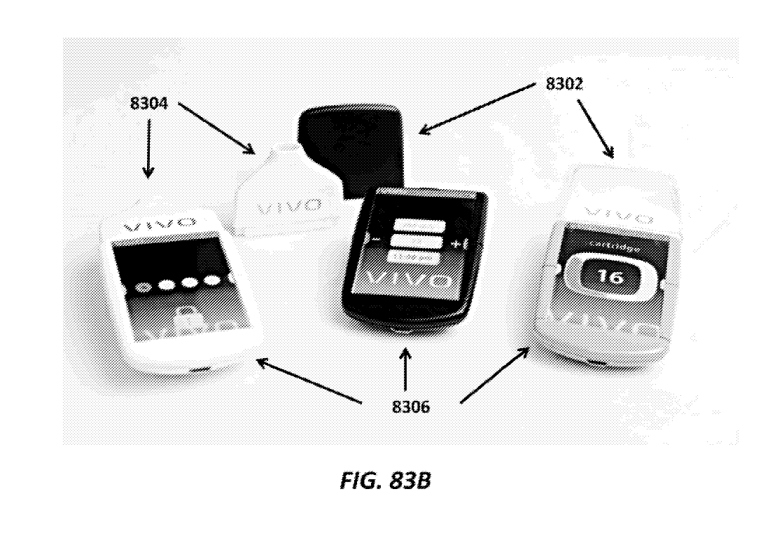

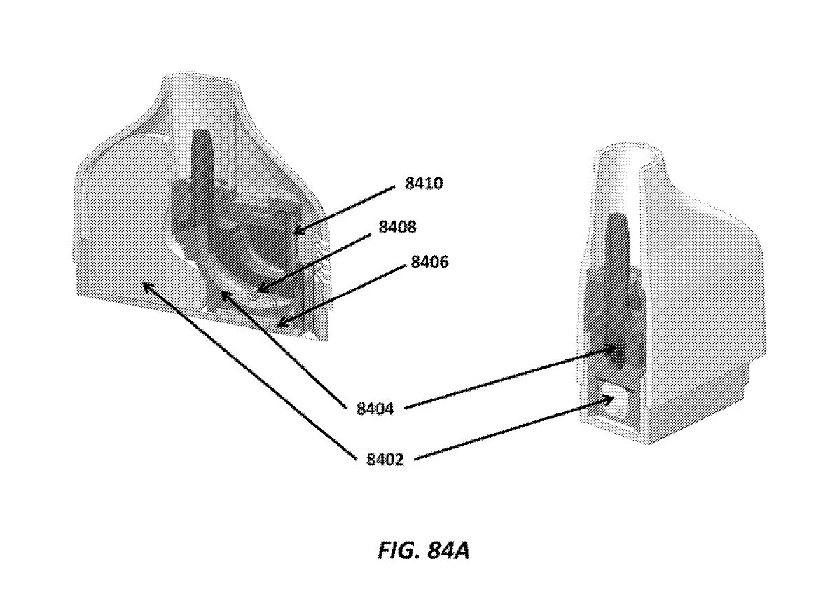

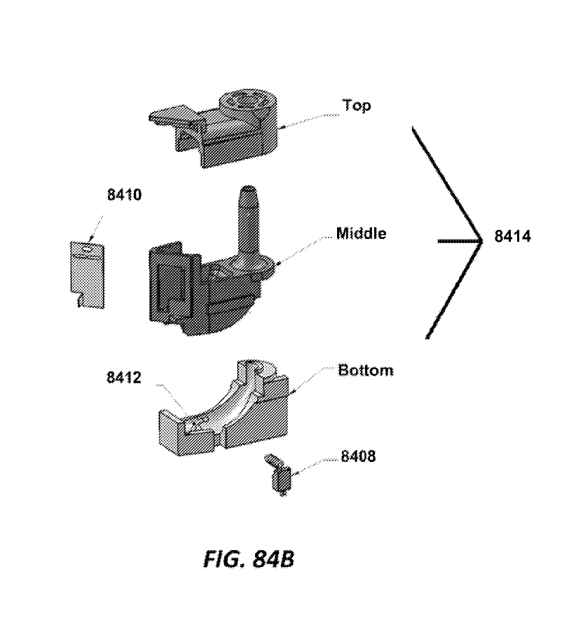

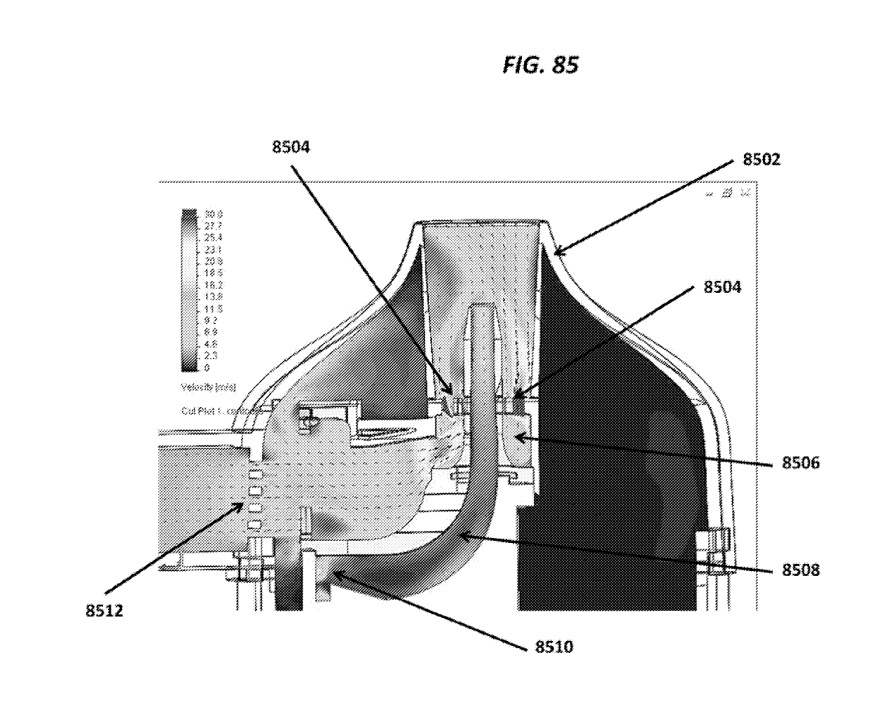

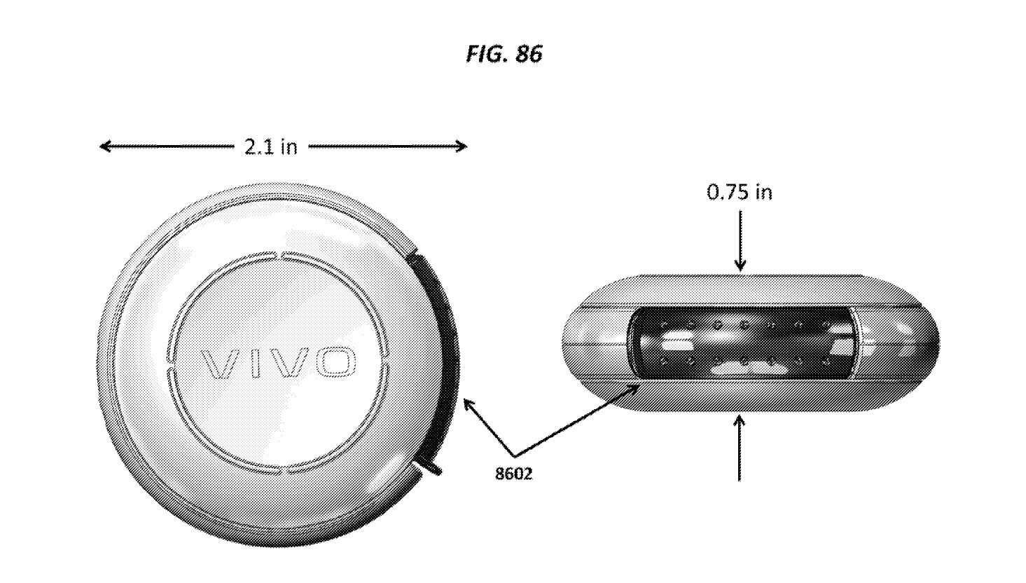

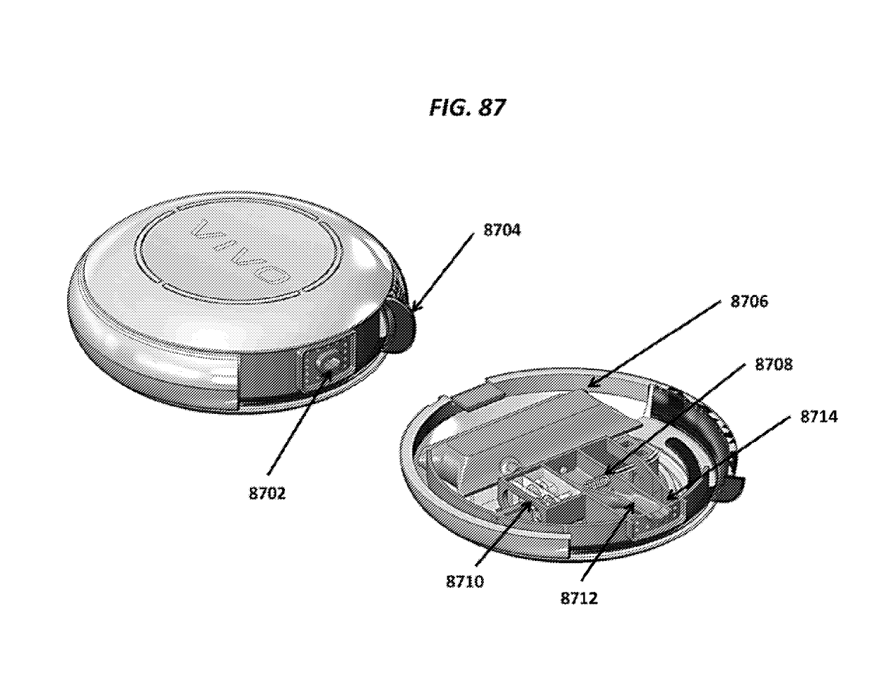

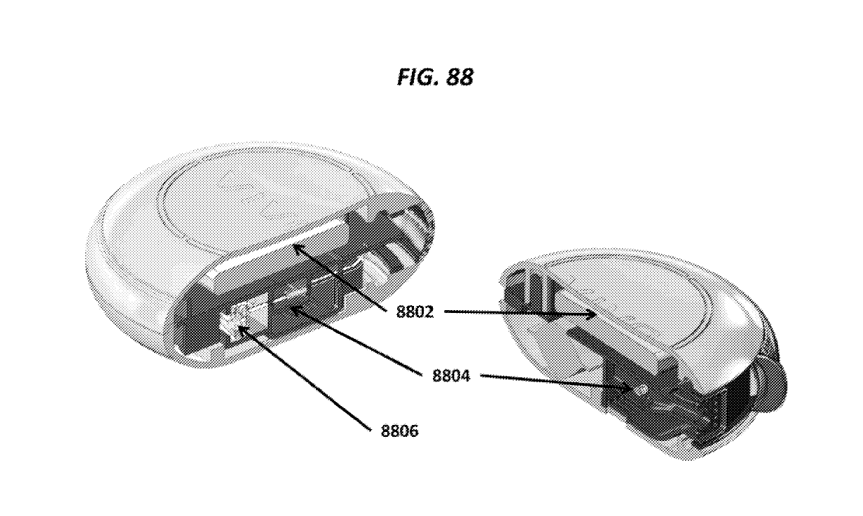

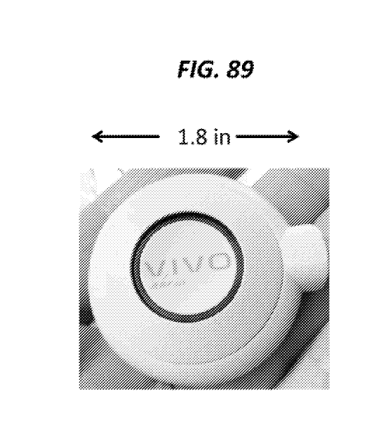

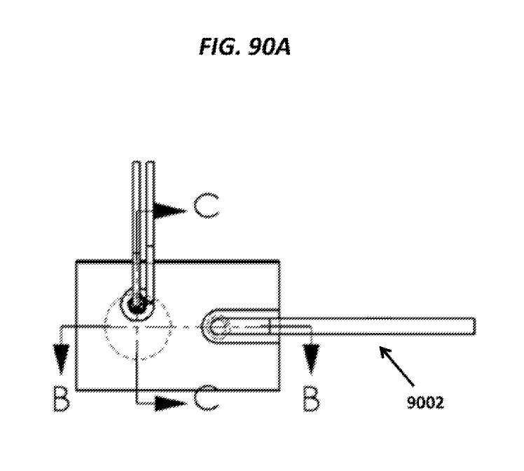

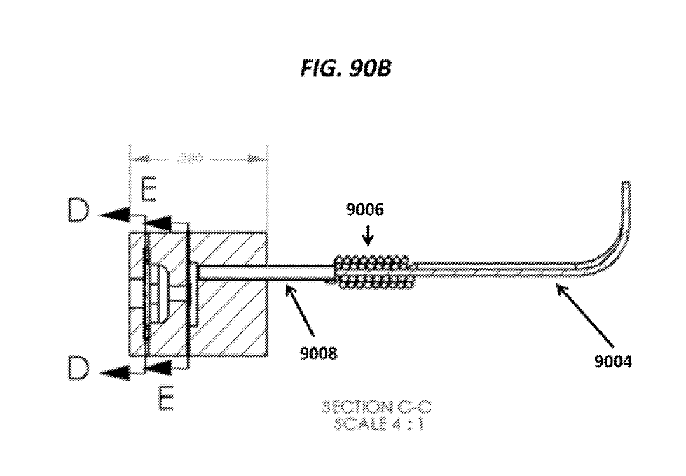

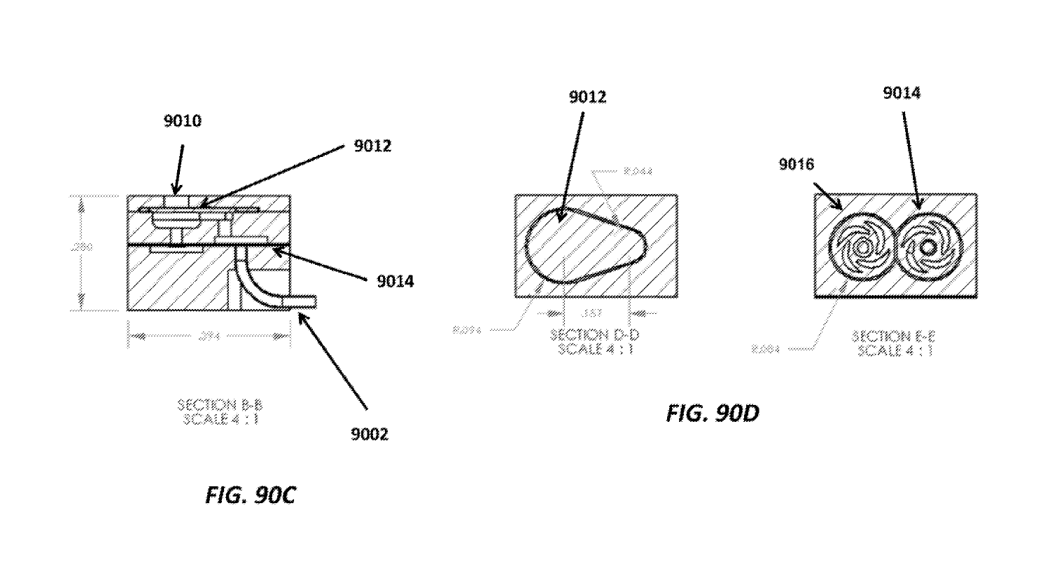

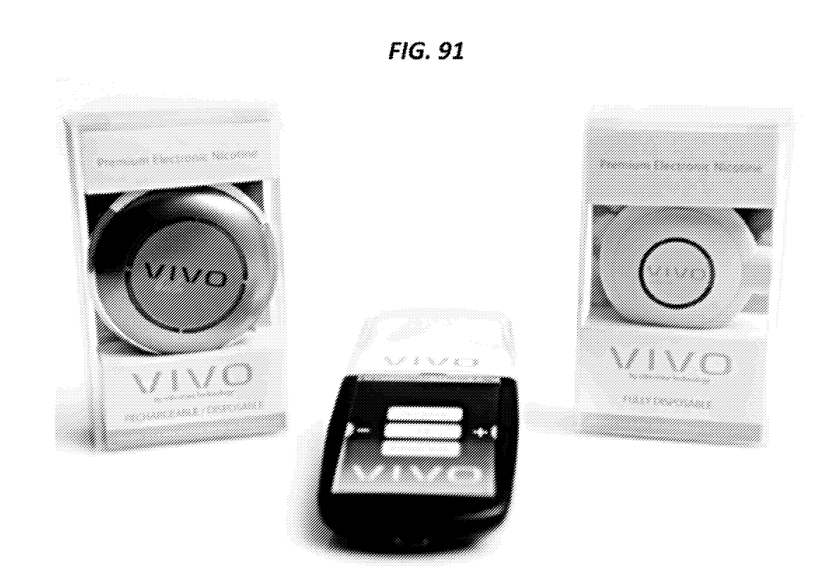

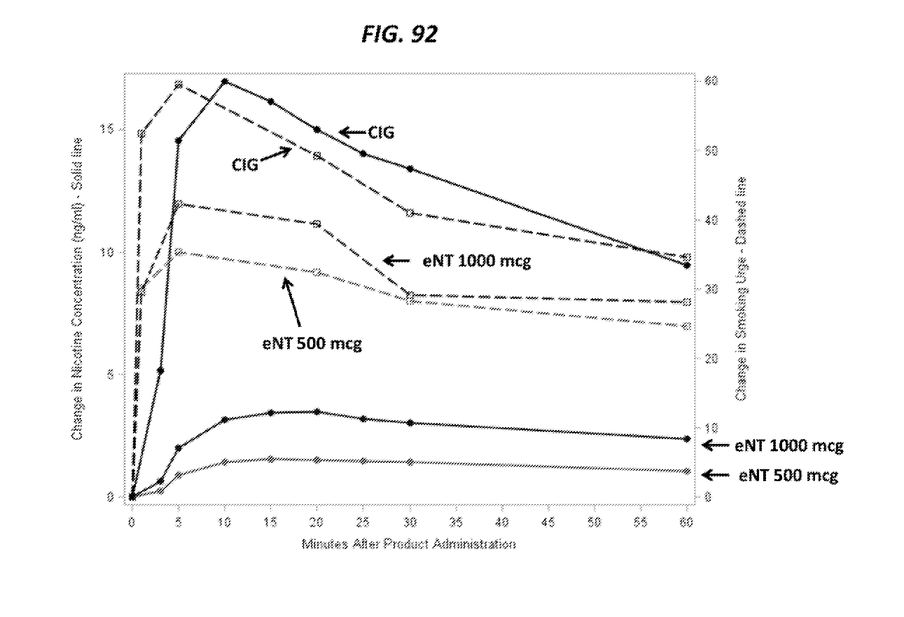

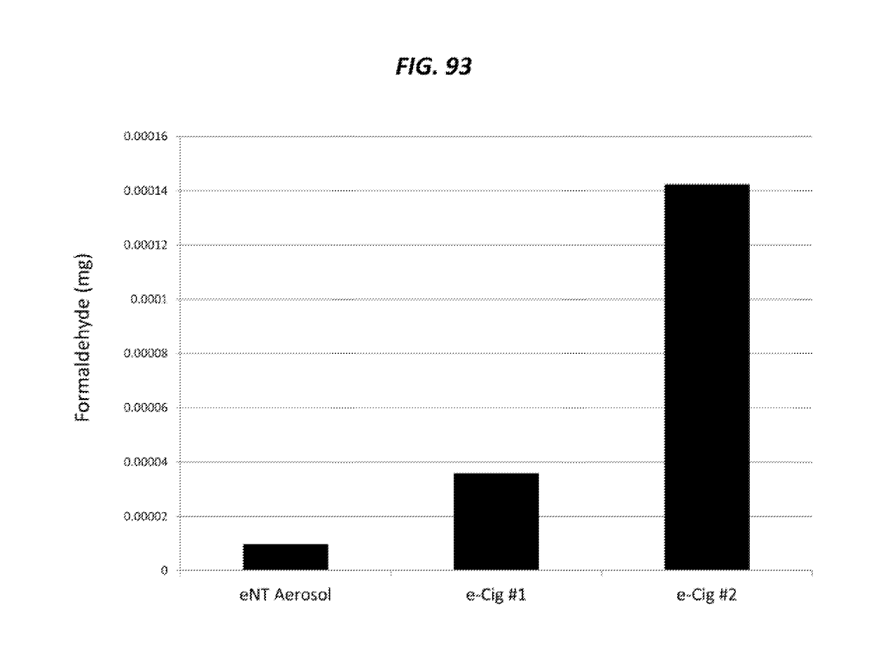

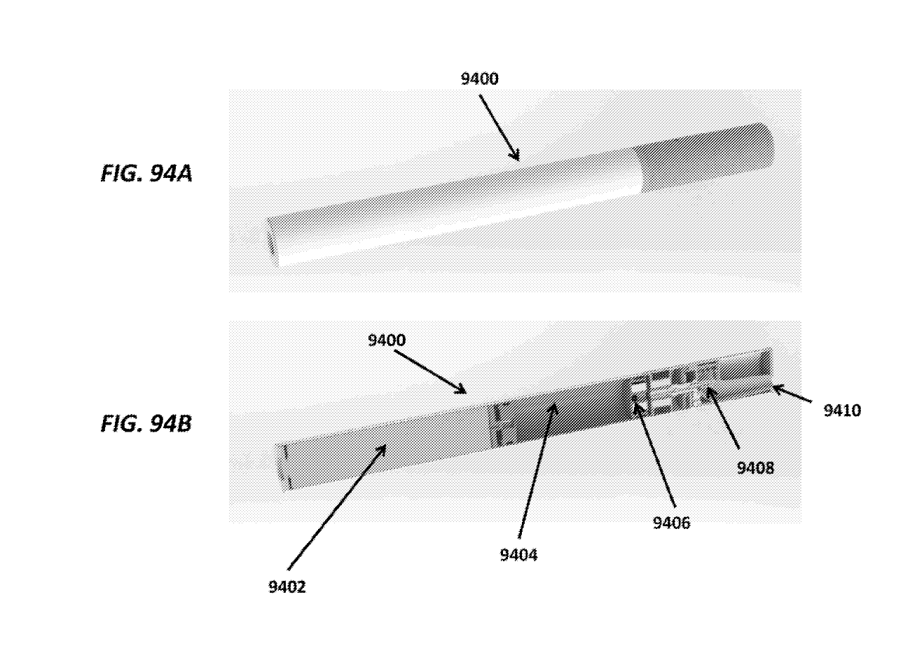

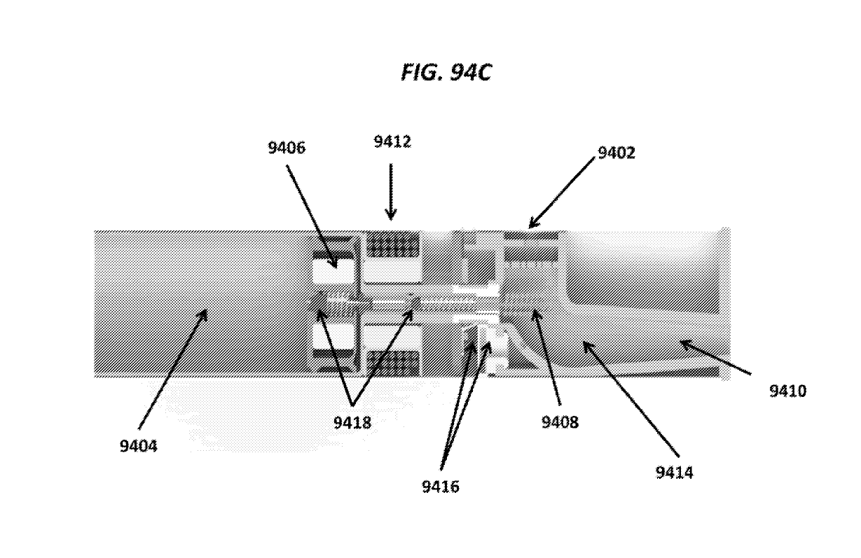

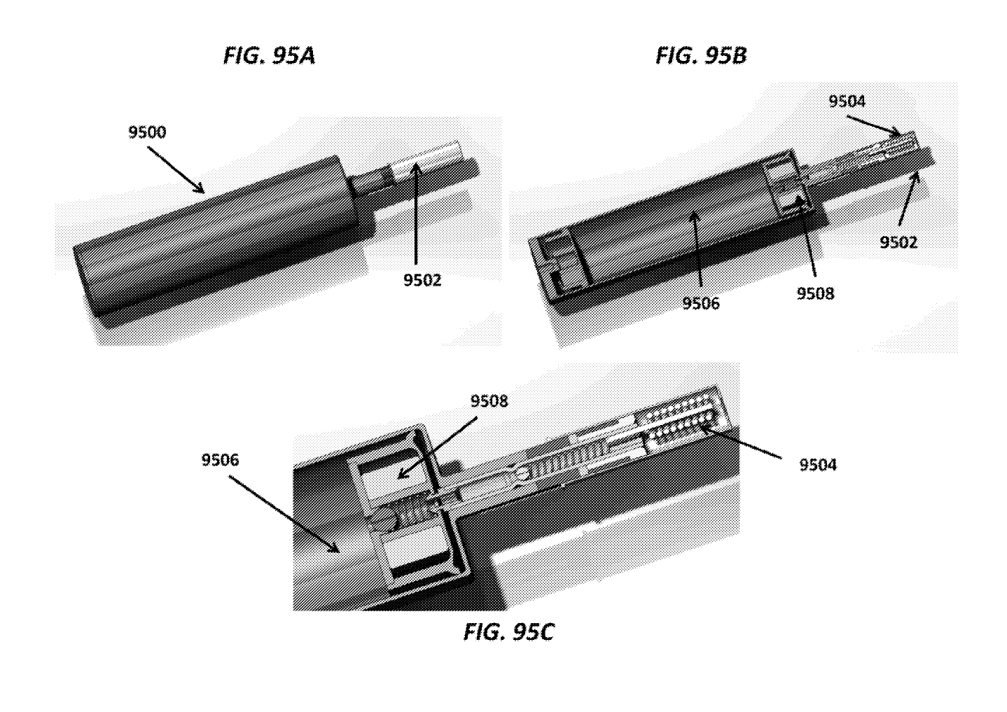

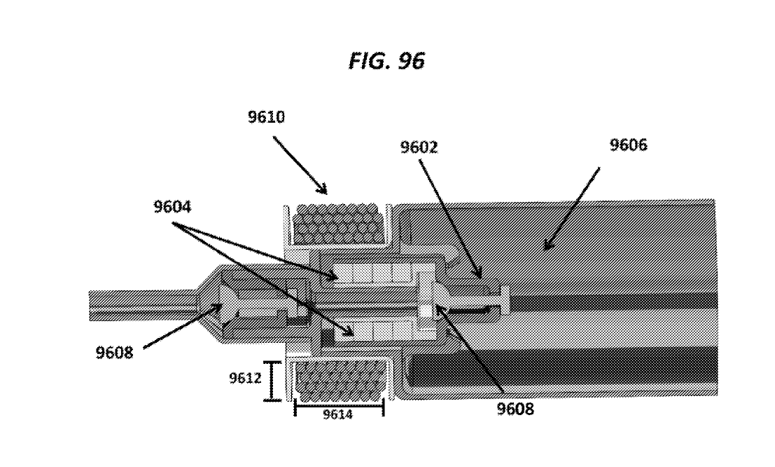

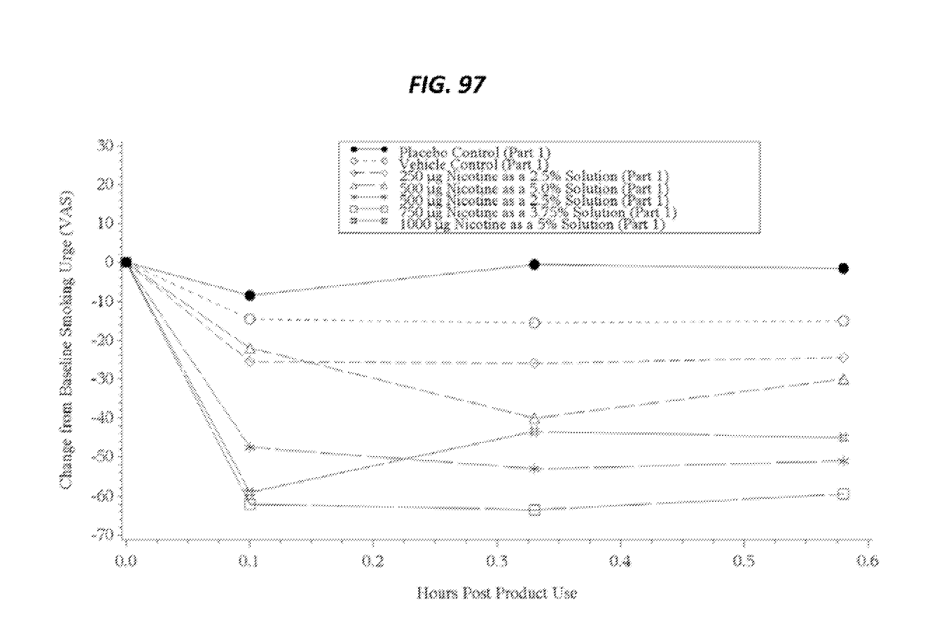

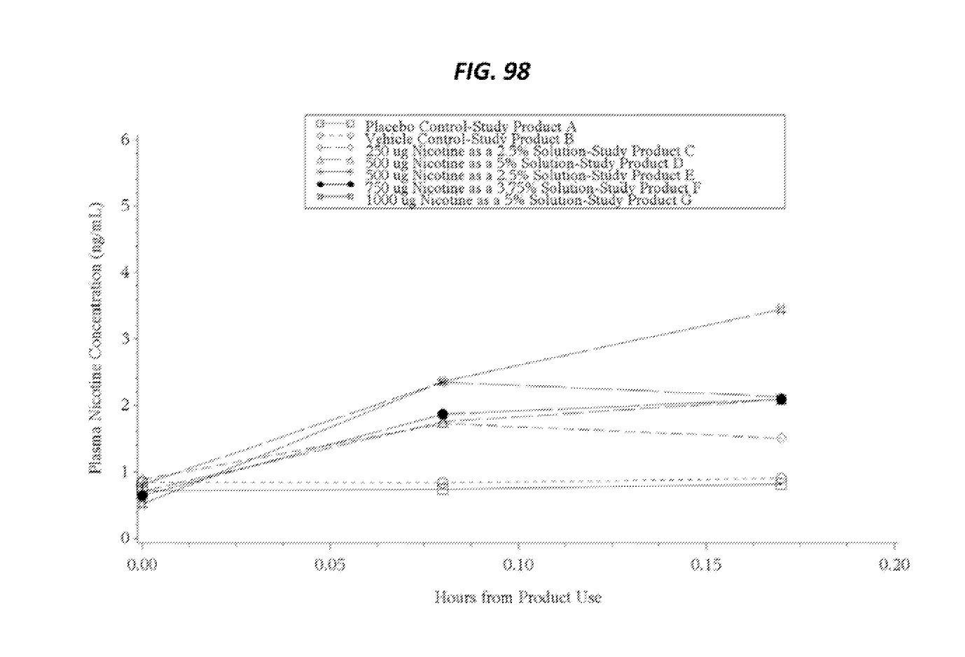

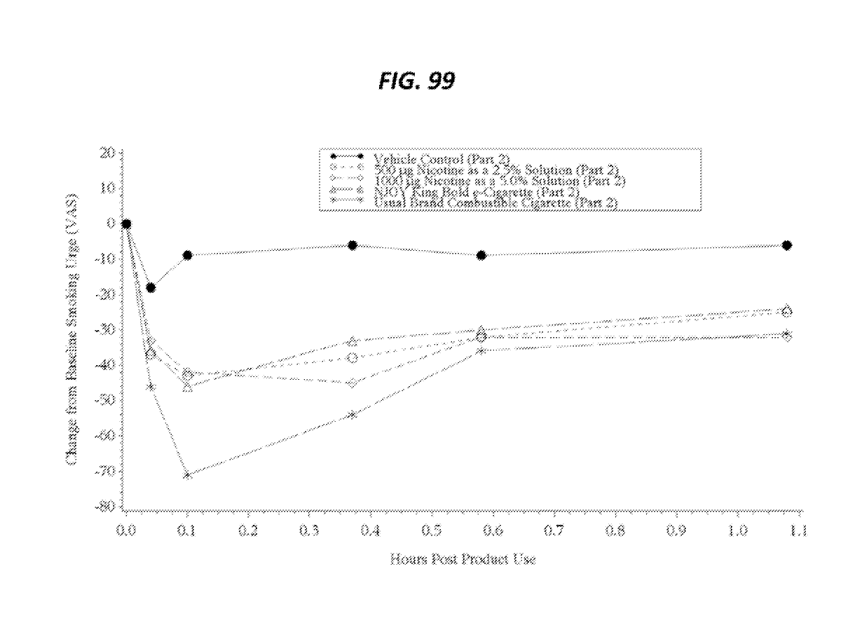

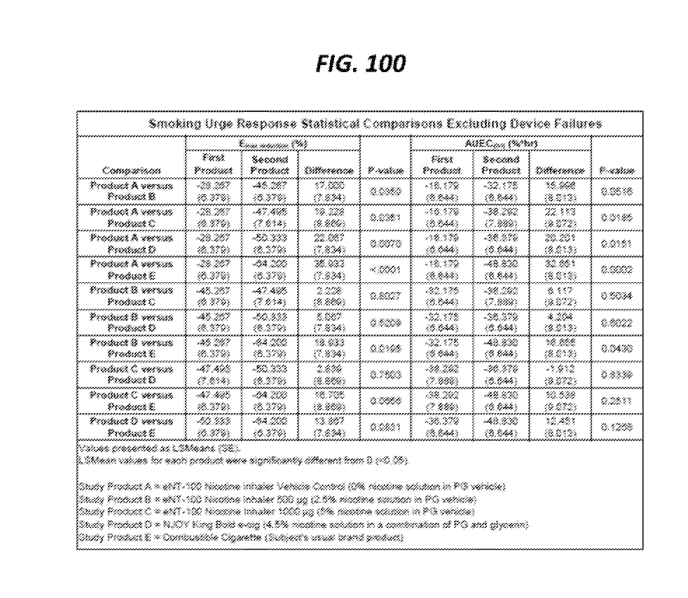

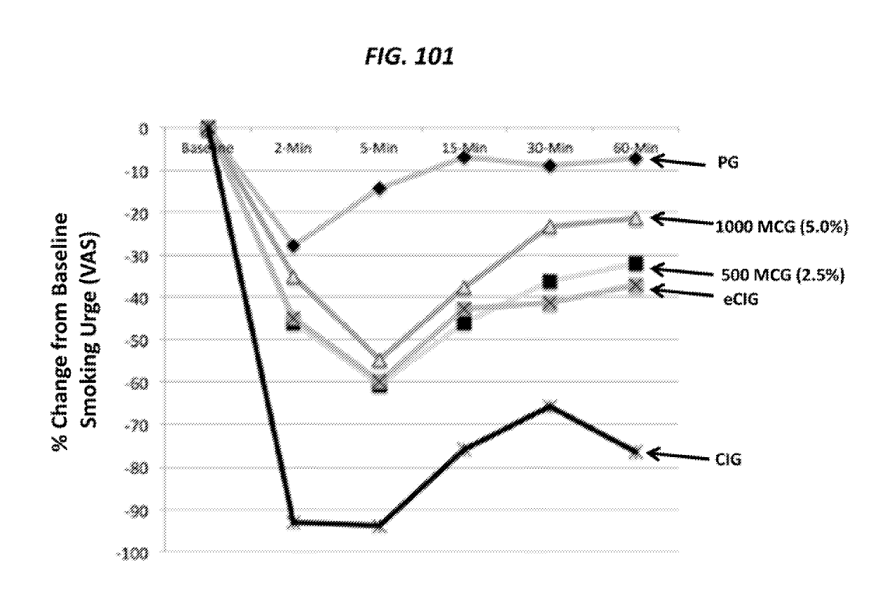

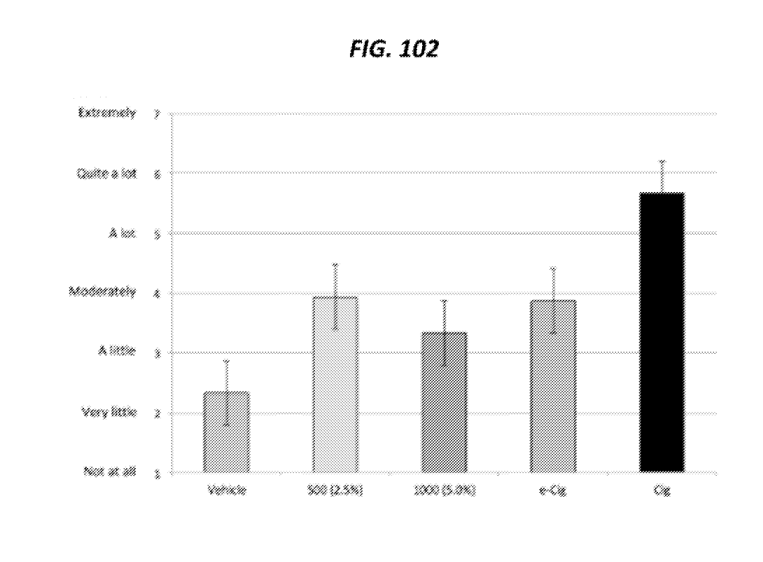

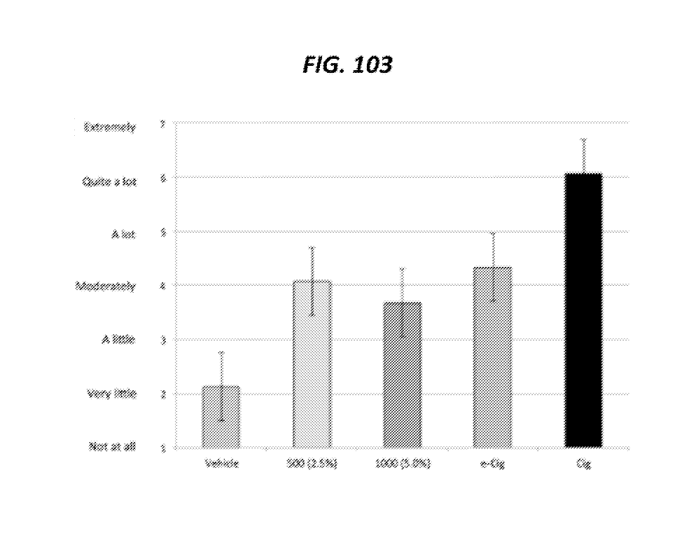

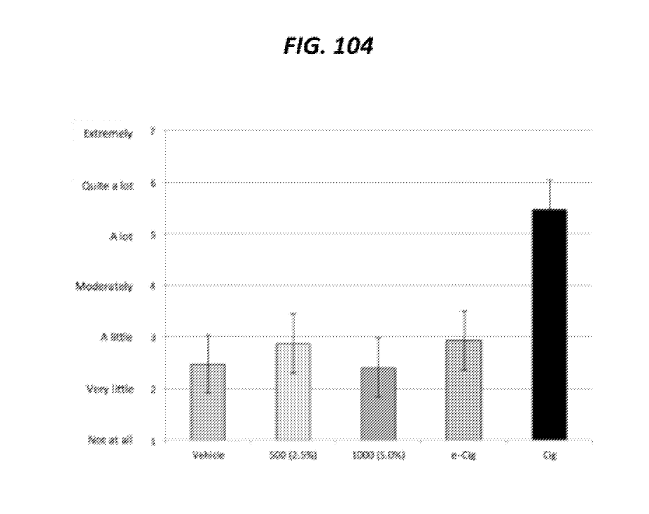

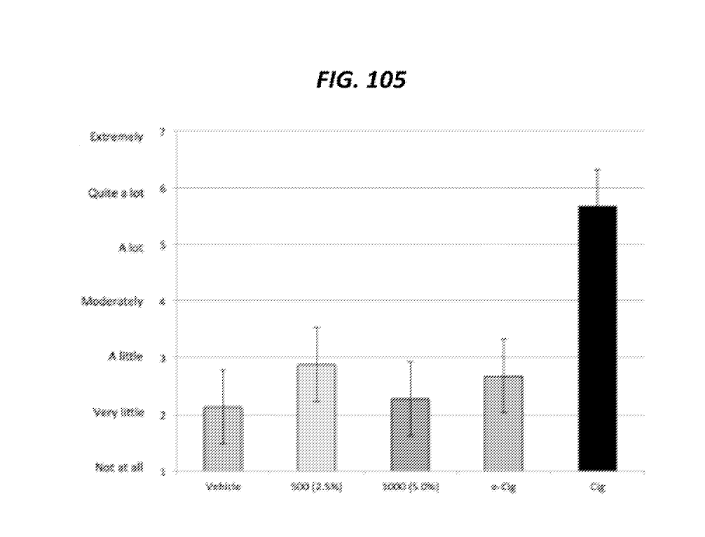

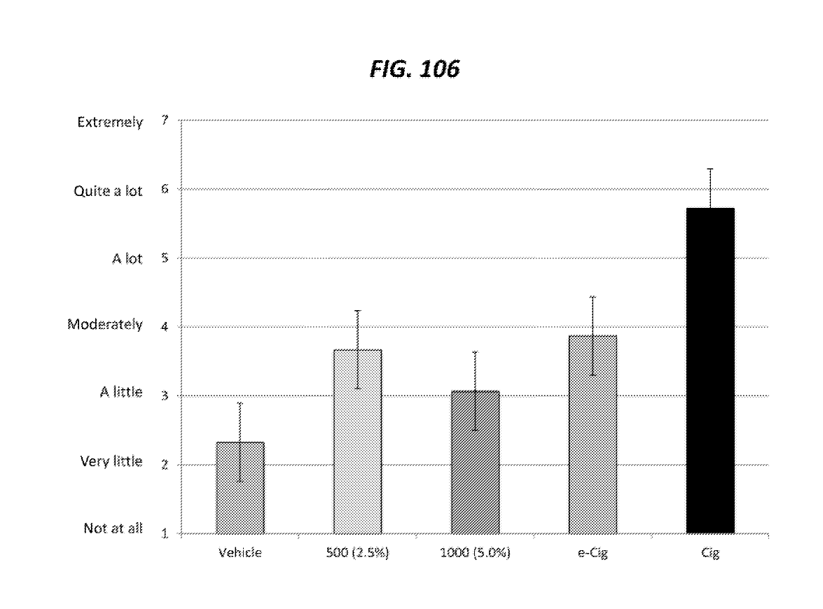

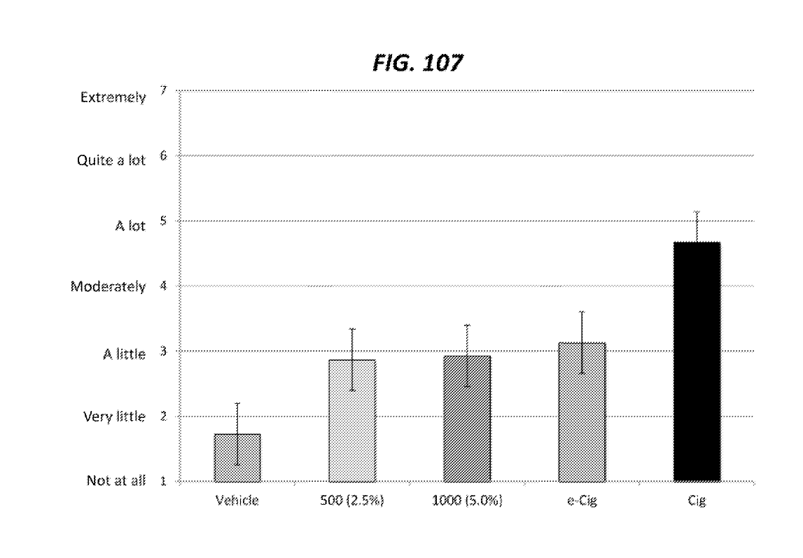

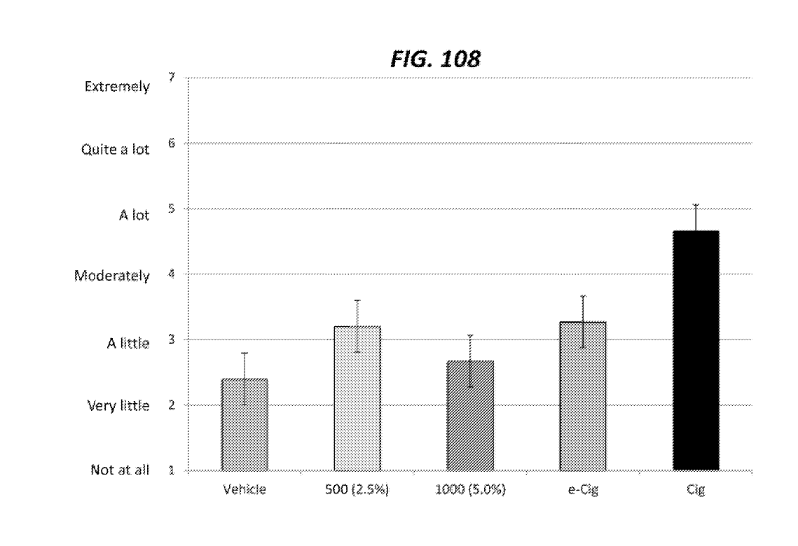

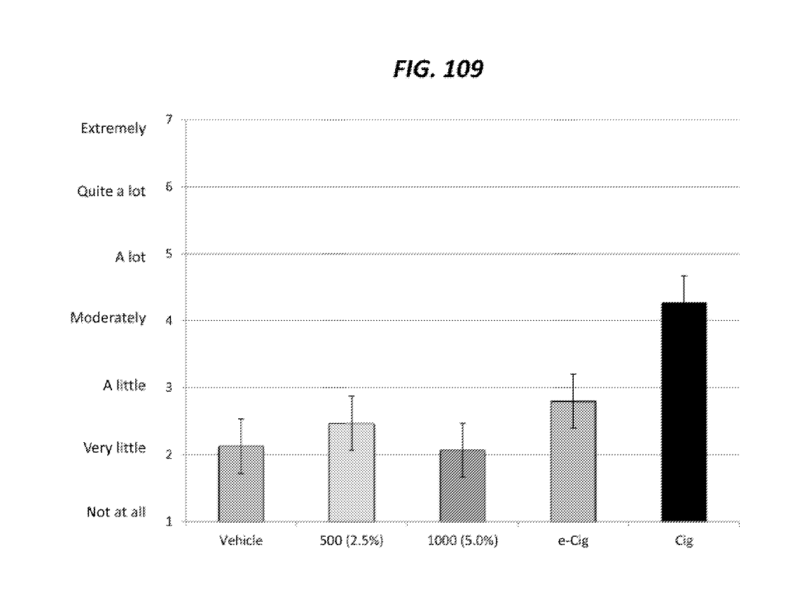

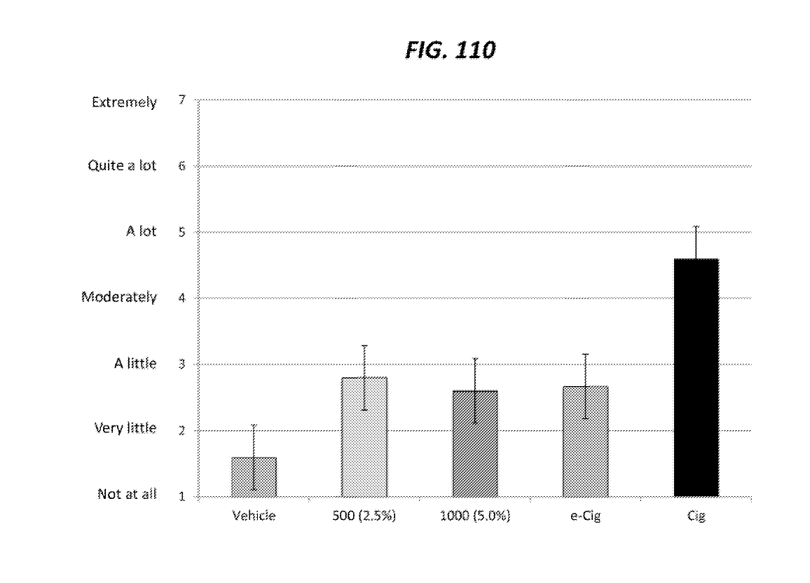

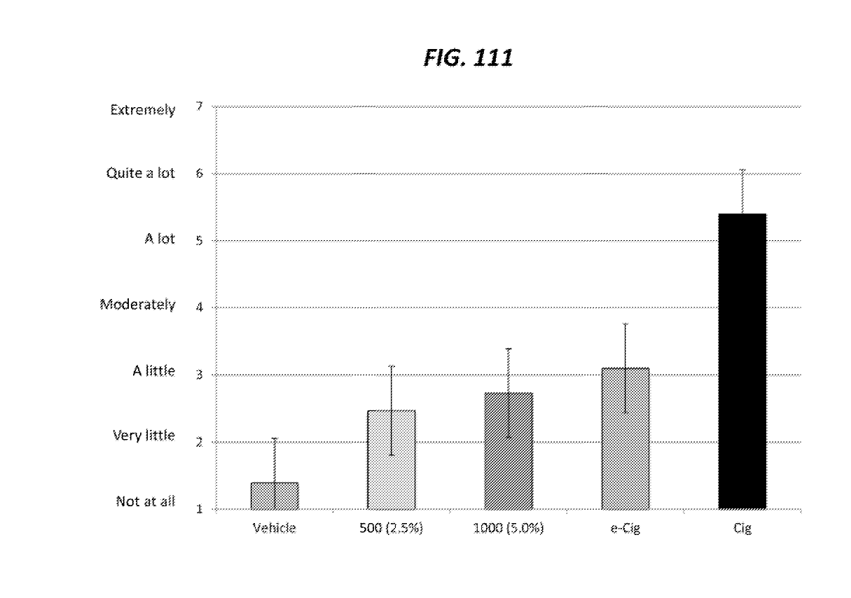

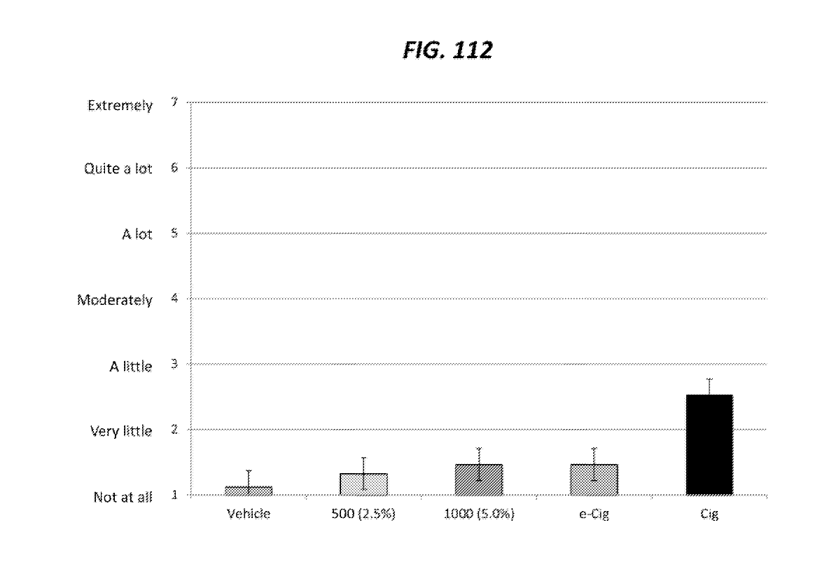

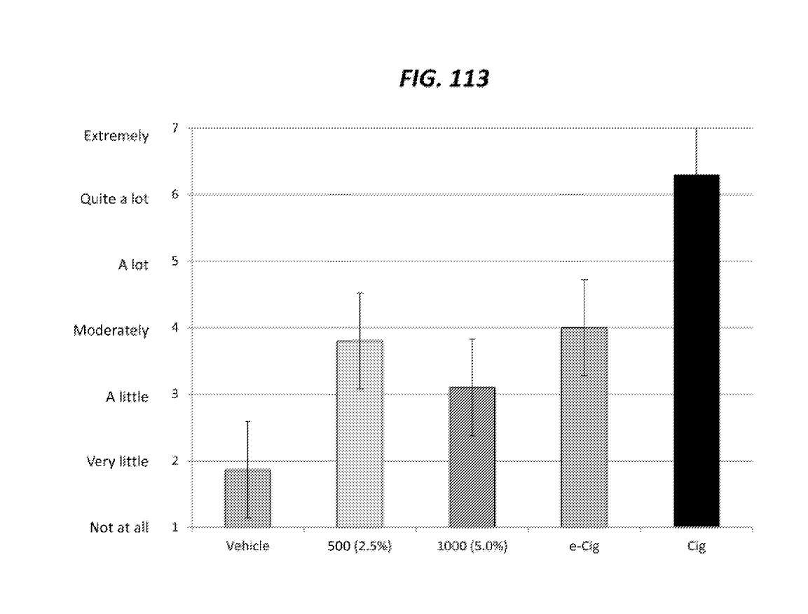

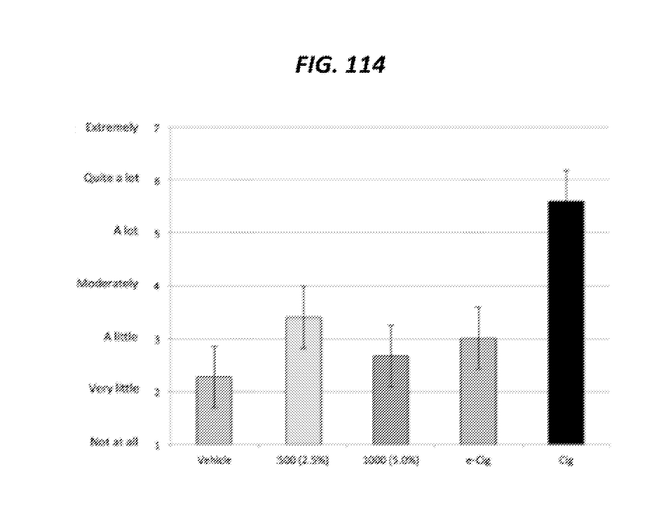

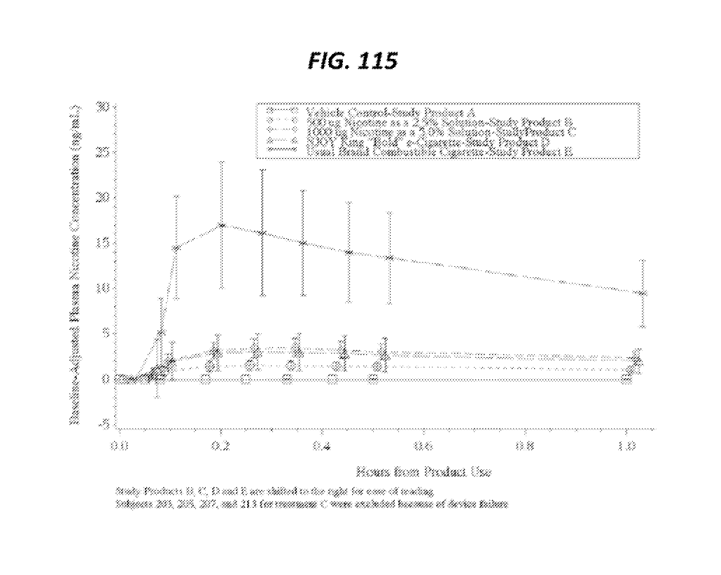

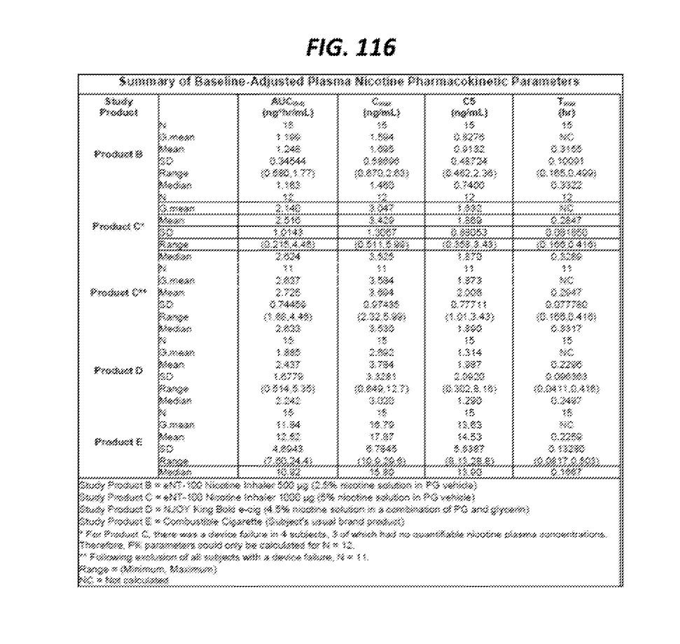

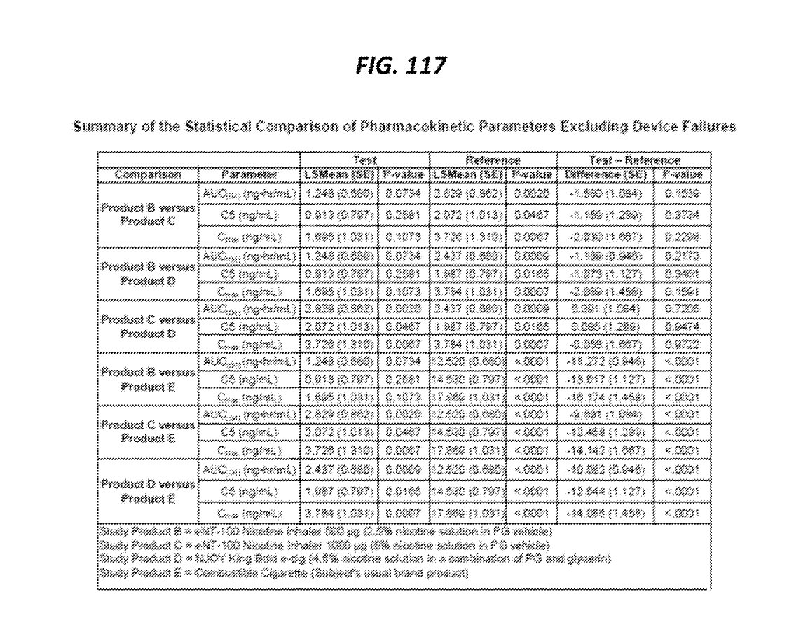

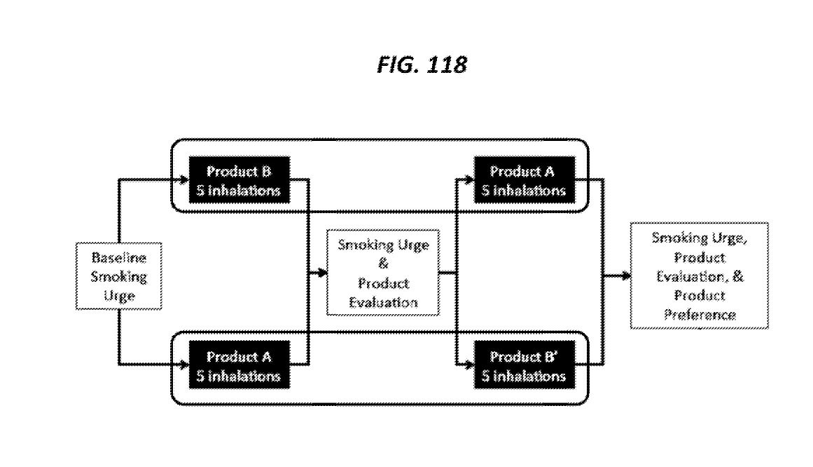

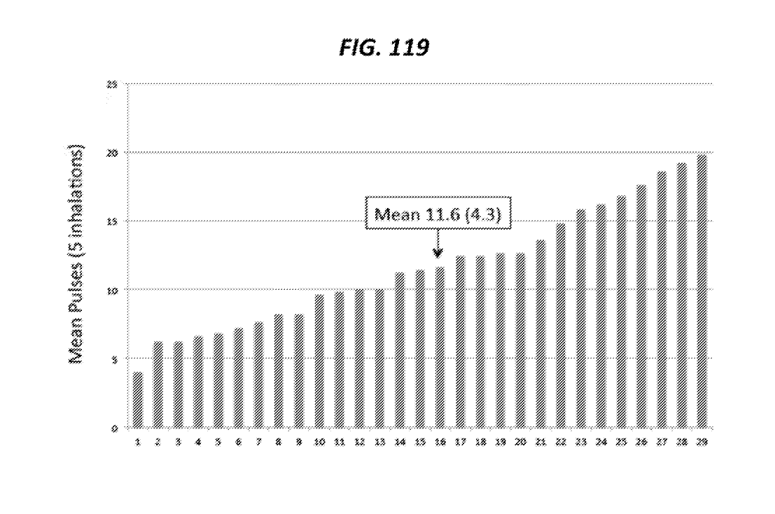

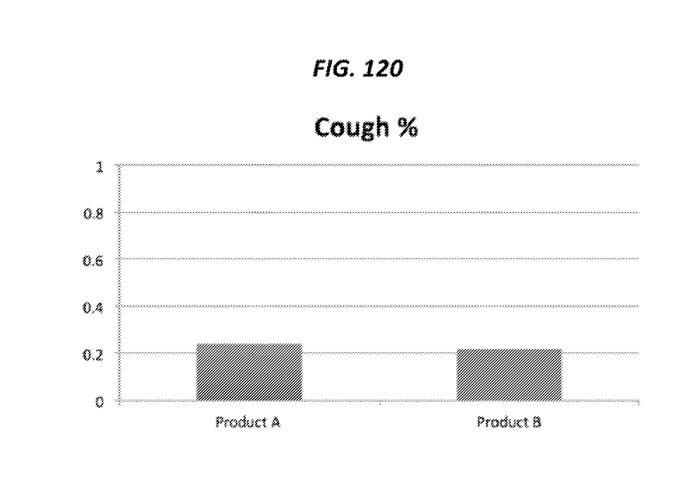

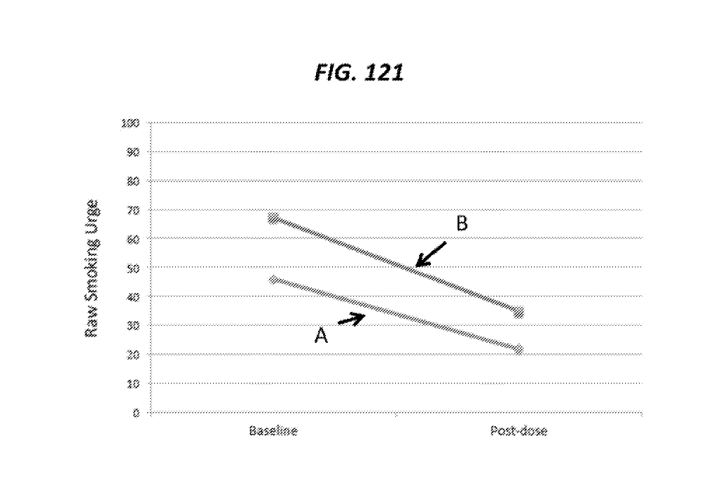

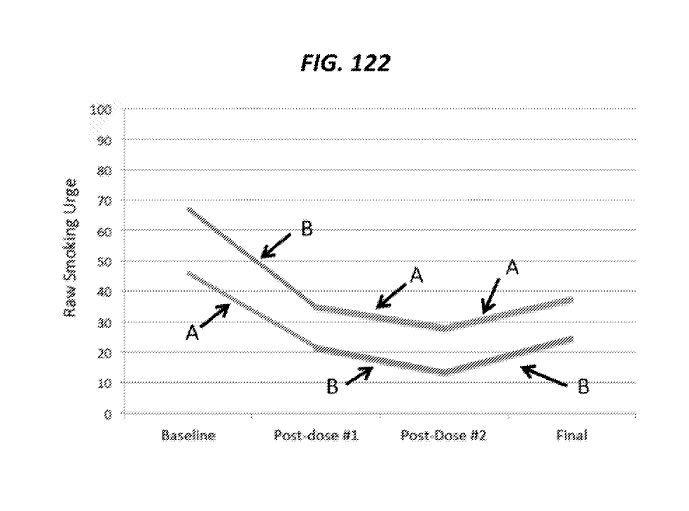

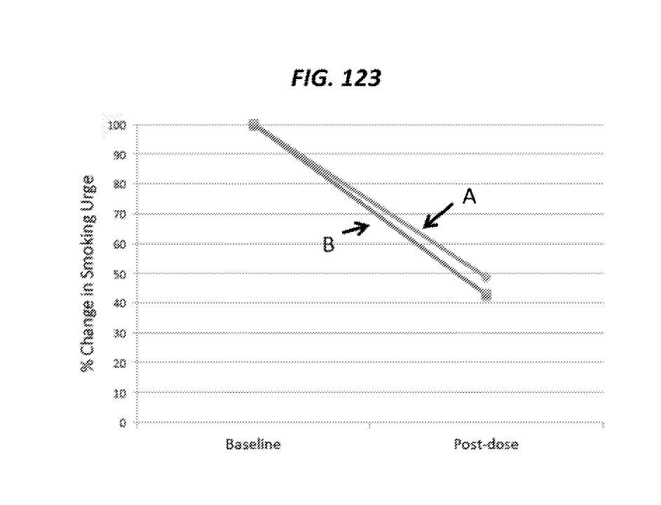

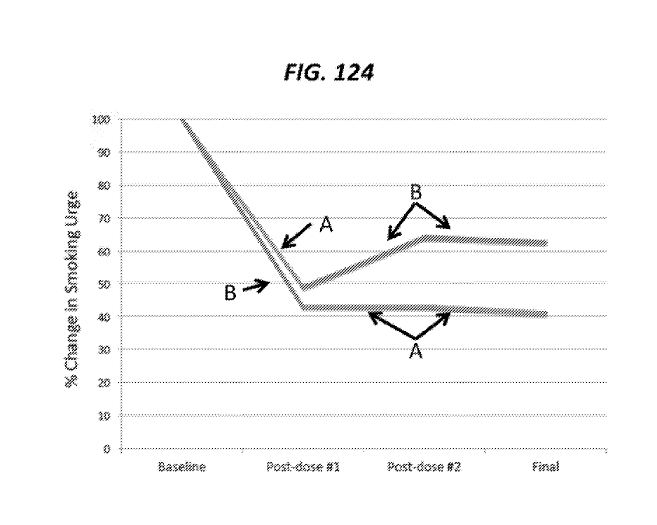

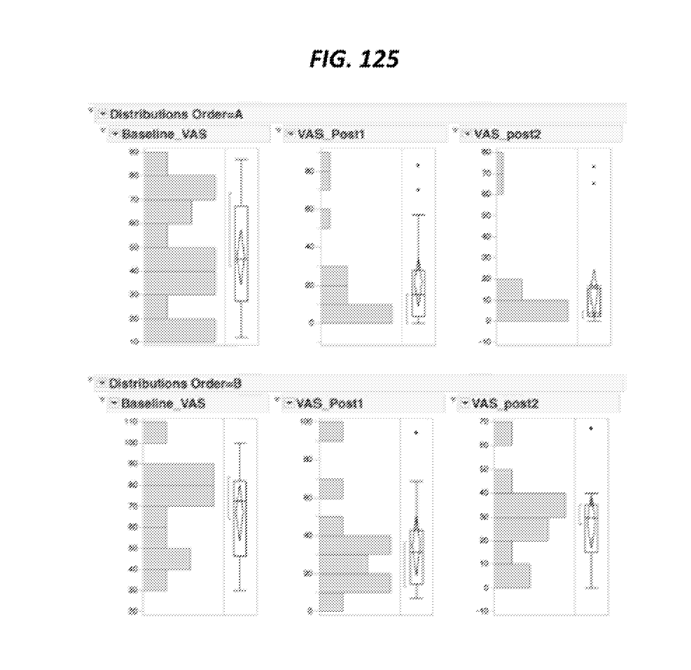

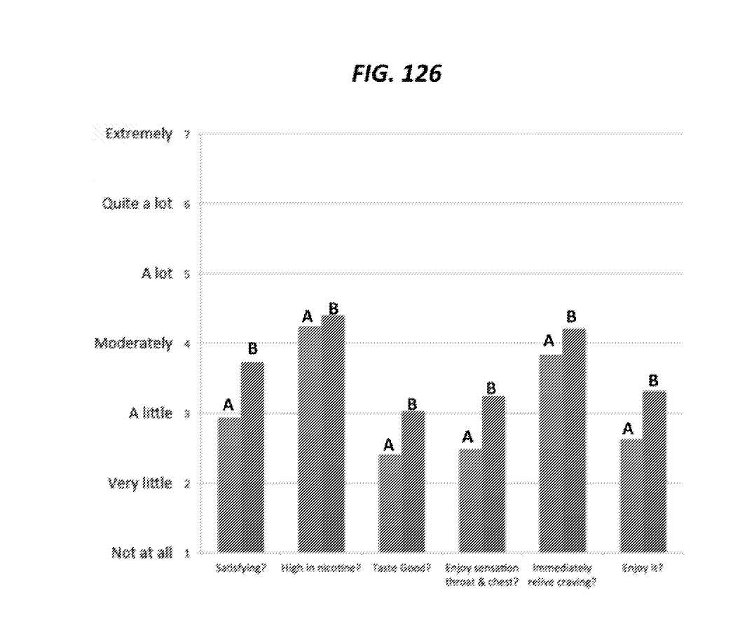

In some cases, the liquid formulation comprising a pharmaceutically active agent (e.g., nicotine) is delivered to the heater element through the use of a positive displacement pump. The positive displacement pump can be a reciprocating, metering, rotary-type, hydraulic, peristaltic, gear, screw, flexible impeller, diaphragm, piston, or progressive cavity pump, or any other pump utilizing positive displacement as known in the art. The positive displacement pump can be in fluid communication with the heater element. The positive displacement pump can be in fluid communication or fluidically coupled to a reservoir comprising a pharmaceutically active agent (e.g., nicotine). The positive displacement pump can be in fluid communication with the heater element and a reservoir comprising a pharmaceutically active agent (e.g., nicotine). The pharmaceutically active agent (e.g., nicotine) can be a liquid formulation. The pump (e.g., positive displacement pump) can be within the passageway or external to the passageway. The pump (e.g., positive displacement pump) can be fully or partially located within a reservoir comprising a liquid formulation comprising a pharmaceutically active agent (e.g., nicotine) in any device as provided herein. A drive motor for a pump (e.g., positive displacement pump) can be located external to a reservoir in a device as provided herein. In some cases, an aerosol generating device as provided herein comprises a pump housed or located within a reservoir comprising a liquid formulation comprising a pharmaceutically active agent (e.g., nicotine) and a drive motor located outside of the reservoir such that the drive motor is in mechanical communication with the pump. The drive motor can be a magnetic drive motor as shown in FIG. 44. The pump can be any pump as provided herein. In some cases, the pump is a piston pump as provided in FIG. 42A-C or FIG. 44. The pump can be a diaphragm pump as depicted in FIG. 90D.

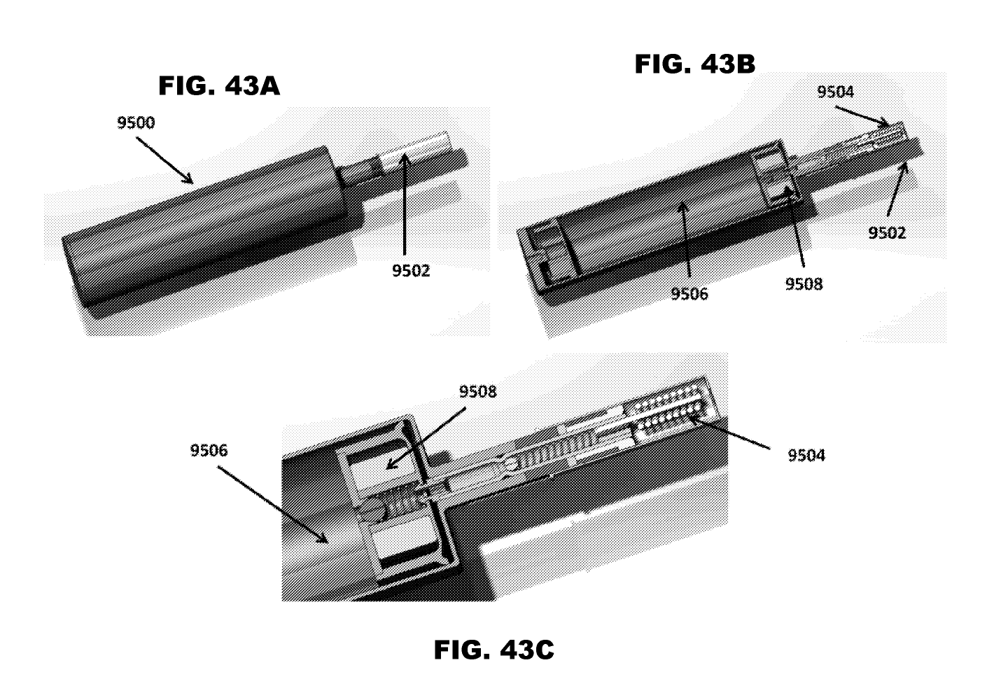

FIG. 42A illustrates an example of an aerosol generating device (9400) that is cylindrical in shape. As shown in FIG. 42B, the device of FIG. 42A comprises a battery (9402), a nicotine reservoir (9404) comprising a liquid nicotine formulation as provided herein, a piston pump (9406) located within the nicotine reservoir (9404), a heater element (9408) and a mouthpiece (9410). A pump (e.g., piston or diaphragm) for use in an aerosol generating device as provided herein can be used to dispense a liquid formulation comprising a pharmaceutically active agent (e.g., nicotine) from a reservoir comprising the liquid formulation comprising a pharmaceutically active agent (e.g., nicotine) to a heater element. FIG. 42C illustrates a close up view of the mouthpiece end of the device in FIGS. 42A and 42B and shows that the piston pump (9406) is flanked by check valves (9418) and is coupled to a pump drive (9412) located adjacent to but outside of the nicotine reservoir (9404). The pump (e.g., piston or diaphragm pump) can be mechanically or magnetically coupled to a pump drive. As can be seen, one of the check valves (9418) is located within the piston within the nicotine reservoir (9404) and can serve as an inlet of for entry of a volume of liquid from the reservoir (9404) to the pump (9406) for subsequent delivery to or onto the heater element (9408). Furthermore, the heater element (9408) comprises a coil and resides within an airway (9414) comprising an air inlet (9402) and an outlet (i.e., mouthpiece; 9410). The nicotine reservoir (9404) can be any reservoir as provided herein. In some cases, the nicotine reservoir can hold the equivalent of 500 puffs (inhalations) (at the 4 mg/puff). The nicotine reservoir can be part of a reservoir or cartridge as depicted in FIG. 43A-C. The heater element (9408) can be any heater element as described herein. In some cases, the heater element is a coil comprising electrically resistive material. An example of a suitable heater element comprising a coil that can be used is represented by the heater element depicted in FIG. 38. The piston pump (9406) can comprise a pump drive (9412) located outside of the nicotine reservoir (9404) such that it is coupled to and can control movement of the piston pump (9406). The piston pump can be mechanically coupled to the pump drive. The piston pump can be magnetically coupled to the pump drive such as shown in FIG. 44. The pump drive (9412) can be adjacent to the nicotine reservoir (9404). In operation, the pump drive (9412) can control the pump piston (9406) to deliver a volume of a liquid formulation comprising nicotine from the nicotine reservoir (9404) onto the heater element (9408). The heater element (9408) can vaporize the volume of liquid formulation delivered to it such that air flowing through the air inlet (9402) can serve to condense the vaporized liquid formulation into a condensation aerosol comprising a desired diameter within the airway (9414) prior to the condensation aerosol flowing through the mouthpiece (9410). The desired diameter can be any diameter provided herein. The desired diameter can be from about 1 μm to about 5 μm. The pump drive (9412) can comprise a magnetic drive motor. The magnetic drive motor can be a magnetic drive motor seated in an aerosol generating device as shown in FIG. 44. Alternatively, the aerosol generating device can be a disk-shaped device. The pump can be designed to oscillate back and forth at a slow frequency (e.g., between 1 and 10 hz). The volume pumped per stroke can be determined by the preset stroke and diameter.

FIG. 44 depicts an embodiment of a reservoir comprising a pharmaceutically active agent (e.g., nicotine (9606)) for use in an aerosol generating device as provided herein. The reservoir in FIG. 44 can be a single unit or component (see FIG. 43) that can be used in a multi-component aerosol generating device as described herein. As shown in FIG. 44, the pump drive (9610) can be located adjacent to the nicotine reservoir (9606). The pump piston (9602) comprises magnets (9604) and check valves (9608) such that the magnets (9604) can be located between the check valves (9608) and can be used to control movement of the pump piston (9602) located partially within the nicotine reservoir (9606). The pump drive can comprise a wire coil.

A piston pump comprising magnets as illustrated in FIG. 44 can comprise 1, 2, 3, 4, 5, 6, 7, 8, 9 or 10 magnets. In some cases, a piston pump comprises 3 magnets. Each of the magnets in a piston pump comprising magnets can have an inner diameter (ID), an outer diameter (OD), and a length.

The pump rate of a piston pump (e.g., FIG. 42 or FIG. 44) for use in an aerosol generating device as provided herein can be controlled by varying the voltage applied to the pump motor, the number of coils in a pump drive comprising wire coils, the gauge of the wire coil in a pump drive comprising wire coils, the size of the magnets (see FIG. 44), the travel distance of the piston, the diameter of the piston, and the frequency of the drive current applied to the pump. The pump rate of a pump in an aerosol generating device as provided herein can be controlled. As provided herein, controlling the pump rate can be used to control aerosol (e.g. condensation aerosol) size (e.g., diameter). The pump rate can less than, more than, at least, at most or about 0.1, 0.5, 1, 1.5, 2, 2.5, 3, 3.5, 4, 4.5, 5, 5.5, 6, 6.5, 7, 7.5, 8, 8.5, 9, 9.5, or 10 mg/second (mg/sec). The pump rate can be from about 0.1 to about 1, about 1 to about 2, about 2 to about 3, about 3 to about 4, about 4 to about 5, about 5 to about 6, about 6 to about 7, about 8 to about 9, about 9 to about 10, or about 0.1 to about 10 mg/sec. In some cases, the pump rate is 2 mg/sec.

The gauge of the wire coil of a pump drive comprising a wire coil (e.g., 9610 in FIG. 44) can be from about 32 to about 38. In some cases, the gauge of the wire coil of a pump drive comprising a wire coil (e.g., 9610 in FIG. 44) is 36.

The pump in an aerosol generating device as provided herein that comprises a pump housed or located within a reservoir comprising a liquid formulation comprising a pharmaceutically active agent (e.g., nicotine) can be a diaphragm pump. The aerosol generating device can be a disk-shaped device. The aerosol generating device can be a cylindrical device (e.g., the devices in FIG. 42A-C). The cylindrical device can resemble a cigarette.

Methods for aliquoting an agent (e.g., nicotine) to ensure dose-to-dose uniformity are provided herein. For example, an element comprising porous materials can wick out fluid comprising agent (e.g., nicotine) at a particular rate in order to measure out a dose to provide dose-to-dose uniformity. A tube, e.g., a capillary tube can be used to measure out a dose. In one embodiment, heat is used as a means of ejecting a dose. A material or geometry of a device can be used to measure out a dose. In one embodiment, providing dose consistency controls for variability in environment and device. In another embodiment, inhalation flow control ensures that variability in inhalations by a user are controlled and corrected for, which can result in dose-to-dose consistency and predictable and desirable aerosol particle sizes.

In some cases, an agent (e.g., nicotine) is metered out into a pre-vaporization area in a device (dosing mechanism) through capillary action. The metering can occur between inhalations of a user of a device. Upon inhalation by a subject, an agent (e.g., nicotine) can be drawn into a vaporization chamber or onto a heater element. The agent can be a pharmaceutically active agent. The agent can be in a formulation that is liquid. The liquid formulation comprising a pharmaceutically active agent (e.g., nicotine) can be drawn or metered out into a vaporization chamber or onto a heater element upon inhalation by a subject. The subject can be a human. The human subject can be a smoker or user of tobacco or nicotine containing substances. The agent (e.g., nicotine) in the vaporization chamber or heater element can be vaporized and subsequently condense to form an aerosol. The aerosol can comprise agent (e.g., nicotine) particles of an optimum size to achieve certain biological effects (e.g., deep lung delivery producing rapid pharmacokinetics). Devices described herein can comprise a mechanism for separating out and reducing large aerosol particles to a size that can navigate to the deep lung of a subject. In the deep lung, the particles can settle and be rapidly absorbed. Also provided herein are methods for controlling aerosol particle size, pH, and other inhalation characteristics, which can ensure deep lung delivery and rapid pharmacokinetics. For example, the aerosol size control can result in rapid, cigarette-like nicotine absorption, which can help to satisfy nicotine cravings. In some cases, aerosol particles comprising nicotine produced by a heater element or device as provided herein can achieve peak plasma concentrations similar to peak plasma concentrations achieved by smoking a cigarette. In some cases, aerosol particles comprising nicotine produced by a heater element or device as provided herein can achieve peak plasma concentrations in a time frame similar to the time frame required to achieve peak plasma concentrations achieved by smoking a cigarette. The condensation aerosol comprising nicotine produced by any of the devices provided herein can result in rapid, cigarette-like nicotine absorption resulting in nicotine blood, serum or plasma concentrations similar or substantially similar to the nicotine blood, serum or plasma concentration achieved from smoking a cigarette. In some cases, the plasma concentration can be an arterial plasma concentration. In some cases, the plasma concentration can be a venous plasma concentration. Smoking a single cigarette can produce peak increments of plasma nicotine concentration of 5-30 ng/ml. In some cases, the blood concentration can be an arterial blood concentration. In some cases, the blood concentration can be a venous blood concentration.

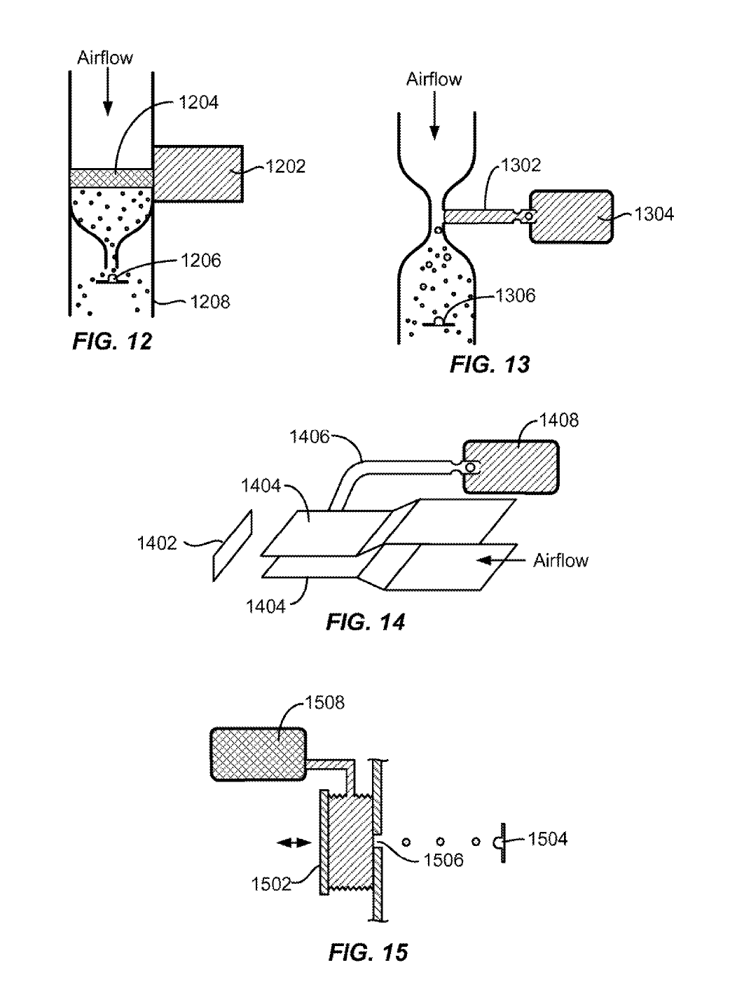

FIG. 12 illustrates an embodiment of a method of removal of an agent (e.g., nicotine) mixture from a reservoir and dispensing the agent (e.g., nicotine) into desired doses. FIG. 12 shows an agent (e.g., nicotine) reservoir (1202) next to a frit (1204) or porous material, such as a metal (stainless steel) or a ceramic, and allowing the agent (e.g., nicotine) to wick into it. Then, upon inhalation, the air can draw the agent (e.g., nicotine) into the airway (1208) and onto the heater element (1206). In some cases, the mixture is a liquid formulation comprising an agent (e.g., nicotine).

FIG. 13 illustrates another embodiment of a method for measuring a dose. Another method of dosing out the mixture is to draw the material out using a venturi. The device can comprise a tube, e.g., a capillary tube (1302), an agent (e.g., nicotine) reservoir (1304), and a heater element (1306). In some cases, the mixture is a liquid formulation comprising an agent (e.g., nicotine).

FIG. 14 illustrates another embodiment of a method for measuring a dose. In this embodiment, an agent (e.g., nicotine) mixture can be wicked into a space between two parallel plates. The device can comprise a heater element (1402), plates (1404), tube, e.g., capillary tube (1406), and an agent (e.g., nicotine) reservoir (1408). In some cases, the mixture is a liquid formulation comprising an agent (e.g., nicotine).

FIG. 15 illustrates another embodiment for measuring a dose. An agent (e.g., nicotine) mixture can be ejected using a piezoelectric device (1502) and an attached chamber with an opening or orifice (1506). When the piezo is activated, either as a single pulse or as a series of pulses (vibrated) the mixture can be driven from the opening. By controlling the amplitude of the pulse or the number of pulses, the amount of material dosed can be controlled. The device can comprise an agent (e.g., nicotine) reservoir (1508) and a heater element (1504). In one embodiment, a piezo electric device is mounted on an end or a side of the reservoir and receipt of an electrical pulse causes the piezo to deflect and push a small amount of the agent (e.g., nicotine) formulation out of a tube, e.g., capillary tube mounted on another end of the reservoir onto a heater element. In some cases, the agent formulation is liquid.

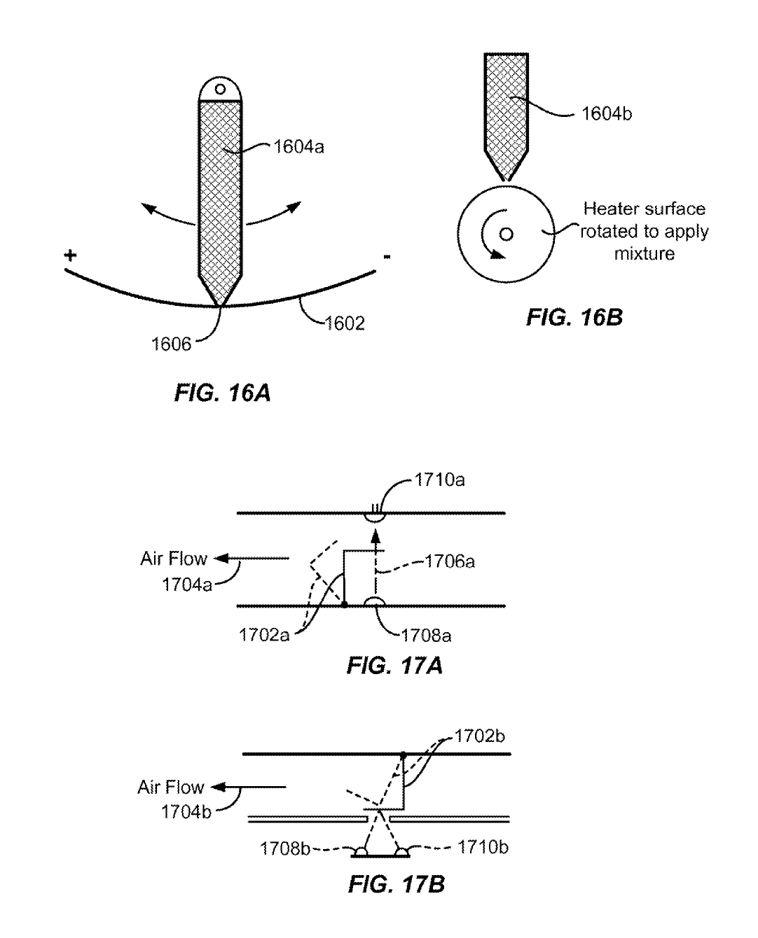

All of the forgoing mechanisms to power the dispensing of a mixture (heat, piezo) can be powered by a user performing a maneuver such as pushing a button or lever. Mechanical energy from the user can also allow for alternative methods of applying agent (e.g., nicotine) to a heater surface. An agent (e.g., nicotine) can be applied to the heater element (1602), where the reservoir is moved over the heater surface in a sweeping (see FIG. 16A) or rolling motion (see FIG. 16B). The heater surface can be etched or pitted to accept the mixture.

To have the device generate an agent (e.g., nicotine) aerosol upon inhalation by a user, a movable member (e.g., vane (1702a or 1702b)) can be used that moves upon air flow (1704a or 1704b) caused by inhalation (see e.g., FIG. 17A or 17B). This member can break an optical path (1706a) (e.g., when no inhalation is occurring), move out of an optical path (1706a) when inhalation occurs (see e.g., FIG. 17A), or can complete an optical path when inhalation occurs (by, e.g., reflection; see e.g., FIG. 17B). An LED (1708a or 1708b) can be used to generate the light. To ensure that a sensor or detector (1710a or 1710b) does not get confused by stray light, the LED (1708a or 1708b) can be strobed in a particular pattern and only when that pattern is detected is an inhalation present. In some cases, optical light pipes can be used to route the light to the valve and to route the light back to the detector.

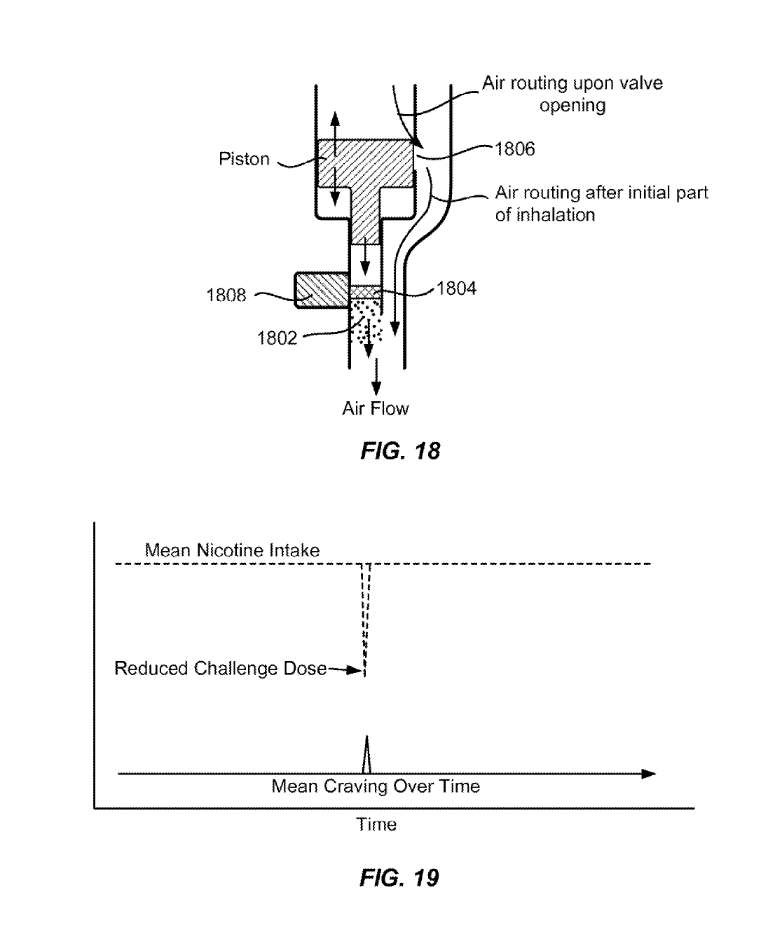

To dispense the agent (e.g., nicotine) mixture (1802) out of some of the frits (1804) or capillaries using the pressure from the inhalation a valve can be designed to create increased pressure in the initial part of the inhalation and decrease the resistance for the duration of the inhalation (see e.g., FIG. 18).

In one embodiment, an electronic agent (e.g., nicotine) delivery device is provided that provides a dose of from 25 to 200 μg of freebase agent (e.g., nicotine). The agent (e.g., nicotine) can be in a mixture of propylene glycol at a ratio of agent (e.g., nicotine) to propylene glycol of from about 1:1 to about 1:20, or about 1:5 to about 1:10. In some cases, a mixture comprises propylene glycol and about 1.25% to about 20% nicotine. In some cases, the mixture is liquid formulation comprising an agent (e.g., nicotine). In some cases, the mixture is liquid formulation comprising an agent (e.g., nicotine) during use of the device. An aerosol can have an MMAD of about 1 to about 5 microns with a geometric standard deviation (GSD) of less than 2.0. An aerosol can have an VMD of about 1 to about 5 microns with a geometric standard deviation (GSD) of less than 2.0. Dose to dose consistency over the lifetime of the product can be no greater than ±30%. The device can have a dose to dose consistency over the lifetime of the product that can be about, more than, less than, at least, or at most ±1%, 2%, 3%, 4%, 5%, 6%, 7%, 8%, 9%, 10%, 11%, 12%, 13%, 14%, 15%, 16%, 17%, 18%, 19%, 20%, 30%, 31%, 32%, 33%, 34%, 35%, 36%, 37%, 38%, 39%, 40%, 41%, 42%, 43%, 44%, 45%, 46%, 47%, 48%, 49%, or 50%. The device can be activated by an inhalation. The device can have an interior air resistance (to inhalation) no greater than that of a cigarette. The device can have an interior air resistance (to inhalation) no greater than 0.08 (cm H₂O)^{1/2}/LPM. The flow resistance of a device as provided herein can be about the same flow resistance as through that of a combustible cigarette. The device can have an interior air resistance (to inhalation) about, more than, less than, at least, or at most 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 (cm H₂O)^{1/2}/LPM. The flow resistance through a device as provided herein can be around 2.5 (cm of H₂O)^{1/2}/LPM. In some cases, a device as provided herein comprises a flow rate of 1 LPM at a vacuum of 7.6 cm of H₂O. In some cases, a device as provided herein comprises a flow rate of 1.5 LPM at a vacuum of 16 cm of H₂O. In some cases, a device as provided herein comprises a flow rate of 2 LPM at a vacuum of 26 cm of H₂O.

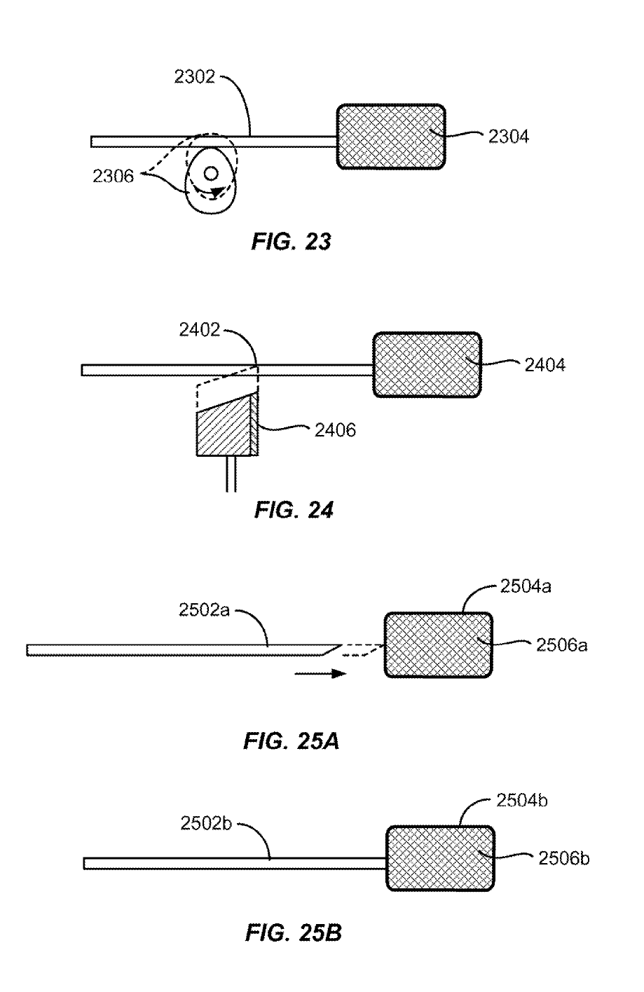

FIG. 23 illustrates another embodiment of a method for measuring a dose. Another method of dosing out the mixture is to draw the material out using a peristaltic pump comprising a rotatable cam. The device can comprise a tube, e.g., capillary tube (2302), agent (e.g., nicotine) reservoir (2304), and a rotatable cam (2306) to pull or draw an agent (e.g., nicotine) mixture from the nicotine reservoir. In one embodiment, an agent (e.g., nicotine) delivery device comprises a disposable component that comprises the tube, e.g., capillary tube, and agent (e.g., nicotine) reservoir and a reusable component comprising the rotatable cam, wherein the tube, e.g., capillary tube and agent (e.g., nicotine) reservoir are mechanically connected to the rotatable cam by mating the disposable component to the reusable component. In some cases, the mixture is a liquid formulation comprising an agent (e.g., nicotine). In some cases, a device as provided herein is disposable.

FIG. 24 illustrates another embodiment of a method for measuring a dose. The device can comprise a tube, e.g., capillary tube (2402), agent (e.g., nicotine) reservoir (2404), and a cam made of variable durometer material (2406). The cam can comprise an area of high durometer material surrounded by low durometer material, wherein the tube, e.g., capillary tube can be sealed within the high durometer material. In one embodiment, an agent (e.g., nicotine) mixture can be pushed out of the tube, e.g., capillary tube by compression, wherein pressure is exerted on the low durometer material of the cam to cause compression of the tube, e.g., capillary tube, within the high durometer material. In one embodiment, an agent (e.g., nicotine) delivery device comprises a disposable component that comprises the tube, e.g., capillary tube and the agent (e.g., nicotine) reservoir and a reusable component comprising the cam made of variable durometer material, wherein the tube, e.g., capillary tube and agent (e.g., nicotine) reservoir are mechanically connected to the cam made of variable durometer material by mating the disposable component to the reusable component. In some cases, the mixture is a liquid formulation comprising an agent (e.g., nicotine).

FIGS. 25A and 25B illustrate an embodiment of a method of removal of an agent (e.g., nicotine) mixture from a reservoir. FIG. 25A shows a tube, e.g., capillary tube (2502a) adjacent to, but separate from, an agent (e.g., nicotine) reservoir (2504a) comprising an agent (e.g., nicotine) mixture (2506a). FIG. 25B shows that the tube, e.g., capillary tube (2502b) can pierce the agent (e.g., nicotine) reservoir (2504b) such that the agent (e.g., nicotine) mixture (2506b) within the agent (e.g., nicotine) reservoir can move into the tube, e.g., capillary tube and subsequently onto a heater element as provided herein. In one embodiment, the agent (e.g., nicotine) reservoir comprises a septum or seal, wherein the tube, e.g., capillary tube pierces the septum or seal. In one embodiment, the agent (e.g., nicotine) reservoir is a collapsible bag or container. In one embodiment, the collapsible bag or container is made of plastic, foil, or any other collapsible material known in the art. In a further embodiment, the tube, e.g., capillary tube can directly pierce an agent (e.g., nicotine) reservoir that is made of a collapsible material. In one embodiment, the tube, e.g., capillary tube is not inserted into the agent (e.g., nicotine) reservoir prior to a first use of the device, wherein upon first use, the tube, e.g., capillary tube, is inserted into the agent (e.g., nicotine) reservoir such that an agent (e.g., nicotine) mixture can move from the agent (e.g., nicotine) reservoir into the tube, e.g., capillary tube and subsequently onto a heater element as provided herein. In some cases, the mixture is a liquid formulation comprising an agent (e.g., nicotine).

Carriers/Excipients

In some cases, an agent (e.g., nicotine) is mixed with one or more other substances. When mixed with an agent (e.g., nicotine) as provided herein, the mixture can be liquid at room temperature. When mixed with an agent (e.g., nicotine) as provided herein, the mixture can be liquid during use of the device such that the liquid mixture is delivered to the heater element during use of the device. The one or more other substances can be pharmaceutically acceptable excipients or carriers. The suitable pharmaceutically acceptable excipients or carriers can be volatile or nonvolatile. The volatile excipients, when heated, can be volatilized, aerosolized and inhaled with the agent (e.g. nicotine). Classes of such excipients are known in the art and include, without limitation, gaseous, supercritical fluid, liquid and solid solvents. The excipient/carriers or substances can be water; terpenes, such as menthol; alcohols, such as ethanol, propylene glycol, glycerol and other similar alcohols; dimethylformamide; dimethylacetamide; wax; supercritical carbon dioxide; dry ice; lipids, triglycerides, acids, surfactants and mixtures or combinations thereof. The candidate acids can be those acids that can be in the lung with minimal, low, no, or substantially no detrimental toxicological effects. The candidate surfactants can be those surfactants that can be in the lung with minimal, low, no, or substantially no detrimental toxicological effects. The acids can be citric acid, tartaric acid, and/or lactic acid. The surfactants can be Ceteareth-25, Cocamide MEA, Cocamidapropyl betaine, Coceth-4, Coceth-7 Coconut Alcohol ethoxylate, Hydroxyethelcellulose, Lauryl polyglucose, Pareth-7, Polyglucose, Polyglucoside, PPG-10-Laureth; PPG-8-Laureth-8, PPG-6C12-15-Pareth-12, and/or Sodium lauraminopropionate.

Particle Size

A device provided herein can generate an aerosol. The aerosol can comprise particles of an optimum size for delivery to the deep lung. The aerosol can be a condensation aerosol. The aerosol can comprise a pharmaceutically active agent as provided herein (e.g., nicotine). The particle size can be about, more than, less than, or at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, or 20 microns. The particle size can be from about 1 to about 10 microns, about 1 to about 9 microns, about 1 to about 7 microns, about 1 to 6 microns, about 1 to about 5 microns, about 1 to about 4 microns, about 1 to about 3 microns, or about 1 to about 2 microns. The particle size can be from about 0.5 to about 10 microns, about 0.5 to about 9.5 microns, about 0.5 to about 9 microns, about 0.5 to about 8.5 microns, about 0.5 to about 8 microns, about 0.5 to about 7.5 microns, about 0.5 to about 7 microns, about 0.5 to about 6.5 microns, about 0.5 to about 6 microns, about 0.5 to about 5.5 microns, about 0.5 to about 5 microns, about 0.5 to about 4.5 microns, about 0.5 to about 4.0 microns, about 0.5 to about 3.5 microns, about 0.5 to about 3 microns, about 0.5 to about 2.5 microns, about 0.5 to about 2 microns, about 0.5 to about 1.5 microns, or about 0.5 to about 1 microns. The particle size can be less than 1 micron. The particle size can be greater than 5 microns. The particle size can be less than 5 microns. The particle size can be greater than 1 micron. In one embodiment, the particle size is from about 1 to about 5 microns. In one embodiment, the particle size is from about 1 to about 3 microns. The particle size can be a mean or average. In some cases, a condensation aerosol produced by any device as provided herein comprises a mean or average particle size. The mean can be an arithmetic or geometric mean. The particle size can be a diameter, radius, or circumference. The particle size can represent a single particle or a population of particles. The population of particles can be an aerosol or condensation aerosol produced by a device as provided herein. In some cases, the population of particles is a condensation aerosol. In some cases, the particle size is a diameter. The diameter can be a physical diameter (e.g., Feret's diameter, Martin's diameter, or equivalent projected area diameter), a fiber diameter, a Stokes' diameter, a thermodynamic diameter, a volumetric diameter, or an aerodynamic diameter. In one embodiment, the particle size is a volume median diameter (VMD). In one embodiment, the particle size is a mass median aerodynamic diameter (MMAD). In one embodiment, the particle size is a physical diameter (e.g., Feret's diameter, Martin's diameter, or equivalent projected area diameter). The particle size can be created at any of the flow rates for any of the devices provided herein. In some cases, a device as provided herein comprises a flow rate of 1 LPM at a vacuum of 7.6 cm of H₂O. In some cases, a device as provided herein comprises a flow rate of 1.5 LPM at a vacuum of 16 cm of H₂O. In some cases, a device as provided herein comprises a flow rate of 2 LPM at a vacuum of 26 cm of H₂O. In some cases, a device for generating a condensation aerosol as provided herein generates a condensation aerosol comprising a pharmaceutically active agent (e.g., nicotine) comprising a particle size of 2.5 microns at a flow rate of 20 liters/minute (LPM). In some cases, a device for generating a condensation aerosol as provided herein generates a condensation aerosol comprising a pharmaceutically active agent (e.g., nicotine) comprising a particle size of 1.4 microns at a flow rate of 50 liters/minute (LPM).

In some cases, an aerosol generating device as provided herein is configured to produce a plurality of aerosols such that each of the plurality of aerosols comprises a size that is different than the size of a separate aerosol produced by the aerosol generating device. Each of the plurality of aerosols can comprise a population of aerosols possessing a range of sizes that is different or substantially different than a separate aerosol of the plurality of aerosols. The plurality of aerosols can be 1, 2, 3, 4, or 5 aerosols. In some cases, an aerosol generating device as provided herein produces a first aerosol and a second aerosol such that the size of the first aerosol is different or substantially different than the size of the second aerosol. The size of the aerosol can be a diameter. The diameter can be an MMAD or VMD. The device can be configured to produce the plurality of aerosols during a single use by a subject using the device. In some cases, an aerosol generating device as provided herein produces a first aerosol and a second aerosol during a single use of the device by a subject. In some cases, an aerosol generating device as provided herein produces a first aerosol and a second aerosol during a single use of the device by a subject such that the diameter of the first aerosol is different or substantially different than the diameter of the second aerosol. In some cases, an aerosol generating device as provided herein produces a first aerosol and a second aerosol during separate uses of the device by a subject. In some cases, an aerosol generating device as provided herein produces a first aerosol and a second aerosol during separate uses of the device by a subject such that the diameter of the first aerosol is different or substantially different than the diameter of the second aerosol. The first aerosol can comprise a size (e.g., diameter) suitable for delivery and absorption into the deep lungs of a user of the device. In some cases, the diameter (e.g., MMAD or VMD) of the first aerosol is from about 1 μm to about 5 μm. The second aerosol can comprise a size (e.g., diameter) suitable for exhalation from a user of the device such that the exhaled aerosol is visible. In some cases, the diameter (e.g., MMAD or VMD) of the second aerosol is less than about 1 μm.

Provided herein are devices and methods for generating multiple aerosols as provided herein from a single aerosol generating device comprising an airflow channel or passageway as provided herein by altering the volume of air through an aerosol generation region of the airflow channel or passageway. In some cases, each of the multiple aerosols produced by the single device is a different size (e.g., diameter). The aerosol generation region of the device can comprise a heater element as provided herein. The heater element can comprise a wire coil as provided herein. The heater element can comprise a wire coil and wicking element as provided herein (e.g., FIG. 38). The volume or amount of air in the aerosol generation region of the airflow channel or passageway can serve to condense the vaporized liquid formulation into a condensation aerosol as described herein which can subsequently exit an outlet in the airflow channel and be inhaled by a subject using the device. The amount or volume of air in the aerosol generation region of the airflow channel or passageway can be altered or adjusted by changing the number and/or size of inlets to the airflow channel.

In some cases, the volume or amount of air flowing through the aerosol generation region of the device can be altered by changing the number of air inlets serving the aerosol generation region by moving adjustable rings or sliders located on the outside of the airflow channel such as described in EP0845220B1 or WO2013083635A1, the disclosure of each of which is incorporated herein by reference in its entirety. The alteration in the number of inlets supplying air to the aerosol generation chamber can be achieved manually or automatically under the control of the electrical circuitry within the device. The electric circuitry can be controlled by a controller. The controller can be a component of the device and can be programmable as provided herein. Manual control of the number of air inlets can be achieved by a user of the device moving the adjustable slider or shutter to block or open an air inlet or inlets. Alteration in the number of air inlets providing air to the airflow channel can effectively alter the air flow rate through the aerosol generation region. In some cases, the number of air inlets generates a flow rate of air through an aerosol generation region of an aerosol generating device as provided herein such that the flow rate generates a condensation aerosol of a desired size. The desired size can be a diameter. The diameter can be effective for deep lung delivery of the condensation aerosol and absorption into the blood stream of a user. The diameter effective for deep lung delivery can be from about 1 μm to about 5 μm. The diameter can be an MMAD or a VMD. The flow rate effective for generating condensation aerosol particles comprising a size (e.g., diameter) effective for deep lung delivery can be from about 1 LPM to about 10 LPM. In some cases, a device as provided herein comprises a flow rate of 1 LPM at a vacuum of 7.6 cm of H₂O. In some cases, a device as provided herein comprises a flow rate of 1.5 LPM at a vacuum of 16 cm of H₂O. In some cases, a device as provided herein comprises a flow rate of 2 LPM at a vacuum of 26 cm of H₂O. The number of air inlets can be altered during a single use or between uses of an aerosol generating device in order to alter the size (e.g., diameter) of a condensation aerosol generated by the device. The cross-section of the airway in a device configured to generate a condensation aerosol of a size (e.g., diameter) suitable for deep lung delivery as well as the vaporization rate of a liquid formulation delivered to or onto the heater element can remain constant in the device such that an increase in the air flow rate can result in a condensation aerosol comprising a smaller size (e.g., diameter) suitable for exhalation of a visible vapor. Thus, the size (e.g., diameter) of the condensation aerosol can be altered from a size effective for deep lung delivery as provided herein to a size (e.g., diameter) effective for exhalation of a visible vapor. The diameter effective for exhalation of a visible vapor can be less than about 1 μm. The flow rate effective for generating condensation aerosol particles comprising a size (e.g., diameter) effective for exhalation of a visible vapor can be greater than 10 LPM. The flow rate can be from about 20 LPM to about 40 LPM. The alteration in the size of the condensation aerosol by altering the number of the air inlets can be performed automatically during use of the device as described herein. The alteration in the size of the condensation aerosol by altering the number of the air inlets can be performed manually during use of the device as described herein.

In some cases, the volume or amount of air flowing through the aerosol generation region of the device can be altered by changing the size of the air inlets serving the aerosol generation region such as described in WO2013083635A1, the disclosure of which is incorporated herein by reference in its entirety. In this embodiment, a second air inlet located between the heater in the aerosol generation region and an outlet of the aerosol generation region can be larger than an air inlet located before the aerosol generation region. The larger second inlet can serve to provide a greater flow of air through the second air inlet for a given inhalation by a user of the device such that a greater flow of air can be drawn through the second air inlet than the first air inlet. The second air inlets can be larger than the first air inlets. The second air inlets can be larger and more numerous than the first air inlets. In some cases, the size of air inlets generates a flow rate of air through an aerosol generation region of an aerosol generating device as provided herein such that the flow rate generates a condensation aerosol of a desired size. The desired size can be a diameter. The diameter can be effective for deep lung delivery of the condensation aerosol and absorption into the blood stream of a user. The diameter effective for deep lung delivery can be from about 1 μm to about 5 μm. The diameter can be an MMAD or a VMD. The flow rate effective for generating condensation aerosol particles comprising a size (e.g., diameter) effective for deep lung delivery can be from about 1 LPM to about 10 LPM. The size of air inlets can be altered during a single use or between uses of an aerosol generating device in order to alter the size (e.g., diameter) of a condensation aerosol generated by the device. The cross-section of the airway in a device configured to generate a condensation aerosol of a size (e.g., diameter) suitable for deep lung delivery as well as the vaporization rate of a liquid formulation delivered to or onto the heater element can remain constant in the device such that an increase in the air flow rate can result in a condensation aerosol comprising a smaller size (e.g., diameter) suitable for exhalation of a visible vapor. Thus, the size (e.g., diameter) of the condensation aerosol can be altered from a size effective for deep lung delivery as provided herein to a size (e.g., diameter) effective for exhalation of a visible vapor. The diameter effective for exhalation of a visible vapor can be less than about 1 μm. The flow rate effective for generating condensation aerosol particles comprising a size (e.g., diameter) effective for exhalation of a visible vapor can be from greater than 10 LPM. The flow rate can be from about 20 LPM to about 40 LPM. The alteration in the size of the condensation aerosol by altering the size of the air inlets can be performed automatically during use of the device as described herein. The alteration in the size of the condensation aerosol by altering the size of the air inlets can be performed manually during use of the device as described herein. Alteration in the size of the air inlets can be achieved through the use of adjustable shutters located adjacent to or over air inlets to the air flow channel. The adjustable shutters can be moved to partially occlude or block one or more air inlets thereby effectively changing the respective air inlet's size.

Provided herein are devices and methods for generating multiple aerosols as provided herein from a single aerosol generating device by altering an amount or volume of a liquid formulation comprising a pharmaceutically active agent (e.g., nicotine) that is delivered to or onto a heater element and vaporized by the heater element. In some cases, each of the multiple aerosols produced by the single device is a different size (e.g., diameter). The heater element can be any heater element as provided herein. The heater element can comprise a wire coil as provided herein. The heater element can comprise a wire coil and wicking element as provided herein (e.g., FIG. 38). In some cases, the aerosol generating device comprises an airflow channel or passageway such that air flowing through the channel serves to condense the vaporized liquid formulation into a condensation aerosol which subsequently exits an outlet in the airflow channel and is inhaled by a subject using the device. The amount of the liquid formulation delivered to or onto the heater element can be controlled by a pump located within the device. The pump can be any pump provided herein. The pump can be a positive displacement pump. In some cases, the device comprises a reservoir housing the liquid formulation and the pump is located within the reservoir as provided herein. In some cases, the amount of the liquid formulation delivered by the pump is controlled by setting a pump rate such that a specific pump rate corresponds to a specific volume that can be delivered by the pump. Adjusting the pump rate from a first pump rate to a second pump rate can result in the pump delivering a different amount or volume of liquid formulation. In some cases, a pump in an aerosol generating device as provided herein is set at a first controlled rate such that a first amount of a liquid formulation comprising a pharmaceutically active agent (e.g., nicotine) is delivered to or onto a heater element within the device which generates a first aerosol comprising a first size (e.g., diameter) and the pump is altered to operate at a second controlled rate such that a second amount of the liquid formulation is delivered to or onto the heater element which generates a second aerosol comprising a second size (e.g., diameter). The first and second aerosols can have different sizes (e.g., diameters). The first aerosol can comprise a size (e.g., diameter) suitable for delivery and absorption into the deep lungs of a user of the device. In some cases, the diameter (e.g., MMAD or VMD) of the first aerosol is from about 1 μm to about 5 μm. The second aerosol can comprise a size (e.g., diameter) suitable for exhalation from a user of the device such that the exhaled aerosol is visible. In some cases, the diameter (e.g., MMAD or VMD) of the second aerosol is less than about 1 μm. Alteration of the rates of the pump in an aerosol generating device as provided herein can occur during a single use of the device by a user. Alteration of the pump rate during a single use can occur automatically or manually. Alteration of the rates of the pump in an aerosol generating device as provided herein can occur during separate uses of the device by a user.

Automatic alteration of the pump rate can be accomplished by electrically coupling the pump to a circuit configured to switch the pump rate during operation of the device. The circuit can be controlled by a control program. The control program can be stored in a controller as provided herein. The controller can be programmable and/or can be a component of the aerosol generating device. A user of the device can select a desired aerosol size or sets of aerosol sizes by selecting a specific program on the controller of the device prior to use of the device. In some cases, a specific program is associated with a specific pump rate for delivering a specific volume of a liquid formulation in order to produce an aerosol comprising a desired size. If the user desires an aerosol with a different size (e.g., diameter) for a subsequent use, then the user can select a different program associated with a different pump rate for delivering a different volume of the liquid formulation in order to produce an aerosol with the newly desired size (e.g., diameter). In some cases, a specific program is associated with specific pump rates for delivering specific volumes of a liquid formulation in order to produce multiple aerosols comprising desired sizes. Each of the specific pump rates in a specific program comprising a set of specific pump rates can deliver in succession a specific amount or volume of the liquid formulation in order to produce a succession of aerosols of differing sizes (e.g., diameters) during a single use of the device. The aerosol or aerosols can be condensation aerosols. The condensation aerosols can be produced within an airway within the device as provided herein.

Manual alteration of the pump rate can be accomplished by the user of the device pressing a button or switch on the device during use of the device. Manual alteration can occur during a single use of the device or between separate uses of the device. The button or switch can be electrically coupled to the pump and/or a controller. The controller can be a component of the device and can be programmable. The controller can comprise program(s) designed to control the operation of the pump such that the pressing of a button or switch can cause the controller to alter the operation (e.g., pump rate) of the pump in order to affect delivery of a differing volume of the liquid formulation. The user of the device can press the button or flip the switch while using the device. The user of the device can press the button or flip the switch between uses of the device.

In some cases, an aerosol generating device as provided herein is configured to produce a condensation aerosol comprising a diameter of from about 1 μm to about 1.2 μm. Upon inhaling from an outlet of the device, a user can perform a breathing maneuver in order to facilitate delivery of the condensation aerosol comprising a diameter of from about 1 μm to about 1.2 μm into the user's deep lungs for subsequent absorption into the user's bloodstream. The breathing maneuver can comprise the user holding his/her's breath following inhalation of the condensation aerosol and subsequently exhaling. The breath-hold can be for 1, 2, 3, 4, 5, 6, 7, 8, 9, or 10 seconds. The breath-hold can be from about 2 to about 5 seconds. Alternatively, the user can inhale and directly exhale the condensation aerosol comprising a diameter of from about 1 μm to about 1.2 μm. Inhalation followed by direct exhalation can cause the generation of a visible vapor since a large percentage of the condensation aerosol can be exhaled. The diameter can be an MMAD or VMD as provided herein.

Agent (e.g., Nicotine) Reservoir

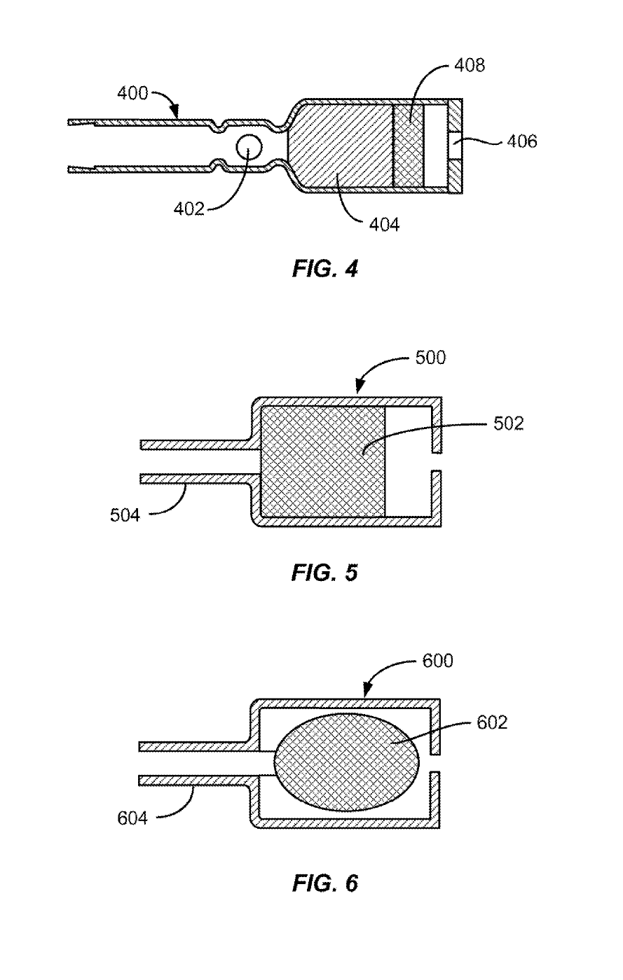

FIG. 4 illustrates an embodiment of an agent (e.g., nicotine) reservoir (404) that can be used in an electronic agent (e.g., nicotine) delivery device provided herein. A tube, e.g., capillary tube (400) with a valve (402) does not need to be inserted into a separate reservoir, but can be the reservoir (404) itself by extending away from the ejection end. The diameter of the tube, e.g., capillary tube, can be increased to store more mixture. To allow for the mixture to be pulled from the reservoir without creating a low pressure, which could resist the mixture leaving, the back end can have a vent (406). To stop an agent (e.g., nicotine) from vaporizing or evaporating from the back end a section of the reservoir could be filled with a soft material such as a wax or grease plug. This plug (408) can be drawn along the reservoir as the mixture is used. In one embodiment, the agent (e.g., nicotine) reservoir is cylindrical. In one embodiment, the agent (e.g., nicotine) reservoir holds a formulation comprising 200 mg of agent (e.g., nicotine) mixed with 1000 mg of propylene glycol. In one embodiment, the agent (e.g., nicotine) reservoir holds a formulation comprising 200 ug of agent (e.g., nicotine) mixed with 1000 ug of propylene glycol. In some cases, the agent (e.g., nicotine) formulation is a liquid formulation.

FIG. 5 illustrates another embodiment of a reservoir. An agent (e.g., nicotine) reservoir (500) can be a porous, open cell foam (502) within a cartridge; a tube, e.g., capillary tube (504) can extend from the reservoir.

FIG. 6 illustrates another embodiment of an agent (e.g., nicotine) reservoir. The mixture can be held in a collapsible bag (602) which can be held within a secondary container (600). A tube, e.g., capillary tube (604) can extend from the reservoir.

In one embodiment, doses of a liquid agent (e.g., liquid nicotine) are held in a safe dose cartridge container until needed. A container for an agent (e.g., nicotine) can comprise a sealing mechanism that can keep the agent (e.g., nicotine) in the container even if the container is crushed. In one embodiment, the sealing mechanism comprises septum sealing. Methods are provided herein for safely puncturing and reclosing access to a drug (e.g., nicotine) cartridge. In one embodiment, a septum and a puncturing needle is used to extract an agent (e.g., nicotine) from a cartridge. A semi-porous material can be used to ensure that the rate of agent (e.g., nicotine) transfer is safe. For example, materials can include a frit or other material (e.g., ceramic, foam, or metal) that has a convoluted or open structure.

In one embodiment, a device comprises a dose cartridge. In one embodiment, the dose cartridge is a disposable dose cartridge. In another embodiment, the dose cartridge houses an agent (e.g., nicotine) formulation and an aerosol creation mechanism as described herein. In another embodiment, the agent (e.g., nicotine) formulation is housed in a reservoir. In one embodiment, the dose cartridge comprises a reservoir comprising an agent (e.g., nicotine) formulation. In one embodiment, the dose cartridge comprises a reservoir comprising an agent (e.g., nicotine) formulation and dispensing tube, e.g., capillary tube, for dispensing the agent (e.g., nicotine) formulation. In one embodiment, the dose cartridge comprises a mouthpiece. In another embodiment, the mouthpiece comprises a cap. The cap can help prevent contamination. The cap can provide a tamper resistance feature. The cap can provide a child resistance feature. In one embodiment, the cap covers both the mouthpiece and any air inlets. In another embodiment, the cap is reusable. In one embodiment, the dose cartridge comprises a mouthpiece at one end and a mating mechanism whereby the dose cartridge can connect to a controller at another end. In one embodiment, the dose cartridge comprises a mechanism for breath detection. In one embodiment, the dose cartridge comprises a flow control valve. In one embodiment, the dose cartridge comprises a flow control valve that can regulate inhalation. The mechanism for breath detection or inhalation sensing can comprise breath sensory components. The breath sensory components can comprise an optical chase whereby light can be routed to and from a flow sensor.

In one embodiment, the dose cartridge comprises a heater element. In one embodiment, the heater element comprises a metal foil. The metal foil can be made of stainless steel or any other electrically resistive material. In one embodiment, the metal foil is made of stainless steel. In one embodiment, the heater element comprises a steel or metal foil that can be about 0.013 mm thick in order to ensure rapid vaporization. In one embodiment, the heater element comprises a coil of wire or wire coil. The coil of wire or wire coil can be from about 0.12 to about 0.5 mm in diameter. In another embodiment, the dose cartridge comprises more than one heater element. In one embodiment, the dose cartridge comprises two heater elements. In some cases, the heater element can be rapidly heated. In one embodiment, a heating element can comprise a heating rate of about 1600° C. (1873.15° K) per second for a duration of 250 msec, which can cause a 400° C. (673.15° K) rise in the temperature of the heater element. In some cases, a heater element is activated for a duration of about 10 msec to about 2000 msec, about 10 msec to about 1000 msec, about 10 msec to about 500 msec, about 10 msec to about 250 msec, about 10 msec to about 100 msec, about 50 msec to about 1000 msec, about 50 msec to about 500 msec, about 50 msec to about 250 msec, about 100 msec to about 1000 msec, about 100 msec to about 500 msec, about 100 msec to about 400 msec, or about 100 msec to about 300 msec. In some cases, a heater element is activated for about 10, 50, 100, 150, 200, 250, 300, 350, 400, 450, 500, 550, 600, 650, 700, 750, 800, 850, 900, 950, or 1000 msec. In some cases, a heater element is activated for at least 10, 50, 100, 150, 200, 250, 300, 350, 400, 450, 500, 550, 600, 650, 700, 750, 800, 850, 900, 950, or 1000 msec. In some cases, the maximum temperature of the heater element is about 100, 150, 200, 250, 300, 350, 400, 450, 500, 550, 600° C. (a range from about 373.15° K to about 873.15° K). In some cases, the maximum temperature of the heater element is at least 100, 150, 200, 250, 300, 350, 400, 450, 500, 550, 600° C. (a range from about 373.15° K to about 873.15° K).

In one embodiment, a device provided herein is made up of multiple components. In one embodiment, the device provided herein is comprised of two components wherein one component comprises a controller and the other component comprises a dose cartridge. In a further embodiment, the controller is reusable and the dose cartridge is replaceable. In yet another embodiment, the dose cartridge is mated to the controller. Mating of the dose cartridge to the controller can be accomplished by inserting the dose cartridge into an interlocking channel in the controller and engaging a locking mechanism. The locking mechanism can comprise a tab or button on the controller which can be depressed. In one embodiment, the dose cartridge is detachable from the controller. In one embodiment, detachment of the dose cartridge is accomplished by releasing the locking mechanism. In one embodiment, releasing the locking mechanism entails depressing the tab or button on the controller. Electrical connection between the dose cartridge and the controller can be accomplished through a set of mating electrical contacts. In one embodiment, attachment or mating of the dose cartridge to the controller establishes a breath detection mechanism. The breath detection mechanism can comprise breath sensory components. In one embodiment, the breath detection mechanism comprises detecting an alteration in an optical signal, wherein attachment or mating of the dose cartridge to the controller establishes an optical path through which the optical signal can be sent and received. In one embodiment, a source and detector of an optical signal is present in the controller, while the dose cartridge comprises an optical path. The optical path can comprise reflectors for reflecting an optical signal. The optical path can comprise a vane, wherein an inhalation can move the vane in such a way as to cause an alteration in an optical signal. In one embodiment, the dose cartridge comprises a vane, wherein an inhalation can move the vane in such a manner as to cause an alteration in an optical signal. The optical signal can be light of any wavelength.

In some cases, a reservoir comprising a liquid formulation comprising a pharmaceutically active agent (e.g., nicotine) is a single unit comprising a pump within the reservoir, a heater element, and a tube in fluid communication with the pump and the heater element. The reservoir can further comprise a protective element that can serve to cover and protect the heater element when the reservoir is not part of an aerosol generating device. The protective element can be retractable. FIG. 42A-C depicts a single unit reservoir. FIG. 43A shows an exterior view of the single unit reservoir (9500), while FIGS. 43B-C show that internally the reservoir comprises a nicotine reservoir (9506) comprising a pump (9508b) connected to an elongated housing comprising a heater element (9504) at the tip. The elongated housing comprising the heater element (9504) can be surrounded by a retractable heater element protector (9508). The single unit reservoir depicted in FIG. 43A-C can be one component in a multi-component aerosol generating device as provided herein. The single unit reservoir can be disposable. The single unit reservoir can be refillable. The single-unit reservoir can be non-refillable. In some cases, the single unit reservoir comprises a retractable heater element protector that is retracted when the reservoir is inserted or connected to a separate component to form an aerosol generating device.

Tube, e.g., Capillary Tube

FIGS. 2A and 2B illustrate embodiments of components of an electronic nicotine delivery device. FIG. 2A illustrates an agent (e.g., nicotine) reservoir (202) and a tube, e.g., capillary tube (204). FIG. 2B illustrates an expanded view of the device. The agent (e.g., nicotine) reservoir can comprise an agent (e.g., nicotine)/propylene glycol (PG) mixture (206). The tube, e.g., capillary tube can comprise a region on the interior which has been coated with an agent (e.g., nicotine)/PG philic material (208) to promote wicking out of a reservoir. A region on the interior which has been coated with an agent (e.g., nicotine)/PG phobic material (210) (such as polytetrafluoroethylene (PTFE)) can lie at the open end. This coating can cause the agent (e.g., nicotine)/PG to stop wicking short of the open end, thereby reducing the surface area of the mixture exposed to air, and air devoid of agent (e.g., nicotine) vapor. The tube, e.g., capillary tube can comprise a heated section (212) of the tube, e.g., capillary tube which, upon heating, can cause the mixture in the tube to vaporize and expand, pushing the mixture from the open end. A ball valve (214) can be trapped between two indentations in the tube, e.g., capillary tube, the end indentation being such that the ball, if pushed by fluid, will form a seal. This configuration can allow the liquid to be ejected from the end upon heating rather than back into the reservoir. All four of these elements can form a pump which can eject a known dose of the mixture from the end of the tube, e.g., capillary tube.

To eject a dose of an agent (e.g., nicotine)/PG mix with a 1:10 ratio, 1 mm³ of material can be in the tube, e.g., capillary tube. For a tube, e.g., capillary tube with an interior diameter of 0.5 mm, the length can be ˜5 mm.

Valve

A valve can be a check valve, and the check valve can be a ball which can be made of a metal, such as stainless steel or can be made of a plastic, such as nylon, delrin, or a homopolymer acetal. The ball can have a diameter less than the interior diameter of the tube, e.g., capillary tube sufficient to allow an agent (e.g., nicotine)/PG mix to wick by it.

Heater Element

A heater element as provided herein can comprise an electrically resistive material. In some cases, an electronic agent (e.g., nicotine) delivery device provided herein comprises a heater element comprising a coil, wherein the coil comprises electrically resistive/conductive material as provided herein. Electrically conductive/resistive materials that can be useful as resistive heater elements can be those having low mass, low density, and moderate resistivity and that are thermally stable at the temperatures experienced during use of the aerosol generating device. In some cases, a heater element heats and cools rapidly, and can efficiently use energy. Rapid heating of the heater element can provide almost immediate volatilization of an aerosol forming substrate (e.g., liquid formulation comprising nicotine) in proximity thereto. Rapid cooling to a temperature below the volatilization temperature of the substrate can prevent substantial volatilization (and hence waste) of the substrate during periods when aerosol formation is not desired. Such heater elements also permit relatively precise control of the temperature range experienced by the substrate, e.g., when time based current control is employed. In some cases, electrically conductive/resistive materials are chemically non-reactive with the materials being heated (e.g., aerosol precursor materials and other inhalable substance materials) so as not to adversely affect the flavor or content of the aerosol or vapor that is produced. Exemplary, non-limiting, materials that can be used as the electrically conductive/resistive material include carbon, nickel, iron, chromium, graphite, tantalum, stainless steel, gold, platinum, tungsten molybdenum alloy, metal ceramic matrices, carbon/graphite composites, metals, metallic and non-metallic carbides, nitrides, silicides, inter-metallic compounds, cermets, metal alloys (e.g., aluminum alloys, iron alloys, etc.), and metal foils. In some cases, a refractory material is used. Various, different materials can be mixed to achieve the desired properties of resistivity, mass, and thermal conductivity. In some cases, metals that can be utilized include, for example, nickel, chromium, alloys of nickel and chromium (e.g., nichrome), and steel. Suitable metal-ceramic matrices can include silicon carbide aluminum and silicon carbide titanium. Oxidation resistant intermetallic compounds, such as aluminides of nickel and aluminides of iron are also suitable. Of the listed materials, stainless steel and the aluminum, iron or chromium alloys can be encapsulated in a suitable ceramic material because of their reactivity. Suitable ceramic materials for encapsulation include silica, alumina, and sol gels. The heater element can be made of a thin stainless steel foil or wires of the materials described herein. Materials that can be useful for providing resistive heating are described in U.S. Pat. Nos. 5,060,671; 5,093,894; 5,224,498; 5,228,460; 5,322,075; 5,353,813; 5,468,936; 5,498,850; 5,659,656; 5,498,855; 5,530,225; 5,665,262; 5,573,692; and 5,591,368, the disclosures of which are incorporated herein by reference in their entireties.

A heater element (e.g., resistive heater element) in an aerosol generating device as provided herein can be provided in a form that enables the heater element to be positioned in intimate contact with or in close proximity to the substrate (i.e. to provide heat to the substrate through, for example, conduction, radiation, or convection). In some cases, the substrate is a liquid substrate or formulation comprising a pharmaceutically active agent (e.g., nicotine). In some cases, the heater element can be provided in a form such that the substrate (e.g., liquid substrate) can be delivered to the heater element for vaporization. The delivery of the liquid substrate can take on a variety of embodiments, such as wicking of the liquid substrate to the heater element using a wick (e.g., fibrous wick) in fluid communication with the liquid substrate or flowing the liquid substrate to the heater element, such as through a capillary, which can include valve flow regulation. As such, the liquid substrate can be in one or more reservoirs positioned sufficiently away from the heater element to prevent premature vaporization, but positioned sufficiently close to the heater element to facilitate transport of the liquid substrate, in the desired amount, to the heater element for vaporization. In some cases, the one or more reservoirs comprising a liquid substrate can be located in an annular space surrounding a tubular or cylindrical air flow channel or passageway. In some cases, the heater element is in fluid communication with the liquid substrate stored in one or more reservoirs located in an annular space surrounding an air flow channel or passageway, wherein the heater element is located within the air flow channel or passageway. In some cases, the liquid substrate comprising a pharmaceutically active agent (e.g., nicotine) is delivered to the heater element through the use of a positive displacement pump. The positive displacement pump can be a reciprocating, metering, rotary-type, hydraulic, peristaltic, gear, screw, flexible impeller, diaphragm, piston, or progressive cavity pump, or any other pump utilizing positive displacement as known in the art. The positive displacement pump can be in fluid communication with the heater element. The positive displacement pump can be in fluid communication or fluidically coupled to a reservoir comprising a pharmaceutically active agent (e.g., nicotine). The positive displacement pump can be in fluid communication with the heater element and a reservoir comprising a pharmaceutically active agent (e.g., nicotine). The positive displacement pump can be within an air-flow channel or passageway in an aerosol generating device as provided herein or external to the air flow channel or passageway. The pump can be located within a source of the liquid substrate as provided herein.

The heater element (e.g., electrically resistive material) can be provided in a variety forms, such as in the form of straight line, a foil, a foam, discs, spirals (e.g., single spiral, double spiral, cluster or spiral cluster), fibers, wires, films, yarns, strips, ribbons, or cylinders, as well as irregular shapes of varying dimensions. In some cases, a heater element can be a resistive heater element comprising a conductive substrate, such as described in US20130255702A1 to Griffith et al., the disclosure of which is incorporated herein by reference in its entirety. In some cases, a heater element can be a resistive heater element that can be present as part of a micro-heater component, such as described in US20140060554A1, the disclosure of which is incorporated herein by reference in its entirety. In some cases, a heater element is a droplet ejection type heater element such as described in U.S. Pat. No. 5,894,841, the disclosure of which is incorporated herein by reference in its entirety. In some cases, a heater element comprises an ejector in combination with a heater element (e.g., electrically resistive coil or thin film or foil), such as described in US20050016550A1, the disclosure of which is incorporated herein by reference in its entirety. In some cases, a heater element comprises a wire coil comprising electrically resistive material wrapped around a wick, wherein the wick has one end within a reservoir comprising the liquid substrate, such as described in US20110094523A1, the disclosure of which is incorporated by reference in its entirety. In some cases, a heater element in an aerosol generating device as provided herein comprises a “cartomizer,” wherein the heater element and the reservoir comprising the liquid substrate are configured as a single disposable cartridge or unit. The cartomizer can be a first part of a two part aerosol generating device, wherein the second part can comprise the battery, LED, and a control apparatus (e.g., air-flow switch and any associated processor). In some cases, a heater element in an aerosol generating device as provided herein comprises an improved cartomizer that comprises: (a) a tube shape having an inlet and outlet; (b) a foam substrate for receiving a liquid formulation, the foam substrate defining an aerosol generation region; (c) a fiberglass member disposed within the aerosol generation region and in contact with the foam substrate to draw the liquid formulation into the region; and (d) a heater element disposed within the aerosol generation region and about the fiberglass member to vaporize the liquid formulation in the aerosol generation region, such as described in US20120199146A1, the disclosure of which is incorporated by reference in its entirety. In some cases, a heater element in an aerosol generating device as provided herein comprises an electrically resistive heater element (e.g., wire coil) with a liquid formulation permeating component (e.g., wicking element) directly sleeved thereon with the liquid permeating component in direct contact with a liquid containing reservoir that surrounds the heater element such as described in US20120111347A1 and US20120279512A1, the disclosure of each of which is incorporated by reference in its entirety. In some cases, a heater element in an aerosol generating device as provided herein comprises a porous wicking component surrounding a heating rod with an electrically resistive wire coil wrapped thereon, such as described in US20110209717A1, US20130125906A1, U.S. Pat. Nos. 7,832,410, 8,156,944, 8,393,331, or a wire coil wrapped around a fibrous wicking component such as described in U.S. Pat. No. 8,375,957, the disclosure of each of which is incorporated by reference in its entirety. In some cases, a heater element in an aerosol generating device as provided herein comprises an electrically resistive heater element within an atomization and spray device, such as described in US20110005535A1, the disclosure of which is incorporated by reference in its entirety. In some cases, a heater element comprises an atomizer, wherein the atomizer comprises an atomizer cover, a rubber sleeve, an atomizer sleeve, fibrous storage component infused with a liquid formulation (e.g., nicotine solution), two wires, a heating wire, a rubber pad, a threaded sleeve, a propping pin, a first fiber pipe, wicking element and a second fiber pipe, such as described in US20120145169A1, the disclosure of which is incorporated by reference in its entirety. In some cases, an aerosol generating device as provided herein comprises a vaporization nozzle. The vaporization nozzle can be located within an air flow channel in the aerosol generating device. The vaporization nozzle can be composed of any of the high-temperature resistant with low thermal conductivity materials provided herein. For example, the vaporization nozzle can be made of conventional ceramics or be made of aluminum silicate ceramics, titanium oxide, zirconium oxide, yttrium oxide ceramics, molten silicon, silicon dioxide, molten aluminum oxide. The vaporization nozzle can be made in the shape of a straight line or spiral, and can also be made from polytetrafluoethylene, carbon fiber, glass fiber, or other materials with similar properties. The vaporization nozzle can be a tubule comprising a heater element within the nozzle or on the outside of the nozzle, or can comprise no heater element and the tubule can be directly applied with heating current, such as described in U.S. Pat. No. 8,511,318, US20060196518A1, and US20120090630A1, the disclosure of each of which is incorporated herein by reference in its entirety. The heater element arranged within the vaporization nozzle can be made of wires of nickel chromium alloy, iron chromium aluminum alloy, stainless steel, gold, platinum, tungsten molybdenum alloy, etc., and can be in the shape of straight line, single spiral, double spiral, cluster or spiral cluster. The heating function of the heater element in the vaporization nozzle can be achieved by applying a heating coating on the inner wall of the tube, and the coating can be made from electro-thermal ceramic materials, semiconductor materials, or corrosion-resistant metal films, such as gold, nickel, chromium, platinum and molybdenum.

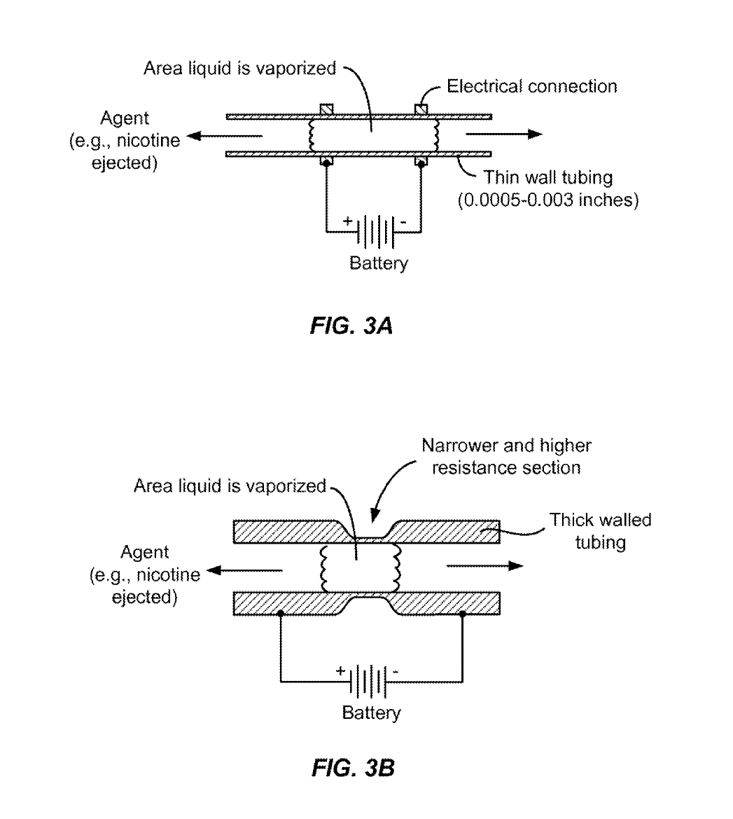

FIGS. 3A and 3B illustrate configurations of a heater element. The tube, e.g., capillary tube can be made of stainless steel, or a similar matter, which has an electrical resistance substantially greater than other metals (aluminum, brass, iron). The tube, e.g., capillary tube can be made of a thin wall material (FIG. 3A), or a section of the wall can be narrowed (FIG. 3B) to result in that section having an electrical resistance such that when an electrical current is passed across the section heating happens. Alternately the tube, e.g., capillary tube can be wrapped with a heater wire. This configuration can allow for the tube, e.g., capillary tube to be made of a non-electrically conductive material such as Kapton (polyimide), which can withstand heat. Electrical heating can be powered directly from a battery or can be powered from a charged capacitor.

A heater element can be used to vaporize an agent (e.g., nicotine)/PG mixture to form an aerosol with a particle size (MMAD=Mass Median Aerodynamic Diameter) of about 1 to about 5 μm. Aerosols with this particle size can deposit in the deep lung and result in rapid PK.

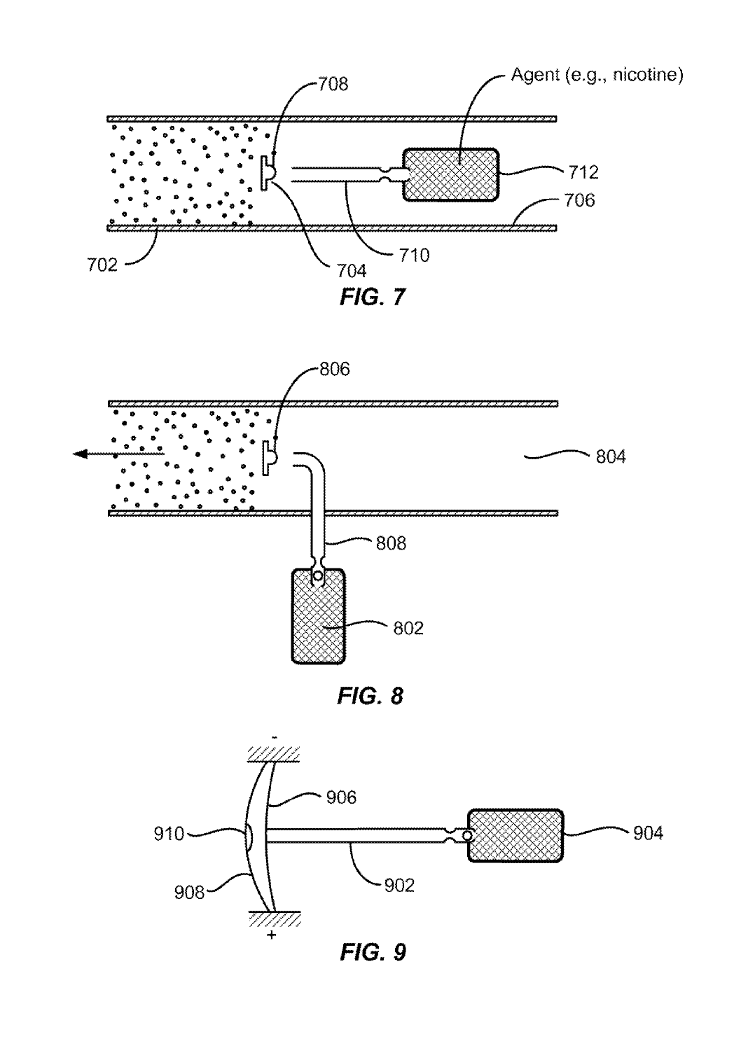

FIG. 7 illustrates a configuration of a heater element (704) in an airway (706). The heater element can be made of a thin stainless steel foil. The foil can be of a thickness of about 0.0005 to about 0.005 inches (a range from about 0.01 mm to about 0.13 mm) thick, or from about 0.0005 to about 0.001 inches (a range from about 0.01 mm to about 0.025 mm) so that less electrical current is needed to vaporize the mixture. The foil can be of a thickness of about, less than, more than, at least or at most 0.0005, 0.0006, 0.0007, 0.0008, 0.0009, 0.001, 0.002, 0.003, 0.003, 0.004, or 0.005 inches (a range from about 0.01 mm to about 0.13 mm). The heater element (704) can be positioned at the exit of the tube, e.g., capillary tube (710) so that the mixture can deposit (708) on the heater element (704). The heater element (704) can be positioned in an airway (706) so that a user upon inhalation can cause the aerosol to pass through the mouthpiece (702) and be drawn into the lungs. The agent (e.g., nicotine) reservoir (712) can be in the airway. FIG. 8 illustrates that in some cases, an agent (e.g., nicotine) reservoir (802) can be placed outside of an airway (804), while the heater element (806) can be in the airway (804). A tube, e.g., capillary tube (808) can enter the airway (804).

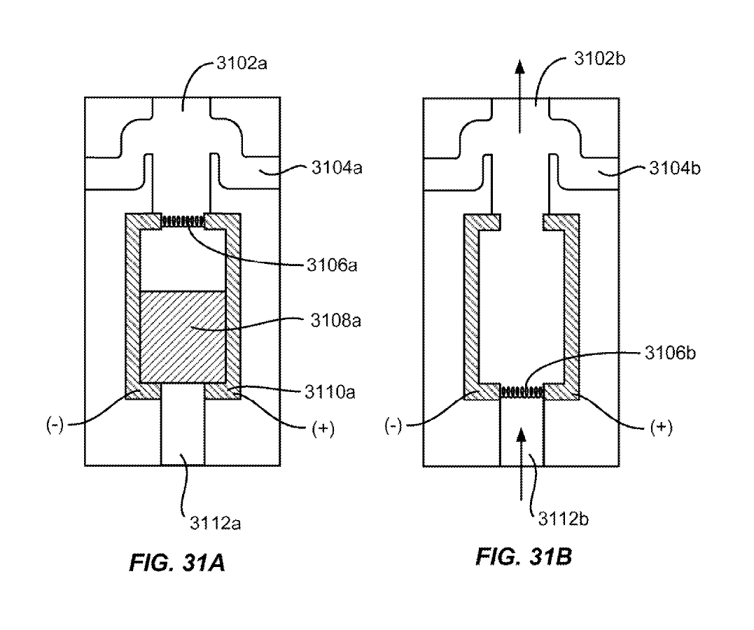

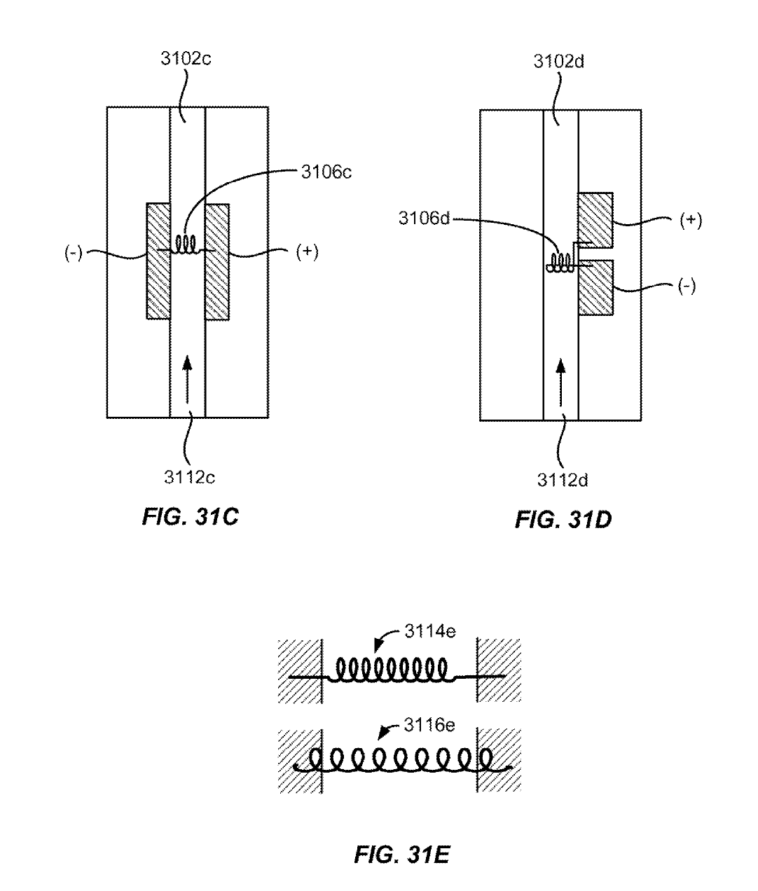

FIGS. 31A-D illustrates another configuration of a heater element (3106a-d) in an airway (3112a-d). FIG. 31A depicts a device (ENT-100-A), comprising a primary carrier gas inlet (3112a), positive and negative brass contacts (3110a), a heater element (3106a) comprising a coil located distally from the inlet to the primary airway (3112a) and two bypass inlets (3104a) located (disposed) downstream of the heater element but prior to the outlet (3102a). FIG. 31B depicts a device designated ENT-100-B, which is the same as ENT-100-A except that the heater element has been moved to be proximal to the inlet of the primary airway (3112b). FIG. 31C depicts a device designated ENT-100-C, which is similar to the ENT-100-A device except that the wire coil heater element has been moved to an intermediate position relative to the location of the coil in ENT-100-A and ENT-100-B. Any of the devices depicted in FIG. 31A-C can comprise the wire coil heater element designated “A Coil” (3114e) or “B Coil” (3116e) as illustrated in FIG. 31E. The coil in both types of heater elements comprise inner diameter of 0.26 inches (about 6.6 mm). The “A Coil” comprises a stretch of coil followed by a straight lead on either end of the coil which connects to the brass contacts. The “B Coil” comprises a stretch of coil, wherein the coil itself connects to the brass contacts. FIG. 31D depicts a device designated ENT-100-D with a primary passageway (3112d) for air to flow through, brass contacts (+/−) embedded within the wall of the primary passageway, and a heater element (3106d) comprising a wire wherein one end of the wire wraps around another segment of the wire, wherein a wire coil is formed with an end of the wire passes through the center of the wire coil. An example of this type of heater element is shown in FIGS. 36-38. In some cases, a liquid formulation comprising a pharmaceutically active agent (e.g., nicotine) is delivered to the heater element of FIGS. 31A-D from a reservoir comprising the liquid formulation comprising a pharmaceutically active agent (e.g., nicotine) through the use of a tube, e.g., capillary tube as provided herein, wherein the tube, e.g., capillary tube is coupled or capable of being coupled to the reservoir. In some cases, a liquid formulation comprising a pharmaceutically active agent (e.g., nicotine) is delivered to the heater element of FIGS. 31A-D from a reservoir comprising the liquid formulation comprising a pharmaceutically active agent (e.g., nicotine) through the use of a positive displacement pump as provided herein, wherein the positive displacement pump is fluidically coupled to the reservoir.

FIG. 9 illustrates another embodiment for a heater element. To aid in reducing an agent (e.g., nicotine) from evaporating from the end of a tube, e.g., capillary tube (902) (attached to an agent (e.g., nicotine) reservoir (904)), the heater element (906) can be positioned to cover the end of the tube, e.g., capillary tube when cold. Upon heating the heater would move away from the end (908) due to thermal expansion, opening up the end and allowing the mixture to leave. The position of deposited material (910) is shown.

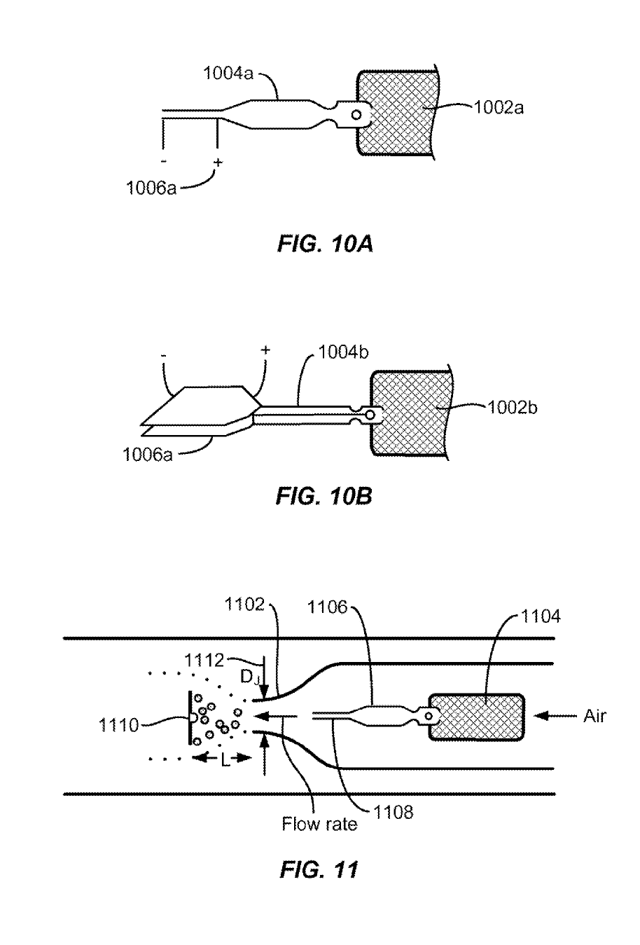

FIGS. 10A and 10B illustrate additional configurations of a heater element. FIG. 10A illustrates that a heater element (1006a) can be positioned at the end of the tube, e.g., capillary tube (1004a), where the tube, e.g., capillary tube can be attached to an agent (e.g., nicotine) reservoir (1002a). FIG. 10B illustrates an agent (e.g., nicotine) reservoir (1002b) and a tube, e.g., capillary tube (1004b), where the geometry of the tube, e.g., capillary tube is modified at the end (1006b) by narrowing or flattening to aid in vaporization.

FIG. 22 illustrates another embodiment of a heater element. The heater element (2200) can be a rod comprising a coil (2202) that can be made of stainless steel, or a similar matter, which has an electrical resistance substantially greater than other metals (aluminum, brass, iron). In some cases, the rod is a wire, wherein the coil is a wire coil. The rod can comprise an electrically resistive material. The electrically resistive material can have an electrical resistance such that when an electrical current is passed across the rod heating happens. The rod is connected to brass contacts (2204) through segments of the rod that do not form the coil. In some cases, the segments of the rod that connect to the brass contacts comprise leads. The brass contacts can serve to pass electrical current across the rod, including the coil. The electrical current can serve to heat the coil and vaporize material (i.e. an agent (e.g., nicotine) mixture) that contacts or is delivered to the coil. The coil can be an open coil that can allow for air to flow between the coils and carry away the vaporized material. In FIG. 22, the brass contacts (2204) are located (disposed) on either side of an airflow channel and the rod, including the coil, span the channel. In some cases, the coil can be oriented parallel to the flow of a carrier gas (e.g., air). In some cases, the coil can be oriented perpendicular to the flow of a carrier gas (e.g., air). In FIG. 22, a tube, e.g., capillary tube (2206) attached to a reservoir (2208) comprising an agent (e.g., nicotine) mixture is located at one end of the coil and an agent (e.g., nicotine) mixture is dispensed from the end of the tube, e.g., capillary tube onto the coil. The agent (e.g., nicotine) mixture, once dispensed, can wick along the coil to cover the entire or part of the coil. The coil can be heated which can vaporize the agent (e.g., nicotine) mixture.

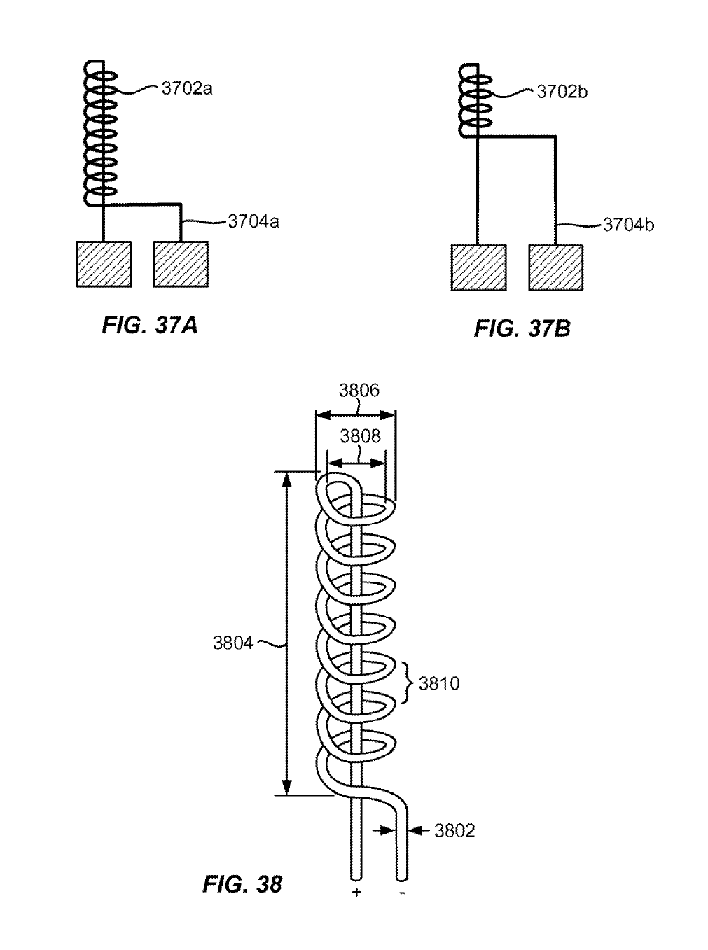

FIGS. 36-38 illustrate yet another embodiment of a heater element. In this embodiment, a first (3602a; +) and a second (3602b; −) brass contact or terminal are located adjacent to each other. The brass contacts can be embedded within or placed proximal to a wall of a housing or channel of a device for generating an aerosol as provided herein. The heater element can be a rod comprising electrically resistive material, wherein a first end or lead (3604a) is connected to one brass contact (3602a; +), while a second end or lead (3604b) is connected to another, separate brass contact (3602b; −). As illustrated in FIG. 36, a portion or segment of the rod between the leads is configured into a coil (3606). In addition, a separate portion or segment (3608) of the rod passes through the interior of the coil (3606). Supplying current to the rod through the brass contacts (3602a,b) can serve to heat both the coil (3606) as well as the segment (3608) of the rod that passes through the interior of the coil (3606). In some cases, the segment of the rod that runs through the center of the coil is capable of holding a liquid formulation comprising an agent (i.e. nicotine) as provided herein. The liquid formulation can wick or be delivered by any of dosing mechanisms provided herein onto the segment of the rod that runs through the center of the coil from a source of the liquid formulation (e.g., a reservoir). In some cases, supplying current to the rod through the brass contacts (3602a,b) serves to heat both the coil (3606) as well as the segment (3608) of the rod that passes through the interior of the coil (3606), wherein a liquid formulations that wicks or is delivered by any of dosing mechanisms provided herein onto the segment of the rod running through the coil is vaporized. In FIG. 36, the coil is oriented perpendicular to the flow of a carrier gas (e.g. air flow) (3610). In some cases, the coil is oriented parallel to the flow of a carrier gas (e.g. air flow) in a device for generating a condensation aerosol as described herein. FIGS. 37A and 37B depict alternate embodiments to the heater element illustrated in FIG. 36, wherein the number of coils shown in the heater element of FIG. 37A is reduced in the heater element of FIG. 37B. As shown in FIGS. 37A-B, alternating the number of coils (3702b, 3702b) in the coil serves to increase the length of the non-coil segments (3704a, 3704b) of the rod and decrease the length of the rod covered by the coil. FIG. 38 illustrates components of the rod and coil in the heater element illustrated in FIG. 36, including the diameter of the rod (3802), total length of the coil (3804) (e.g., 0.1 to 0.15 inches (a range from about 2.54 mm to about 3.81 mm)), inner diameter of the coil (3808) (e.g., 0.027-0.040 inches (about 0.6 mm to about 1.02 mm)), outer diameter of the coil (3806) (e.g., 0.047-0.06 inches (a range from about 1.19 mm to about 1.53 mm)), and pitch of the coil (3810).

In some cases, the heater element can comprise a rod comprising electrically resistive material. The rod can be a wire. The wire can be made of any of the electrically resistive/conductive materials described herein. The rod can be a pliable rod. A heater element comprising a rod as provided herein can comprise a coil and a wick element around which the coil can be wrapped. The wick element can be capable of being heated. The wick element can be connected to the rod. The wick element can be continuous with the rod. The wick element can be independent of the rod. In some cases, the wick element is capable of being heated, and wherein the wick element is connected to the rod. The rod can be a wire. The coil can be a wire coil. The rod can comprise a coil along the entire length of the wick element. The wick element can be capable of wicking or holding a liquid formulation comprising an agent as provided herein. The wick element can be a capillary (a self wicking tube). The liquid formulation comprising an agent as provided herein can be in fluid communication with a source of the liquid formulation. The source of the liquid formulation can be any source as provided herein, including but not limited to, a reservoir. The liquid formulation comprising an agent as provided herein can be delivered to the wick element by any means known in the art. The delivery can be through capillary action or through the use of a pump. In some cases, the rod comprises a capillary wherein the capillary is in fluid communication with a reservoir, wherein the reservoir comprises a liquid formulation comprising a pharmaceutically active agent (e.g. nicotine), and wherein the capillary is capable of holding the liquid formulation comprising a pharmaceutically active agent (e.g. nicotine). The wick element can be made of any material known in the art capable of wicking or holding a liquid formulation comprising an agent as provided herein. In some cases, the coil connects to a source of electricity. The coil can connect to the source of electricity through one or more leads protruding from both ends of the coil. The source of electricity can be a battery or a charged capacitor. The battery can be rechargeable.

A heater element comprising a rod as provided herein can comprise one or more segments comprising a coil and one or more segments not comprising a coil (i.e. non-coil segment). The rod can be a wire. The coil can be a wire coil. One or more non-coil segments of the rod can be capable of wicking or holding a liquid formulation comprising an agent as provided herein. The non-coil segment can act as a capillary or wick. In some cases, one or more non-coil segments of the rod comprise a wick element. One or more wick elements can be capable of being heated, thereby forming one or more heated wick elements. The liquid formulation comprising an agent as provided herein can be in fluid communication with a source of the liquid formulation. The source of the liquid formulation can be any source as provided herein, including, but not limited to, a reservoir. The liquid formulation comprising an agent as provided herein can be delivered to a non-coil segment of the rod by any means known in the art. The delivery can be through capillary action or through the use of a pump. In some cases, the non-coil segment is in fluid communication with a reservoir, wherein the reservoir comprises a liquid formulation comprising a pharmaceutically active agent (e.g. nicotine), and wherein the non-coil segment is capable of holding the liquid formulation comprising a pharmaceutically active agent (e.g., nicotine).

The non-coil segments can serve as electrical leads for connecting the rod to a source of electricity. The rod can comprise a coil along the entire length of the rod. In some cases, the coil connects to the source of electricity. The source of electricity can be a battery or a charged capacitor. The battery can be rechargeable.

In some cases, a distance between the first and second leads of the rod when the first lead is connected to either the first or second terminal of the power source while the second lead is connected to the other of the first or second terminal of the power source is about, more than, less than, or at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.11, 0.12, 0.13, 0.14, 0.15, 0.16, 0.17, 0.18, 0.19, or 0.2 inches (a range from about 0.254 mm to about 5.08 mm). A distance between the first and second leads of the rod when the first lead is connected to either the first or second terminal of the power source while the second lead is connected to the other of the first or second terminal of the power source is from about 0.01 to about 0.1 inches, about 0.02 to about 0.09 inches, or about 0.025 to about 0.8 inches (a range from about 0.254 mm to about 20.32 mm).

Methods of renewal of a heater element are provided herein. Heating elements can be renewed with changes in an agent (e.g., nicotine) dose cartridge to ensure dose consistency by removal of any build up of combusted material on the heater element.

In some cases, the heater element comprises a coil and a wick element, wherein the coil wraps around the wick element, and wherein the liquid formulation wicks onto the heated wick element, wherein the liquid formulation is vaporized through heating of the coil and wick element.

The heater element can be in fluid communication with a source of liquid formulation comprising an agent (e.g., nicotine) as provided herein. In some cases, the heater element further comprises a source of a liquid formulation comprising an agent (e.g., nicotine), wherein the source is in fluid communication with the wick element capable of being heated, wherein the liquid formulation comprising an agent (e.g., nicotine) wicks onto the wick element capable of being heated, whereby the liquid formulation is aerosolized by heating of the coil and wick element capable of being heated upon activation of a power source, wherein the power source is electrically coupled to the heater element. In some cases, the heater element further comprises a source of a liquid formulation comprising an agent, wherein the source is in fluid communication with the heatable wick element, wherein the liquid formulation comprising an agent wicks onto the heatable wick element, wherein the heatable wick element is heated after the formulation has wicked onto the heatable wick element, whereby the liquid formulation is aerosolized by heating of the coil and heatable wick element upon activation of the power source.

The heater element comprising a coil with a center exit wick element capable of being heated as described herein can vaporize substantially all of the liquid formulation comprising the pharmaceutically active agent (e.g., nicotine) that wicks onto the center wick element. The heater element comprising a coil with a center exit wick element capable of being heated can have a reduced or substantially no splatter. In some cases, the heater element comprises a coil with a center exit wick element capable of being heated, wherein a liquid formulation comprising a pharmaceutically active agent (e.g., nicotine) is held or wicks onto the center exit wick element capable of being heated, and wherein both the wick element capable of being heated and coil are heated, thereby vaporizing the liquid formulation, wherein substantially all of the liquid formulation is vaporized. The heater element comprising a coil with a center exit wick element capable of being heated can vaporize greater than 95% of the liquid formulation wicked onto the wick element. The amount of residue or build-up of non-vaporized liquid formulation comprising a pharmaceutically active agent (e.g., nicotine) can be substantially reduced. Following vaporization of a liquid formulation as provided herein by a heater element comprising a coil and a center exit wick element capable of being heated less than 5% residue of non-vaporized liquid formulation can remain on the heater element.

In some cases, a heater element is connected to a timing device.

Control Apparatus

In some cases, an aerosol generating device (e.g., electronic cigarette) as provided herein comprises a control apparatus for regulating activation of a heater element. In some cases, the control apparatus is in electrical communication with the heater element. The electrical communication can be direct or indirect. In some cases, the control apparatus is a valve or flap as provided herein, wherein the valve or flap comprises an electrical component that serves to control activation of the heater element. The valve or flap can be a gas-control valve or flap. The heater element can be any heater element as provided herein. The control apparatus can activate the heater element at a trip point or activation trip point as described herein.

In some cases, the control apparatus can comprise a switch. The switch can be any switch known in the art. The switch can comprise a diaphragm. The switch can be an air-flow switch. The diaphragm can be a component of a pressure sensor in the air-flow switch. The switch can be configured for detecting air flow or inhalation from the device by a user.

In some cases, the control apparatus comprises a processor or microprocessor. In some cases, the control apparatus comprises a switch and a processor, wherein the switch detects an air flow rate (or pressure change) due to inhalation by a user and the processor serves to activate the heater element based on data from the sensor.

In some cases, a control apparatus comprising a switch is constructed to activate the heater element prior to the air-flow rate in an aerosol generation region of an aerosol generating device as provided herein reaching a desired or predetermined rate. Timing of activation is such that the heater element begins vaporization of a substrate (e.g., liquid nicotine solution) at about the time or after the air-flow through the aerosol generation region reaches the desired air-flow rate. In some cases, the heater element is activated when the air-flow rate through the aerosol generation region reaches the desired air-flow rate. In some cases, the heater element is activated at a selected time after the desired flow rate has been reached in the aerosol generation region. The desired rate can be detected in the aerosol generation region. The desired rate can be any rate as provided herein. The desired rate can be any trip point or activation trip point as provided herein. The desired rate can be less than 3 LPM. The desired rate can be less than 1 LPM. The desired rate can be up to 0.5 LPM. The desired rate can be about 0.15 LPM. The switch in the device can be configured for activating the heater element in relation to airflow through the aerosol generation region, such that the heater element produces an aerosol when the air flow rate through the aerosol generation region is sufficient for producing desired-size aerosol particles. The desired-size aerosol particles can comprise a desired diameter. The desired diameter can be from about 1 μm to about 5 μm. The desired diameter can be from about 1 μm to about 3 μm. The desired diameter can be an MMAD or a VMD. The desired-size aerosol particles can be condensation aerosol particles. In some cases, the switch is controlled by airflow through the aerosol generation region, such that the heater element is activated when (or just prior to, or after) the rate of airflow in the device reaches its desired rate. Alternatively, the switch can be user activated, allowing the user to initiate aerosol formation as air is being drawn into the device. In this manner, the device can provide a signal, such as an audible tone, to the user, when the desired rate of airflow through the aerosol generation region is reached.

A trip point can be a flow rate (or vacuum applied to the mouthpiece that can result in a flow rate) which causes an electrical current to be applied to a heater element, which activates (heats) the heater element and results in generation of an aerosol from a substrate in contact with the heater element. The flow rate (or vacuum applied to the mouthpiece that can result in a flow rate) can be detected by the control apparatus, wherein the control apparatus can subsequently activate the heater element. In some cases, a flow rate that is detected by the control apparatus and causes the control apparatus to activate a heater element of an aerosol generating device is the flow rate at which an aerosol comprising a desired diameter is generated following vaporization of a substrate in contact with the activated heater element. The desired diameter can be from about 1 μm to about 5 μm. The diameter can be an MMAD. The diameter can be a VMD.

Removal of Particles

In some cases, an issue with vaporization within the capillary can arise. First, liquid droplets can be ejected by vapor pushing the material out. Second, because the high vapor concentration can be high within the capillary end, rapid condensation and aggregation leading to larger than optimum particle size can result. To reduce the particle size of the aerosol the large particles can be removed and revaporized. Removal can be accomplished thru inertial impaction (FIG. 11). FIG. 11 shows an agent (e.g., nicotine) reservoir (1104), tube, e.g., capillary tube (1106), heater element 1 (1108), and a heater element 2 (1110). One consideration is whether a restriction in a nozzle (1102) can cause an unacceptable increase in the air flow resistance. The following formula can be used to calculate the diameter of an orifice (D_{J}) (1112).

$${d}_{50} = \sqrt{{C}_{c}} = {[ \frac{9 π {ND}_{J}^{3} ( {Stk}_{50} )}{4 {P}_{p} Q} ]}^{1 / 2}$$

Where d₅₀= is the average aerosol practice size.

Where:

N=viscosity (of air)=1.81×10⁻⁵ Pa sec

D_{J}=The nozzle diameter in meters

Stk₅₀=Stokes number for a round nozzle=0.24 (dimensionless)

Pₚ=Density of particle, for liquids assumed to be 1000 kg/meter³

Q=Flow rate in liters/mixture (assume 15 L/min (about 2.5×10⁻⁴ m³/s))

Additionally to correct for slip factor the following equation can be used:

d₅₀=d₅₀\sqrt{C_{c}}−0.078 in microns

Using the above, a table of nozzle sizes vs. particle sizes that will impact can be generated as shown in Table 1:

TABLE 1

| Nozzle Size (mm) | Particle Size (μm) |
|---|---|
| 7 | 6.41 |
| 6 | 5.07 |
| 5 | 3.84 |
| 4 | 2.72 |

If a particle size of approximately 5 μm is desired, a nozzle with a diameter of about 6 mm can be used, which can be acceptable for a pressure drop at 15 L/min (about 2.5×10⁻⁴ m³/s) flow rate of inhalation.

In some cases, a device for generating a condensation aerosol from a liquid formulation comprising a pharmaceutically active agent (e.g., nicotine) as provided herein comprises a means for removing aerosol particles of a size not optimal for deep lung delivery and subsequent rapid PK. The non-optimal particles can have a particle size of about, greater than, at least, or at most 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, or 20 microns. The particle size can be about, more than, less than, or at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, or 20 microns. The particle size can be from about 1 to about 10 microns, about 1 to about 9 microns, about 1 to about 7 microns, about 1 to 6 microns, about 1 to about 5 microns, about 1 to about 4 microns, about 1 to about 3 microns, or about 1 to about 2 microns. In some cases, the non-optimal particle sizes are greater than 1, 1.5, 2, 2.5, 3, 3.5, 4, 4.5, or 5 microns. The means for removing the non-optimal particles can be a solid structure within a passageway in which a condensation aerosol generated as provided herein flows. The structure can be an impactor, a baffle or baffle plate. In some cases, the structure (e.g., impactor, baffle, or baffle plate) is within a passageway in a device as provided herein. In some cases, the structure is located between a heater element and an outlet in a passageway of a device for generating a condensation aerosol comprising a pharmaceutically active agent (e.g., nicotine) as provided herein. In some cases, the structure is located downstream of an aerosol generation area and upstream of an outlet in a passageway of a device for generating a condensation aerosol comprising a pharmaceutically active agent (e.g., nicotine) as provided herein. In some cases, the structure (e.g., impactor, baffle, or baffle plate) comprises a surface attached to the passageway such that the surface has a diameter or width that occupies a portion of the diameter or width of the passageway such that only particles of an optimal size flow or are diverted around the surface while non-optimally sized particles impact or are substantially retained by the surface (e.g., impactor, baffle, or baffle plate) and are thereby incapable of flowing or being diverted around the surface. The surface can be a planar surface. The particles that flow or are diverted passed, around, by, beyond or are not substantially retained by the structure (e.g., impactor, baffle, or baffle plate) and thereby exit an outlet in a device for producing a condensation The particle size can be from about 1 to about 5 microns, about 1 to about 4 microns, about 1 to about 3 microns, or about 1 to about 2 microns. In some cases, the optimal particle sizes are less than 1, 1.5, 2, 2.5, 3, 3.5, 4, 4.5, or 5 microns. The particle size can be a diameter, radius, or circumference. In some cases, the particle size is a diameter. The diameter can be an average or mean. The mean can be arithmetic or geometric. The particle size can be an average or mean diameter. The particle size can be a mass median aerodynamic diameter (MMAD). The particle size can be a volumetric median diameter (VMD). In some cases, the optimally sized particles have an MMAD of less than or equal to 5 μm. In some cases, the optimally sized particles have an MMAD of about 1 to about 5 μm. The small particles can have a size of from about 1 to about 5 microns, about 1 to about 4 microns, about 1 to about 3 microns, or about 1 to about 2 microns. The size of the small and/or large particles can be a diameter, radius, or circumference. In some cases, the size of the small particles is a diameter. In some cases, the size of the large particles is a diameter. The diameter can be a physical diameter (e.g., Feret's diameter, Martin's diameter, or equivalent projected area diameter), a fiber diameter, a Stokes diameter, a thermodynamic diameter, a volumetric diameter, or an aerodynamic diameter. The size of the small and/or large particles can be an MMAD or a VMD. In some cases, a baffle or impactor in a passageway of a device as provided herein for generating a condensation aerosol comprising a pharmaceutically active agent (e.g., nicotine) removes large particles from the condensation aerosol that exits an outlet of the device, wherein the condensation aerosol that exits the outlet comprises a particles size with a GSD of less than 2. In some cases, the GSD of the particle size is less than 1. The particle size with a GSD can be a diameter, radius, or circumference. In some cases, a baffle or impactor in a passageway of a device as provided herein for generating a condensation aerosol comprising a pharmaceutically active agent (e.g., nicotine) removes large particles from the condensation aerosol that exits an outlet of the device, wherein the condensation aerosol that exits the outlet comprises a diameter with a GSD of less than 2. In some cases, a baffle or impactor in a passageway of a device as provided herein for generating a condensation aerosol comprising a pharmaceutically active agent (e.g., nicotine) removes large particles from the condensation aerosol that exits an outlet of the device, wherein the condensation aerosol that exits the outlet comprises an average particles size of from about 1 to about 5 μm. In some cases, a baffle or impactor in a passageway of a device as provided herein for generating a condensation aerosol comprising a pharmaceutically active agent (e.g., nicotine) removes large particles from the condensation aerosol that exits an outlet of the device, wherein the condensation aerosol that exits the outlet comprises an average particles size of from about 1 to about 3 μm. In some cases, a baffle or impactor in a passageway of a device as provided herein for generating a condensation aerosol comprising a pharmaceutically active agent (e.g., nicotine) removes large particles from the condensation aerosol that exits an outlet of the device, wherein the condensation aerosol that exits the outlet comprises an average or mean particles size of from about 1 to about 2 μm. The average or mean particle size can be a diameter, radius, or circumference. In some cases, the average or mean particles size is a diameter. The diameter can be a physical diameter (e.g., Feret's diameter, Martin's diameter, or equivalent projected area diameter), a fiber diameter, a Stokes diameter, a thermodynamic diameter, a volumetric diameter, or an aerodynamic diameter. In some cases, a baffle or impactor in a passageway of a device as provided herein for generating a condensation aerosol comprising a pharmaceutically active agent (e.g., nicotine) reduces the average or mean particle size of the condensation aerosol that exits an outlet of the device. The average or mean particle size can be reduced by about, at least, at most, more than or less than 1%, 2%, 3%, 4%, 5%, 6%, 7%, 8%, 9%, 10%, 11%, 12%, 13%, 14%, 15%, 16%, 17%, 18%, 19%, 20%, 30%, 31%, 32%, 33%, 34%, 35%, 36%, 37%, 38%, 39%, 40%, 41%, 42%, 43%, 44%, 45%, 46%, 47%, 48%, 49%, or 50% of the average or mean particle size prior to encountering the baffle or impactor within a device as provided herein. The average or mean particle size can be reduced from about 10% to about 20%, about 20% to about 30%, about 30% to about 40%, or about 40% to about 50% of the average or mean particle size prior to encountering the baffle or impactor within a device as provided herein. The average or mean can be geometric or arithmetic. The average or mean particle size can be an average or mean diameter, radius, or circumference. In some cases, a baffle or impactor in a passageway of a device as provided herein for generating a condensation aerosol comprising a pharmaceutically active agent (e.g., nicotine) reduces the average or mean diameter of the particles of the condensation aerosol that exits an outlet of the device.

Flow Regulation

A device provided herein can be configured to limit a flow of a carrier gas through the passageway or aerosol generation area/chamber to permit condensation of the vaporized liquid formulation. The carrier gas can be air. The flow of a carrier gas through the aerosol generation chamber or passageway comprising or in fluid communication with the heater element can be limited to about 1 to about 10 liters per minute (LPM) (a range from about 1.667×10⁻⁵ m³/s to about 1.667×10⁻⁴ m³/s). The device can be configured to comprise a flow resistance (to inhalation) of about 0.05 to about 0.15 sqrt (cm-H₂O)/LPM. The device can be configured to comprise an inhalation resistance comprising a vacuum pressure of about 1 to about 10 inches of H₂O (a range from about 249 Pa to about 2488 Pa). The flow resistance of the device as provided herein for use in a method as provided herein can be about the same flow resistance as through that of a combustible cigarette. The flow resistance through a device as provided herein for use in a method as provided herein can be around 2.5 (cm of H₂O)^{1/2}/LPM. In some cases, a device as provided herein for use in a method as provided herein comprises a flow rate of 1 LPM at a vacuum of 7.6 cm of H₂O. In some cases, a device as provided herein for use in a method as provided herein comprises a flow rate of 1.5 LPM at a vacuum of 16 cm of H₂O. In some cases, a device as provided herein for use in a method as provided herein comprises a flow rate of 2 LPM at a vacuum of 26 cm of H₂O.

Methods are provided herein for sensing an inhalation by a user and triggering a device. For example, an optical sensor that uses a deformable member (e.g., a vane) that moves during inhalation can be used to either open or close an optical path. In some embodiments, a Hall effect sensor is used to measure inhalation. In one embodiment, inhalation sensing is accomplished using an optical signal wherein a unique pattern of light pulses is sent along an optical path or light pipe and resent back along the optical path to a light detector. In one embodiment, the optical signal is sent from a controller into a dose cartridge whereby it is resent back into the controller to a light detector. In one embodiment, a vane is positioned in the path of an airway such that when an inhalation occurs, the vane is deflected out of the way and interrupts the optical signal. In this case, the device notes the absence of the optical signal and triggers the creation of an aerosol.

Methods are provided herein for inhalation flow control. In some cases, a valve system to allow for a user to experience an initial high pressure and low flow rates, followed by low pressure is used. An initial high-pressure drop through the device to facilitate the ejection of an agent (e.g., nicotine) from a dosing mechanism can be used. The following high flow rate can facilitate deep lung delivery. In one embodiment, a slide valve with an attached piston mechanism is used to eject an agent (e.g., nicotine) from a dosing reservoir. In one embodiment, air flow over a vaporizing agent (e.g., nicotine) formulation is regulated and controlled to an optimum level using a valve system, resulting in optimum particle sizing and dosing effectiveness. In a one embodiment, a valve system is used to create an internal air or inhalation resistance that is low (e.g., 0.08 to 0.12 (cm H₂O)^{1/2}/LPM). In a one embodiment, a valve system is used to create an internal air or inhalation resistance that is similar to that of a combustible cigarette (e.g., about 2.5 (cm H₂O)^{1/2}/LPM).

In some cases, a device for generating a condensation aerosol as provided herein can comprise a heater element. In some cases, a device provided herein can comprise a passageway, wherein the passageway comprises a heater element and a reservoir. In some cases, the device comprises a passageway, a reservoir, and a housing which comprises a heater element, wherein the passageway is in fluid communication with the heater element. The passageway comprising the heater element or in fluid communication with the heater element can comprise an aerosol generation area or chamber. In some cases, the aerosol generation area or chamber comprises the heater element. In some cases, the aerosol generation area or chamber comprises the heater element and a source of a formulation comprising an agent as provided herein. The source can be a tube, e.g., capillary tube, or a reservoir. The tube, e.g., capillary tube can be coupled to the reservoir. The reservoir can comprise the liquid formulation. The reservoir can be in fluid communication with the heater element. The reservoir can serve to deliver the liquid formulation to the heater element, wherein the liquid formulation can wick onto the heater element. The reservoir can comprise a tube, e.g., capillary tube, wherein the tube, e.g., capillary tube can deliver the liquid formulation onto the heater element.

In some cases, a device for generating a condensation aerosol as provided herein comprises an aerosol generation chamber. The aerosol generation chamber can comprise a heater element. The aerosol generation chamber can comprise a source of a liquid formulation comprising a pharmaceutically active agent (e.g. nicotine). In some cases, the aerosol generation chamber comprises a heater element and a source of a liquid formulation comprising a pharmaceutically active agent (e.g. nicotine). The aerosol generation chamber can be within a primary flow-through passageway. In some cases, a device for producing a condensation aerosol as provided herein comprises a flow-through passageway, wherein the flow-through passageway comprises an upstream opening and a downstream opening, wherein the flow-through passageway comprises an aerosol generation chamber between the upstream and downstream openings of the flow-through passageway. The passageway can be a primary flow-through passageway. The primary flow-through passageway can be in fluid communication with a secondary flow-through passageway as provided herein. In some cases, the aerosol generation chamber further comprises a nozzle as provided herein. In some cases, a device for generating a condensation aerosol as provided herein comprises an aerosol generation chamber, wherein the aerosol generation chamber is within a passageway configured to limit the flow of a carrier gas through the aerosol generation chamber to a flow rate effective for producing a condensation aerosol comprising particles of a size suitable for delivery to the deep lung of a subject. The flow rate can be limited to about 1 to about 10 liters per minute (LPM) (a range from about 1.667×10⁻⁵ m³/s to about 1.667×10⁻⁴ m³/s) at, e.g., a vacuum of about 1 to about 15 inches of water (a range from about 249 Pa to about 3738 Pa).

In some cases, a device for producing a condensation aerosol as provided herein comprises a primary flow-through passageway, wherein the primary flow-through passageway comprises an upstream opening and a downstream opening, wherein the upstream opening comprises an inlet for a carrier gas (e.g., air) and the downstream opening comprises an outlet for the carrier gas (e.g., air). The passageway can be a primary flow-through passageway. The primary flow-through passageway can be in fluid communication with a secondary flow-through passageway as provided herein. The inlet can comprise a flow restrictor configured to limit the flow of the carrier gas through primary flow-through passageway to a flow rate effective for producing a condensation aerosol comprising particles of a size suitable for delivery to the deep lung of a subject. The flow restrictor can limit the flow rate to about 1 to about 10 liters per minute (LPM) (a range from about 1.667×10⁻⁵ m³/s to about 1.667×10⁻⁴ m³/s), e.g., at a vacuum of about 1 to about 15 inches of water (a range from about 249 Pa to about 3738 Pa). The flow restrictor can be a valve or an orifice comprising dimensions that limit the flow of a carrier gas (e.g., air) to a rate suitable for producing a condensation aerosol comprising particles of a size suitable for delivery to the deep lung of a subject.

In some cases, a device for producing a condensation aerosol as provided herein comprises a flow-through passageway, wherein the flow-through passageway comprises an upstream opening and a downstream opening, wherein the flow-through passageway is configured to facilitate formation of a condensation aerosol comprising particles of a size effective for delivery to the deep lung of a subject. The particles can comprise an MMAD of about 1 to about 5 μm. The subject can be a human. The subject can be a human who smokes and/or uses tobacco or nicotine containing products. The condensation aerosol can comprise a pharmaceutically active agent (e.g. nicotine). The passageway can be a primary flow-through passageway. The primary flow-through passageway can be in fluid communication with a secondary flow-through passageway as provided herein. The upstream opening can be an inlet. The inlet can comprise a flow restrictor as provided herein. The downstream opening can comprise an outlet. The outlet can be a mouthpiece.

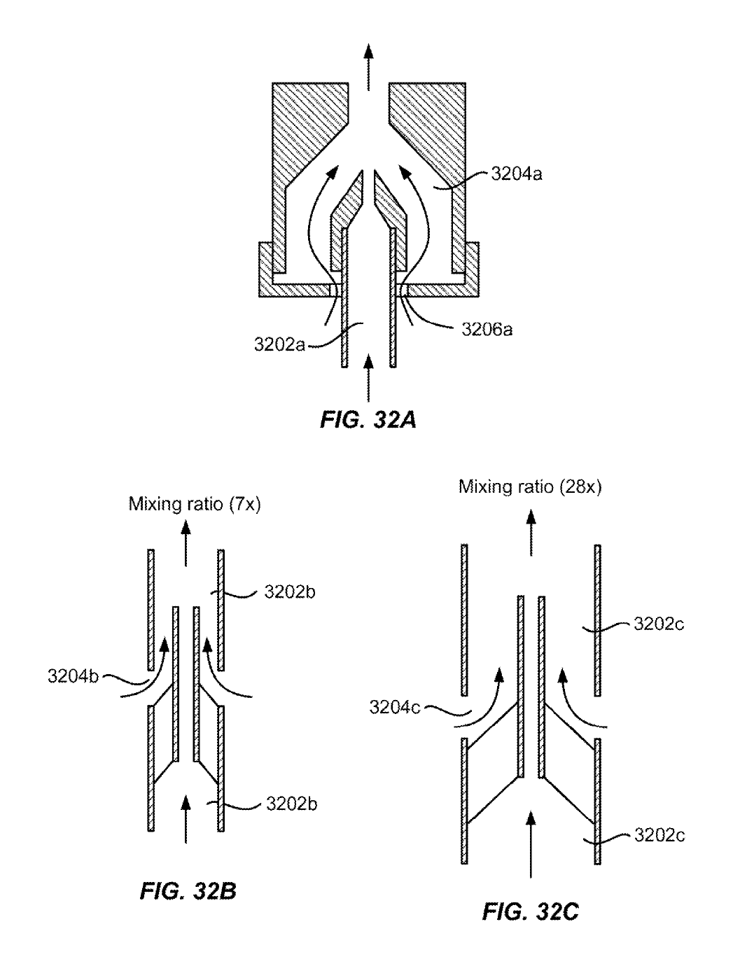

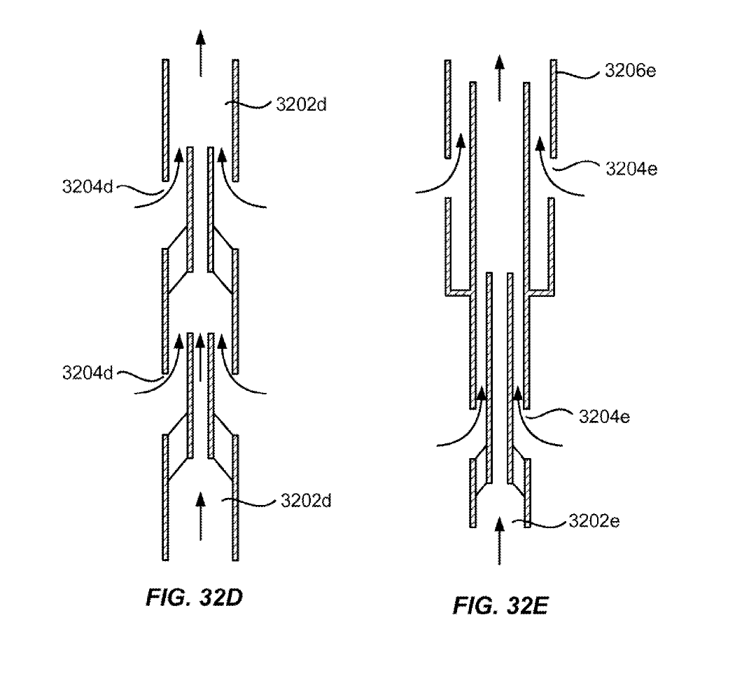

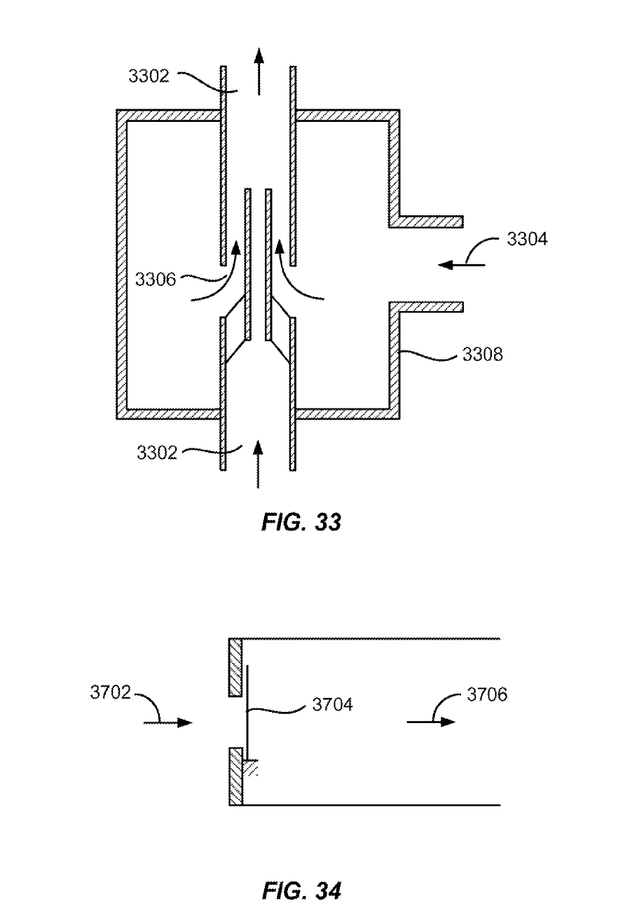

The flow-through passageway can be configured to form a narrow channel between the upstream and downstream openings. The passageway can be further configured to widen downstream of the narrow channel prior to the downstream opening of the passageway. The narrow channel can comprise an inner diameter and an outer diameter (see, e.g., FIGS. 32 and 33).

In some cases, a device for generating a condensation aerosol comprising a primary flow-through passageway as provided herein further comprises a secondary flow-through passageway. The secondary flow-through passageway can be in fluid communication with the primary flow through passageway. The secondary flow-through passageway can comprise one or more channels. In some cases, the secondary flow-through channel comprises a first, a second, and a third channel. The first channel can be in fluid communication with a primary flow-through chamber upstream of an aerosol generation chamber as provided herein. The second channel can be in fluid communication with a primary flow through passageway between an aerosol generation chamber as provided herein and a downstream opening of the primary flow through passageway. The third channel can comprise a second inlet for a carrier gas (e.g. air) and can be in fluid communication with the second channel. The secondary flow-through passageway can also comprise an articuable element. The articuable element can be a diaphragm. The articuable element can be further connected to springs. The springs can control the movement of the articuable element. The articuable element can be articulated by changes in pressure within the device. The pressure that articulates the articuable element can be inhalation resistance or vacuum pressure. The inhalation resistance can be a vacuum of about 1 to about 10 inches of H₂O (a range from about 249 Pa to about 2488 Pa). An increase in pressure can compress the springs. Inhalation through a device for generating a condensation aerosol as provided herein can increase the pressure in the device. The articuable element can comprise a protruding member. In some cases, one or more springs are located on a first side of an articuable element, while the protruding member is located on a second side opposite the first side. The protruding member can be configured to enter and block the third channel. A pressure differential between primary and secondary flow-through passageways within the device can cause articulation or movement of the articuable element. The pressure differential can be affected by inhalation through the downstream opening of the primary flow chamber. The pressure differential can be across the first channel of the secondary flow chamber. Under conditions of low pressure or inhalation resistance, the articuable element can block the third channel, thereby preventing entry of the carrier gas (e.g. air). Under conditions of increased pressure or inhalation resistance, the articuable element can be articulated or removed from blocking the third channel, thereby allowing the carrier gas to enter the device. In some cases, inhalation through the downstream opening of the primary flow-through passageway serves to articulate the articuable element, whereby the articulation serves to open the third channel, wherein the opening permits the carrier gas (e.g. air) to flow through the third channel of the secondary flow-through passageway and enter the primary flow through passageway through the second channel in the secondary flow-through passageway, thereby entraining the condensation aerosol in the carrier gas from the secondary flow-through passageway. Additional carrier gas entering the primary flow-through passageway through the secondary flow-through passageway as described herein can entrain the condensation aerosol in the carrier gas (e.g. air) to produce a total flow rate of about 20 to about 80 LPM (a range from about 3×10⁻⁴ m³/s to about 1.3×10⁻³ m³/s). The device can have an interior air resistance (to inhalation) no greater than that of a cigarette. The device can have an interior air resistance (to inhalation) of about 0.05 to about 0.15 (cm H₂O)^{1/2}/LPM.

A device for generating condensation aerosols comprising a primary flow-through passageway as provided herein can further comprise one or more additional sources of carrier gas, wherein the additional sources permit the flow of carrier gas to enter the device in addition to the carrier gas flowing through the primary flow-through passageway. The one or more additional sources can be inlets or channels. The one or more additional sources can be bypass inlets or bypass channels, wherein carrier gas entering a device through the bypass inlets or channels is bypass carrier gas. The bypass carrier gas can be air. The one or more sources can be within one or more walls of the primary flow-through passageway. The one or more sources can be components of a secondary flow-through passageway as provided herein, wherein the secondary flow-through passageway can be in fluid communication with the primary flow-through passageway. The one or more sources can be within one or more walls of the secondary flow-through passageway. The one or more sources can be within one or more walls of a housing, wherein the housing surrounds or encompasses the primary flow-through passageway. The one or more sources can be flow regulators. The carrier gas entering the device through the one or more sources can be the same type or a different type of carrier gas as that flowing through a primary flow-through passageway. In some cases, the carrier gas entering through the one or more sources can be air. In some cases, the one or more sources permit flow of carrier gas to enter the device downstream of a heater element or aerosol generation chamber or area as provided herein. The flow of carrier gas entering the device through the one or more sources can mix with the carrier gas flowing through a primary flow through passageway. The mixing can be downstream of a heater element or aerosol generation chamber as provided herein but before a downstream opening or outlet of a primary passageway comprising the heater element or aerosol generation chamber. The mixing of the carrier gases can produce a total flow rate exiting the device that can be similar to normal breathing of a subject. The total flow rate can be about 20 to about 80 LPM (a range from about 3×10⁻⁴ m³/s to about 1.3×10⁻³ m³/s). The subject can be a human. The subject can be a human who smokes and/or uses tobacco or nicotine containing products.

FIG. 21 illustrates an embodiment of an electronic agent (e.g., nicotine) delivery device comprising a valve system (2100) for controlling air flow for deep lung delivery and rapid PK. Upon inhalation, negative pressure in a mouthpiece (2102) increases causing a pressure drop across a gas control valve (2104). An increase in the pressure drop can cause the valve (2104) to close and prevent airflow (2106) into an aerosol generating area (2108) within a flow through chamber (2110). The aerosol generating area (2108) can comprise an agent (e.g., nicotine) reservoir comprising an agent (e.g., nicotine) formulation, any of the dosing mechanisms described herein, and a heater for vaporizing an agent (e.g., nicotine) droplets that can be released from the dosing mechanism. Closing of the valve (2104) can subsequently cause an increase in airflow (2106) from an air inlet (2112) across a backflow valve (2114) through a diversion air orifice (2116) and into a diversion air channel (2118). In this manner, the airflow over a vaporizing agent (e.g., nicotine) formulation can be regulated and controlled to an optimal level in order to achieve optimum particle sizing and dosing effectiveness. In one embodiment, the valve system produces an inhalation resistance no greater than that of a cigarette. In one embodiment, the valve system produces an inhalation resistance no greater than 0.08 (cm H₂O)^{1/2}/LPM.

FIG. 32 A-E illustrates multiple embodiments of a device for regulating the flow of a carrier gas (e.g. air). In each embodiment, the device comprises a primary flow-through passageway (3202A-E) and one or more sources of bypass or additional carrier gas (3204A-E). In each embodiment, the one or more sources of bypass or additional carrier gas (3204A-E) permit an additional or bypass flow of carrier gas (e.g. air) to mix with the carrier gas flowing through the primary flow-through passageway (3202A-E). In some cases, the mixing occurs downstream of an aerosol generation chamber, thereby mixing a condensation aerosol produced in the aerosol generation chamber with a larger volume of carrier gas (e.g. air). The mixing can produce a total flow rate downstream of the mixing of about 20 to about 80 liters per minute (LPM) (a range from about 3×10⁻⁴ m³/s to about 1.3×10⁻³ m³/s). FIG. 32A shows a device comprising a primary flow-through passageway (3202a) comprising an upstream and downstream section comprising an inner diameter of 0.25 inches (about 6.35 mm), and two secondary flow-through chambers (3204a), wherein bypass or additional carrier gas enters the device through two inlets (3206a) adjacent to the primary flow-through chamber (3202a). The inner diameter of the primary flow through chamber (3202a) narrows just prior to entry of the bypass carrier gas. In some cases, the narrowing of the primary flow-through passageway permits formation of condensation aerosol particles comprising particles with an MMAD of about 1 to about 5 uM. The device in FIG. 32A can permit the mixing of the bypass carrier gas with the carrier gas flow through the primary chamber at a ratio of 10:1.

FIG. 32B shows a device comprising a primary flow-through passageway (3202b) comprising an upstream and downstream section comprising an inner diameter of 0.25 inches (about 6.35 mm), and two inlets (3204b) within the wall of the primary flow-through chamber (3202b), wherein bypass or additional carrier gas enters the device. The primary flow through chamber (3202b) narrows just prior to entry of the bypass carrier gas to comprise an inner diameter of 0.084 inches (about 2.13 mm) and an outer diameter of 0.108 inches (about 2.74 mm). In some cases, the narrowing of the primary flow-through passageway (3202b) permits formation of condensation aerosol particles comprising particles with an MMAD of about 1 to about 5 μm. The device in FIG. 32B can permit the mixing of the bypass carrier gas with the carrier gas flow through the primary chamber at a ratio of 7:1.

FIG. 32C shows a device comprising a primary flow-through passageway (3202c) comprising an upstream and downstream section comprising an inner diameter of 0.5 inches (about 12.7 mm), and two inlets (3204c) within the wall of the primary flow-through chamber (3202c), wherein bypass or additional carrier gas enters the device. The primary flow through chamber (3202c) narrows just prior to entry of the bypass carrier gas to comprise an inner diameter of 0.084 inches (about 2.13 mm) and an outer diameter of 0.108 inches (about 2.74 mm). In some cases, the narrowing of the primary flow-through passageway (3202c) permits formation of condensation aerosol particles comprising particles with an MMAD of about 1 to about 5 μm. The device in FIG. 32C can permit the mixing of the bypass carrier gas with the carrier gas flow through the primary chamber at a ratio of 28:1.

FIG. 32D shows a device comprising a primary flow-through passageway (3202d) comprising an upstream and downstream section comprising an inner diameter of 0.25 inches (about 6.35 mm), and two sets of two inlets (3204d) adjacent to the primary flow-through chamber (3202d), wherein bypass or additional carrier gas enters the device. The flow through chamber narrows just prior to entry of the bypass carrier gas from each set of two inlets to comprise an inner diameter of 0.096 inches (about 2.44 mm) and an outer diameter of 0.125 inches (about 3.175 mm). Following the first set of two inlets, the primary flow through passageway widens to an inner diameter of 0.250 inches (about 6.35 mm), before narrowing again. In some cases, the narrowing of the primary flow-through passageway permits formation of condensation aerosol particles comprising particles with an MMAD of about 1 to about 5 μm. The device in FIG. 32D can permit the mixing of the bypass carrier gas with the carrier gas flow through the primary chamber at a ratio of 35:1.

The device in FIG. 32E is similar to the device in FIG. 32D, wherein FIG. 32E shows a device comprising a primary flow-through passageway (3202e) comprising an upstream and downstream section comprising an inner diameter of 0.250 inches (about 6.35 mm), and two sets of two inlets (3204e) adjacent to the primary flow-through chamber (3202e), wherein bypass or additional carrier gas enters the device. The primary flow through chamber (3202e) narrows just prior to entry of the bypass carrier gas from the first set of two inlets to comprise an inner diameter of 0.096 inches (about 2.44 mm) and an outer diameter of 0.125 inches (about 3.175 mm). Following the first set of two inlets, the primary flow through passageway (3202e) widens to an inner diameter of 0.250 inches (about 6.35 mm) and an out diameter of 0.280 inches (about 7.112 mm). Subsequently, the primary flow-through passageway (3202e) opens into a secondary housing (3206e), which has an inner diameter of 0.466 inches (about 11.8 mm). In FIG. 32E, the second pair of inlets (3204e) are located in the wall of a secondary housing (3206e), which is coupled to and encompasses the primary flow-through passageway.

FIG. 33 illustrates another embodiment of a device for regulating the flow of a carrier gas (e.g. air). FIG. 33 shows a device comprising a primary flow-through passageway (3302) comprising an upstream and downstream section comprising an inner diameter of 0.25 inches (about 6.35 mm), and two inlets (3306) within the wall of the primary flow-through chamber (3302), wherein bypass or additional carrier gas enters the device. The primary flow-through chamber narrows (3302) just prior to entry of the bypass carrier gas to comprise an inner diameter of 0.086 inches (about 2.18 mm) and an outer diameter of 0.106 inches (about 2.69 mm). As depicted in FIG. 33, the section of the primary flow-through chamber (3302) is coupled to and encased by a secondary housing (3308). The secondary housing comprises a bypass inlet (3304), which permits entry of bypass or additional carrier gas (e.g. air) to enter the primary flow-through passageway through the inlets (3306). In some cases, the narrowing of the primary flow-through passageway permits formation of condensation aerosol particles comprising particles with an MMAD of about 1 to about 5 μm.

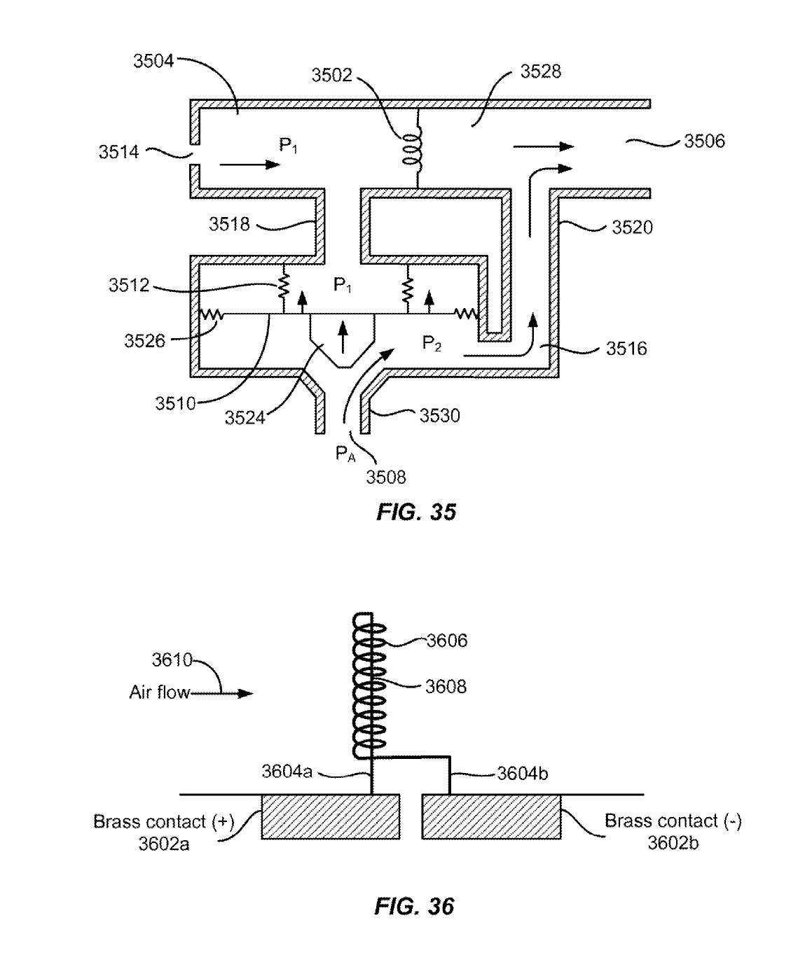

FIG. 35 illustrates another embodiment a device for regulating the flow of a carrier gas (e.g. air). The device comprises a primary airway (3504) that comprises an aerosol generation chamber (3528) comprising a heater element (3502), a restrictive orifice (3514) and a mouthpiece (3506). The heater element (3502) comprises a coil. The heater element can be any heater element comprising a coil as provided herein. The primary airway (3504) is fluidically connected to a secondary airway (3516), through a first channel (3518) located (disposed) between the restrictive orifice (3514) and heater element (3502), and a second channel (3520) located (disposed) between the heater element (3502) and the mouthpiece (3506). The secondary airway (3516) further comprises a third channel (3530) that is a secondary inlet (3508) for a carrier gas (e.g. air) and a diaphragm (3510). The diaphragm (3510) comprises a base member that is connected to a pair of springs (3512) on a first side and a protruding member (3524) on a second side. The springs (3512) are additionally connected to a wall opposite the first side of the base member that is part of the housing of the secondary airway (3516). The base member of the diaphragm (3510) is also connected to a pair of lateral springs (3526) on its lateral edges, which are further connected to the walls of the housing of the secondary airway (3516) opposite the lateral edges of the base member. The restrictive orifice (3514) is configured to limit the flow rate of the carrier gas (e.g. air) through the aerosol generation chamber (3528) in order to allow for the condensation of a liquid formulation comprising a pharmaceutically active agent as provided herein vaporized by the heater element (3502) to particles comprising about 1 to about 5 um MMAD. The restrictive orifice (3514) limits the flow rate of the carrier gas (i.e. air) about 1 to about 10 liters per minute (LPM) (a range from about 1.667×10⁻⁵ m³/s to about 1.667×10⁻⁴ m³/s) at, e.g., a vacuum of about 1 to about 15 inches of water (a range from about 249 Pa to about 3738 Pa). Inhalation through the mouthpiece (3506) can produce a flow of carrier gas (e.g. air) through the restrictive orifice (3514) that can produce an inhalation resistance. The inhalation resistance produces a pressure differential across the opening of the first channel (3518) connecting the primary airway (3504) with the secondary airway (3516). The inhalation resistance causes the springs (3512) coupled to the first side of the diaphragm (3510) to compress and the lateral springs (3526) coupled to the lateral edges of the diaphragm (3510) to extend, whereby the protruding member of coupled to the second side of the diaphragm (3510) is removed from the third channel (3530) of the secondary airway (3516). Removal of the protruding member (3524) causes an additional flow of carrier gas (e.g. air) to enter the device. The additional flow of carrier gas (e.g. air) then enters the primary airway (3504) downstream of the heater element (3502) and aerosol generation area (3528) through the second channel (3520). The additional flow of carrier gas (e.g. air) can serve to mix or entrain the condensation aerosol comprising particles of about 1 to about 5 μm to produce a total flow rate suitable for delivery of the particles to the deep lung of a user of the device.

A device for producing a condensation aerosol as provided herein can have an interior air resistance (to inhalation) no greater than 0.08 (cm H₂O)^{1/2}/LPM. The device can have an interior air resistance (to inhalation) exactly, about, more than, less than, at least, or at most 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, or 0.25 (cm H₂O)^{1/2}/LPM. The device can comprise a primary flow-through passageway for a carrier gas and one or more sources of additional or bypass carrier gas as provided herein. These flow rates can be at a vacuum of about 1 to about 15 inches of water (a range from about 249 Pa to about 3738 Pa).

The one or more sources of additional or bypass carrier gas (e.g. air) can be configured to limit the flow rate of additional or bypass carrier gas to produce a total flow rate as provided herein. The flow rate can be limited by using a restrictive orifice on the one or more sources of additional or bypass carrier gas (e.g. air). The restrictive orifice can comprise any valve or flap as known in the art. The valve or flap can be moderated at specific flow rates. The flow rates that moderate the valve or flap can be the limited to flow rates provided herein. The valve or flap can be opened at specific inhalation resistance levels. The restrictive orifice can be opened at inhalation resistances comprising a vacuum of about 1 to about 10 inches of water (a range from about 249 Pa to about 2488 Pa).

A device for producing a condensation aerosol as provided herein can be configured to limit the flow rate of a carrier gas across or through a aerosol generation area or heater element as provided herein to a flow rate of exactly, about, more than, less than, at least, or at most 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, or 16 liters per minute (LPM) (a range from about 1.667×10⁻⁵ m³/s to about 2.667×10⁻⁴ m³/s). A device for producing a condensation aerosol as provided herein can be configured to limit the flow rate of a carrier gas across or through a aerosol generation area or heater element to between 1-2, 2-4, 4-6, 6-8, 8-10, 10-12, 12-14, or 14-16 LPM a range from (about 1.667×10⁻⁵ m³/s to about 2.667×10⁻⁴ m³/s). A device for producing a condensation aerosol as provided herein can be configured to limit the flow rate of a carrier gas across or through a aerosol generation area or heater element to about 1 to about 2, about 2 to about 4, about 4 to about 6, about 6 to about 8, about 8 to about 10, about 10 to about 12, about 12 to about 14, or about 14 to about 16 LPM (a range from about 1.667×10⁻⁵ m³/s to about 2.667×10⁻⁴ m³/s). The flow rate can be limited by using a restrictive orifice on the inlet for a carrier gas (e.g. air). The restrictive orifice can comprise any valve or flap (see FIG. 30A or FIG. 34) and as known in the art. The valve or flap can be moderated at specific flow rates. The flow rates that moderate the valve or flap can be the limited flow rates provided herein. The valve or flap can be opened at specific inhalation resistance levels. The restrictive orifice can be opened at inhalation resistances comprising a vacuum of about 1 to about 10 inches of water (a range from about 249 Pa to about 2488 Pa). The restrictive orifice can be configured to limit the flow rates to flow rates as provided herein. The restrictive orifice can be configured into a slot as depicted in FIG. 30B. An aerosol generation area or heater element as provided herein can be within a flow-through passageway. The flow-through passageway can be a primary flow through passageway.

A device for producing a condensation aerosol comprising a primary flow-through passageway and one or more sources of additional or bypass carrier gas (e.g. air) as provided herein can produce a mixing ratio of bypass or additional carrier gas to carrier gas flowing through the primary flow through chamber of 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 31:1, 32:1, 33:1, 34:1, 35:1, 36:1, 37:1, 38:1, 39:1, 40:1, 41:1, 42:1, 43:1, 44:1, 45:1, 46:1, 47:1, 48:1, 49:1, or 50:1. The mixing ratio can be between 1:1 and 5:1, 5:1 and 10:1, 10:1 and 15:1, 15:1 and 20:1; 20:1 and 25:1, 25:1, and 30:1, 30:1, and 35:1, 35:1 and 40:1, 40:1 and 45:1, or 45:1 and 50:1. The mixing ratio can be about 1:1 to about 5:1, about 5:1 to about 10:1, about 10:1 to about 15:1, about 15:1 to about 20:1; about 20:1 to about 25:1, about 25:1 to about 30:1, about 30:1 to about 35:1, about 35:1 to about 40:1, about 40:1 to about 45:1, or about 45:1 to about 50:1.

Agents

Any suitable agent (e.g., drug) can be used in the methods and devices described herein. Agents (e.g., pharmaceutically active agents) that can be used include, for example, drugs of one of the following classes: anesthetics, antibiotic, anticonvulsants, antidepressants, antidiabetic agents, antidotes, antiemetics, antihistamines, anti-infective agents, antineoplastics, antiparkisonian drugs, antirheumatic agents, antipsychotics, anxiolytics, appetite stimulants and suppressants, blood modifiers, cardiovascular agents, central nervous system stimulants, drugs for Alzheimer's disease management, a cold medication, COPD (chronic obstructive pulmonary disease) drug, cough medication, drugs for cystic fibrosis management, diagnostics, dietary supplements, drugs for erectile dysfunction, gastrointestinal agents, hormones, drugs for the treatment of alcoholism, drugs for the treatment of addiction, immunosuppressives, mast cell stabilizers, migraine preparations, motion sickness products, drugs for multiple sclerosis management, muscle relaxants, drugs for treating myocardial infarction, nonsteroidal anti-inflammatories, opioids, other analgesics and stimulants, opthalmic preparations, osteoporosis preparations, pain medication, panic medication, prostaglandins, respiratory agents, sedatives and hypnotics, skin and mucous membrane agents, Tourette's syndrome agents, urinary tract agents, insomnia medication, weight loss drug, and vertigo agents. In some cases, an agent is an herb, supplement, or vitamin.

Formulations

Any agent as provided herein for use in the methods and devices described herein can be in a formulation comprising one or more additional substances as provided herein. In some cases, the formulation comprising an agent (e.g., nicotine) and one or more additional substances is a liquid formulation. In some cases, the formulation is liquid at room temperature. In some cases, the liquid formulation is contained in a reservoir as provided herein in a device as provided herein and is liquid at an operating temperature of the device. The operating temperature of any of the devices as described herein can be at, below, or above room temperature. In some cases, the liquid formulation comprising a pharmaceutically active agent (e.g., nicotine) as provided herein is delivered as a liquid to a heater element as provided herein in a device as provided herein when a user inhales from the outlet or mouthpiece of the device. In some cases, the liquid formulation is not a viscous liquid. In some cases, the liquid formulation is not gel-like or a gel. In some cases, a liquid formulation comprising a pharmaceutically active agent (e.g., nicotine) as provided herein is not coated as a solid or film of any thickness onto a heater element as provided herein. In some cases, a liquid formulation comprising nicotine for use in the methods and devices described herein is not admixed with thickening agents and thereby has a viscosity that is reduced or is less than a liquid formulation comprising nicotine that has been admixed with a thickening agent. In some cases, a liquid formulation for use in the methods and devices as provided herein is not applied to or coated on a heater element as provided herein prior to use of the device by a user or subject as provided herein. In some cases, the liquid formulation comprising a pharmaceutically active agent is delivered as a liquid to a heater element in a device as provided herein only upon use of the device. Use of the device can be a user as provided herein inhaling or drawings on an outlet or mouthpiece on a device as provided herein. In some cases, inhalation on the outlet or mouthpiece draws carrier gas (e.g., air) into the device through an inlet on the device as provided herein, wherein the flow of the carrier gas (e.g., air) through the inlet triggers delivery of a liquid formulation comprising a pharmaceutically active agent (e.g., nicotine) by any of the means provided herein to a heater element contained within the device. The device can comprise one or more inlets as provided herein, wherein inhalation on an outlet draws carrier gas (e.g., air) through the one or more inlets simultaneously.

In some cases, one or more carriers or excipients is added to a liquid formulation to change a property of the formulation. One or more carriers can be used to change the density, compressibility, specific weight, viscosity, surface tension, or vapor pressure of a liquid formulation.

In some cases, the use of any of the devices for generating a condensation aerosol comprising a pharmaceutically active agent (e.g., nicotine) as provided herein by a subject does not adversely affect functioning of the subject's bodily systems and/or organs. The bodily system can be the cardiovascular system and/or pulmonary system. The bodily organs can be the heart and/or lungs. In some cases, a subject using a device as provided herein has a substantially similar heart rate and pulse following use of the device as compared to a baseline. The baseline can be the subject's heart rate or pulse prior to using the device. In some cases, a subject using a device as provided herein has substantially similar lung function following use of the device as compared to a baseline. The baseline can be the subject's lung function prior to using the device. Lung function can be assessed by recording or measuring a subject's forced vital capacity (FVC) and/or the forced expiratory volume (FEV1), or calculating the ratio of FEV1/FVC. FEV1 is the volume of air that can forcibly be blown out in one second after full inspiration, while FVC is the maximum amount of air a person can expel from the lungs after a maximum inhalation. FVC is equal to the sum of inspiratory reserve volume, tidal volume, and expiratory reserve volume. For a healthy adult, the ratio of FEV1/FVC is approximately 75-80%.

### III. eHealth Tools

### Overview

Provided herein are eHealth tools which can include mobile devices, web-based devices, computer readable medium, and an eHealth-enabled electronic agent (e.g., nicotine) delivery platform. The eHealth tools can also be referred to as mobile Health tools or mHealth tools. In some cases, an eHealth-enabled electronic nicotine delivery platform can help a smoker transition to clean nicotine delivery by delivering a pre-determined nicotine dose with a pre-determined nicotine particle size at a pre-determined time for an individual user of a device. The eHealth-enabled electronic nicotine delivery platform can provide nicotine to an individual user on a particular schedule, which may involve varying the number of doses per day, timing of doses within the day, or amount of nicotine per dose over time. In one embodiment, the eHealth-enabled electronic nicotine delivery platform is used to achieve a reduction in an urge or desire of a subject to smoke a tobacco based smoking article. In another embodiment, the eHealth tools can help to ensure user safety when administering doses of nicotine from an electronic nicotine delivery device, so as to prevent overdose. In some cases, any of the devices provided herein are Bluetooth enabled. Bluetooth enabled devices as provided herein can be used to track usage of the device by a user. The mHealth tools can be used to aid or help a user transition from combustibles (e.g., tobacco cigarettes or cigars). Any of the devices as provided herein can be adapted or configured to leverage mobile technology, mHealth or eHealth tools as provided herein.

The methods can be applied to a variety of types of classifications of users of combustible tobacco products, including a new smoker, a trough maintainer smoker, an intermittent smoker, a light smoker, a weight-loss smoker, a heavy smoker, or a very heavy smoker. An intermittent smoker can be an individual who does not smoke every day. A light smoker can be an individual who smokes 1 to 9 cigarettes per day. A moderate smoker can be an individual who smokes 10 to 19 cigarettes a day. A heavy smoker can be an individual who smokes 20 to 29 cigarettes per day. A very heavy smoker can be an individual who smokes 30 or more cigarettes per day.

Provided herein is a method for managing treatment of a condition. The method can comprise providing a device for generating a condensation aerosol comprising a pharmaceutically active agent. The pharmaceutically active agent can be an agent as provided herein. In some cases, the condition is smoking or nicotine addiction. In some cases, the pharmaceutically active agent is nicotine. The device for generating the condensation aerosol can be device as provided herein. The device can comprise a heater element. The heater element can be any heater element as provided herein. The heater element can vaporize a composition comprising the pharmaceutically active agent. In some cases, the formulation is a liquid formulation. The heater element can be in fluid communication with a source of the formulation. The source of the formulation can be a reservoir. The heater element can be in fluid communication with a passageway configured for permitting the condensation of the vaporized formulation to produce particles comprising a size effective for deep lung delivery. The size of the particles can have an MMAD of about 1 to about 5 um. The device can further comprise a programmable controller, wherein the programmable controller comprises a non-transitory computer readable medium comprising one or more algorithms, and an interface for communicating with the programmable controller, wherein the interface is capable of receiving information from and/or transmitting information to a source. The source can be a user of the device, a healthcare provider and/or a counselor. The methods provided herein can include inputting, receiving and/or recording data on the device; analyzing the data; and regulating a dosage, frequency of administration and/or delivery schedule of the condensed formulation comprising the pharmaceutically active agent based on the analysis of the data by the one or more algorithms. The method as provided herein can also comprise adjusting the dosage, frequency of administration and/or delivery schedule of the condensed formulation comprising the pharmaceutically active agent based on the information received from the source. The inputting, analysis, regulating, and, optionally, adjusting can be repeated in order to manage treatment of the condition. Prior to a user engaging in a method or using a device as provided herein for a first time, the dosage, frequency of administration and/or delivery schedule of the condensed formulation comprising the pharmaceutically active agent can be pre-set by a source. The analysis of the data can be performed by the one or more algorithms. The regulation the dosage, frequency of administration and/or delivery schedule of agent as provided herein can be based on an analysis of the data by the one or more algorithms.

Provided herein are methods and devices for reducing an amount or level of a toxic agent in an aerosol produced by a device as provided herein. The aerosol can be a condensation aerosol. The method can comprise providing to a subject any device for generating a condensation aerosol comprising nicotine as provided herein, wherein the subject inhales the condensation aerosol comprising nicotine as generated by the device, wherein the condensation aerosol comprising nicotine from the device comprises a reduced or substantially reduced level of a toxic agent, thereby exposing the subject to the reduced or substantially reduced level of the toxic agent. The toxic agent or toxin can be any toxin or toxic agent associated with smoking or using a tobacco cigarette or commonly known e-cigarette as known in the art. In some cases, the toxic agent is formaldehyde. The device can comprise a controller. The controller can be programmable. In some cases, the condensation aerosol comprising nicotine has a diameter of from about 1 to about 5 μm. In some cases, the condensation aerosol has a diameter of from about 1 to about 3 μm. In some cases, the diameter is a mass median aerodynamic diameter (MMAD). In some cases, the diameter is a volume median diameter (VMD). The subject can be a smoker. The smoker can be a new smoker, a trough maintainer smoker, an intermittent smoker, a light smoker, a weight-loss smoker, a heavy smoker, or a very heavy smoker. An intermittent smoker can be an individual who does not smoke every day. A light smoker can be an individual who smokes 1 to 9 cigarettes per day. A moderate smoker can be an individual who smokes 10 to 19 cigarettes a day. A heavy smoker can be an individual who smokes 20 to 29 cigarettes per day. Any of the devices provided herein can use up to 40-70% less nicotine than cigarettes or existing e-cigarettes.

Visible Vapor

Provided herein is a method for reducing an amount of an exhaled vapor in a user of a cigarette or electronic cigarette. The vapor can be a visible vapor. The visible vapor can be an inhaled visible vapor and/or exhaled visible vapor. The exhaled visible vapor can be referred to as a second-hand vapor. The method comprises providing a user with any of the electronic agent (e.g., nicotine) delivery devices as provided herein, the user inhaling a condensation aerosol comprising a pharmaceutically active agent (e.g., nicotine) from the device, and the user exhaling, wherein the exhaling by the user produces a substantially reduced level of vapor. In some cases, the vapor is a visible vapor. In some cases, an electronic agent (e.g., nicotine) delivery devices as provided herein emits no visible vapor. In some cases, an electronic agent (e.g., nicotine) delivery devices as provided herein emits substantially no visible vapor. The visible vapor can be an inhaled and/or exhaled vapor. In some cases, use of (e.g., inhalation from) any device as provided herein by a user produces no or substantially no exhaled visible vapor by the user. The reduction in an exhaled visible vapor from a subject following use of an electronic agent (e.g., nicotine) delivery device as provided herein can be at least or about 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% of the exhaled visible vapor (e.g., second hand smoke or vapor) produced by a subject following use of or smoking a cigarette or use of, smoking, or vaping from an electronic cigarette. The reduction in the exhaled visible vapor in a subject following use of a device as provided herein can be 50%-60%, 60%-70%, 70%-80%, 80%-90%, or 90%-100% of the exhaled visible vapor (e.g., second hand smoke or vapor) produced from a subject smoking a cigarette or using smoking, or vaping from an electronic cigarette. The reduction in the exhaled visible vapor in a subject following use of a device as provided herein can be about 1% to about 10%, about 10% to about 20%, about 20% to about 30%, about 30% to about 40%, about 40% to about 50%, about 50% to about 60%, about 60% to about 70%, about 70% to about 80%, about 80% to about 90%, or about 90% to about 100% of the exhaled visible vapor (e.g., second hand smoke or vapor) produced from a subject smoking a cigarette or using smoking, or vaping from an electronic cigarette. The electronic cigarette can be any commercial, conventional, or existing electronic cigarette known in the art (e.g., NJOY® King Bold, Finiti brand e-cig.). The electronic cigarette can be an electronic cigarette comprising a 4.5% nicotine solution. In some embodiments, an electronic agent (e.g., nicotine) delivery device as provided herein produces no or a substantially reduced amount of an exhaled visible vapor from a subject using said device.

An eHealth tool can be a healthcare practice supported by electronic processes and/or communication. In some cases, eHealth tools comprise healthcare practice using the Internet. The eHealth tools can be formatted for use by different types of smokers, including a new smoker, a weight loss smoker, a trough maintainer, a light smoker, a heavy smoker, or a very heavy smoker. The eHealth tools can be formatted for use by different types of patients who may be using nicotine to enhance their cognition or otherwise improve other symptoms of their illness (ulcerative colitis). In some cases the eHealth tools can communicate with a device described herein (e.g., through Bluetooth or infrared connectivity), or eHealth tools can be incorporated into a device described herein.

The eHealth tools provided herein include mechanisms for tracking use of a device. For example, the frequency of use of a device can be tracked. Also, provided herein are algorithms for analyzing the use of a device. The algorithms can be used to generate goals for a user of the device. In some cases, the algorithms can suggest a recommended dose of an agent (e.g., nicotine) for a user. The algorithms can suggest an agent (e.g., nicotine) delivery schedule for a user. Algorithms provided herein can change over time based on input from a device or feedback from the user over time. An eHealth nicotine delivery platform described herein can track use of a nicotine delivery device, assess the user in terms of their subjective nicotine craving, mood, or other psychological or behavioral parameters, and adjust nicotine delivery to accomplish desired effects. Smoking behavior can be tracked, as can other symptoms of a disease where nicotine is being used either as a treatment or to enhance deficiencies in cognition associated with a specific illness.

A smoking pattern of a user can be monitored, or use of a device described herein can be monitored. For example, tools provided herein can be used to determine if smoking or use of a device provided herein was used to satisfy a morning craving, determine if smoking occurred, or a device was used, while a subject was bored, drinking, under stress. Tools can be used to assess whether a subject smoked or used a device described herein alone or in the presence of others (e.g., friends), or whether the dose of nicotine administered was successful in enhancing cognition or improving another target medical or psychiatric symptom.

One or more algorithms can be used to devise a plan (e.g., nicotine dose, nicotine delivery schedule) for a user. In some cases, web-based tools can be used to transition a smoker to use of an electronic nicotine delivery device described herein along with customized behavioral input.

In some cases, the eHealth tools are web-based tools. The web-based tools can enable an appropriate dosing of nicotine for a user of a device described herein. In some cases, the web-based tools can track experiences of a user. In some cases, a web-based tool can track success in making a transition from smoking tobacco cigarettes. Web-based tools described herein can track health benefits derived from using devices described herein. Such tracking can enable generation of rewards (e.g., decreased health premiums). Web-based tools can enable development of constantly-improving use algorithms by obtaining use profiles from a multitude of users in the field, and can provide feedback to users. In some cases, web-based tools described herein can leverage social media to produce ideal health outcomes. The social media can be a social networking site (e.g., Facebook, Google+, MySpace, Bebo), blog or microblog (e.g., Twitter), a content community (e.g., YouTube), a virtual social world (e.g., Second Life), a virtual game world (e.g., World of Warcraft), or a collaborative project (e.g., Wikipedia). Social media can include technologies such as a blog, picture-sharing, vlog, wall-posting, email, instant messaging, music-sharing, crowdsourcing, voice over IP, Internet forums, weblog, social blog, microblog, wiki, podcast, and social bookmarking. The customized feedback can also be specific for users suffering from a medical or psychiatric disorder. For example, nicotine has been shown to have beneficial effects on cognition among patients with schizophrenia. The device could be used to deliver nicotine and also provide therapeutic input to patients to help them manage their nicotine intake in such a way as to provide maximum therapeutic advantage to their cognition or psychiatric symptom control. Other disorders where nicotine has been shown to have beneficial effects on cognition include Parkinson's disease, attention deficient disorder, mild cognitive impairment, and Alzheimer's disease.

In some cases, an eHealth tool is a mobile device. In some cases, the mobile device is an electronic nicotine delivery device. The mobile device can ensure dosing occurs at an appropriate time. The mobile device can comprise on-board tracking of dosing, can provide reminders to a subject, and can provide nicotine craving assessments. Also, a mobile device can comprise complementary advertising opportunities.

The devices provided herein can comprise electronics that control for variability in battery condition and ensure consistent heating.

Identifying Individualized User Goals

eHealth tools can include Web based and mobile tools. For example, for web-based tools, self-report measures can be used to help a smoker or new user of a device provided herein identify a target goal based on their degree of nicotine dependency, health status, health goals, economic goals (i.e., decrease the amount of money spent on cigarettes), target body weight or change in body weight, or other factors.

When a mobile device is used, smoking patterns can be tracked prior to the transition to an electronic nicotine delivery platform, which can enable a real world, ecologically valid assessment of actual behavior to be used as a foundation for a subsequent prescribed pattern of use of an electronic nicotine delivery device.

Algorithm Development

By systematically tracking user characteristics at the outset, tracking their actual use of the electronic nicotine delivery device over time in terms of patterns of dosing, algorithms can be generated that can be used to suggest an optimal pattern of use, dose, pH, particle size, and other characteristics (e.g., flavoring) of the electronic nicotine delivery device to maintain use and minimize smoking urge. These algorithms can be constantly enhanced through additional user experience, adding to the empirical foundation of the algorithms and enabling more robust and finer-grained algorithms to be customized to an individual user's nicotine dependency and health goals.

For a mobile device, data can be captured from individual users in the field and can be sent to a backend web-based central database for algorithm development. The mobile device can also assess the ecological risk factors for relapse and adjust the dose or dose characteristics of nicotine accordingly to help achieve the desired outcome. An initial trial of several different types of dose characteristics may also be helpful in determining the ideal use algorithm.

In a web-based method, data from real world use of the electronic nicotine delivery device can be collected and used to predict outcomes. Users can also pick from one of several established algorithms that they think will best suit their health or other goals. The central database can issue instructions back to the electronic nicotine device, either in the form of explicit compliance reminders to use the device to achieve the optimal nicotine absorption, or implicit dosing instructions to the device to gradually taper the dose (or other characteristics of the nicotine dose, including its concentration, pH, particle size, flavorings, or flow characteristics coming from the device which can affect back of the throat impaction, which in turn can affect subjective sensations associated with the nicotine dose (i.e., tingling or burning in the back of the throat)) over the days or weeks to help achieve various health or nicotine-related goals.

Matching Users to Algorithms

A user's goal when transitioning off of combustible tobacco products may change over time. By carefully matching users to an initial use and dose algorithm, and then monitoring their progress over time, adjustments can be made to ensure the maximal probability of success in their individual goals.

For a mobile device, feedback from the mobile device, both in terms of use patterns as well as real-time self-reports of cravings, and on-going tests of psychological dependency can be used help identify an initial use algorithm, as well as make changes to the use algorithm or switch to a new algorithm entirely.

For a web-based device, as new data is used to refine use algorithms, a web-based backend database can communicate subtle and/or gross changes in prescribed use algorithms to the device to help enhance the probability that a target goal will be achieved. In this way, each user can become part of a community helping to refine his/her own and others optimal algorithms to achieve a variety of goals.

Customized Dose, pH, Particle Size, Etc.

By systematically varying different dose characteristics (e.g., dose, particle size, pH, amount of nicotine in the gas vs. particulate phase, air speed velocity coming out of a nicotine delivery device, flavorings, etc.), a differentially reinforcing subjective reward from the nicotine can be created. The probability that certain goals will be achieved can be maximized by varying dose characteristics of nicotine.

Relying on use algorithms matched to individual users regarding their stated goals, physical or psychological nicotine dependency characteristics, and/or biomarkers, the electronic nicotine delivery device can modify dose characteristics of nicotine. In some cases, the modifications can change in response to environmental triggers (e.g., by altering the mean particle size of the dose to provide an especially reinforcing dose if the subject reports on the electronic nicotine delivery device a strong craving). In some cases, the modifications can change to help the initial transition off of combustible tobacco (e.g., by altering the pH or flavor of the dose to help match previous stimulus characteristics of smoking).

Administering Nicotine Challenge Doses

As part of a behavioral program to achieve certain health or other nicotine-related goals, the electronic nicotine delivery device can administer one or more nicotine challenge doses. These challenge doses may contain no nicotine, less nicotine than previous doses, or doses of nicotine that vary in regards to other important characteristics (e.g., dose, particle size, pH, amount of nicotine in the gas vs. particulate phase, air speed velocity coming out of a nicotine delivery device, flavorings, etc). An electronic nicotine delivery device can then assess self-reported cravings or changes in a pattern of use that suggests increased or decreased nicotine administration. This feedback can then be used as real world data to help maintain or change the use algorithm to increase the probability that the user will achieve certain health or other nicotine-related goals.

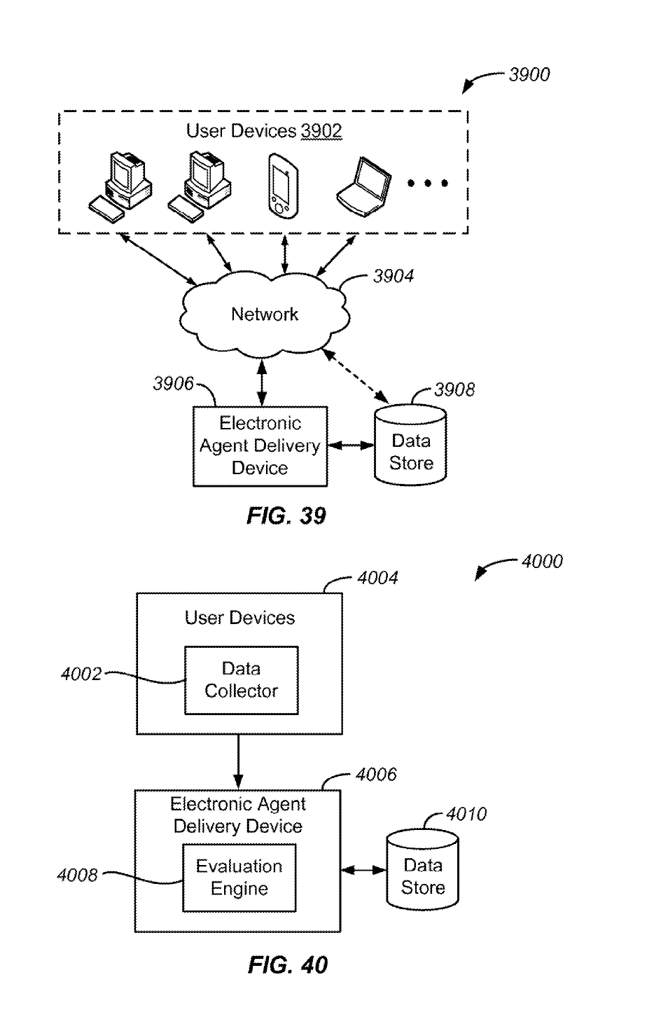

FIG. 39 illustrates an example environment 3900 for implementing devices and methods described herein in accordance with an embodiment. As illustrated, one or more user devices 3902 connect via a network 3904 to an electronic agent (e.g., nicotine) delivery device 3906 as provided herein which can be configured to produce a condensation aerosol comprising a pharmaceutically active agent (e.g., nicotine) as provided herein. The electronic agent (e.g., nicotine) delivery device 3906 can comprise a controller, which can be programmable, as provided herein and the electronic agent (e.g., nicotine) delivery device 3906 can be connected to the network 3904 through the programmable controller. In some cases, the condensation aerosol comprising the pharmaceutically active agent (e.g., nicotine) is produced from a liquid formulation comprising the pharmaceutically active agent (e.g., nicotine) as provided herein. In various embodiments, the user devices 3902 can include any device capable of communicating with the network 3904, such as personal computers, workstations, laptops, smartphones, mobile phones, tablet computing devices, smart TVs, game consoles, internet-connected set up boxes, and the like. In some embodiments, the user devices 3902 can include applications such as web browsers and/or applications (e.g., mobile apps) that are capable of communicating with the electronic agent (e.g., nicotine) delivery device 3906 and/or a system that uses the electronic agent (e.g., nicotine) delivery device 3906. In some cases, the user devices 3902 communicate with the electronic agent (e.g., nicotine) delivery device 3906 via the programmable controller as provided herein. The user can be a patient, and/or a healthcare provider (e.g., physician, physician's assistant, nurse, nurse practioner, pharmacist or other medical professional). In some cases, a first user uses the device, while a second user uses the other user devices 3902. In some cases, a first user uses the device and the other user devices 3902, while the second user also uses the user devices 3902.

In some embodiments, the electronic agent (e.g., nicotine) delivery device 3906 can communicate with a data store 3908 in order perform the functionalities described herein (e.g., track device usage, adjust dose, frequency of administration, delivery schedule, customize feedback, administer challenge doses, etc.). For example, the data store 3908 can be used to store historical (e.g. user use history, dosage history, delivery schedule history, frequency of administration history, etc.), evaluation rules, and the like.

In some embodiments, the data store 3908, or any other data stores discussed herein, can include one or more data files, databases, (e.g., SQL database), data storage devices (e.g., tape, hard disk, solid-state drive), data storage servers, or the like. The data store 3908 can be connected to the electronic agent (e.g., nicotine) delivery device 3906 locally or remotely via a network. In some embodiments, data store 3908, or any other data stores discussed herein, can comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

In various embodiments, the network 3904 can include the Internet, a local area network (“LAN”), a wide area network (“WAN”), a cellular network, wireless network or any other public or private data and/or telecommunication network.

FIG. 40 illustrates example components of an electronic agent (e.g., nicotine) delivery system 4000, in accordance with an embodiment. In this example, the electronic agent (e.g., nicotine) delivery system 4000 includes a data collector 4002 residing on a user or client device 4004. The system further comprises an electronic agent (e.g., nicotine) delivery device 4006, which can be the same as 3906 as depicted in FIG. 39. The electronic agent (e.g., nicotine) delivery device 4006 can comprise a programmable controller, wherein the data collector resides on the programmable controller. The data collector can be implemented as a browser script using JavaScript or any other scripting language. The data collector can be configured to communicate with a web-based backend database. For example, the data collector can be configured to collect parameter information about the electronic agent (e.g., nicotine) delivery device 4006 such as discussed herein and transmit such parameter information to the web-based backend database, for example, using an application programming interface (API) provided by the user device 4004. In some embodiments, the collection and/or communication with the user device 4004 can be triggered by an event on the electronic agent (e.g., nicotine) delivery device 4006. For example, the event can include a click on a portion (e.g., a button or a link) of a user display on the electronic agent (e.g., nicotine) delivery device 4006, use of the delivery device by a user or patient, and the like. The user display can be on the programmable controller as provided herein.

In some embodiments, the electronic agent (e.g., nicotine) delivery device 4006 can be configured to receive parameter information (e.g., dosage, frequency of administration, dosing schedule, etc.) provided by the data collector of the user device and to compare and/or analyze the parameter information received from the data collector of the user device to the parameter information from use of the electronic agent (e.g., nicotine) delivery device 4006. To that end, the electronic agent (e.g., nicotine) delivery device 4006 can utilize an evaluation engine 4008. The evaluation engine 4008 can be configured to analyze the parameter information in order to customize or adjust output parameters of the electronic agent (e.g., nicotine) delivery device 4006. In some embodiments, the evaluation engine 4008 can be implemented using one or more server-side library files. In some embodiments, the evaluation engine 4008 can be implemented using one or more algorithms as provided herein for analyzing the respective parameter.

In some embodiments, customized feedback or a treatment regimen (e.g., agent dosage, frequency of administration and/or delivery schedule) can be evaluated based on some or all of the parameters as provided herein. For example, a lookup table (e.g., stored in memory) can be used to determine the weight values associated with some or all of the parameters. The weight values may or may not be further weighted, combined or otherwise processed to derive a final customized feedback or treatment regimen. In some embodiments, the lookup table and the one or more algorithms for deriving the customized feedback or treatment regimen can be included on one or more rules that are pre-determined based on historical data such as past usage and/or user activities. In some embodiments, analysis of parameter information and/or generation of customized feedback or treatment regimen can be performed in real time or nearly real time with respect to the receipt of the parameter information. In other embodiments, any or all of the above operations may be performed in an asynchronous mode, for example, using batch processing.

In some embodiments, the generated feedback and/or treatment regimen can be stored in a data store 4010. In some embodiments, the data store 4010 can include a memory of a server, one or more data storage device (e.g., SSD, hard disk, taps), or a cloud-based storage service such as discussed in connection with FIG. 39. The data store 4010 may or may not be owned and/or operated by the same as the provider of the electronic agent (e.g., nicotine) delivery device 4006.

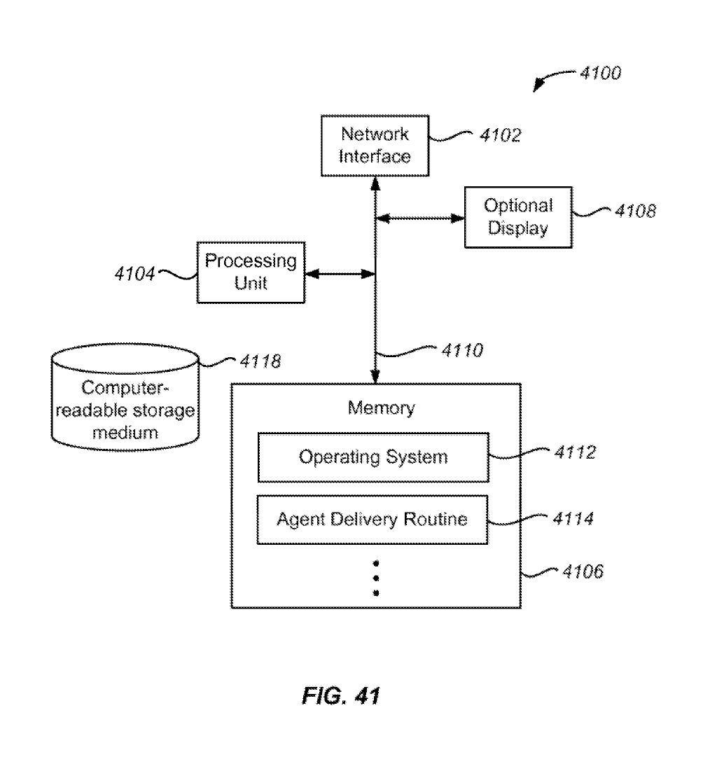

FIG. 41 illustrates example components of a computer device 4100 for implementing aspects of devices and methods described herein, in accordance with an embodiment. In another embodiment, the computer device 4100 may be configured to implement a user device such as a user device 3902 discussed in connection with FIG. 39 and/or components or aspects of the electronic agent (e.g., nicotine) delivery device 3906 such as described in connection with FIGS. 39 and 40. In some embodiments, computing device 4100 can include many more components than those shown in FIG. 41. However, it is not necessary that all of these components be shown in order to disclose an illustrative embodiment.

As shown in FIG. 41, computing device 4100 includes a network interface 4102 for connecting to a network such as discussed above. In some cases, the computing device 4100 is housed on a programmable controller on an electronic agent (e.g., nicotine) delivery device as provided herein. In various embodiments, the computing device 4100 may include one or more network interfaces 4102 for communicating with one or more types of networks such as the Internet, wireless networks, cellular networks, and any other network.

In an embodiment, computing device 4100 also includes one or more processing units 4104, a memory 4106, and an optional display or user interface as provided herein 4108, all interconnected along with the network interface 4102 via a bus 4110. The processing unit(s) 4104 can be capable of executing one or more methods or routines stored in the memory 4106. The display 4108 can be configured to provide a graphical user interface to a user operating the computing device 4100 for receiving user input, displaying output, and/or executing applications. In some cases, such as when the computing device 4100 is a server, the display 4108 may be optional.

The memory 4106 can generally comprise a random access memory (“RAM”), a read only memory (“ROM”), and/or a permanent mass storage device, such as a disk drive. The memory 4106 may store program code for an operating system 4112, one or more agent (e.g., nicotine) delivery routines 4114, and other routines. In various embodiments, the program code can be stored on a computer-readable storage medium, for example, in the form of a computer program comprising a plurality of instructions executable by one or more processors. The computer-readable storage medium can be non-transitory. The one or more agent (e.g., nicotine) delivery routines 4114, when executed, can provide various functionalities associated with the electronic agent (e.g., nicotine) delivery device as described herein.

In some embodiments, the software components discussed above can be loaded into memory 4106 using a drive mechanism associated with a non-transient computer readable storage medium 4118, such as a floppy disc, tape, DVD/CD-ROM drive, memory card, USB flash drive, solid state drive (SSD) or the like. In other embodiments, the software components can alternatively be loaded via the network interface 4102, rather than via a non-transient computer readable storage medium 4118. In an embodiment, the computing device 4100 can also include an optional time keeping device (not shown) for keeping track of the timing of usage of the electronic agent (e.g., nicotine) delivery device.

In some embodiments, the computing device 4100 also communicates via bus 4110 with one or more local or remote databases or data stores such as an online data storage system via the bus 4110 or the network interface 4102. The bus 4110 can comprise a storage area network (“SAN”), a high-speed serial bus, and/or via other suitable communication technology. In some embodiments, such databases or data stores may be integrated as part of the computing device 4100.

### EXAMPLES

### Example 1: Effect of Changes in Air Flow Rate, Electrical Current, Duration of Heating, and Thickness of Heater Element on Particle Size of a Aerosol Generated from a Propylene Glycol Formulation

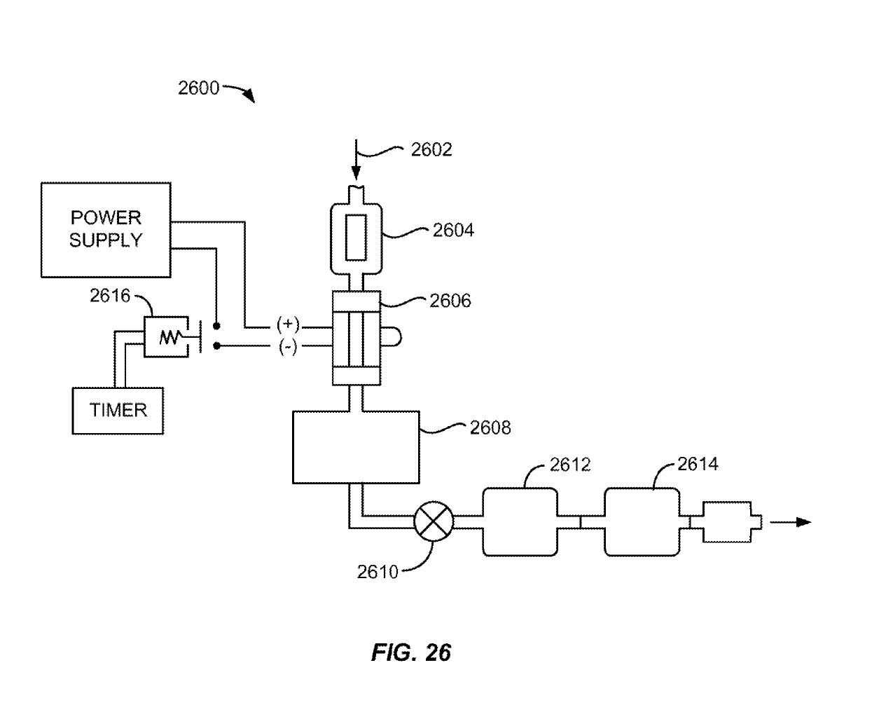

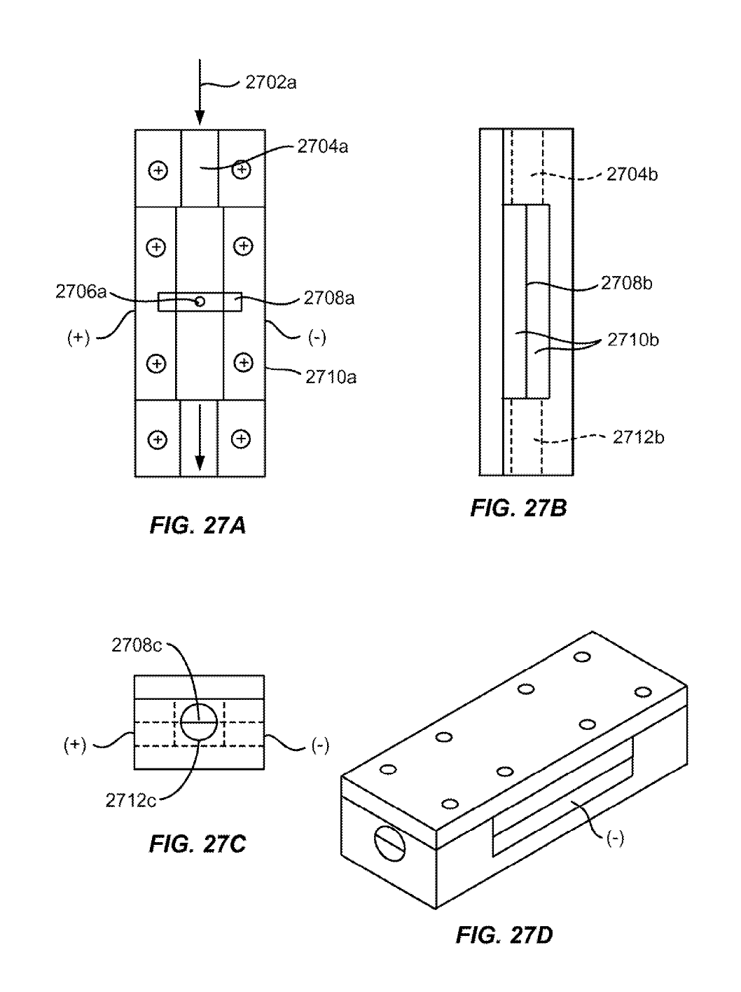

This example describes how changes in specific parameters (i.e. air flow rate, electrical current to a heater element, and thickness of a heater element) affected the size of aerosol particles generated by a test apparatus designed to comprise components and/or parameters of a nicotine delivery device as described herein. FIG. 26 shows a schematic of the entire test apparatus while FIGS. 27A-D shows alternate views of the test airway used in the test apparatus. The test bed had an airway created between a block of Delrin (bottom) and a sheet of clear plexiglass (top) with brass sides used to clamp and make electrical contact with a heater element. The heater element was a stainless steel foil of variable thickness (0.0005 inches (about 0.013 mm) or 0.001 inches (about 0.025 mm)), and the formulation used to generate an aerosol was composed of propylene glycol. FIG. 27A shows a top view, with airflow (2702a) into an inlet (2704a). A hole to deposit drug (2706a) was provided and foil was shown (2708a). Brass contacts (2710a) were provided. The length of the device was 6 inches (about 152.4 mm), and the width was 2.25 inches (about 57.15 mm). FIG. 27B shows a side view of the inlet (2704b), foil (2708b), brass electrical contacts (2710b), and outlet (2712b). FIG. 27C shows an end view of the foil (2708c) and (2712c). FIG. 27D shows an isometric view. Table 2 shows the results of altering heater element thickness, air flow rate, current, and duration of heating on particle size distribution. Based on the results in Table 2, as the air flow rate was increased, the particle size diameter (PSD) decreased when the other parameters were held constant.

TABLE 2
Propylene glycol aerosol data from test airway

| | | Heater | | | | Duration | Particle |
|---|---|---|---|---|---|---|---|
| | | Element | Air Flow | | | of | Size |
| | | Thickness | Rate | Dose | Current | Heating | Diameter |
| Sequence | Material | (inches) | (Liters/min) | (mg) | (Amps) | (seconds) | (microns) |
| 1 | PG | 0.0005 | 1 | 1 | 8 | 0.5 | 2 |
| 2 | PG | 0.0005 | 1 | 1 | 6 | 1 | 2.1-3 |
| 3 | PG | 0.001 | 1 | 1 | 8 | 0.7 | 1 |
| 4 | PG | 0.001 | 3 | 1 | 7 | 1 | 1.8 |
| 5 | PG | 0.001 | 3 | 1 | 7 | 1 | 2 |
| 6 | PG | 0.001 | 3 | 1 | 7 | 1 | 2 |
| 7 | PG | 0.001 | 3 | 1 | 7 | 1 | 1.5-1.8 |
| 8 | PG | 0.001 | 3 | 1 | 7 | 1 | 1.4-1.8 |
| 9 | PG | 0.001 | 3 | 1 | 7 | 1 | 2 |
| 10 | PG | 0.001 | 3 | 1 | 10 | 1 | 1 |
| 11 | PG | 0.001 | 3 | 1 | 10 | 1 | 0.9 |
| 12 | PG | 0.001 | 6 | 1 | 10 | 1 | 0.6 |
| 13 | PG | 0.001 | 6 | 1 | 10 | 1 | 0.6-0.8 |
| 14 | PG | 0.001 | 12 | 1 | 10 | 1 | 0.5 |
| 15 | PG | 0.001 | 12 | 1 | 10 | 1 | 0.5 |

### Example 2: Effect of Changes in Air Flow Rate, Electrical Current, Duration of Heating, and Thickness of Heater Element on Particle Size of an Aerosol Generated from a Nicotine/Propylene Glycol Formulation

This example describes how changes in specific parameters (i.e. air flow rate, and electrical current to a heater element) affected the size of aerosol particles generated from a 10% nicotine/propylene glycol formulation by a test apparatus as described in Example 1. Table 3 shows the results of altering heater element thickness, air flow rate, current, and duration of heating on particle size distribution. As shown in Table 3, when air flow rate was altered while other parameters were held constant, the higher the air flow rate, the smaller the average particle size diameter (PSD).

TABLE 3
Nicotine/propylene glycol mixture (10%) aerosol data from test airway

| | | | | | | | Average |
|---|---|---|---|---|---|---|---|
| | | Heater | | | | Duration | Particle |
| | | Element | Air Flow | | | of | Size |
| | | Thickness | Rate | Dose | Current | Heating | Diameter |
| Sequence | Material | (inches) | (Liters/min) | (mg) | (Amps) | (seconds) | (microns) |
| 1 | Nic/PG | 0.001 | 4 | 1 | 9 | 1 | 1.35 |
| 2 | Nic/PG | 0.001 | 4 | 1 | 9 | 1 | 1.45 |
| 3 | Nic/PG | 0.001 | 4 | 1 | 9 | 1 | 1.45 |
| 4 | Nic/PG | 0.001 | 2 | 1 | 9 | 1 | 1.85 |
| 5 | Nic/PG | 0.001 | 2 | 1 | 9 | 1 | 2.3 |
| 6 | Nic/PG | 0.001 | 2 | 1 | 9 | 1 | 2.3 |
| 7 | Nic/PG | 0.001 | 4 | 1 | 10 | 1 | 1.55 |
| 8 | Nic/PG | 0.001 | 4 | 1 | 10 | 1 | 1.2 |
| 9 | Nic/PG | 0.001 | 4 | 1 | 10 | 1 | 1.325 |

### Example 3: Particle Size Diameter Ranges of Aerosols Generated from a Test Apparatus Using a Heater Element Comprising a Wire Coil

This example describes the particle size diameters of aerosols generated from either a PG formulation or 10% nicotine/PG formulation using a test apparatus as shown in FIGS. 26 and 27A-D and described in Example 1. In this example, the heater element was a stainless steel coil comprising 3.5 coils and a diameter of 0.10 inches (about 2.54 mm). The heater element was heated using a current of 2.5 Amps and the air flow rate was 4 Liters/min (about 6.7×10⁻⁵ m³/s). Table 4 shows the results.

TABLE 4

| | | Duration | | | | |
|---|---|---|---|---|---|---|
| | | Air Flow | | | Particle | |
| | | Rate | | | of | Size |
| Se- | | (Liters/ | Dose | Current | Heating | Diameter |
| quence | Material | min) | (mg) | (Amps) | (seconds) | (microns) |
| 1 | PG | 4 | 1 | 2.5 | 1 | 1.5-2.2 |
| 2 | PG | 4 | 1 | 2.5 | 1 | 1.5-2.2 |
| 3 | Nic/PG | 4 | 1 | 2.5 | 1 | 1.57-2.2 |
| 4 | Nic/PG | 2 | 1 | 2.5 | 1 | 1.6-2.8 |
| 5 | Nic/PG | 2 | 1 | 2.5 | 1 | 1.52-2.2 |
| 6 | PG | 2 | 1 | 2.5 | 1 | 1.5-2.2 |
| 7 | PG | 4 | 1 | 2.5 | 1 | 1.5-2.3 |
| 8 | PG | 4 | 1 | 2.5 | 1 | 2.4-1.5 |

### Example 4: Particle Size Diameters of Aerosols Generated from Commercially Available e-Cigarettes (eCigs)

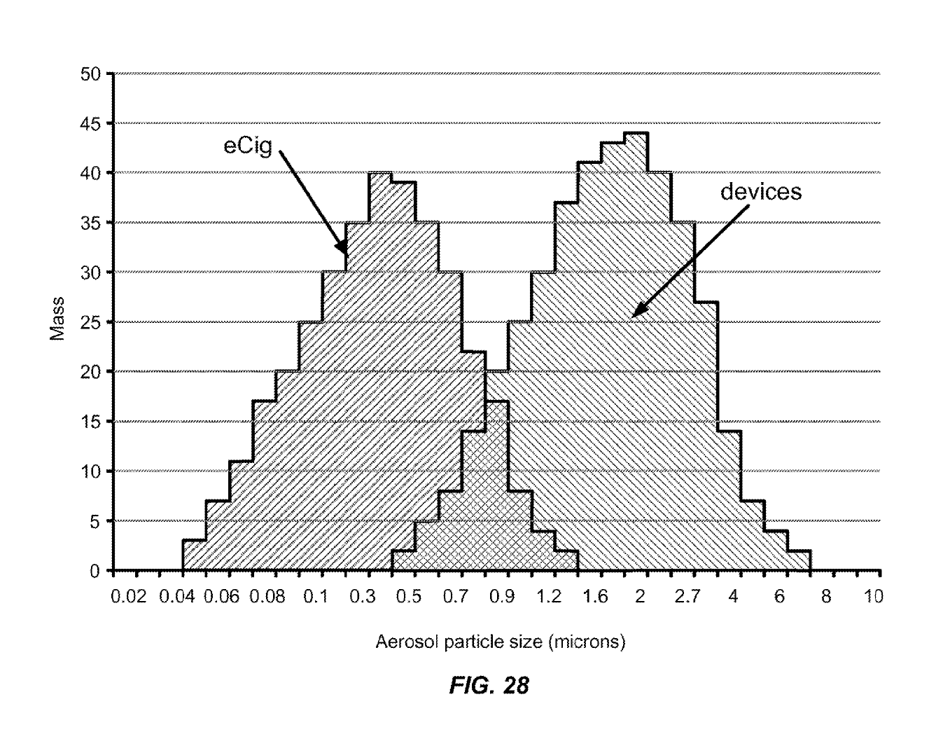

This example describes the particle size diameters of aerosols generated from either one of two brands of eCigs (Finiti and BLU). In this example, a 50 ml volume of an aerosol was pulled from either one of the two brands of eCigs over a period of 3 seconds in order to simulate a human breath. The collected aerosol was then injected into a laser particle size detector set at a flow rate of 14 Liters/min (about 2.33×10⁻⁴ m³/s). Table 5 shows the particle size diameter of the aerosols generated from two brands of eCigs. FIG. 28 shows a comparison of the particle size distribution for aerosols created by eCigs vs. aerosol created by devices provided herein (devices). As shown in FIG. 28, the particle size distribution of aerosols generated by devices provided herein was shifted toward larger particle sizes vs. those generated by eCigs.

TABLE 5

| | | Particle Size | | |
|---|---|---|---|---|
| Test | | Low | High | |
| Number | Brand | End | End | Average |
| 1 | Finiti | 0.5 | 0.5 | 0.5 |
| 2 | Finiti | 0.5 | 0.6 | 0.55 |
| 3 | Finiti | 0.5 | 0.5 | 0.5 |
| 4 | Finiti | 0.5 | 0.5 | 0.5 |
| 5 | BLU | 0.5 | 0.5 | 0.5 |
| 6 | BLU | 0.5 | 0.8 | 0.65 |

### Example 5: Effect of Changes in Valve Material, and the Diameter of a Bypass Orifice on Particle Size of a Aerosol Generated from a Propylene Glycol Formulation

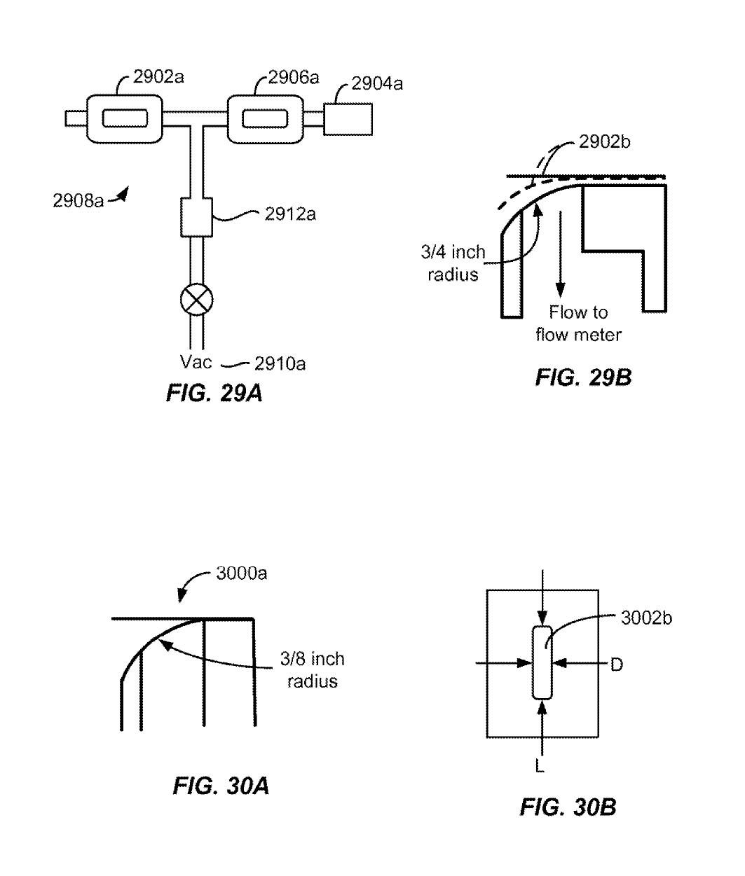

This example describes how changes in specific parameters (i.e. valve material and diameter of a bypass orifice) affected the size of aerosol particles generated by a test apparatus designed to comprise components and/or parameters of a device for generating condensation aerosols as described herein. FIG. 29A shows a schematic of the entire test apparatus while FIG. 29B shows an internal view of the valve (2904a) used in the test apparatus. The valve flap (2902b) had a ¾ inch diameter and the diameter of the channel downstream of the valve was 0.375 inches (about 9.53 mm) in length and 0.090 inches (about 2.29 mm) in width. The test bed had a primary airway (2906a), and a bypass airway (2908a), an aerosol generation chamber (2912a) and vacuum source (2910a). The aerosol generation chamber comprised a heater element. The inlet to the bypass airway was a slot of varying dimensions (L×W). Table 6 shows the results using a valve of ¾ inch (about 19.05 mm) diameter and altering valve material and bypass orifice diameter. As shown in Table 6, regardless of valve material type and bypass orifice diameter, above inhalation pressures of about 2 inches of H₂O (about 498 Pa), the primary flow remained relatively constant, while the bypass flow increased with increasing vacuum pressure. Table 7 shows the results using a valve of ⅜ inch diameter, a bypass orifice of varying dimensions, and altering the orifice dimensions for the inlet of the primary airway. As shown in Table 7, reducing the size of the orifice of the primary airway consistently reduced the flow rate through the primary airway regardless of varying vacuum pressure, dimensions of the bypass orifice, or varying the valve material.

TABLE 6
Testing of Flow Control with the device of FIG. 29.

| | Flow Bypass | Flow Primary | Δ P Vac | Total Flow | Bypass φ |
|---|---|---|---|---|---|
| Valve Material | (LPM) | (LPM) | (inches H₂O) | (LPM) | (inches) |
| .0045″ Brown | 15.4 | 4.9 | 2.11 | 20.03 | .149 |
| .0045″ Brown | 18.6 | 5.6 | 3 | | .149 |
| .0045″ Brown | 21.5 | 6.39 | 4.2 | | .149 |
| .0045″ Brown | 24.2 | 6.94 | 5.5 | | .149 |
| .0045″ Brown | 28.75 | 7.62 | 8 | | .149 |
| .0045″ Brown | 31.7 | 7.9 | 9.6 | | .149 |
| .0045″ Brown | 34.6 | 8.2 | 11.3 | | .149 |
| .0045″ Brown | 38.2 | 8.5 | 14 | | .149 |
| Green | 9.5 | 1.99 | .3 | | .199 |
| | 17.08 | 3.49 | .93 | | .199 |
| | 24.80 | 4.39 | 2.0 | | .199 |
| | 31.7 | 4.80 | 3.2 | | .199 |
| | 38.2 | 5.0 | 4.7 | | .199 |
| | 44.2 | 5.11 | 6.3 | | .199 |
| | 49.4 | 5.18 | 8.2 | | .199 |
| | 53 | 5.10 | 9.8 | | .199 |
| | | | | Δ P Vac | |
| Valve Slot Size | Bypass φ | Bypass Flow | Primary | (inches | Valve |
| (inches) | (inches) | (LPM) | Flow (LPM) | H₂O) | Material |
| .300 | .199 | 6.0 | 2.9 | .1 | Green |
| .300 | .199 | 9.2 | 4.2 | .28 | Green |
| .300 | .199 | 14.1 | 6.2 | .65 | Green |
| .300 | .199 | 17.5 | 7.4 | .99 | Green |
| .300 | .199 | 24.4 | 7.6 | 1.9 | Green |
| .300 | .199 | 28.9 | 7.5 | 2.7 | Green |
| .300 | .199 | 33.9 | 6.3 | 3.7 | Green |
| .300 | .199 | 38.0 | 5.46 | 4.8 | Green |
| .300 | .199 | 46.7 | 4.76 | 7.5 | Green |
| .300 | .199 | 50.3 | 4.6 | 8.5 | Green |
| .300 | .199 | 54 | 4.6 | 9.8 | Green |
| .300 | 1.99 | 5.9 | 2.6 | .1 | Brown |
| .300 | 1.99 | 7.9 | 3.6 | .2 | Brown |
| .300 | 1.99 | 11.8 | 5.4 | .45 | Brown |
| .300 | 1.99 | 17.7 | 7.9 | 1.0 | Brown |
| .300 | 1.99 | 23.9 | 10.48 | 1.9 | Brown |
| .300 | 1.99 | 28.59 | 11.76 | 2.7 | Brown |
| .300 | 1.99 | 33.2 | 11.9 | 3.7 | Brown |
| .300 | 1.99 | 38.5 | 10.9 | 5.0 | Brown |
| .300 | 1.99 | 42.8 | 10.3 | 6.0 | Brown |
| .300 | 1.99 | 45.5 | 10.2 | 6.8 | Brown |
| .300 | 1.99 | 48.6 | 9.6 | 7.9 | Brown |
| .300 | 1.99 | 49.5 | 9.7 | 8.3 | Brown |

TABLE 7
Re-lay out of valve with 3.8 radius and smaller slot (device of FIG. 29).

| | | | | Δ P | |
|---|---|---|---|---|---|
| | | | | Vac | Flap |
| Bypass φ | Primary Slot | Bypass Flow | Primary Flow | (inches | Material |
| (inches) | Size (inches) | (LPM) | (LPM) | H₂O) | (Color) |
| .265 | .04 × .150 | 8.75 | .65 | .13 | Brown |
| .265 | .04 × .150 | 12.5 | .95 | .23 | Brown |
| .265 | .04 × .150 | 18.0 | 1.4 | .45 | Brown |
| .265 | .04 × .150 | 40.3 | 3.14 | 2.02 | Brown |
| .265 | .04 × .150 | 25.0 | 1.99 | .84 | Brown |
| .265 | .04 × .150 | 64.0 | 4.5 | | Brown |
| .199Ø Equivalent | .04 × .150 | 18.7 | 2.82 | 1.38 | Green |
| (EQUI) SLOT | | | | | |
| .199Ø EQIU | .04 × .150 | 21.8 | 3.19 | 1.8 | Green |
| SLOT | | | | | |
| .199Ø EQIU | .04 × .150 | 25.5 | 3.68 | 2.54 | Green |
| SLOT | | | | | |
| .199Ø EQIU | .04 × .150 | 29.5 | 4.07 | 3.26 | Green |
| SLOT | | | | | |
| .199Ø EQIU | .04 × .150 | 34.1 | 4.45 | 4.19 | Green |
| SLOT | | | | | |
| .199Ø EQIU | .04 × .150 | 38.7 | 4.75 | 5.21 | Green |
| SLOT | | | | | |
| .199Ø EQIU | .04 × .150 | 43.3 | 4.88 | 6.2 | Green |
| SLOT | | | | | |
| .199Ø EQIU | .04 × .150 | 46.2 | 4.97 | 7.0 | Green |
| SLOT | | | | | |
| .199Ø EQIU | .04 × .150 | 54.1 | 4.79 | 9.12 | Green |
| SLOT | | | | | |
| .199Ø EQIU | .04 × .150 | 55.0 | 4.69 | 9.9 | Green |
| SLOT | | | | | |
| .199Ø EQIU | .04 × .150 | 19.8 | 1.05 | 1.5 | .001 |
| SLOT | | | | | KAPTON |
| .199Ø EQIU | .04 × .150 | 28.6 | 1.37 | 3.17 | .001 |
| SLOT | | | | | KAPTON |
| .199Ø EQIU | .04 × .150 | 35.7 | 1.10 | 4.56 | .001 |
| SLOT | | | | | KAPTON |
| .199Ø EQIU | .04 × .150 | 41.7 | .97 | 5.8 | .001 |
| SLOT | | | | | KAPTON |
| .199Ø EQIU | .04 × .150 | 46.7 | .94 | 7.1 | .001 |
| SLOT | | | | | KAPTON |
| .199Ø EQIU | .04 × .150 | 60.8 | .94 | 11.5 | .001 |
| SLOT | | | | | KAPTON |
| | | | | Δ P Vac | |
| Bypass φ | Primary Slot | Bypass Flow | Primary Flow | (inches | Valve |
| (inches) | Size (inches) | (LPM) | (LPM) | H₂O) | Material |
| .199 “SLOT” | .040 × .275 | 16.7 | 1.79 | 1.08 | .001 |
| | | | | | KAPTON |
| .199 “SLOT” | .040 × .275 | 18.1 | 1.87 | 1.3 | .001 |
| | | | | | KAPTON |
| .199 “SLOT” | .040 × .275 | 25.3 | 2.12 | 3.48 | .001 |
| | | | | | KAPTON |
| .199 “SLOT” | .040 × .275 | 35.7 | 2.7 | 4.6 | .001 |
| | | | | | KAPTON |
| .199 “SLOT” | .040 × .275 | 43.5 | 2.8 | 6.4 | .001 |
| | | | | | KAPTON |
| .199 “SLOT” | .040 × .275 | 50.2 | 2.8 | 8.34 | .001 |
| | | | | | KAPTON |
| .199 “SLOT” | .040 × .275 | 54.0 | 2.72 | 9.67 | .001 |
| | | | | | KAPTON |
| .199 “SLOT” | .040 × .275 | 56.3 | 2.64 | 10.4 | .001 |
| | | | | | KAPTON |

VALVE REVERSED

| | | | | | |
|---|---|---|---|---|---|
| .199 “SLOT” | .040 × .275 | 19.4 | 1.5 | 1.45 | .001 |
| | | | | | KAPTON |
| .199 “SLOT” | .040 × .275 | 24.8 | 1.89 | 2.3 | .001 |
| | | | | | KAPTON |
| .199 “SLOT” | .040 × .275 | 36.2 | 2.36 | 4.7 | .001 |
| | | | | | KAPTON |
| .199 “SLOT” | .040 × .275 | 41.3 | 2.5 | 5.8 | .001 |
| | | | | | KAPTON |
| .199 “SLOT” | .040 × .275 | 50.4 | 2.6 | 8.3 | .001 |
| | | | | | KAPTON |
| .199 “SLOT” | .040 × .275 | 55.9 | 2.6 | 9.6 | .001 |
| | | | | | KAPTON |

RETEST

| | | | | | |
|---|---|---|---|---|---|
| .199 “SLOT” | .040 × .275 | 12.4 | 1.56 | 0.6 | .001 |
| | | | | | KAPTON |
| .199 “SLOT” | .040 × .275 | 21.1 | 1.65 | 1.71 | .001 |
| | | | | | KAPTON |
| .199 “SLOT” | .040 × .275 | 30.2 | 2.0 | 3.4 | .001 |
| | | | | | KAPTON |
| .199 “SLOT” | .040 × .275 | 41.5 | 2.08 | 6.0 | .001 |
| | | | | | KAPTON |
| .199 “SLOT” | .040 × .275 | 50.1 | 2.03 | 8.4 | .001 |
| | | | | | KAPTON |
| .199 “SLOT” | .040 × .275 | 57.5 | 1.65 | 11.0 | .001 |
| | | | | | KAPTON |
| .199 “SLOT” | .040 × .275 | 46.0 | 1.64 | 7.5 | .001 |
| | | | | | KAPTON |
| .199 “SLOT” | .040 × .275 | 33.7 | 1.55 | 4.32 | .001 |
| | | | | | KAPTON |
| .199 “SLOT” | .040 × .275 | 19.5 | 1.36 | 1.48 | .001 |
| | | | | | KAPTON |
| .199 “SLOT” | .040 × .275 | 30.0 | 1.76 | 9.39 | .001 |
| | | | | | KAPTON |

### Example 6: Particle Size Diameters of Aerosols Generated from Devices Comprising Wire Coil Heater Elements and Bypass Inlets

This example describes the particle size diameters (PSD) of aerosols generated from a device comprising a heater element comprising a wire coil. An example of this type of device is shown in FIGS. 31A-D. FIG. 31A depicts a device designated ENT-100-A, (two inches (about 50.8 mm) long) comprising a primary carrier gas inlet (3112a), positive and negative brass contacts (3110a), a heater element (3106a) comprising a coil located distally from the inlet to the primary airway (3112a) and two bypass inlets (3104a) located (disposed) downstream of the heater element but prior to the outlet (3102a). FIG. 31B depicts a device designated ENT-100-B, which was the same as ENT-100-A except that the heater element had been moved to be proximal to the inlet of the primary airway (3112b). FIG. 31C depicts a device designated ENT-100-C, which was similar to the ENT-100-A device except that the wire coil heater element had been moved to an intermediate position relative to the location of the coil in ENT-100-A and ENT-100-B. Any of the devices depicted in FIG. 31A-C could have comprised the wire coil heater element designated “A Coil” (3114e) or “B Coil” (3116e) as illustrated in FIG. 31E. The coil in both types of heater elements comprised inner diameter of 0.26 inches (about 6.604 mm). The “A Coil” comprised a stretch of coil followed by a straight lead on either end of the coil which connected to the brass contacts. The “B Coil” comprised a stretch of coil, wherein the coil itself connected to the brass contacts. Tables 8-12 shows the particle size diameter of the aerosols generated from the devices depicted in FIG. 31A-C. Table 8 shows the PSD of particles generated using an ENT-100-A device with the “B Coil”. Table 9 shows the PSD of particles generated using an ENT-100-B device with the “A Coil”. Table 10 shows the PSD of particles generated using an ENT-100-B device with the “B Coil”. Table 11 shows the PSD of particles generated using an ENT-100-C device with the “A-Coil”. Table 12 shows the PSD of particles generated using an ENT-100-C device with the “B-Coil”.

TABLE 8
Testing of ENT-100-A, B prototype
Dose = 2 mg (propylene glycol formulation), current = 3 amps, duration = 1 sec.

| Total Flow | Primary | Bypass | PSD | |
|---|---|---|---|---|
| (LPM) | Flow (LPM) | Flow (LPM) | (microns) | Notes |
| 9.7 | N/A | N/A | 1.7-1.8 | ENT-100-A Device |
| 9.7 | N/A | N/A | 1.5-2.1 | |
| 2.2 | 1.67 | | 0.4-0.5 | ENT-100-A Device |
| | | | | w/o screen in flow valve |
| 2.2 | 1.67 | | 0.38-0.5 | |
| 2.2 | .7 | | 1.7-1.5 | |
| 2.2 | 2.3 | | 0.4 | w/screen |
| 32 | 1.6 | N/A | 0.4 | ENT-100-B (heater coil moved |
| | | | | aft) |
| Ø | 0.7 | N/A | 1.7-2.0 | |
| Ø | 0.66 | N/A | 1.4-1.5 | |
| | 1.7 | Ø | 0.5-1.0 | Bypass taped over ENT-100-B |
| | 1.7 | Ø | 0.5-1.0 | Bypass taped over ENT-100-B |
| | 1.7 | Ø | 0.5-1.0 | Bypass taped over ENT-100-B |
| | 1.7 | Ø | 0.5-1.0 | Bypass taped over ENT-100-B |
| | 0.5 | Ø | 3 | Bypass taped over ENT-100-B |
| | 0.51 | Ø | 2.9 | Bypass taped over ENT-100-B |
| | .82 | Ø | 3.3/1.8 | Bypass taped over ENT-100-B |
| | .84 | Ø | 3.2-3.3 | Bypass taped over ENT-100-B |
| | 1.1 | Ø | 2.7 | Bypass taped over ENT-100-B |
| | 1.11 | Ø | 2.7-2.8 | Bypass taped over ENT-100-B |
| | 1.38 | Ø | 2.1-2.3 | Bypass taped over ENT-100-B |
| | 1.42 | Ø | 2.2-2.4 | Bypass taped over ENT-100-B |
| | 1.72 | Ø | 1.7 | Bypass taped over ENT-100-B |
| | 1.72 | Ø | 1.7-1.75 | Bypass taped over ENT-100-B |
| | 2.04 | Ø | .5-1.0 | Bypass taped over ENT-100-B |

| Primary | | | |
|---|---|---|---|
| Flow | Bypass | PSD | |
| (LPM) | Flow (LPM) | (microns) | Notes |
| 1.45 | Ø | 2.3 | ENT-100-B Device |
| | | | Flap removed from flow valve |
| 1.45 | Ø | 2.2-2.4 | |
| 1.74 | Ø | 1.95-2.0 | |
| 1.75 | Ø | 1.8-1.9 | |
| 2.04 | Ø | 1.7-1.8 | |
| 2.04 | Ø | 1.6-1.7 | |
| 3.0 | Ø | 0.5-1.0 | |
| 3.0 | Ø | 0.5-1.0 | |
| 3 | Ø | 0.5-1.0 ST | Flow control valve removed/replaced with |
| 3 | Ø | 2.0-2.3 | Black Delyrn W O.196φ hole |
| 3 | Ø | 2.3-2.4 | |
| 1.04 | Ø | No trigger | |
| 2.0 | Ø | 3.8 | |
| 2.04 | Ø | 0.5-1.0 | With foam (open cell packing foam used to |
| | | | even out air flow, placed upstream from the |
| | | | heater element), no valve |
| 2.04 | Ø | 0.5-1.0 ST | |
| 1.05 | Ø | 1.8-2.1 | |
| 1.05 | Ø | 2.0-2.1 | |
| 1.5 | Ø | .79-1.0 | |
| 1.49 | Ø | 1.6 | |
| 1.25 | Ø | 1.6 | |
| 1.24 | Ø | 0.7-1.2 | |
| 1.24 | Ø | 0.7-1.2 | |
| 2.0 | Ø | 0.5-1.0 | |
| 2.0 | Ø | 0.5-1.0 | |

TABLE 9
Testing of ENT-100-B device with “A Coil” heater element
Dose = 2 mg (propylene glycol formulation),
1 sec duration, current 3.1 amps

| Flow | PSD | |
|---|---|---|
| (LPM) | (Microns) | Notes |
| 1.01 | 3.4-3.6 | |
| 1.01 | 3.1-3.5 | |
| 1.51 | 2.6-2.7 | |
| 1.51 | 2.5-2.7 | |
| 2.06 | 2.6-2.3 | |
| 2.12 | 2.15-2.2 | |
| 2.48 | 1.9-2.2 | |
| 2.49 | 1.85-1.9 | |
| 3.02 | 1.5-1.6 | |
| 3.02 | 1.4-1.5 | |
| 3.02 | 1.35-1.45 | |
| 3.04 | 1.45-1.6 | |
| 3.26 | 1.4-1.6 | |
| 3.27 | 1.3-1.5 | |
| 4.25 | | |

TABLE 10
Testing of ENT-100-B device with “B Coil” heater element
Dose = 2 mg (propylene glycol formulation),
Duration 1 sec, current 2.0 amps

| Dose | | PSD | |
|---|---|---|---|
| (mg) | Flow (LPM) | (microns) | Notes |
| 2 | 1.5 | 2.9-3.1 | With foam |
| 2 | 1.53 | 2.6-2.8 | |
| 2 | 1.53 | 2.8-2.9 | |
| 2 | 2.49 | 1.8-1.9 | |
| 2 | 2.49 | 1.7-1.8 | |
| 2 | 3.01 | 1.4 | |
| 2 | 3.01 | 1.4-1.5 | |
| 2 | 3.49 | | |
| 2 | 1.55 | 2.5 | With stainless steel (SS) screen to |
| | 1.56 | 2.6-2.9 | even flow |
| | 1.56 | 2-2.5 | Taped up bypass |
| | 2.52 | 1.5-1.6 | |
| | 2.56 | 1.5 | |
| | 2.35 | 1.8-2.0 | With foam (taped up bypass) |
| | 2.51 | 1.9-2.0 | |
| | 2.48 | 1.9 | |
| | 1.48 | 2.9-3.0 | |
| | 1.50 | 2.8-3.0 | |
| | 1.5 | 1.8-1.9 | Bypass untaped Total flow ~8.5 LPM |
| | 1.52 | 1.7-1.8 | |
| | 1.48 | 1.2-1.1 | With 0.42 φ orifice added to primary |
| | | | inlet (Total flow = 24) |
| | 1.5 | 1.7-1.8 | With heater element moved aft |
| | 1.60 | 1.7-1.75 | B configuration (Total flow 12 LPM) |

TABLE 11
Testing of ENT-100-C with “A Coil” heater element,
which has 7 coils Current set @ 2.0 amps, 1 sec, 2 mg
dose (propylene glycol formulation)

| Inlet | Primary | | Δ P | |
|---|---|---|---|---|
| orifice | Flow | PSD | Vac (inches | |
| (inches) | (LPM) | (microns) | H₂O) | Notes |
| .04 | 1.01 | 4.6-5 | 2.48 | No adder |
| .04 | 1.00 | 4.3-4.7 | 2.50 | 0.250 straight tube |
| .04 | 3.00 | 1.7-1.8 | 17.5 | 2.4 amps |
| .04 | 3.00 | 1.6-1.7 | 17.2 | 2.4 amps |
| .04 | 4.85 | ~1.0 | LIMIT | |
| .020 + | 0.98 | 2.2-2.4 | .45 | 2.4 amps - No adder |
| FOAM | | | | |
| .020 + | 1.00 | 3.5-4.0 | .46 | 2.4 amps - No adder |
| FOAM | | | | |
| .020 + | 1.00 | 4.2-4.7 | .46 | 2.4 amps - No adder |
| FOAM | | | | |
| .020 + | 1.00 | 4.0-5.7 | .46 | 2.4 amps - No adder |
| FOAM | | | | |
| .020 + | 1.00 | 3.0-4.3 | .46 | 2.4 amps - No adder |
| FOAM | | | | |
| .020 + | 2.09 | 2.2 | 1.52 | 2.4 amps - No adder |
| FOAM | | | | |
| .020 + | 2.07 | 2.4-2.5 | 1.51 | 2.4 amps - No adder |
| FOAM | | | | |
| .020 + | 2.07 | 2.2-2.4 | 1.48 | 2.4 amps - No adder |
| FOAM | | | | |
| .020 + | 2.08 | 2.4-2.5 | 1.53 | 2 amps |
| FOAM | | | | |
| .020 + | 2.08 | 2.1-2.3 | 1.53 | 2 amps |
| FOAM | | | | |
| .020 + | 2.09 | 2.5-2.6 | 1.53 | 2 amps |
| FOAM | | | | |

TABLE 12
Testing of ENT-100-C with “B Coil” heater element,
with 0.050 spacer between contacts then spread to .200 in
Current set @ 2.0 amps, 1 sec, 2 mg dose
(propylene glycol formulation)

| | | Δ P | | |
|---|---|---|---|---|
| | | Vac | | |
| Flow | PSD | (inches | Current | |
| (LPM) | (microns) | H₂O) | (amps) | Notes |
| .94 | 3.0-3.2 | .67 | 2.4 | |
| .94 | 2.4-2.5 | .67 | 2.8 | |
| .95 | 2.5-3.1 | .67 | 2.8 | |
| .95 | 3.3-3.4 | .67 | 2.8 | |
| .95 | 2.7-3.4 | .67 | 2.8 | |
| 2.11 | 2.3-2.4 | 2.58 | 2.8 | |
| 2.11 | 2.3-2.7 | 2.58 | 2.8 | |
| 2.11 | 2.6-2.7 | 2.58 | 2.8 | |

New Heater Element .040 ID

| | | | |
|---|---|---|---|
| 1.91 | 1.7-2.0 | .86 | 2.4 |
| 1.91 | 2.4-2.5 | .86 | 2.6 |
| 1.97 | 2.6-2.7 | .86 | 2.6 |
| 1.91 | 2.4-2.5 | .86 | 2.6 |
| 1.91 | 2.5-2.6 | .86 | 2.6 |
| 1.91 | 2.4-2.5 | .86 | 2.8 |
| 2.04 | 1.8-2.0 | .96 | 2.8 |
| 2.04 | 2.4-2.7 | .96 | 2.8 |
| 2.04 | 2.0-1.9 | .96 | 2.8 |

New Heater Element .032 ID 0.100 stretch

| | | | | |
|---|---|---|---|---|
| 2.04 | 2.0-2.5 | .93 | 2.6 | |
| 2.04 | 2.0-2.2 | .96 | 2.6 | |
| 2.04 | 2.1-2.3 | .96 | 2.6 | Spit (nicotine/propylene glycol |
| | | | | was heated under conditions |
| | | | | (air flow, heating rate) that |
| | | | | lead to the mixture being boiled |
| | | | | off of the heater element and |
| | | | | “spit” off of the heater element) |
| 2.04 | 2.1-2.2 | .89 | 2.6 | spit |

### Example 7: Particle Size Diameters of Aerosols Generated from Heater Element Comprising a Center Exit Wire Lead

This example describes the particle size diameters (PSD) of aerosols generated from a heater element comprising a wire wherein one end of the wire wrapped around another segment of the wire, wherein a wire coil was formed with an end of the wire passing through the center of the wire coil. An example of this type of heater element is shown in FIGS. 36, 37A-B, and 38. In this example, the heater element was inserted into the device depicted in FIG. 31D. FIG. 31D depicts a device designated ENT-100-D with a primary passageway for air to flow through, brass contacts (+/−) embedded within the wall of the primary passageway, and a heater element as described in this example. The wire of the heater element had a diameter of 0.10 inches (about 2.54 mm). The wire coil of the heater element had 9 coils, and the wire coil had an inner diameter of 0.032 inches (about 0.813 mm). In this example, the liquid formulation comprised propylene glycol and it wicked onto the ends of the wire of the heater element and onto the brass contacts. Table 13 shows the particle size diameter of the aerosols generated from a device comprising the heater element. As shown in Table 13, the particle size distribution of aerosols generated by devices with the heater element was unaffected by alterations in current used to heat the wire.

TABLE 13
Propylene glycol (dose: 2 mg) was found to wick to ends
of heater element and onto brass contacts ENT-100-D.
Heater Element .032 10, 010 ∅ wire, 9 turn, center exit

| | | Δ P | | |
|---|---|---|---|---|
| | | Vac | | |
| Flow | PSD | (inches | Current | |
| (LPM) | (microns) | H₂O) | (amps) | Notes |
| 2.01 | 2-2.2 | 1.14 | 2.2 | Foam |
| 2.00 | 2-2.2 | 1.14 | 2.2 | |
| 2.00 | 2.0-2.2 | 1.14 | 2.0 | |
| 2.0 | 2.1-2.2 | 1.14 | 2.0 | |
| 2.0 | 1.8-2.1 | 1.14 | 1.8 | |
| 2.0 | 1.9-2.1 | 1.14 | 1.8 | |
| 0.99 | 5.0-5.3 | .34 | 1.8 | |
| 1.00 | 5.0-5.2 | .34 | 1.8 | |
| 1.52 | 2.6-2.8 | .71 | 2.0 | |
| 1.52 | 2.6-2.7 | .71 | 2.0 | |
| 1.53 | 2.4-2.7 | .71 | 1.8 | |
| 1.53 | 2.5-2.7 | .71 | 1.8 | |
| 2.02 | 2.1-2.2 | | 2.0 | |
| 3.0 | 1.2-1.4 | 2.43 | 2.0 | |
| 3.0 | 0.8-1.4 | 2.43 | 2.0 | |
| 3.0 | .90-1.3 | 2.43 | 2.2 | |
| 3.0 | .6-1.3 | 2.43 | 2.2 | |

### Example 8: Particle Size Diameters of Aerosols Generated from Heater Element Comprising a Center Exit Wire Lead when the Length of the Leads are Increased

This example describes the particle size diameters (PSD) of aerosols generated from a heater element as described in FIG. 36. In this example, the length of the leads connecting the wire coil to the brass contacts was increased as shown in FIGS. 37A and 37 B. The length of the leads in this example was 0.70 inches (about 17.78 mm). The heater element was inserted into the device depicted in FIG. 31D. FIG. 31D depicts a device designated ENT-100-D with a primary passageway for air to flow through, brass contacts (+/−) embedded within the wall of the primary passageway, and a heater element as described in this example. In some cases, the diameter of the inlet was varied from 0.060 inches to either 0.070, 0.071, or 0.041 inches (a range from about 1.524 mm to either 1.78, 1.80, or 1.04 mm. The wire of the heater element had a diameter of 0.10 inches (about 0.254 mm). The wire coil of the heater element had a reduced number of coils, and the wire coil had an inner diameter of 0.032 inches (about 0.813 mm). In this example, the liquid formulation comprised propylene glycol and it wicked onto the ends of the wire of the heater element and onto the brass contacts. Table 14 shows the particle size diameter of the aerosols generated from a device comprising the heater element. As shown in Table 14, the particle size distribution of aerosols generated by device with the heater element was unaffected by alterations in current used to heat the wire. Table 14 also shows the effects of altering the airway configuration in the ENT-100-D device. As shown in Table 14, altering the configuration of the airway of the ENT-100-D device by adding the airway depicted in FIG. 32E (designated the MARK V adders in Table 14) downstream of the heater element produced particles with a PSD of about 1 to about 2 μm.

TABLE 14
Heater element leads lengthened

| | | Δ P | | |
|---|---|---|---|---|
| | | Vac | | |
| Flow | PSD | (inches | Current | |
| (LPM) | (microns) | H₂O) | (amps) | Notes |
| 2.0 | 3.1-3.2 | .96 | 2.0 | |
| 2.0 | 3.1-3.2 | .96 | 2.0 | |
| 2.01 | 3.1-3.2 | .96 | 1.8 | |
| 2.01 | 3.1-3.2 | .96 | 1.8 | |
| 2.02 | 3.0-3.2 | .96 | 2.2 | Orifice .060 |
| 2.02 | 2.9-3.0 | .96 | 2.2 | |

Test of ΔP affecting PSD

| | | | | |
|---|---|---|---|---|
| 2.06 | 3.3-3.4 | 1.74 | 2.0 | Orifice size = .060 |
| 2.04 | 3.2-3.3 | .96 | 2.0 | .071 |
| 2.04 | 3.0-3.2 | 7.00 | 2.0 | .041 |
| 2.04 | 3.1-3.2 | 7.08 | 2.0 | .041 |

Test to see affect of foam

| | | | | |
|---|---|---|---|---|
| 2.06 | 2.4-2.5 | 6.65 | 2.0 | Foam removed |
| 2.06 | 2.4-2.5 | 6.65 | 2.0 | |
| 2.0 | 2.7-2.9 | 1.63 | 2.0 | Original foam |
| 2.05 | 2.7-2.8 | 1.63 | 2.0 | Replaced orifice .070 |
| 2.05 | 2.7-2.8 | 1.70 | 2.0 | New foam |
| 2.06 | 2.7 | 1.70 | 2.0 | |
| 2.06 | 2.9-3.0 | 1.05 | 2.0 | New foam rotated 90° |
| 2.04 | 2.7-2.9 | .98 | 2.0 | |
| 2.0 | 2.6 | 1.47 | 2 | Foam rotated |
| 2.0 | 2.6 | 1.47 | 2 | again 90° |

Foam replaced w/SS screen

| | | | | |
|---|---|---|---|---|
| 2.05 | 2.6-2.8 | .63 | 2 | |
| 2.04 | 2.7-3.0 | .63 | 2 | |
| 2.04 | 2.8-3.0 | .63 | 2 | |
| 2.06 | 2.8-3.0 | .65 | 2 | New screen |
| 2.06 | 3.0-3.1 | .65 | 2 | |

New heater element

| | | | |
|---|---|---|---|
| 2.03 | 3.0-3.2 | .62 | 2 |
| 2.04 | 2.7-2.8 | .62 | 2 |
| 2.04 | 2.7-2.8 | .62 | 2 |
| 2.04 | 2.9-3.0 | .62 | 2 |
| 2.50 | 2.7-2.9 | .9 | 2 |
| 2.50 | 2.4-2.6 | .9 | 2 |
| 2.54 | 2.6-2.8 | .9 | 2 |
| 2.54 | 2.6-2.9 | .9 | 2 |
| 3.52 | 1.9 | 1.60 | 2 |
| 3.51 | 2.1 | 1.60 | 2 |
| 4.53 | 1.8-1.9 | 2.54 | 2 |
| 4.51 | 1.8-1.9 | 2.54 | 2 |

Heater element broke

| | | | | |
|---|---|---|---|---|
| 2.02 | 2.8-3.0 | .61 | 2 | Heater replaced |
| 4.52 | 1.9 | 2.53 | 2 | |
| 4.53 | 1.9 | 2.53 | 2 | |
| 6.10 | 1.3-1.5 | 4.33 | 2 | |
| 6.10 | 1.4-1.5 | 4.35 | 2 | |
| 7.03 | 1.1-1.2 | 5.68 | 2 | |

| | | Δ P Vac | | |
|---|---|---|---|---|
| Flow | PSD | (inches | | |
| (LPM) | (microns) | H₂O) | Notes | |
| 1.48 | 2.8-3 | .34 | | |
| 1.48 | 3.2-2.4 | .34 | | |
| 1.48 | 2.6-2.9 | .34 | | |
| 1.48 | 2.4-2.7 | .34 | | |
| 2.04 | 3-3.2 | .62 | | |
| 2.04 | 3-3.2 | .62 | | |
| .95 | 3.9-4.2 | 0.14 | | |
| .95 | 3.9-4.2 | 0.14 | | |
| | | | Bypass | Adder used (Mark V) |
| 2.08 | 1.4-1.8 | 1.06 | 14.9 | |
| 2.08 | 1.9-2.1 | 1.06 | 14.9 | |
| 2.08 | 2.0-2.1 | 1.06 | 14.9 | |
| 2.08 | 2.0-2.1 | 1.06 | 14.9 | |
| 3.02 | 1.7-1.8 | 2.06 | 21.0 | |
| 3.02 | 1.8 | 2.06 | 21.09 | |
| 4.48 | 1.3-1.4 | 4.22 | 30.4 | |
| 4.48 | 1.2-1.4 | 4.22 | 30.1 | |
| 2.0 | 1.9-2 | 1.08 | ∅ | Flow meter taped up on bypass |
| 2.0 | 2 | 1.08 | ∅ | |
| 2.0 | 2.4-2.5 | 1.08 | ∅ | |
| 2.01 | 2.2-2.3 | 1.08 | ∅ | |

### Example 9: Particle Size Diameters of Aerosols Generated from Heater Element Comprising a Center Exit Wire Lead when the Length of the Leads are Decreased

This example describes the particle size diameters (PSD) of aerosols generated from a heater element as described in FIG. 36. In this example, the length of the leads connecting the wire coil to the brass contacts was 0.30 inches (about 0.762 mm). The heater element was inserted into the device depicted in FIG. 31D. FIG. 31D depicts a device designated ENT-100-D with a primary passageway for air to flow through, brass contacts (+/−) embedded within the wall of the primary passageway, and a heater element as described in this example. The wire of the heater element had a diameter of 0.10 inches (about 2.54 mm). The wire coil of the heater element had an increased number of coils relative to Example 8, and the wire coil had an inner diameter of 0.032 inches (about 0.813 mm). In this example, the liquid formulation comprised propylene glycol and it wicked onto the ends of the wire of the heater element and onto the brass contacts. The dose of the formulation was 2 mg. Table 15 shows the particle size diameter of the aerosols generated from the device described in this example. As shown in Table 15, the particle size diameter distribution of aerosols generated by this device was unaffected by alterations in current used to heat the wire.

TABLE 15
Testing using ENT-100-D (side mount)
(w/bottom leads) with leads shortened.

| Dose | 2 mg, current 2.00 amps (U.N.O.) | | |
|---|---|---|---|
| Primary | | Δ P | |
| Flow | PSD | Vac (inches | |
| (LPM) | (microns) | H₂O) | Current (amps) |
| 2.02 | 3.0-3.2 | .62 | 2.0 |
| 2.02 | 2.9-3.2 | .62 | 2.0 |
| 1.48 | 2.3-2.5 | .37 | 2.0 |
| 1.48 | 2.0-2.4 | .37 | 2.0 |
| 1.48 | 2.0-2.6 | .37 | 1.8 |
| 1.48 | 2.0-2.5 | .37 | 1.8 |
| 1.10 | 2.8-4.1 | .20 | 1.8 |
| 1.10 | 2.3-3.4 | .20 | 1.8 |
| 2.0 | 3.1-3.2 | .62 | 2.0 |
| 2.12 | 2.2 | 1.16 | 2.0 |
| 2.12 | 2.2 | 1.16 | 2.0 |
| 1.01 | 2.8 | .30 | 1.8 |
| 1.01 | 2.8-3.0 | .30 | 1.8 |
| .49 | 4.7-5.4 | .08 | 1.8 |
| .49 | 4.5-4.8 | .09 | 1.8 |
| 4.50 | 1.4-1.6 | 4.14 | 2.0 |

### Example 10: Particle Size Diameters of Aerosols Generated from a Device Comprising a Heater Element Comprising a Center Exit Wire Lead

This example describes the particle size diameters (PSD) of aerosols generated from a device comprising a heater element as described in FIG. 36. In this example, the heater element was inserted into the device depicted in FIG. 31D. FIG. 31D depicts a device designated ENT-100-D with a primary passageway for air to flow through, brass contacts (+/−) embedded within the wall of the primary passageway, and a heater element as described in this example. The wire of the heater element had a diameter of 0.10 inches (about 2.54 mm). The wire coil of the heater element had an inner diameter of 0.032 inches (about 0.813 mm). In this example, the liquid formulation comprised propylene glycol and it wicked onto the ends of the wire of the heater element and onto the brass contacts. The dose of the formulation in this example was 2 mg. Table 16 shows the particle size diameter of the aerosols generated from a device comprising the heater element described in this example. As shown in Table 16, the particle size distribution of aerosols generated by devices with the heater element was unaffected by alterations in current used to heat the wire. Also as shown in Table 16, altering the configuration of the airway of the ENT-100-D device by adding the airway depicted in FIG. 33 (designated the MARK VI adder in Table 15) downstream of the heater element produced particles with a PSD of about 1 to about 2 uM, which matched the PSD of the particles generated without the MARK VI adder. The MARK VI adder comprised a primary airway with an internal diameter of 0.25 inches (about 6.35 mm), which narrows to an airway comprising an internal diameter of 0.086 inches (about 2.18 mm) and an external diameter of 0.106 inches (about 2.69 mm).

TABLE 16
Testing of ENT-100-D device
Dose = 2 mg; Current 2 amps; 1 sec duration

| | | | Δ P Vac | |
|---|---|---|---|---|
| P Flow | B Flow | PSD | (inches | |
| (LPM) | (LPM) | (microns) | H₂O) | Notes |
| 1.97 | ∅ | 3.0-3.1 | .58 | Straight tube |
| 1.52 | ∅ | 2.0-2.5 | .37 | |
| 1.52 | ∅ | 2.4 | .36 | |
| 1.0 | ∅ | 3.2-3.7 | .17 | |
| 3.0 | ∅ | 2.0-2.3 | 1.21 | |
| 3.0 | ∅ | 2.3-2.4 | 1.22 | |
| 4.53 | ∅ | 1.6-1.8 | 2.52 | |
| 4.53 | ∅ | 1.3-1.5 | 2.50 | |
| 6.08 | ∅ | 1.2-1.3 | 4.23 | |
| 6.08 | ∅ | 0.8-1.3 | 4.23 | |
| 6.11 | ∅ | 0.7-1.2 | 7.13 | w/SS needle in |
| | | (ST) | | |
| 6.11 | ∅ | .6-1.2 | 7.13 | .250 tube |
| 4.48 | ∅ | 1.5-1.6 | 4.14 | |
| 4.48 | ∅ | 1.6-1.7 | 4.14 | |
| 3.01 | ∅ | 1.7-1.9 | 2.05 | |
| 3.01 | ∅ | 1.7-1.8 | 2.05 | |
| 2.01 | ∅ | 2.2 | 1.04 | |
| 2.01 | ∅ | 2.2-2.7 | 1.04 | |
| 1.47 | ∅ | 2.0-2.1 | .6 | |
| 1.47 | ∅ | 2.1 | .6 | |
| 0.98 | ∅ | 2.8-3.0 | .29 | |
| 0.98 | ∅ | 2.7-3.0 | .29 | |
| .48 | ∅ | 4.7-5.2 | .07 | |
| .48 | ∅ | 4.4-5.1 | .07 | |
| 1.5 | ∅ | 2.1 | .6 | Delrin “double cone” |
| 1.5 | ∅ | 2.1-2.2 | .64 | |
| 2.05 | ∅ | 2.3 | 1.04 | |
| 2.05 | ∅ | 2.2 | 1.08 | |
| 2.5 | ∅ | 2.1-2.2 | 1.48 | |
| 3.0 | ∅ | 1.9-2.0 | 2.04 | |
| 3.0 | ∅ | 1.9-2.0 | 2.04 | |
| 1.0 | ∅ | 2.9-3.1 | .29 | |
| 1.24 | ∅ | 2.6-2.7 | .43 | |
| 1.25 | ∅ | 2.5-2.7 | .43 | |
| 1.75 | ∅ | 2.3-2.4 | .76 | |
| 1.75 | ∅ | 2.3 | .76 | |
| 1.49 | ∅ | 2.1-2.2 | .6 | Current changed to 2.2 |
| 1.49 | ∅ | 2.1-2.2 | 2.41 | Back to 2.0 amps orifice |
| | | | | changed |
| Adder installed | | | | .250 w/SS needle 6 slots |
| | | | | .100 long x .080 |
| 3.0 | 21.16 | 1.8 | 1.98 | |
| 3.0 | 21.16 | 1.8-1.9 | 1.98 | 7x Adder |
| 2.0 | 14.13 | 2.0-2.1 | 1.0 | Mark VI |
| 2.0 | 14.13 | 2.0-2.1 | 1.0 | |
| .98 | 7.06 | 2.7-2.8 | .28 | |
| .98 | 7.00 | 2.8-2.9 | .29 | |
| 1.5 | 10.49 | 2.1-2.2 | .63 | |
| 1.53 | 10.62 | 2.0-2.2 | .63 | |
| .49 | 3.45 | 4.3-4.5 | .07 | |
| 4.51 | 31.4 | 1.5-1.6 | 4.09 | |
| 4.51 | 31.4 | 1.5-1.6 | 4.04 | |
| 6.1 | 4.2 | 1.2 | 7.0 | |
| 1.98 | 3.98 | 2.3-2.5 | .98 | |
| 1.98 | 3.98 | 2.3-2.4 | .98 | |
| 2.02 | 0 | 2.3-2.4 | 1.03 | |
| 2 | 28 | 2 | 3.52 | |
| 2 | 28 | 2.0-2.1 | 3.52 | |

### Example 11: Particle Size Diameters of Aerosols Generated from Device Comprising a Bypass Inlet for Mixing the Condensation Aerosol in a Larger Volume of Carrier Gas

In this example, the particle size diameters (PSD) of a condensation aerosol generated by a device comprising the airway configuration depicted in FIG. 33 was tested. The device comprised a primary airway with an internal diameter of 0.25 inches (about 6.35 mm), which narrowed to an airway comprising an internal diameter of 0.086 inches (about 2.18 mm) and an external diameter of 0.106 inches (about 2.69 mm). The airway configuration was coupled to a heater element comprising a wire coil, wherein the heater element vaporized a liquid formulation comprising propylene glycol upstream of where the primary airway narrowed. The vaporized formulation then entered the narrowed airway and condensed into particles. The narrowed primary airway was designed to carry the vaporized formulation in a carrier gas (e.g. air) at a flow rate suitable for condensing the vapor into particles of a desired size (e.g. an MMAD of about 1 μm to about 5 μm). In this example, the narrowed primary airway opened up into a wide downstream airway comprising an internal diameter of 0.25 inches (about 6.35 mm) and the condensed particles were mixed with bypass carrier gas (e.g. air) that entered the widened primary airway from inlets located (disposed) in the walls of the primary airway. The carrier gas entering through the inlets was fed from a bypass inlet which was in a wall of a secondary housing that encompassed the primary airway. In this example, the effect of varying the flow rates of the bypass gas (B flow) on the PSD of the condensed was examined. Table 17 shows the results. As shown in Table 17, different rates of B flow had no effect on the PSD. Moreover, the PSD at each B flow rate was between 1 μm and 3 μm. Table 18 shows the effect on PSD of limiting the flow of bypass carrier gas through the bypass inlet on the secondary housing. The flow of bypass gas through the bypass inlet was limited by using either a valve or by altering the geometry of the orifice (i.e. forming a slot of different dimensions. As shown in Table 18, either the use of a valve or slot to control the flow of bypass gas was effective in producing particles with a PSD of about 1 μm to about 5 μm.

TABLE 17
Characterization of Primary Flow (P flow), Bypass Flow (B Flow),
and particle size diameter of device comprising Mark VI Adder

| | | | Δ P | |
|---|---|---|---|---|
| P Flow | B Flow | PSD | Vac (inches | |
| (LPM) | (LPM) | (microns) | H₂O) | Notes |
| 1.01 | 7 | 2.7-2.8 | .29 | |
| 1.02 | 14.2 | 2.5-2.8 | 1.99 | |
| 1.0 | 14.03 | 2.5-2.7 | 2.11 | |

TABLE 18
Characterization of Primary Flow (P flow), Bypass Flow (B Flow),
and particle size diameter of device comprising Mark VI Adder
with addition of Flap valve to bypass inlet

| | | Δ P | | |
|---|---|---|---|---|
| | | Vac | | |
| P Flow | B Flow | (inches | Orifice | |
| (LPM) | (LPM) | H₂O) | (inches) | Value |
| 0 | 0 | 0 | .060 | Clear |
| 1.48 | .64 | 1 | .060 | Slot .080 |
| 2.20 | 1.58 | 2 | .060 | x 240 |
| 2.81 | 2.70 | 3.14 | .060 | |
| 3.23 | 3.72 | 4 | .060 | |
| 3.66 | 5.10 | 5 | .060 | |
| 4.42 | 7.3 | 7 | .060 | |
| 5.3 | 10.48 | 10 | .060 | |
| 1.48 | 4.86 | 1 | Tee slot | |
| 1.83 | 6.74 | 1.48 | | |
| 2.25 | 9.02 | 2.08 | | |
| 2.50 | 10.6 | 2.53 | | |
| 2.79 | 12.6 | 3.07 | | |
| 3.38 | 17.2 | 4.32 | | |
| 4.14 | 23.7 | 6.24 | | |
| 5.32 | 34.6 | 10.0 | | |
| 1.47 | 5.05 | 1.01 | Internal | |
| | | | radius | |
| 1.86 | 6.34 | 1.51 | valve | |
| 2.23 | 7.7 | 2.06 | Blue | |
| | | | material | |
| 2.52 | 8.7 | 2.56 | | |
| 1.5 | 5.75 | 1 | Internal | |
| | | | radius | |
| 2.2 | 9.2 | 2 | Green | |
| 2.75 | 12.94 | 3 | | |
| 3.27 | 17.5 | 4.06 | | |
| 4.2 | 26.2 | 6.4 | | |
| 5.4 | 38.7 | 10.5 | | |

### Example 12: Effects of Gravity on Particle Size Diameters of Aerosols Generated from an ENT-100-D Device

In this example, the effects of gravity on the particle size diameters (PSD) of a condensation aerosol generated by an ENT-100-D device as depicted in FIG. 31D were tested. The ENT-100-D device was loaded with 2 mg of a liquid propylene glycol formulation and the device was rotated during the use of the device. The device was rotated 90 degrees in all dimensions from a stable baseline position. The particle size diameter was measured at each rotation and found not to change. As a result, the device produced particles of a consistent size regardless of the orientation in space of the device.

### Example 13: Study of the Safety, Tolerability, Pharmacokinetics, and Pharmacodynamics of the eNT-100 Nicotine Inhaler Among Healthy Volunteer Cigarette Smokers-Part 1

Existing electronic nicotine delivery devices tend to produce submicron particles, which have insufficient mass to settle in the deep lung, resulting in buccal delivery and slow pharmacokinetics (PK) and pharmacodynamics (PD). In contrast, 1-3 micron particles can reach the deep lung and have enough gravitational mass to settle on the alveoli, leading to rapid PK and PD effects. This example describes an ascending, placebo- and vehicle-controlled, dose ranging Phase 1 study conducted to explore the tolerability, PK and PD of a novel 1-3 micron condensation aerosol of nicotine and propylene glycol (PG). In this example, Part 1 of a two-part study was conducted to examine the safety, tolerability, pharmacokinetics, and pharmacodynamics of condensation aerosol comprising nicotine produced from a liquid nicotine formulation using the ENT-100 nicotine inhaler (FIG. 82). The primary objectives of Part 1 were to establish the maximally tolerated dose in the range of 25-150 μg per inhalation (250-1500 μg per administration) of a condensation aerosol (i.e., 1-3 microns) comprising nicotine and propylene glycol (PG) from the eNT-100 nicotine inhaler) when administered repeatedly (10 inhalations over 5 minutes), and to establish that use of the eNT-100 nicotine inhaler leads to rapid nicotine absorption with a well-tolerated dose (i.e., rapid nicotine pharmacokinetics [PK]). The secondary objectives were to: 1.) evaluate the acute tolerability and specific adverse event (AE) profile of single doses from the eNT-100 nicotine inhaler (FIG. 82) as compared to both placebo (air only) and a vehicle control (PG alone); 2.) evaluate the pharmacodynamics (PD) of different single doses from the eNT-100 nicotine inhaler) in terms of their ability to reduce acute, abstinence-induced smoking urges, and also affect respiratory and other subjective sensations as compared to both placebo (air only) and a vehicle control (PG alone); 3.) evaluate the nicotine concentrations produced by single doses from the eNT-100 nicotine inhaler as compared to both placebo (air only) and a vehicle control; and 4.) explore the impact of inhalation on liking, satisfaction, respiratory symptoms (e.g., irritation, coughing) and craving or urge reduction.

While preferred embodiments have been shown and described herein, it will be obvious to those skilled in the art that such embodiments are provided by way of example only. Numerous variations, changes, and substitutions will now occur to those skilled in the art. It should be understood that various alternatives to the embodiments of the invention described herein may be employed. It is intended that the following claims define the scope of the invention and that methods and structures within the scope of these claims and their equivalents be covered thereby.

1. A method for generating an aerosol comprising:
using an electronic controller to control amounts of liquid delivered to a heater in a vaporizing device, the electronic controller having a control program including a first phase and a second phase, the electronic controller controlling operation of the heater and a liquid moving component, with the vaporizing device:
delivering a first amount of a liquid to the heater via operation of the first phase of the control program;
heating the first amount of the liquid to generate a first aerosol of aerosol particles of a first diameter;
delivering a second amount of the liquid to the heater via operation of the second phase of the control program, wherein the second amount is different from the first amount; and
heating the second amount of the liquid to generate a second aerosol of aerosol particles of a second diameter different from the first diameter.

2. The method of claim 1 wherein the first phase and the second phase occur sequentially during use of the device.

3. The method of claim 2 wherein the first diameter is 1-5 microns for delivery and absorption in a deep lung of a subject using the device, and the device produces no or substantially no visible vapor upon exhalation by a subject using the device.

4. The method of claim 1 wherein the second diameter is less than one micron for producing a visible vapor upon exhalation by a user of the device.

5. The method of claim 1 wherein the liquid moving component comprises a pump, and wherein the first phase controls the pump to deliver the first amount to the heater, and wherein the second phase controls the pump to deliver the second amount to the heater.

6. The method of claim 5 wherein the first phase controls the pump to operate at a first rate, and wherein the second phase controls the pump to operate at a second rate, wherein the first rate and the second rate are different.

7. The method of claim 1 wherein the first diameter is a size effective for delivery and absorption in a deep lung of a subject using the device, and wherein the size effective for delivery and absorption in the deep lung of a subject using the device produces no or substantially no visible vapor upon exhalation by a subject using the device.

8. The method of claim 1 wherein the second diameter is a size effective for producing a visible vapor upon exhalation by a subject using the device.
